(19) United States
(12) Patent Application Publication
(10) Pub. No.: US 2019/0338190 A1
(43) Pub. Date: Nov. 7, 2019

(54) SILICON-CONTAINING COMPOUND, LIQUID-CRYSTAL COMPOSITION AND LIQUID-CRYSTAL DISPLAY USING THE SAME

(71) Applicant: DAXIN MATERIALS CORPORATION, Taichung City (TW)

(72) Inventors: Chung-Hsien WU, Taichung City (TW); Ching-Tien LEE, Taichung City (TW); Chih-Yuan LO, Taichung City (TW); Chun-Chih WANG, Taichung City (TW)

(21) Appl. No.: 16/403,941

(22) Filed: May 6, 2019

(30) Foreign Application Priority Data
May 7, 2018 (TW) 107115434

(51) Int. Cl. C09K 19/40; C07F 7/08

(52) U.S. Cl. CPC C09K 19/406; C07F 7/0812; C07F 7/081

(57) ABSTRACT

A silicon-containing compound, liquid-crystal composition and a liquid-crystal display using the silicon-containing compound are provided. The silicon-containing compound has a structure represented by Formula (I):

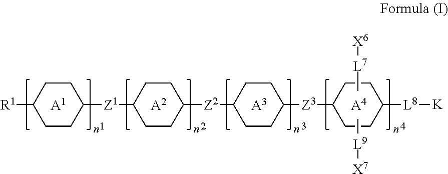

wherein K, R¹, A¹, A², A³, A⁴, Z¹, Z², Z³, L⁷, L⁸, L⁹, X⁶, X⁷, n¹, n², n³, and n⁴ are defined as in the specification.

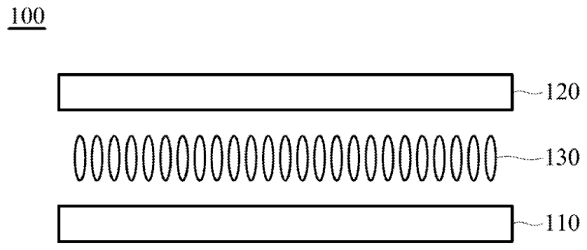

### CROSS REFERENCE TO RELATED APPLICATIONS

This application claims priority of Taiwan Patent Application No. 107115434, filed on May 7, 2018, the entirety of which is incorporated by reference herein.

### BACKGROUND

### Technical Field

The present disclosure relates to a silicon-containing compound, and in particular, it relates to a liquid-crystal composition and a liquid-crystal display using the silicon-containing compound.

### Description of the Related Art

Liquid-crystal display devices have been used in various applications, including personal computers, personal digital assistants (PDAs), mobile phones, televisions, and so on, because of these devices equipped with many advantages. These advantages include light in weight, low power consumption, and no emitting radiation.

In a liquid-crystal display device, alignment of liquid-crystal molecules can be achieved with a polyimide film. Conventional liquid-crystal alignment layers are generally produced by coating a polyimide onto a substrate to form a film, and then mechanically rubbing it to form the desired liquid-crystal alignment groove on the surface of the polyimide film. However, after rubbing the alignment film, uneven alignment may occur or serious brush marks may be produced. As a result, the product yield of the liquid-crystal display device is not good.

Furthermore, the procedure can also be simplified without alignment layer. Therefore, manufacturers have begun to develop liquid-crystal display devices having no alignment layer. The liquid-crystal composition of such a liquid-crystal display device contains polar compounds, and the liquid-crystal molecules are vertically aligned by the function of the polar compounds. However, it is difficult for such polar compounds to be compatible with vertical alignment ability and a high voltage holding ratio.

Accordingly, a liquid-crystal composition having excellent vertical alignment ability and a high voltage holding ratio is still needed in this technical field.

### BRIEF SUMMARY

In one embodiment of the present disclosure, a silicon-containing compound is provided. The silicon-containing compound is represented by Formula (I):

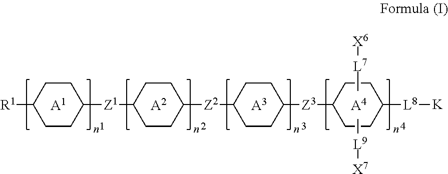

wherein

K represents

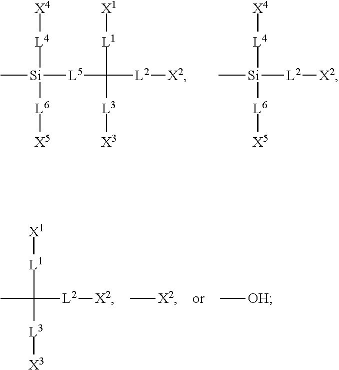

R¹ represents fluorine, chlorine, hydrogen, a C₁-C₂₀ linear alkyl group, a C₃-C₂₀ branched alkyl group, a C₁-C₂₀ linear alkoxy group, or a C₃-C₂₀ branched alkoxy group, wherein the C₁-C₂₀ linear alkyl group, the C₃-C₂₀ branched alkyl group, the C₁-C₂₀ linear alkoxy group, or the C₃-C₂₀ branched alkoxy group is unsubstituted or at least one —CH₂— of the C₁-C₂₀ linear alkyl group, the C₃-C₂₀ branched alkyl group, the C₁-C₂₀ linear alkoxy group, or the C₃-C₂₀ branched alkoxy group is substituted by —SiR^{a}₂—, —C≡C—, —CH═CH—, —CF₂O—, —O—, —COO—, —OCO—, or —OOC—, and/or at least one hydrogen atom of the C₁-C₂₀ linear alkyl group, the C₃-C₂₀ branched alkyl group, the C₁-C₂₀ linear alkoxy group, or the C₃-C₂₀ branched alkoxy group is substituted by a halogen atom, and wherein R^{a} represents a C₁-C₁₀ linear alkyl group or a C₃-C₁₀ branched alkyl group, and two R^{a} groups bonded to the same Si atom are identical to each other or different from each other;

each of A¹, A², A³ and A⁴ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the tetrahydronaphthalene-2,6-diyl group, or the indane-2,5-diyl group is unsubstituted or at least one hydrogen atom of the 1,4-phenylene group, the 1,4-cyclohexylene group, the tetrahydronaphthalene-2,6-diyl group, or the indane-2,5-diyl group is substituted by a halogen atom or a CN group, and/or at least one —CH₂— of the 1,4-phenylene group, the 1,4-cyclohexylene group, the tetrahydronaphthalene-2,6-diyl group, or the indane-2,5-diyl group is substituted by —O—, —N— or —S—, and wherein the —O—, —N—, and —S— do not directly bond to one another;

each of Z¹, Z², and Z³ independently represents a single bond, —CH₂—CH₂—, —C≡C—, —CH═CH—, —CF₂O—, —OCF₂—, —CH₂O—, —OCH₂—, —COO—, —OCO—, —OOC—, —CF₂—CF₂—, or —CF═CF—;

each of L¹, L², L³, L⁴, L⁵, L⁶, L⁷, L⁸ and L⁹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by —C≡C—, —CH═CH—, —CF₂O—, —O—, —COO—, —OCO—, or —OOC—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom, and wherein L⁴, L⁵, L⁶, L⁷ and L⁹ are unsubstituted or at least one carbon atom of L⁴, L⁵, L⁶, L⁷ and L⁹ is substituted by a silicon atom;

each of X¹, X², X³, X⁴, X⁵, X⁶, and X⁷ independently represents hydrogen, —OH,

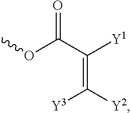

or any one of the following:

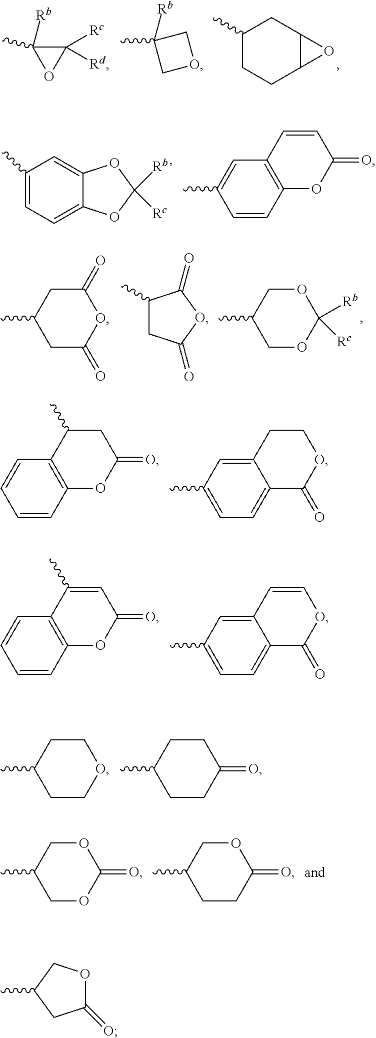

wherein Y¹ represents —OH, hydrogen, a C₁-C₁₅ alkyl group, or a C₂-C₁₅ alkenyl group, and the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH or any one of the following:

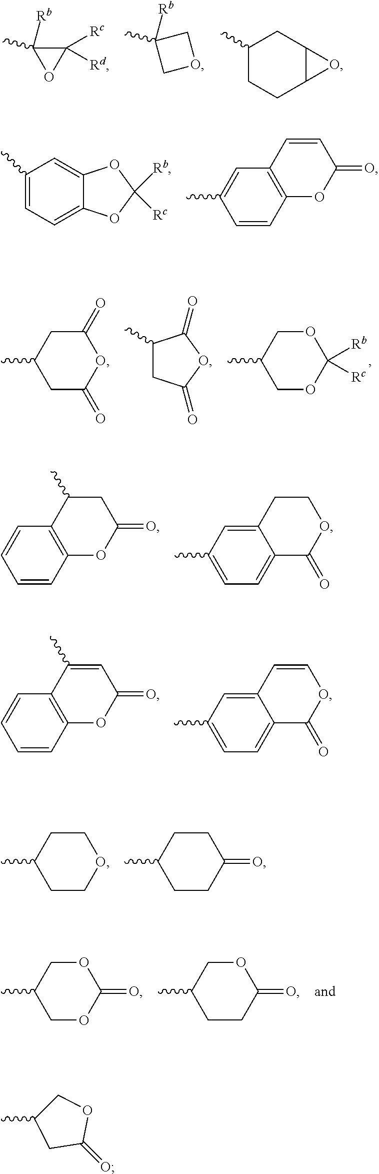

each of Y² and Y³ independently represents hydrogen, halogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by a halogen atom;

each of R^{b}, R^{c}, and R^{d} independently represents fluorine, chlorine, hydrogen, a C₁-C₁₀ linear alkyl group, a C₃-C₁₀ branched alkyl group, a C₁-C₁₀ linear alkoxy group, or a C₃-C₁₀ branched alkoxy group, wherein the C₁-C₁₀ linear alkyl group, the C₃-C₁₀ branched alkyl group, the C₁-C₁₀ linear alkoxy group, or the C₃-C₁₀ branched alkoxy group is unsubstituted or at least one —CH₂— of the C₁-C₁₀ linear alkyl group, the C₃-C₁₀ branched alkyl group, the C₁-C₁₀ linear alkoxy group, or the C₃-C₁₀ branched alkoxy group is substituted by —CH═CH—, —CF₂O—, —O—, —COO—, —OCO—, or —OOC—, and/or at least one hydrogen atom of the C₁-C₁₀ linear alkyl group, the C₃-C₁₀ branched alkyl group, the C₁-C₁₀ linear alkoxy group, or the C₃-C₁₀ branched alkoxy group is substituted by a halogen atom;

wherein at least one of X¹, X², X³, X⁴, X⁵, X⁶, and X⁷ represents —OH or any one of the following:

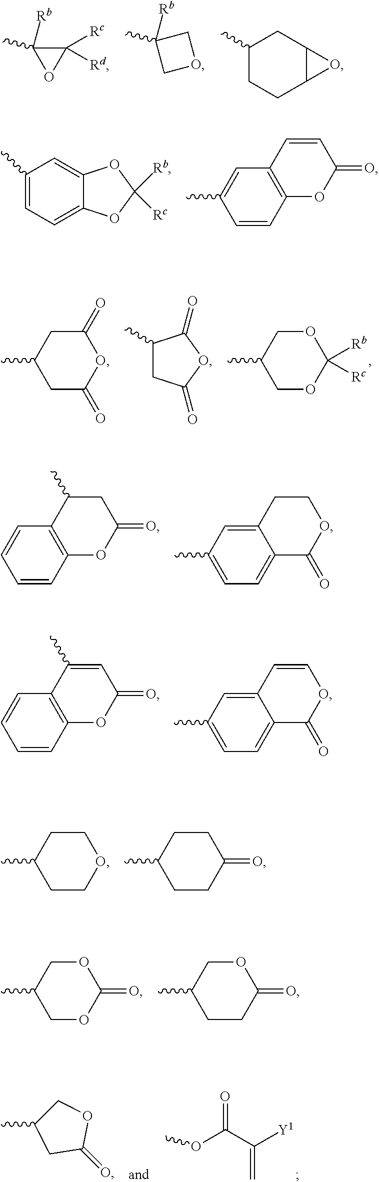

wherein Y¹ represents —OH, a C₁-C₁₅ alkyl group, or a C₂-C₁₅ alkenyl group, and wherein at least one hydrogen atom of the C₁-C₁₅ alkyl group or the C₂-C₁₅ alkenyl group is substituted by —OH or any one of the following:

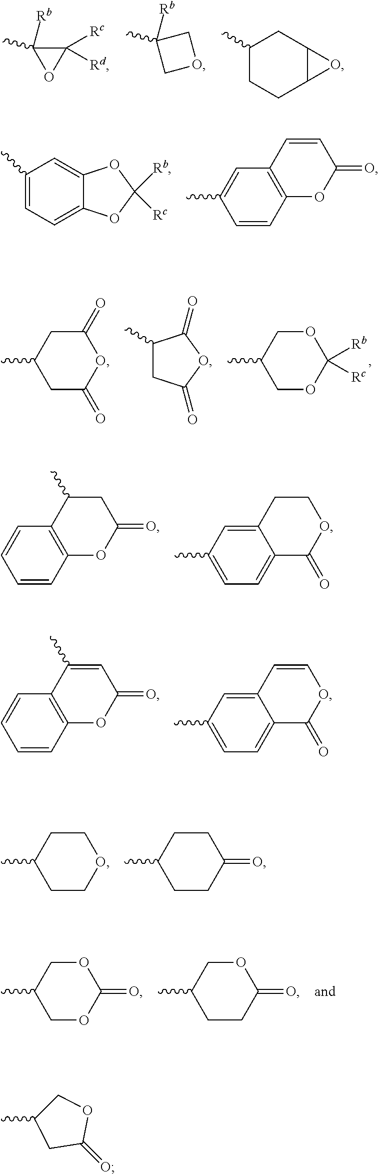

wherein at most two of X¹, X², X³, X⁴, X⁵, X⁶, and X⁷ represents —OH;

wherein when R¹ does not include silicon, K represents

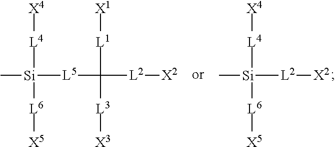

each of n¹, n², n³, and n⁴ independently represents 0 or 1, and wherein at least one of n¹, n², n³, and n⁴ does not represent 0; and

wherein in the Formula (I), a silicon atom does not directly bond to another silicon atom, and a silicon atom does not directly bond to an oxygen atom.

In another embodiment of the present disclosure, a liquid-crystal composition is provided. The liquid-crystal composition includes a first component and a second component. The first component includes at least one silicon-containing compound as mentioned above, and the second component includes at least one compound represented by Formula (II):

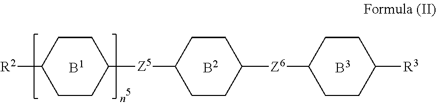

wherein

each of R² and R³ independently represents hydrogen, halogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by a halogen atom, and/or at least one —CH₂— of the C₁-C₁₅ alkyl group or the C₂-C₁₅ alkenyl group is substituted by —O—, and wherein the —O— do not directly bond to another —O—;

each of B¹, B², and B³ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is unsubstituted or at least one hydrogen atom of the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is substituted by a halogen atom or a CN group, and/or at least one —CH₂— of the 1,4-phenylene group, the 1,4-cyclohexylene group, the 1,3-dioxane-2,5-diyl group, the benzofuran-2,5-diyl group, the tetrahydronaphthalene-2,6-diyl group, the or the tetrahydropyran-2,5-diyl group is substituted by —O—, —N— or —S—, and wherein the —O—, —N—, and —S— do not directly bond to one another;

each of Z⁵ and Z⁶ independently represents a single bond, a C₁-C₄ alkylene group, a C₂-C₄ alkenylene group, or a C₂-C₄ alkynylene group, wherein the C₁-C₄ alkylene group, the C₂-C₄ alkenylene group, or the C₂-C₄ alkynylene group is unsubstituted or at least one hydrogen atom of the C₁-C₄ alkylene group, the C₂-C₄ alkenylene group, or the C₂-C₄ alkynylene group is substituted by a halogen atom or a CN group, and/or at least one —CH₂— of the C₁-C₄ alkylene group, the C₂-C₄ alkenylene group, or the C₂-C₄ alkynylene group is substituted by —O— or —S—, and wherein the —O— does not directly bond to —O— or —S—, and —S— does not directly bond to —S—; and

n⁵ represents 0, 1, or 2, and when n⁵ represents 2, two B¹ groups are identical to each other or different from each other.

In another embodiment of the present disclosure, a liquid-crystal composition is provided. The liquid-crystal display device includes a first substrate and a second substrate disposed opposite to the first substrate. The liquid-crystal display device also includes a liquid-crystal layer disposed between the first substrate and the second substrate. The liquid-crystal layer includes the above-mentioned silicon-containing compound.

### BRIEF DESCRIPTION OF THE DRAWINGS

To further simplify and clarify the foregoing contents and other objects, characteristics, and merits of the present disclosure, a detailed description is given in the following embodiments with reference to the accompanying drawings. It should be emphasized that many features are not drawn to scale according to industry standard practice. In fact, the dimensions of the various components may be arbitrarily increased or decreased for clarity of discussion.

The sole FIGURE is a cross-sectional view showing a liquid-crystal display device in accordance with some embodiments of the present disclosure.

### DETAILED DESCRIPTION

In the present specification, the term “about” or “approximately” means in a range of 20% of a given value or range, preferably 10%, and more preferably 5%. In the present specification, if there is no specific explanation, a given value or range means an approximate value which may imply the meaning of “about” or “approximately”.

The present disclosure provides a silicon-containing compound. In some embodiments, the silicon-containing compound has excellent vertical alignment ability while having a high voltage holding ratio. In the present specification, the term “vertical alignment ability of the silicon-containing compound” means the degree of vertical alignment of liquid-crystal molecules in a liquid-crystal composition when a silicon-containing compound is added to the liquid-crystal composition. More specifically, by adding the silicon-containing compound of the present disclosure as an additive to the liquid-crystal composition, most liquid-crystal molecules can be vertically aligned well without using a conventional alignment film (for example, a polyimide film). Furthermore, the liquid-crystal display device using the silicon-containing compound of the present disclosure has a high voltage holding ratio.

In some embodiments, a silicon-containing compound is provided. The silicon-containing compound is represented by Formula (I):

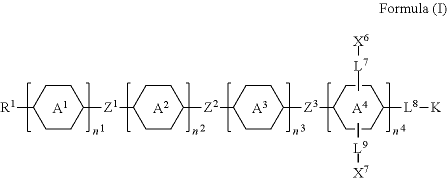

wherein

K represents

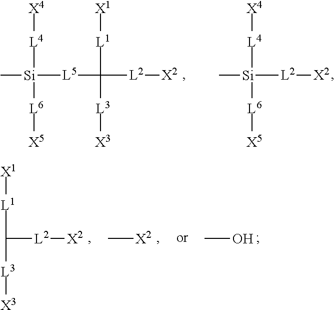

R¹ represents fluorine, chlorine, hydrogen, a C₁-C₂₀ linear alkyl group, a C₃-C₂₀ branched alkyl group, a C₁-C₂₀ linear alkoxy group, or a C₃-C₂₀ branched alkoxy group, wherein the C₁-C₂₀ linear alkyl group, the C₃-C₂₀ branched alkyl group, the C₁-C₂₀ linear alkoxy group, or the C₃-C₂₀ branched alkoxy group is unsubstituted or at least one —CH₂— of the C₁-C₂₀ linear alkyl group, the C₃-C₂₀ branched alkyl group, the C₁-C₂₀ linear alkoxy group, or the C₃-C₂₀ branched alkoxy group is substituted by —SiR^{a}₂—, —C≡C—, —CH═CH—, —CF₂O—, —O—, —COO—, —OCO—, or —OOC—, and/or at least one hydrogen atom of the C₁-C₂₀ linear alkyl group, the C₃-C₂₀ branched alkyl group, the C₁-C₂₀ linear alkoxy group, or the C₃-C₂₀ branched alkoxy group is substituted by a halogen atom, and wherein R^{a} represents a C₁-C₁₀ linear alkyl group or a C₃-C₁₀ branched alkyl group, and two R^{a} groups bonded to the same Si atom are identical to each other or different from each other;

each of A¹, A², A³ and A⁴ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the tetrahydronaphthalene-2,6-diyl group, or the indane-2,5-diyl group is unsubstituted or at least one hydrogen atom of the 1,4-phenylene group, the 1,4-cyclohexylene group, the tetrahydronaphthalene-2,6-diyl group, or the indane-2,5-diyl group is substituted by a halogen atom or a CN group, and/or at least one —CH₂— of the 1,4-phenylene group, the 1,4-cyclohexylene group, the tetrahydronaphthalene-2,6-diyl group, or the indane-2,5-diyl group is substituted by —O—, —N— or —S—, and wherein the —O—, —N—, and —S— do not directly bond to one another;

each of Z¹, Z², and Z³ independently represents a single bond, —CH₂—CH₂—, —C≡C—, —CH═CH—, —CF₂O—, —OCF₂—, —CH₂O—, —OCH₂—, —COO—, —OCO—, —OOC—, —CF₂—CF₂—, or —CF═CF—;

each of L¹, L², L³, L⁴, L⁵, L⁶, L⁷, L⁸ and L⁹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by —C≡C—, —CH═CH—, —CF₂O—, —O—, —COO—, —OCO—, or —OOC—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom, and wherein L⁴, L⁵, L⁶, L⁷ and L⁹ are unsubstituted or at least one carbon atom of L⁴, L⁵, L⁶, L⁷ and L⁹ is substituted by a silicon atom;

each of X¹, X², X³, X⁴, X⁵, X⁶, and X⁷ independently represents hydrogen, —OH,

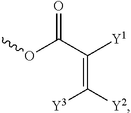

or any one of the following:

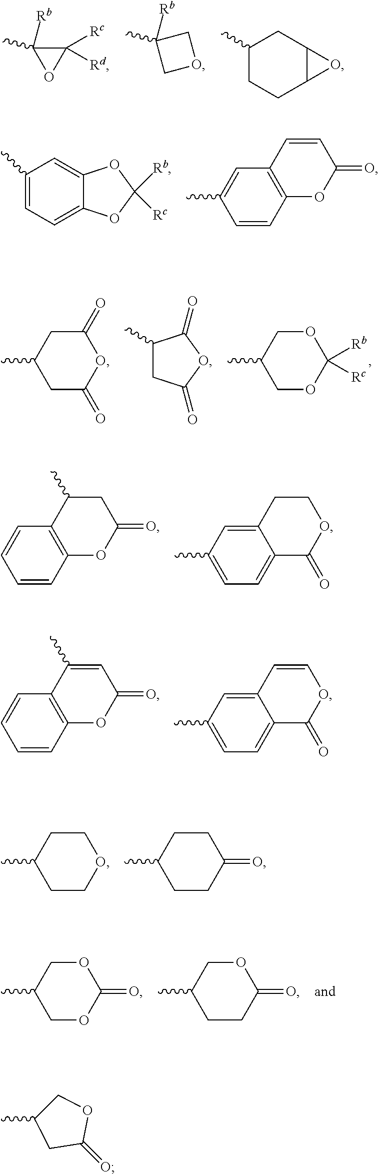

wherein Y¹ represents —OH, hydrogen, a C₁-C₁₅ alkyl group, or a C₂-C₁₅ alkenyl group, and the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH or any one of the following:

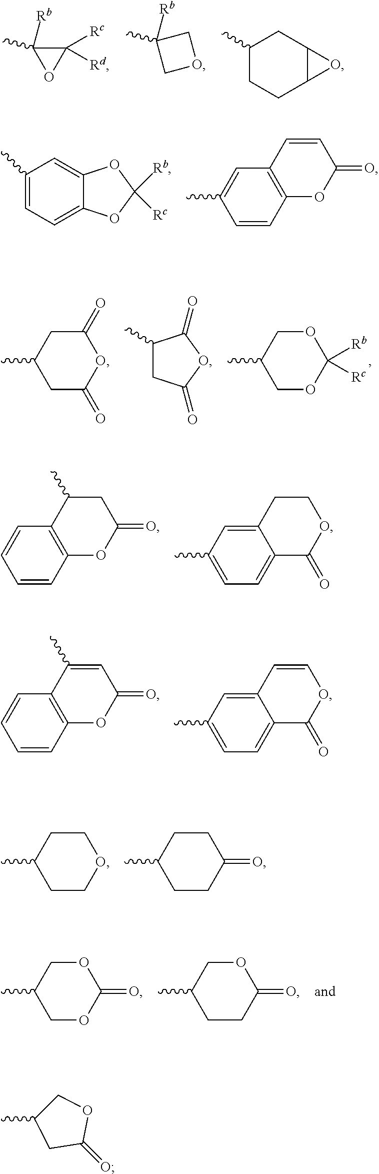

each of Y² and Y³ independently represents hydrogen, halogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by a halogen atom;

each of R^{b}, R^{c}, and R^{d} independently represents fluorine, chlorine, hydrogen, a C₁-C₁₀ linear alkyl group, a C₃-C₁₀ branched alkyl group, a C₁-C₁₀ linear alkoxy group, or a C₃-C₁₀ branched alkoxy group, wherein the C₁-C₁₀ linear alkyl group, the C₃-C₁₀ branched alkyl group, the C₁-C₁₀ linear alkoxy group, or the C₃-C₁₀ branched alkoxy group is unsubstituted or at least one —CH₂— of the C₁-C₁₀ linear alkyl group, the C₃-C₁₀ branched alkyl group, the C₁-C₁₀ linear alkoxy group, or the C₃-C₁₀ branched alkoxy group is substituted by —CH═CH—, —CF₂O—, —O—, —COO—, —OCO—, or —OOC—, and/or at least one hydrogen atom of the C₁-C₁₀ linear alkyl group, the C₃-C₁₀ branched alkyl group, the C₁-C₁₀ linear alkoxy group, or the C₃-C₁₀ branched alkoxy group is substituted by a halogen atom;

wherein at least one of X¹, X², X³, X⁴, X⁵, X⁶, and X⁷ represents —OH or any one of the following:

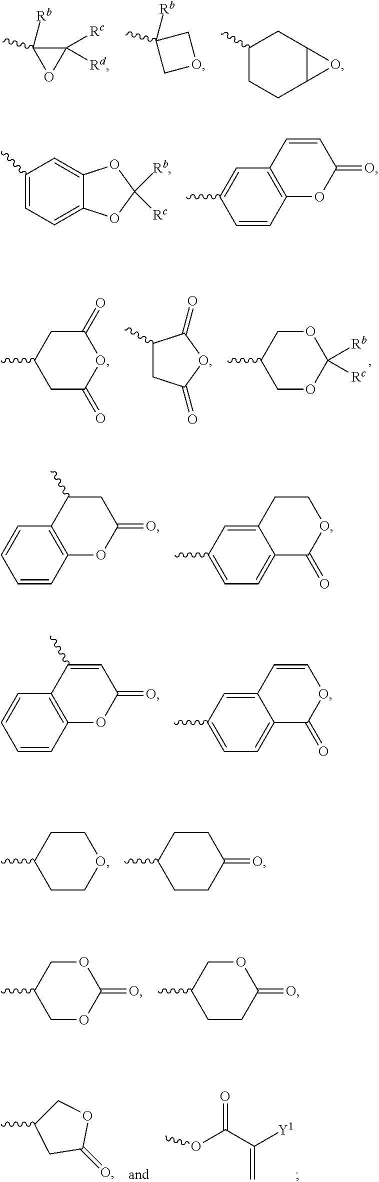

wherein Y¹ represents —OH, a C₁-C₁₅ alkyl group, or a C₂-C₁₅ alkenyl group, and wherein at least one hydrogen atom of the C₁-C₁₅ alkyl group or the C₂-C₁₅ alkenyl group is substituted by —OH or any one of the following:

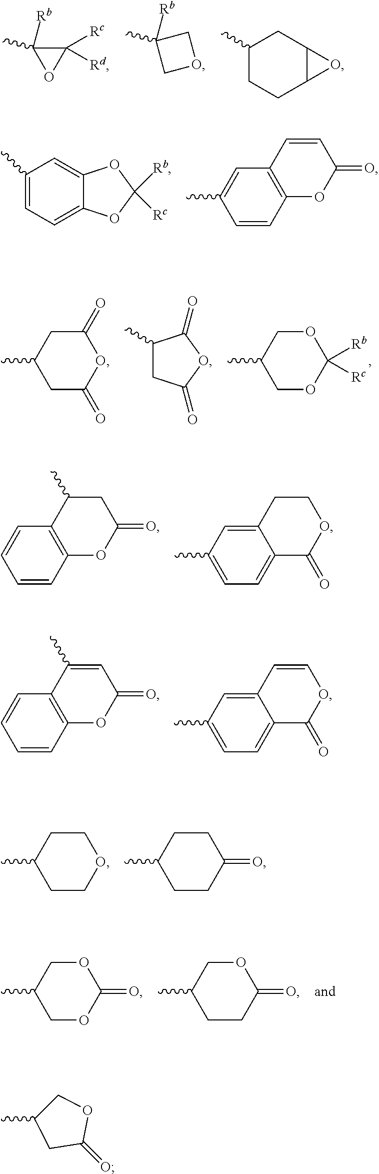

wherein at most two of X¹, X², X³, X⁴, X⁵, X⁶, and X⁷ represents —OH;

wherein when R¹ does not include silicon, K represents

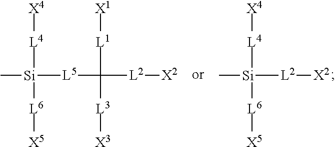

each of n¹, n², n³, and n⁴ independently represents 0 or 1, and wherein at least one of n¹, n², n³, and n⁴ does not represent 0; and

wherein in the Formula (I), a silicon atom does not directly bond to another silicon atom, and a silicon atom does not directly bond to an oxygen atom.

The structure represented by the Formula (I) is substantially a rod-shaped structure. This rod-shaped structure has a first axial direction and a second axial direction. The first axial direction is the long axial direction of the rod-shaped structure, that is, the direction in which the functional group R¹ and the functional group K are connected. The second axial direction is a short axial direction of the rod-shaped structure, that is, a direction perpendicular to the first axial direction. In the Formula (I), at least one of the functional groups X¹, X², X³, X⁴, X⁵, X⁶, and X⁷ may be used as an anchoring group to fix the silicon-containing compound to the substrate (for example, the first substrate 110 or the second substrate 120 shown in the sole FIGURE). The anchoring group may be a functional group having a higher polarity. The anchoring group may generate a bond or a hydrogen bond with a substrate (for example, glass or ITO), and therefore, the silicon-containing compound can be adsorbed (or fixed) on the substrate. For example, the anchoring group may include —OH or any one of the following functional groups:

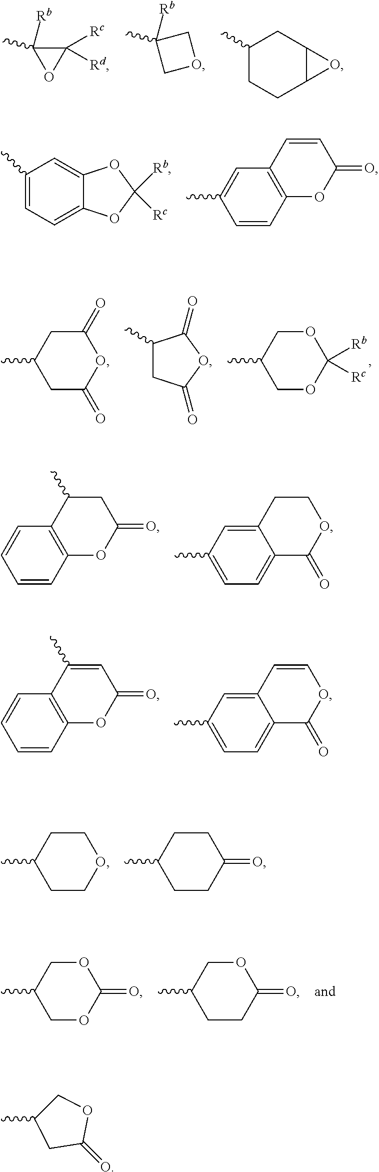

In order to achieve a state in which the liquid-crystal molecules are well aligned vertically, the silicon-containing compound may be fixed on the substrate in such a manner that the first axial direction is perpendicular to the top surface of the substrate. In some embodiments, the anchoring group is one of X¹, X², X³, X⁴, X⁵, X⁶, and X⁷ that is closest to the right end of the molecule of the Formula (I) such that the first axis is perpendicular to the top surface of the substrate.

In some embodiments, each of the silicon-containing compounds has only one anchoring group. Therefore, each silicon-containing compound has the same alignment direction on the substrate. In other words, the first axial directions of the different silicon-containing compounds are parallel to each other. In this way, the liquid-crystal molecules can be aligned in a uniform state, and defects (for example, local bright spots generated in the dark state) are not easily generated. In other embodiments, each of the silicon-containing compounds has two anchoring groups. Therefore, it is helpful for the immobilization of the silicon-containing compound on the substrate without being easily detached. In this way, the occurrence of defects can also be reduced. In such an embodiment, in order to avoid that the orientation of the different silicon-containing compounds is too different (for example, the angle of the first axial direction of the different silicon-containing compound is 45-90 degrees), the distance between two anchoring groups can be shortened as much as possible. For example, two anchoring groups may be located on two carbons of the same carbon chain. In addition, in order to avoid the difference in the arrangement direction of different silicon-containing compounds, and to avoid the polarity of the silicon-containing compound being too high to be dissolved in the liquid-crystal composition, in one silicon-containing compound, the number of anchoring groups is not more than two.

In the Formula (I), the cyclic functional groups (i.e., A¹, A², A³, and A⁴) may be an aliphatic ring or an aromatic ring. The cyclic functional group contributes to the alignment of the liquid-crystal molecules. More specifically, the aromatic cyclic functional group may generate a π-π stacking so that the rod-shaped liquid-crystal molecules may be aligned in a specific direction. The aliphatic cyclic functional group can align the rod-shaped liquid-crystal molecules in a specific direction by steric hindrance. In some embodiments, the first axial direction of the silicon-containing compound is perpendicular to the top surface of the substrate, and the long axis of the rod-shaped liquid-crystal molecules is parallel to the first axial direction of the silicon-containing compound. Therefore, the long axis of the rod-shaped liquid-crystal molecules can be made perpendicular to the substrate by the silicon-containing compound. In other words, the vertical alignment of the liquid-crystal molecules can be achieved.

Some negative ions (for example, fluoride ions) may be remained in the liquid-crystal composition. These ions can cause residual current and reduce the voltage holding ratio during the operation of the display. More specifically, the higher concentration of the negative ions results in the lower the voltage holding ratio. Silicon atoms are electron-poor than carbon atoms, and therefore, silicon atoms can attract (or capture) the negative ions in the liquid-crystal composition. As a result, the concentration of the negative ions in the liquid-crystal composition can be lowered, and the voltage holding ratio of the liquid-crystal display device can be increased. In other words, in the molecule of the Formula (I), the silicon atom has a function of increasing the voltage holding ratio. Furthermore, in order to attract the negative ions, the silicon atom in the molecule of the Formula (I) is not directly bonded to the oxygen atom. In addition, the silicon atom is bonded to at least two methyl groups, and the solubility of the molecule of the Formula (I) in the liquid-crystal composition can also be improved.

In the Formula (I), at least one of the functional groups X¹, X², X³, X⁴, X⁵, X⁶, and X⁷ may be used as the polymerizable group. The polymerizable group may undergo the polymerization reaction with another polymerizable group by irradiation or heating, and the two polymerizable groups may be bonded to each other. When a plurality of silicon-containing compounds are fixed on the substrate, the polymerizable group of the silicon-containing compound undergoes the polymerization reaction with the polymerizable group of the adjacent silicon-containing compound. Therefore, a plurality of vertically aligned silicon-containing compounds can form a network structure. This network structure can avoid the tilt of the silicon-containing compound. As a result, the vertical alignment of the liquid-crystal molecules is improved further. The polymerizable group may include an acrylic group, a methacrylic group, or a derivative thereof. In some embodiments, at least one of the functional groups X¹, X², X³, X⁴, X⁵, X⁶, and X⁷ is a polymerizable group having the structure:

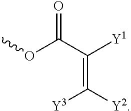

In accordance with some embodiments, the silicon atoms may be located at the left end of the molecule of the Formula (I). In such an embodiment, in the Formula (I), R¹ is a C₁-C₁₈ alkyl group or a C₁-C₁₈ alkoxy group, and one —CH₂— of the C₁-C₁₈ alkyl group or the C₁-C₁₈ alkoxy group is substituted by —SiR^{a}₂—, and wherein R^{a} is a C₁-C₁₀ linear alkyl group or a C₃-C₁₀ branched alkyl group, and K is

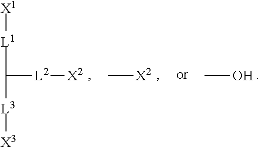

In accordance with some embodiments, the chain length of the linking group directly bonded to the anchoring group is longer than the chain length of the other two linking groups. In such an embodiment, the steric hindrance due to the other two linking groups can be avoided, and therefore, the anchoring group can be fixed on the surface of the substrate. For example, when X³ is an anchoring group, the linking group L³ directly bonded to the anchoring group X³ has a longer chain length than the chain lengths of other two linking groups L¹ and L². In some embodiments, L³ is a C₁-C₁₅ linear alkylene group, a C₃-C₁₅ branched alkylene group, a C₁-C₁₅ linear alkyleneoxy group or a C₃-C₁₅ branched alkyleneoxy group; and each of L¹ and L² independently is a single bond, a C₁-C₈ alkylene group, a C₂-C₈ alkenylene group, or a C₂-C₈ alkynylene group; and the chain length of L¹ is shorter than the chain length of L³, and the chain length of L² is shorter than the chain length of L³.

In accordance with some embodiments, the above-mentioned silicon-containing compound of the Formula (I) has the structure represented by Formula (I′):

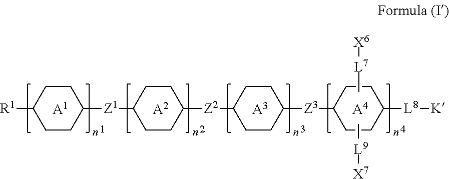

wherein

when R¹ does not comprise silicon, K′ represents

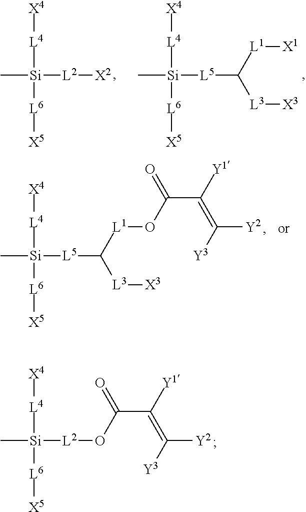

when R¹ comprises silicon, K′ represents

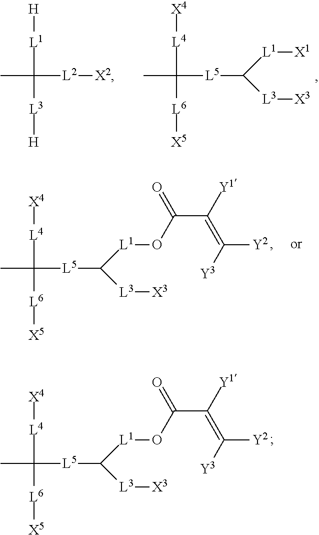

the definitions of R¹, A¹, A², A³, A⁴, Z¹, Z², Z³, L¹, L², L³, L⁴, L⁵, L⁶, L⁷, L⁸, L⁹, X⁴, X⁵, X⁶, X⁷, Y¹, Y², Y³, n¹, n², and n³ are respectively the same as the definitions of R¹, A¹, A², A², A³, A⁴, Z¹, Z², Z³, L¹, L², L³, L⁴, L⁵, L⁶, L⁷, L⁸, L⁹, X⁴, X⁵, X⁶, X⁷, Y¹, Y², Y³, n¹, n² and n³ defined in the previous paragraphs;

each of X¹, X², and X³ independently represents —OH or any one of the following:

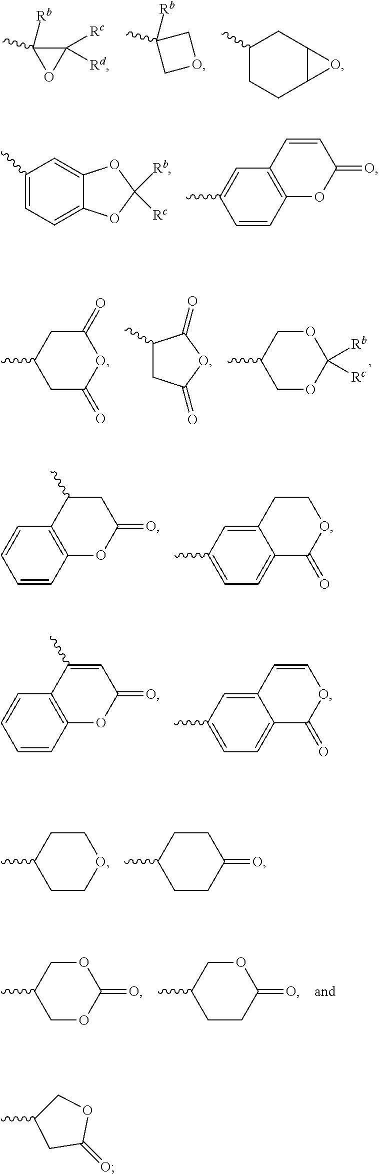

and

Y^{1′} represents hydrogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH.

In accordance with some embodiments, the above-mentioned silicon-containing compound of the Formula (I′) has the structure represented by Formula (I-A-1), Formula (I-B-1), Formula (I-C-1), Formula (I-D-1), or Formula (I-D-2):

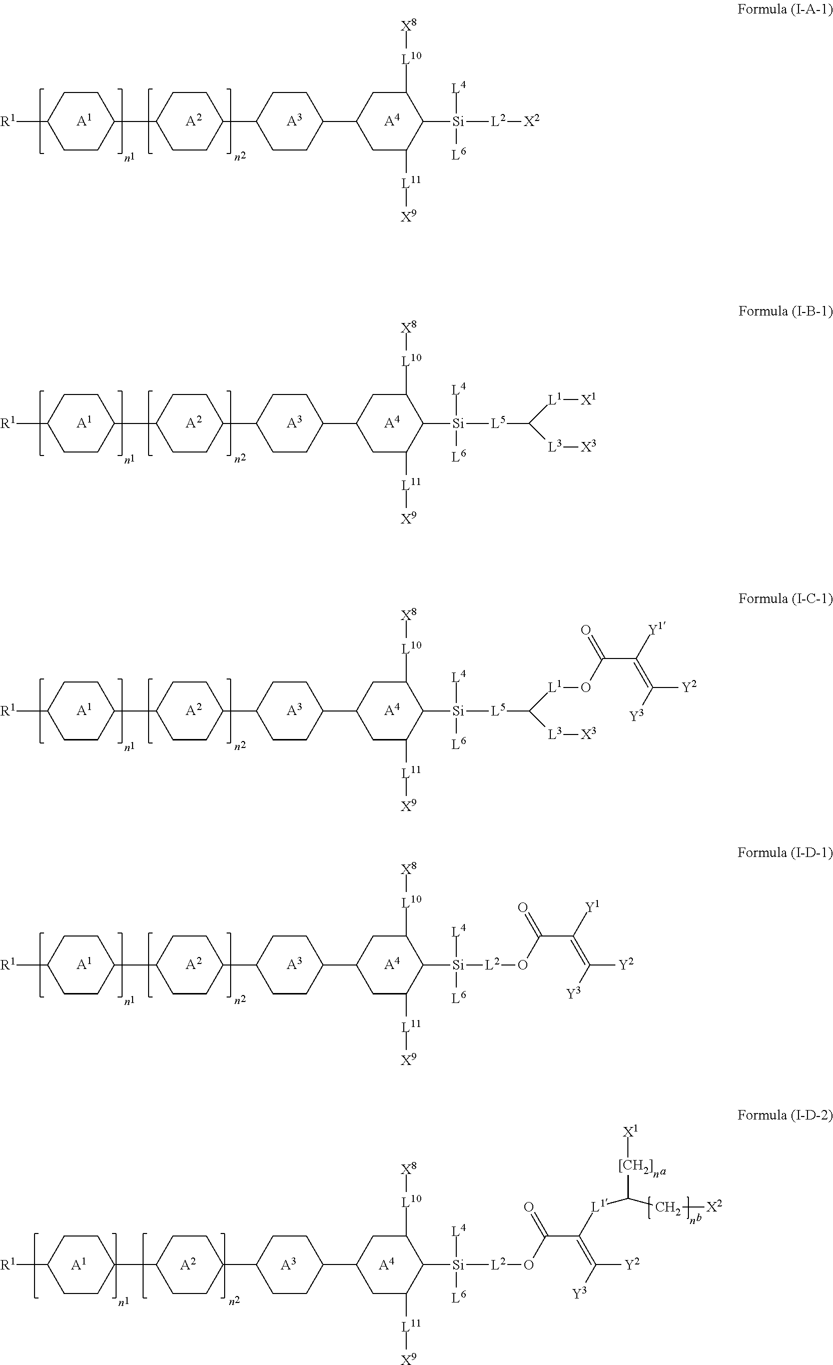

wherein

the definitions of R¹, L¹, L², L³, L⁴, L⁵, L⁶, Y¹, Y², Y³, n¹, and n² are respectively the same as the definitions of R¹, L¹, L², L³, L⁴, L⁵, L⁶, Y¹, Y², Y³, n¹, and n² defined in the previous paragraphs;

each of A¹, A², A³ and A⁴ independently represents a 1,4-phenylene group, a tetrahydronaphthalene-2,6-diyl group, or a 1,4-cyclohexylene group, wherein the 1,4-phenylene group, the tetrahydronaphthalene-2,6-diyl group, or the 1,4-cyclohexylene group is unsubstituted or at least one hydrogen atom of the 1,4-phenylene group, the tetrahydronaphthalene-2,6-diyl group, or the 1,4-cyclohexylene group is substituted by a halogen atom, and/or at least one —CH₂— of the 1,4-phenylene group, the tetrahydronaphthalene-2,6-diyl group, or the 1,4-cyclohexylene group is substituted by —O—, and wherein the —O— do not directly bond to another —O—;

the definitions of X¹, X², and X³ are respectively the same as the definitions of X¹, X², and X³ defined in the previous paragraphs;

each of X⁸ and X⁹ independently represents hydrogen,

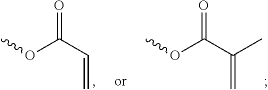

L^{1′} represents a single bond, a C₁-C₅ linear alkylene group, a C₃-C₅ branched alkylene group, a C₁-C₅ linear alkyleneoxy group, or a C₃-C₅ branched alkyleneoxy group, wherein the C₁-C₅ linear alkylene group, the C₃-C₅ branched alkylene group, the C₁-C₅ linear alkyleneoxy group, or the C₃-C₅ branched alkyleneoxy group is unsubstituted or at least one —CH₂— of the C₁-C₅ linear alkylene group, the C₃-C₅ branched alkylene group, the C₁-C₅ linear alkyleneoxy group, or the C₃-C₅ branched alkyleneoxy group is substituted by —O— or —COO—, and/or at least one hydrogen atom of the C₁-C₅ linear alkylene group, the C₃-C₅ branched alkylene group, the C₁-C₅ linear alkyleneoxy group, or the C₃-C₅ branched alkyleneoxy group is substituted by a halogen atom;

each of L¹⁰ and L¹¹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by —O— or —COO—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom;

each of n^{a} and n^{b} independently represents an integer of 0 to 10, and the sum of n^{a} and n^{b} is not greater than 10; and

Y^{1′} represents hydrogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH.

In accordance with some embodiments, the above-mentioned silicon-containing compound of the Formula (I′) has the structure represented by Formula (I-A-2), Formula (I-B-2), Formula (I-C-2), Formula (I-D-3), or Formula (I-D-4):

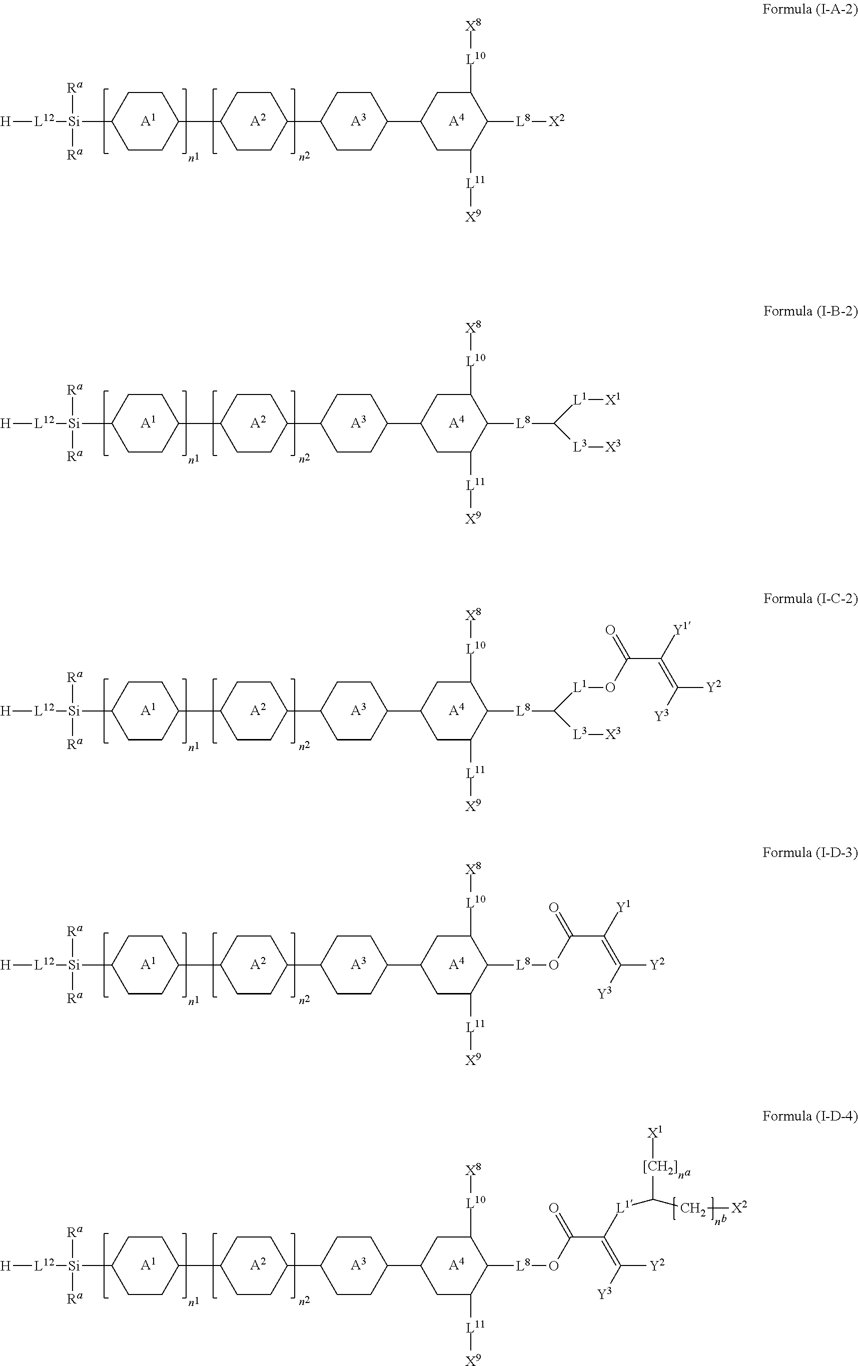

wherein

the definitions of R^{a}, L⁸, Y¹, Y², Y³, n¹, and n² are respectively the same as the definitions of R^{a}, L⁸, Y¹, Y², Y³, n¹, and n² defined in the previous paragraphs;

each of A¹, A², A³ and A⁴ independently represents a 1,4-phenylene group, a tetrahydronaphthalene-2,6-diyl group, or a 1,4-cyclohexylene group, wherein the 1,4-phenylene group, the tetrahydronaphthalene-2,6-diyl group, or the 1,4-cyclohexylene group is unsubstituted or at least one hydrogen atom of the 1,4-phenylene group, the tetrahydronaphthalene-2,6-diyl group, or the 1,4-cyclohexylene group is substituted by a halogen atom, and/or at least one —CH₂— of the 1,4-phenylene group, the tetrahydronaphthalene-2,6-diyl group, or the 1,4-cyclohexylene group is substituted by —O—, and wherein the —O— do not directly bond to another —O—;

the definitions of X¹, X², and X³ are respectively the same as the definitions of X¹, X², and X³ defined in the previous paragraphs;

each of X⁸ and X⁹ independently represents hydrogen,

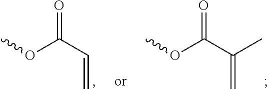

L^{1′} represents a single bond, a C₁-C₅ linear alkylene group, a C₃-C₅ branched alkylene group, a C₁-C₅ linear alkyleneoxy group, or a C₃-C₅ branched alkyleneoxy group, wherein the C₁-C₅ linear alkylene group, the C₃-C₅ branched alkylene group, the C₁-C₅ linear alkyleneoxy group, or the C₃-C₅ branched alkyleneoxy group is unsubstituted or at least one —CH₂— of the C₁-C₅ linear alkylene group, the C₃-C₅ branched alkylene group, the C₁-C₅ linear alkyleneoxy group, or the C₃-C₅ branched alkyleneoxy group is substituted by —O— or —COO—, and/or at least one hydrogen atom of the C₁-C₅ linear alkylene group, the C₃-C₅ branched alkylene group, the C₁-C₅ linear alkyleneoxy group, or the C₃-C₅ branched alkyleneoxy group is substituted by a halogen atom;

each of L¹⁰ and L¹¹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-Cis branched alkyleneoxy group is substituted by —O— or —COO—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom;

L¹² represents a single bond, a C₁-C₁₈ linear alkylene group, a C₃-C₁₈ branched alkylene group, a C₁-C₁₈ linear alkyleneoxy group, or a C₃-C₁₈ branched alkyleneoxy group, wherein the C₁-C₁₈ linear alkylene group, the C₃-C₁₈ branched alkylene group, the C₁-C₁₈ linear alkyleneoxy group, or the C₃-C₁₈ branched alkyleneoxy group is unsubstituted or at least one —CH₂— of the C₁-C₁₈ linear alkylene group, the C₃-C₁₈ branched alkylene group, the C₁-C₁₈ linear alkyleneoxy group, or the C₃-C₁₈ branched alkyleneoxy group is substituted by —CH═CH—, —CF₂O—, —O—, —COO—, —OCO—, or —OOC—, and/or at least one hydrogen atom of the C₁-C₁₈ linear alkylene group, the C₃-C₁₈ branched alkylene group, the C₁-C₁₈ linear alkyleneoxy group, or the C₃-C₁₈ branched alkyleneoxy group is substituted by a halogen atom;

each of n^{a} and n^{b} independently represents an integer of 0 to 10, and the sum of n^{a} and n^{b} is not greater than 10; and

Y^{1′} represents hydrogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH.

Specific exemplary silicon-containing compounds are shown in Tables 1-6 below. The silicon-containing compounds of the Formula (I-A-1) and Formula (I-A-2) are shown in Tables 1-3. The silicon-containing compounds of the Formula (I-B-1) and Formula (I-B-2) are shown in Table 4. The silicon-containing compounds of the Formula (I-C-1) and Formula (I-C-2) are shown in Table 5. The silicon-containing compounds of the Formula (I-D-1), Formula (I-D-2), Formula (I-D-3) and Formula (I-D-4) are shown in Table 6. The silicon-containing compound in Table 1 includes a silicon atom and an anchoring group, thereby having good vertical alignment ability and increasing the voltage holding ratio. In addition to a silicon atom and an anchoring group, the silicon-containing compounds in Tables 2 and 3 further includes at least one polymerizable group bonded to the cyclic group, thereby further improving the degree of the vertical alignment of the liquid-crystal molecules. The silicon-containing compound in Table 4 includes two anchoring groups, and therefore, the generation of defects can be reduced. The silicon-containing compound in Tables 5 and 6 includes an anchoring group and a polymerizable group directly bonded to a linking group (acyclic group), and therefore, the degree of vertical alignment of the liquid-crystal molecules can be improved further.

TABLE 1

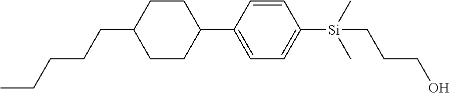 [SMILES: CCCCCC1CCC(c2ccc([Si](C)(C)CCCO)cc2)CC1]

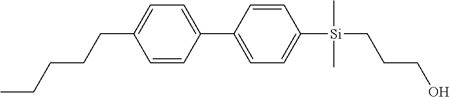 [SMILES: CCCCCc1ccc(-c2ccc([Si](C)(C)CCCO)cc2)cc1]

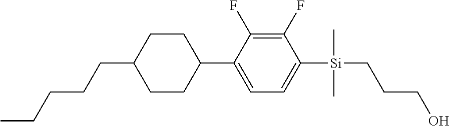 [SMILES: CCCCCC1CCC(c2ccc([Si](C)(C)CCCO)c(F)c2F)CC1]

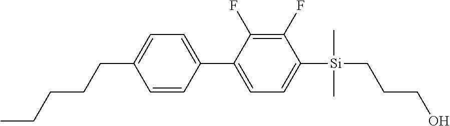 [SMILES: CCCCCc1ccc(-c2ccc([Si](C)(C)CCCO)c(F)c2F)cc1]

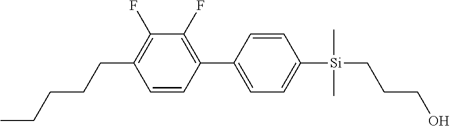 [SMILES: CCCCCc1ccc(-c2ccc([Si](C)(C)CCCO)cc2)c(F)c1F]

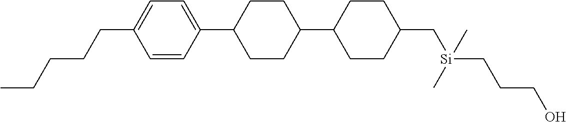 [SMILES: CCCCCc1ccc(C2CCC(C3CCC(C[Si](C)(C)CCCO)CC3)CC2)cc1]

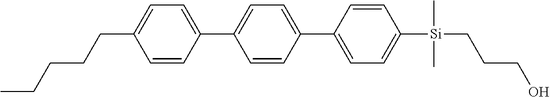 [SMILES: CCCCCc1ccc(-c2ccc(-c3ccc([Si](C)(C)CCCO)cc3)cc2)cc1]

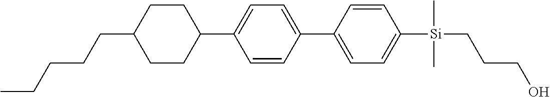 [SMILES: CCCCCC1CCC(c2ccc(-c3ccc([Si](C)(C)CCCO)cc3)cc2)CC1]

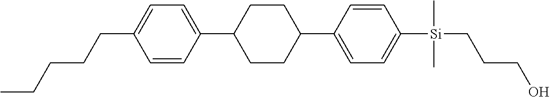 [SMILES: CCCCCc1ccc(C2CCC(c3ccc([Si](C)(C)CCCO)cc3)CC2)cc1]

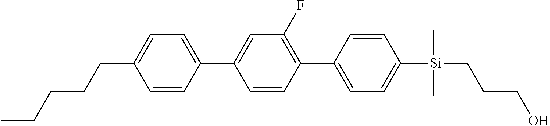 [SMILES: CCCCCc1ccc(-c2ccc(-c3ccc([Si](C)(C)CCCO)cc3)c(F)c2)cc1]

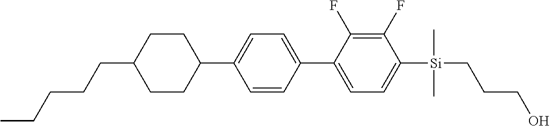 [SMILES: CCCCCC1CCC(c2ccc(-c3ccc([Si](C)(C)CCCO)c(F)c3F)cc2)CC1]

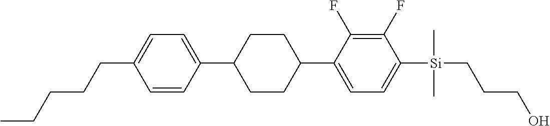 [SMILES: CCCCCc1ccc(C2CCC(c3ccc([Si](C)(C)CCCO)c(F)c3F)CC2)cc1]

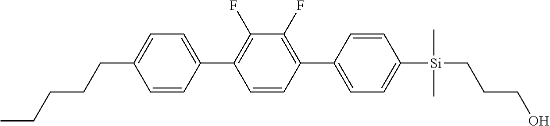 [SMILES: CCCCCc1ccc(-c2ccc(-c3ccc([Si](C)(C)CCCO)cc3)c(F)c2F)cc1]

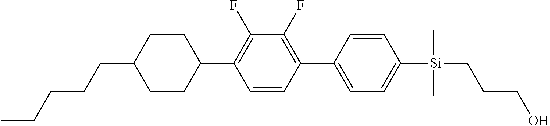 [SMILES: CCCCCC1CCC(c2ccc(-c3ccc([Si](C)(C)CCCO)cc3)c(F)c2F)CC1]

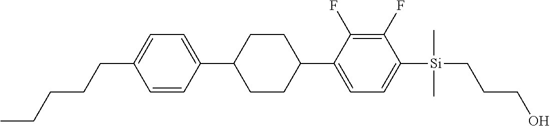 [SMILES: CCCCCc1ccc(C2CCC(c3ccc([Si](C)(C)CCCO)c(F)c3F)CC2)cc1]

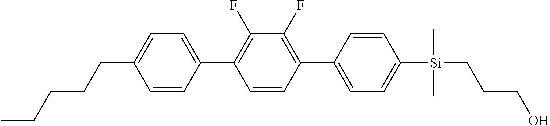 [SMILES: CCCCCc1ccc(-c2ccc(-c3ccc([Si](C)(C)CCCO)cc3)c(F)c2F)cc1]

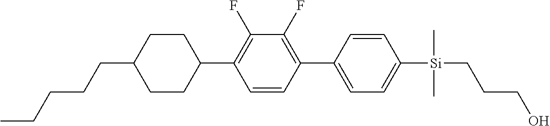 [SMILES: CCCCCC1CCC(c2ccc(-c3ccc([Si](C)(C)CCCO)cc3)c(F)c2F)CC1]

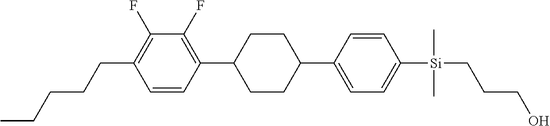 [SMILES: CCCCCc1ccc(C2CCC(c3ccc([Si](C)(C)CCCO)cc3)CC2)c(F)c1F]

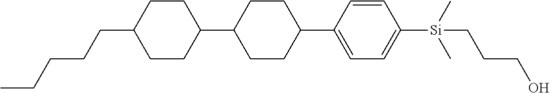 [SMILES: CCCCCC1CCC(C2CCC(c3ccc([Si](C)(C)CCCO)cc3)CC2)CC1]

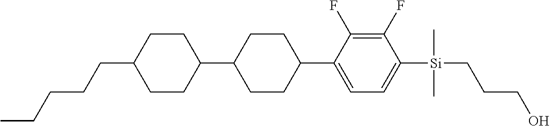 [SMILES: CCCCCC1CCC(C2CCC(c3ccc([Si](C)(C)CCCO)c(F)c3F)CC2)CC1]

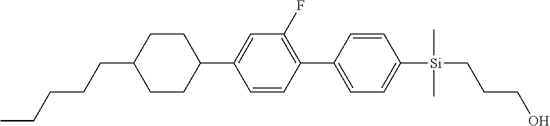 [SMILES: CCCCCC1CCC(c2ccc(-c3ccc([Si](C)(C)CCCO)cc3)c(F)c2)CC1]

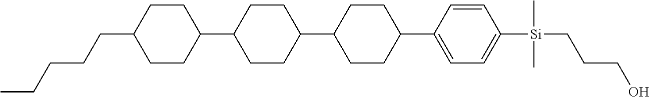 [SMILES: CCCCCC1CCC(C2CCC(C3CCC(c4ccc([Si](C)(C)CCCO)cc4)CC3)CC2)CC1]

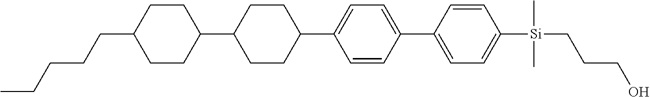 [SMILES: CCCCCC1CCC(C2CCC(c3ccc(-c4ccc([Si](C)(C)CCCO)cc4)cc3)CC2)CC1]

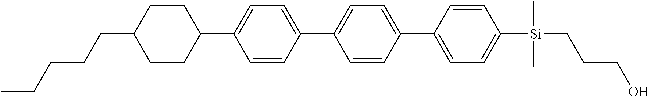 [SMILES: CCCCCC1CCC(c2ccc(-c3ccc(-c4ccc([Si](C)(C)CCCO)cc4)cc3)cc2)CC1]

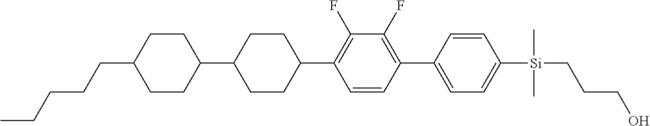 [SMILES: CCCCCC1CCC(C2CCC(c3ccc(-c4ccc([Si](C)(C)CCCO)cc4)c(F)c3F)CC2)CC1]

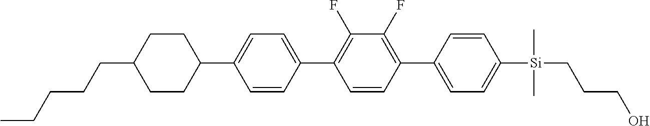 [SMILES: CCCCCC1CCC(c2ccc(-c3ccc(-c4ccc([Si](C)(C)CCCO)cc4)c(F)c3F)cc2)CC1]

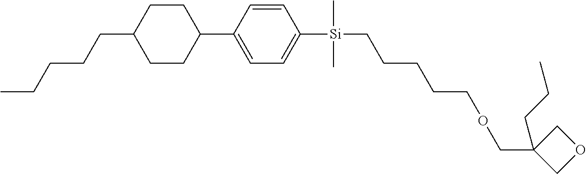 [SMILES: CCCCCC1CCC(c2ccc([Si](C)(C)CCCCCOCC3(CCC)COC3)cc2)CC1]

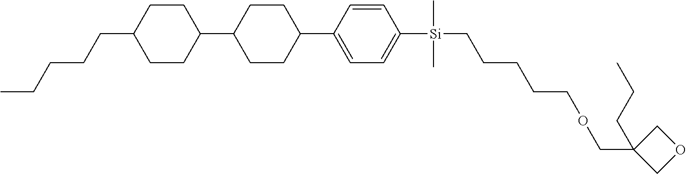 [SMILES: CCCCCC1CCC(C2CCC(c3ccc([Si](C)(C)CCCCCOCC4(CCC)COC4)cc3)CC2)CC1]

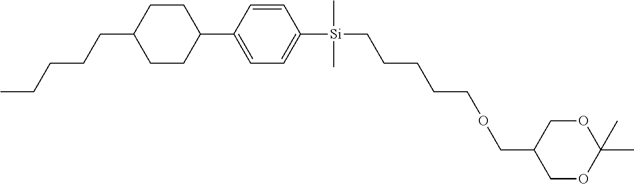 [SMILES: CCCCCC1CCC(c2ccc([Si](C)(C)CCCCCOCC3COC(C)(C)OC3)cc2)CC1]

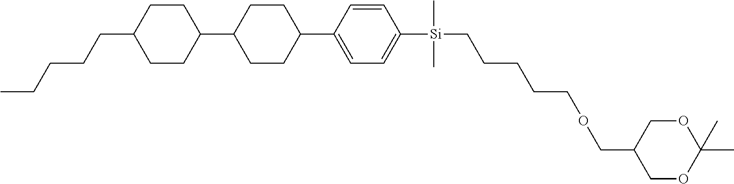 [SMILES: CCCCCC1CCC(C2CCC(c3ccc([Si](C)(C)CCCCCOCC4COC(C)(C)OC4)cc3)CC2)CC1]

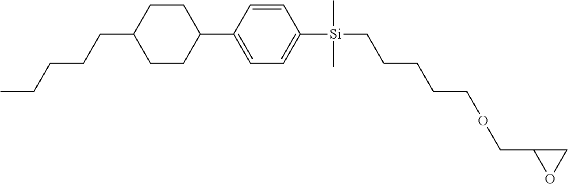 [SMILES: CCCCCC1CCC(c2ccc([Si](C)(C)CCCCCOCC3CO3)cc2)CC1]

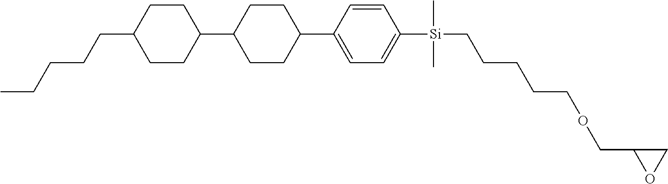 [SMILES: CCCCCC1CCC(C2CCC(c3ccc([Si](C)(C)CCCCCOCC4CO4)cc3)CC2)CC1]

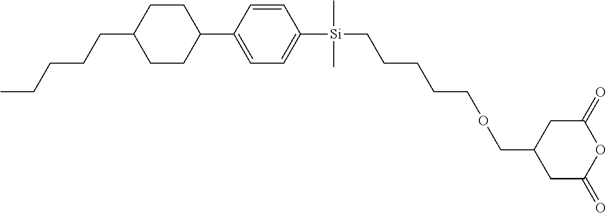 [SMILES: CCCCCC1CCC(c2ccc([Si](C)(C)CCCCCOCC3CC(=O)OC(=O)C3)cc2)CC1]

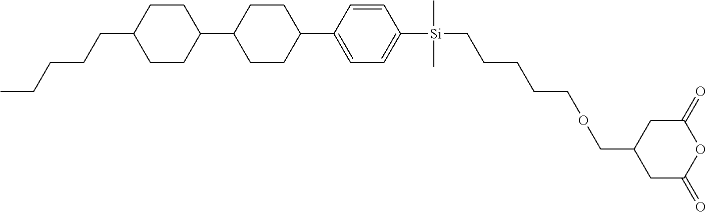 [SMILES: CCCCCC1CCC(C2CCC(c3ccc([Si](C)(C)CCCCCOCC4CC(=O)OC(=O)C4)cc3)CC2)CC1]

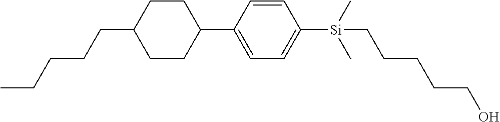 [SMILES: CCCCCC1CCC(c2ccc([Si](C)(C)CCCCCO)cc2)CC1]

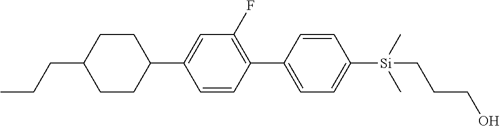 [SMILES: CCCC1CCC(c2ccc(-c3ccc([Si](C)(C)CCCO)cc3)c(F)c2)CC1]

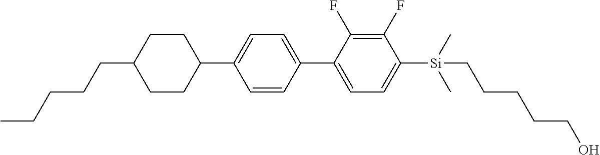 [SMILES: CCCCCC1CCC(c2ccc(-c3ccc([Si](C)(C)CCCCCO)c(F)c3F)cc2)CC1]

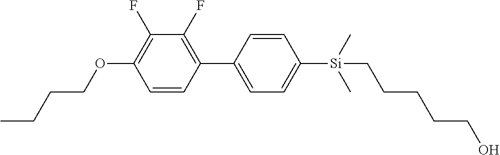 [SMILES: CCCCOc1ccc(-c2ccc([Si](C)(C)CCCCCO)cc2)c(F)c1F]

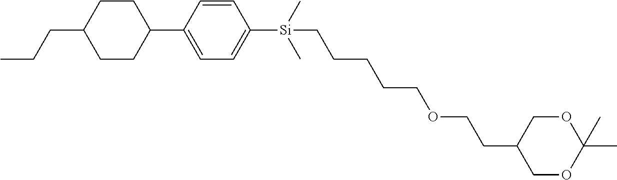 [SMILES: CCCC1CCC(c2ccc([Si](C)(C)CCCCCOCCC3COC(C)(C)OC3)cc2)CC1]

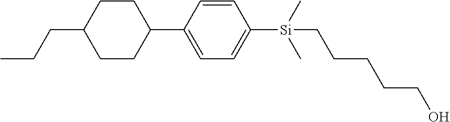 [SMILES: CCCC1CCC(c2ccc([Si](C)(C)CCCCCO)cc2)CC1]

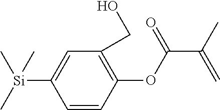 [SMILES: C=C(C)C(=O)Oc1ccc([Si](C)(C)C)cc1CO]

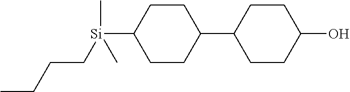 [SMILES: CCCC[Si](C)(C)C1CCC(C2CCC(O)CC2)CC1]

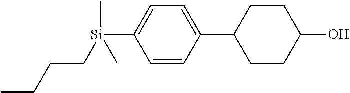 [SMILES: CCCC[Si](C)(C)c1ccc(C2CCC(O)CC2)cc1]

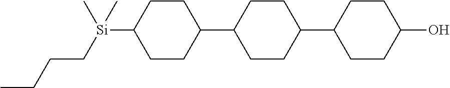 [SMILES: CCCC[Si](C)(C)C1CCC(C2CCC(C3CCC(O)CC3)CC2)CC1]

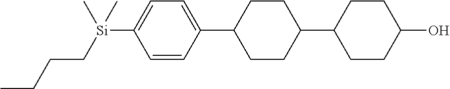 [SMILES: CCCC[Si](C)(C)c1ccc(C2CCC(C3CCC(O)CC3)CC2)cc1]

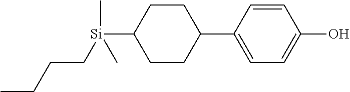 [SMILES: CCCC[Si](C)(C)C1CCC(c2ccc(O)cc2)CC1]

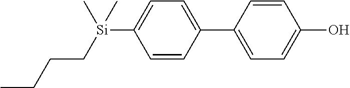 [SMILES: CCCC[Si](C)(C)c1ccc(-c2ccc(O)cc2)cc1]

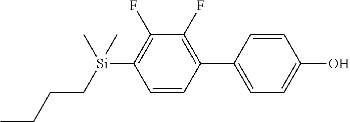 [SMILES: CCCC[Si](C)(C)c1ccc(-c2ccc(O)cc2)c(F)c1F]

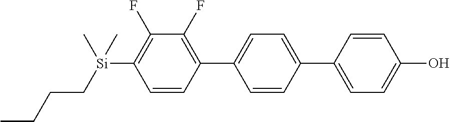 [SMILES: CCCC[Si](C)(C)c1ccc(-c2ccc(-c3ccc(O)cc3)cc2)c(F)c1F]

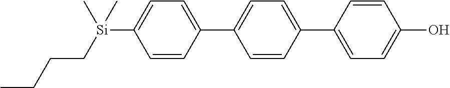 [SMILES: CCCC[Si](C)(C)c1ccc(-c2ccc(-c3ccc(O)cc3)cc2)cc1]

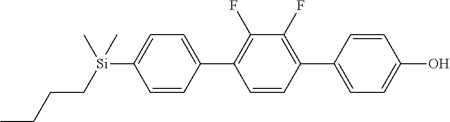 [SMILES: CCCC[Si](C)(C)c1ccc(-c2ccc(-c3ccc(O)cc3)c(F)c2F)cc1]

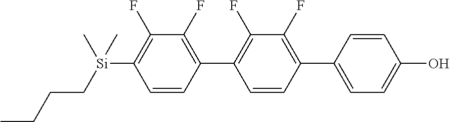 [SMILES: CCCC[Si](C)(C)c1ccc(-c2ccc(-c3ccc(O)cc3)c(F)c2F)c(F)c1F]

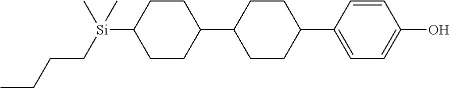 [SMILES: CCCC[Si](C)(C)C1CCC(C2CCC(c3ccc(O)cc3)CC2)CC1]

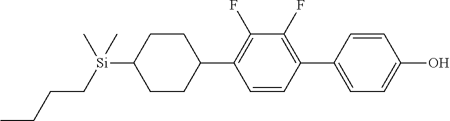 [SMILES: CCCC[Si](C)(C)C1CCC(c2ccc(-c3ccc(O)cc3)c(F)c2F)CC1]

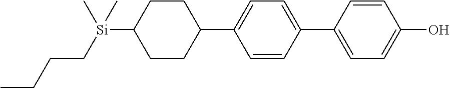 [SMILES: CCCC[Si](C)(C)C1CCC(c2ccc(-c3ccc(O)cc3)cc2)CC1]

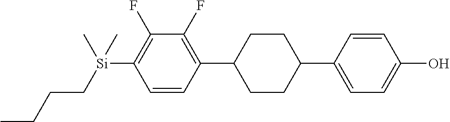 [SMILES: CCCC[Si](C)(C)c1ccc(C2CCC(c3ccc(O)cc3)CC2)c(F)c1F]

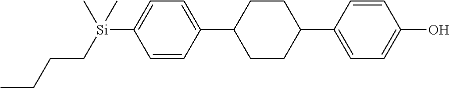 [SMILES: CCCC[Si](C)(C)c1ccc(C2CCC(c3ccc(O)cc3)CC2)cc1]

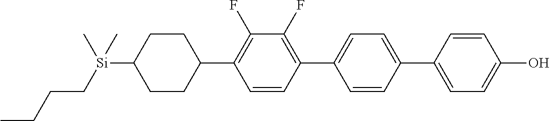 [SMILES: CCCC[Si](C)(C)C1CCC(c2ccc(-c3ccc(-c4ccc(O)cc4)cc3)c(F)c2F)CC1]

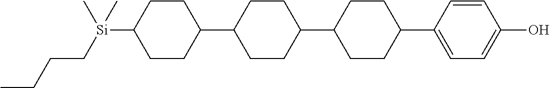 [SMILES: CCCC[Si](C)(C)C1CCC(C2CCC(C3CCC(c4ccc(O)cc4)CC3)CC2)CC1]

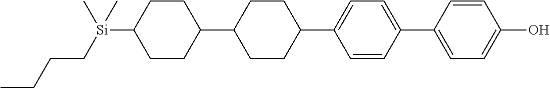 [SMILES: CCCC[Si](C)(C)C1CCC(C2CCC(c3ccc(-c4ccc(O)cc4)cc3)CC2)CC1]

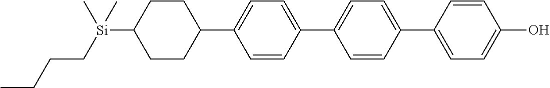 [SMILES: CCCC[Si](C)(C)C1CCC(c2ccc(-c3ccc(-c4ccc(O)cc4)cc3)cc2)CC1]

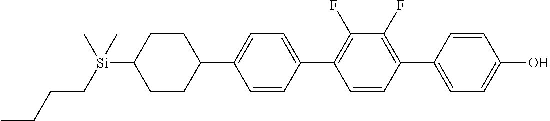 [SMILES: CCCC[Si](C)(C)C1CCC(c2ccc(-c3ccc(-c4ccc(O)cc4)c(F)c3F)cc2)CC1]

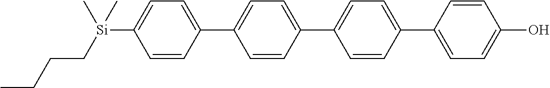 [SMILES: CCCC[Si](C)(C)c1ccc(-c2ccc(-c3ccc(-c4ccc(O)cc4)cc3)cc2)cc1]

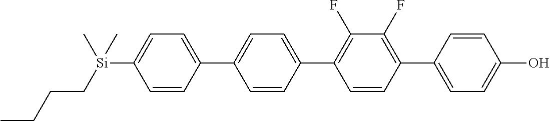 [SMILES: CCCC[Si](C)(C)c1ccc(-c2ccc(-c3ccc(-c4ccc(O)cc4)c(F)c3F)cc2)cc1]

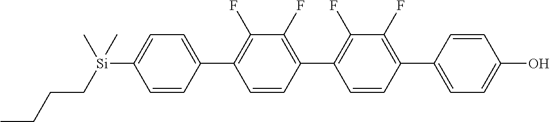 [SMILES: CCCC[Si](C)(C)c1ccc(-c2ccc(-c3ccc(-c4ccc(O)cc4)c(F)c3F)c(F)c2F)cc1]

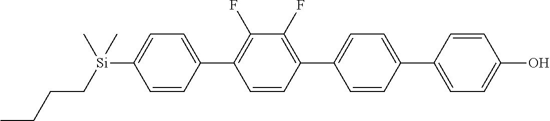 [SMILES: CCCC[Si](C)(C)c1ccc(-c2ccc(-c3ccc(-c4ccc(O)cc4)cc3)c(F)c2F)cc1]

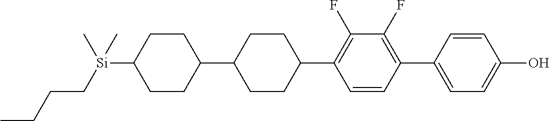 [SMILES: CCCC[Si](C)(C)C1CCC(C2CCC(c3ccc(-c4ccc(O)cc4)c(F)c3F)CC2)CC1]

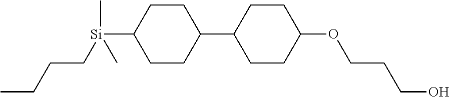 [SMILES: CCCC[Si](C)(C)C1CCC(C2CCC(OCCCO)CC2)CC1]

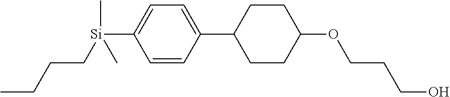 [SMILES: CCCC[Si](C)(C)c1ccc(C2CCC(OCCCO)CC2)cc1]

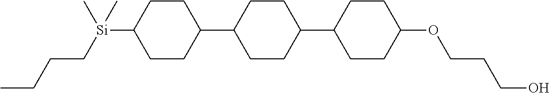 [SMILES: CCCC[Si](C)(C)C1CCC(C2CCC(C3CCC(OCCCO)CC3)CC2)CC1]

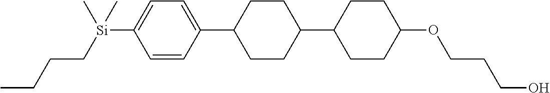 [SMILES: CCCC[Si](C)(C)c1ccc(C2CCC(C3CCC(OCCCO)CC3)CC2)cc1]

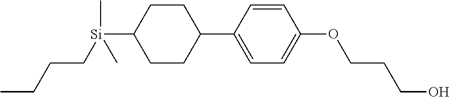 [SMILES: CCCC[Si](C)(C)C1CCC(c2ccc(OCCCO)cc2)CC1]

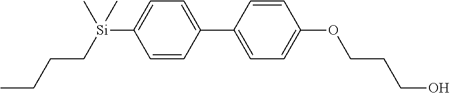 [SMILES: CCCC[Si](C)(C)c1ccc(-c2ccc(OCCCO)cc2)cc1]

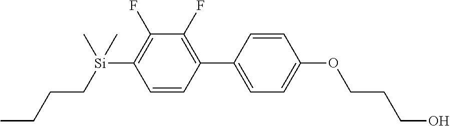 [SMILES: CCCC[Si](C)(C)c1ccc(-c2ccc(OCCCO)cc2)c(F)c1F]

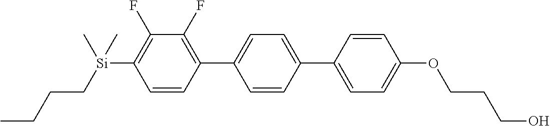 [SMILES: CCCC[Si](C)(C)c1ccc(-c2ccc(-c3ccc(OCCCO)cc3)cc2)c(F)c1F]

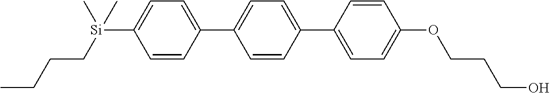 [SMILES: CCCC[Si](C)(C)c1ccc(-c2ccc(-c3ccc(OCCCO)cc3)cc2)cc1]

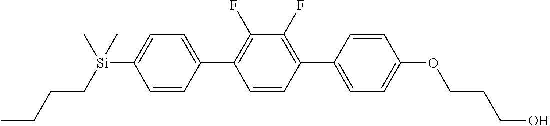 [SMILES: CCCC[Si](C)(C)c1ccc(-c2ccc(-c3ccc(OCCCO)cc3)c(F)c2F)cc1]

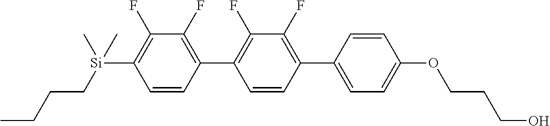 [SMILES: CCCC[Si](C)(C)c1ccc(-c2ccc(-c3ccc(OCCCO)cc3)c(F)c2F)c(F)c1F]

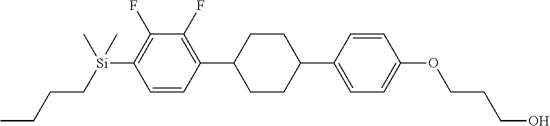 [SMILES: CCCC[Si](C)(C)c1ccc(C2CCC(c3ccc(OCCCO)cc3)CC2)c(F)c1F]

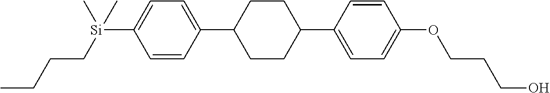 [SMILES: CCCC[Si](C)(C)c1ccc(C2CCC(c3ccc(OCCCO)cc3)CC2)cc1]

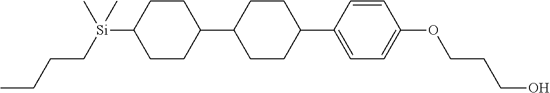 [SMILES: CCCC[Si](C)(C)C1CCC(C2CCC(c3ccc(OCCCO)cc3)CC2)CC1]

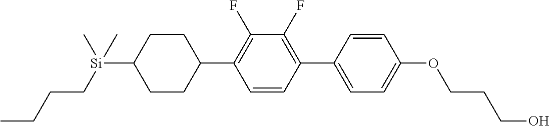 [SMILES: CCCC[Si](C)(C)C1CCC(c2ccc(-c3ccc(OCCCO)cc3)c(F)c2F)CC1]

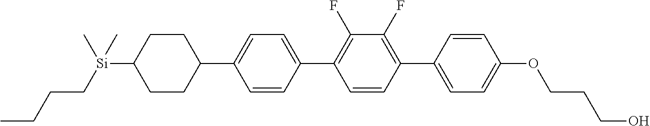 [SMILES: CCCC[Si](C)(C)C1CCC(c2ccc(-c3ccc(-c4ccc(OCCCO)cc4)c(F)c3F)cc2)CC1]

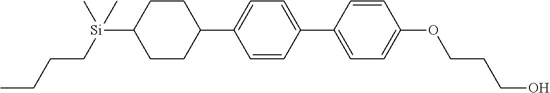 [SMILES: CCCC[Si](C)(C)C1CCC(c2ccc(-c3ccc(OCCCO)cc3)cc2)CC1]

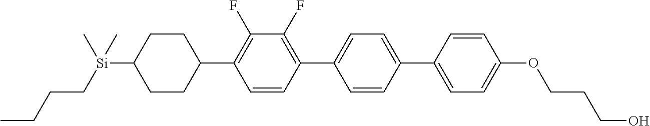 [SMILES: CCCC[Si](C)(C)C1CCC(c2ccc(-c3ccc(-c4ccc(OCCCO)cc4)cc3)c(F)c2F)CC1]

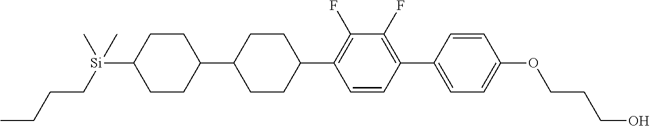 [SMILES: CCCC[Si](C)(C)C1CCC(C2CCC(c3ccc(-c4ccc(OCCCO)cc4)c(F)c3F)CC2)CC1]

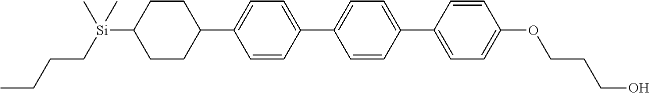 [SMILES: CCCC[Si](C)(C)C1CCC(c2ccc(-c3ccc(-c4ccc(OCCCO)cc4)cc3)cc2)CC1]

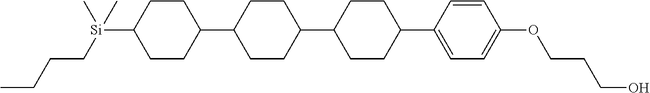 [SMILES: CCCC[Si](C)(C)C1CCC(C2CCC(C3CCC(c4ccc(OCCCO)cc4)CC3)CC2)CC1]

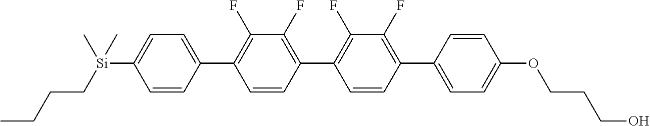 [SMILES: CCCC[Si](C)(C)c1ccc(-c2ccc(-c3ccc(-c4ccc(OCCCO)cc4)c(F)c3F)c(F)c2F)cc1]

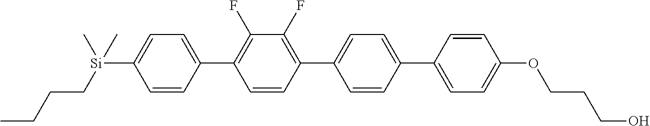 [SMILES: CCCC[Si](C)(C)c1ccc(-c2ccc(-c3ccc(-c4ccc(OCCCO)cc4)cc3)c(F)c2F)cc1]

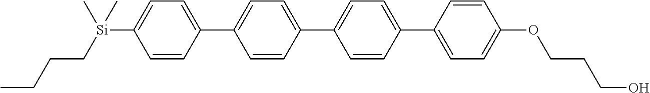 [SMILES: CCCC[Si](C)(C)c1ccc(-c2ccc(-c3ccc(-c4ccc(OCCCO)cc4)cc3)cc2)cc1]

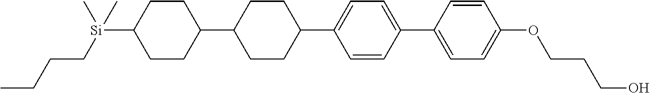 [SMILES: CCCC[Si](C)(C)C1CCC(C2CCC(c3ccc(-c4ccc(OCCCO)cc4)cc3)CC2)CC1]

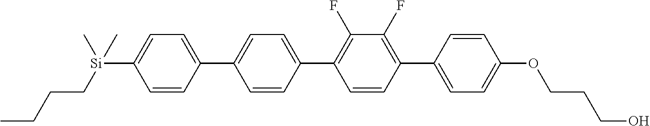 [SMILES: CCCC[Si](C)(C)c1ccc(-c2ccc(-c3ccc(-c4ccc(OCCCO)cc4)c(F)c3F)cc2)cc1]

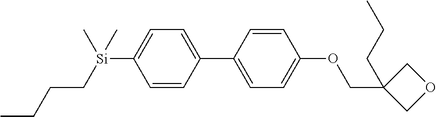 [SMILES: CCCC[Si](C)(C)c1ccc(-c2ccc(OCC3(CCC)COC3)cc2)cc1]

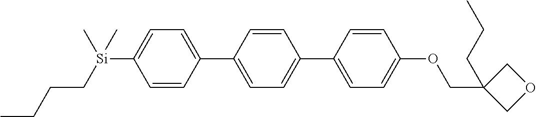 [SMILES: CCCC[Si](C)(C)c1ccc(-c2ccc(-c3ccc(OCC4(CCC)COC4)cc3)cc2)cc1]

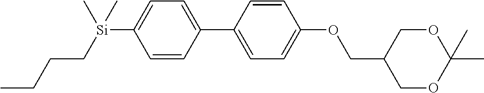 [SMILES: CCCC[Si](C)(C)c1ccc(-c2ccc(OCC3COC(C)(C)OC3)cc2)cc1]

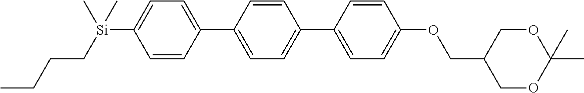 [SMILES: CCCC[Si](C)(C)c1ccc(-c2ccc(-c3ccc(OCC4COC(C)(C)OC4)cc3)cc2)cc1]

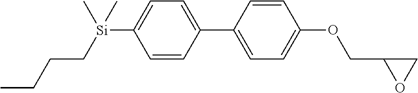 [SMILES: CCCC[Si](C)(C)c1ccc(-c2ccc(OCC3CO3)cc2)cc1]

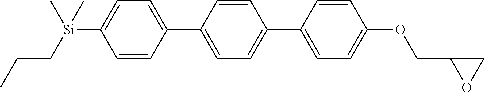 [SMILES: CCC[Si](C)(C)c1ccc(-c2ccc(-c3ccc(OCC4CO4)cc3)cc2)cc1]

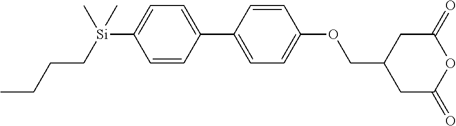 [SMILES: CCCC[Si](C)(C)c1ccc(-c2ccc(OCC3CC(=O)OC(=O)C3)cc2)cc1]

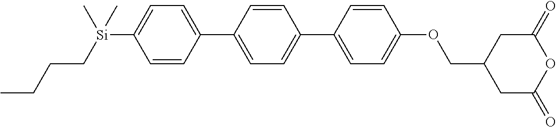 [SMILES: CCCC[Si](C)(C)c1ccc(-c2ccc(-c3ccc(OCC4CC(=O)OC(=O)C4)cc3)cc2)cc1]

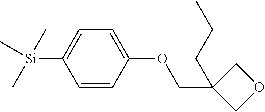 [SMILES: CCCC1(COc2ccc([Si](C)(C)C)cc2)COC1]

TABLE 2

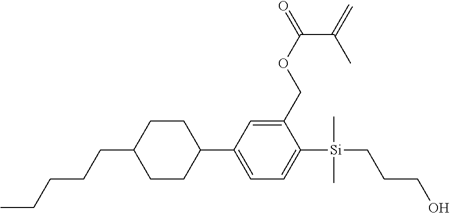 [SMILES: C=C(C)C(=O)OCc1cc(C2CCC(CCCCC)CC2)ccc1[Si](C)(C)CCCO]

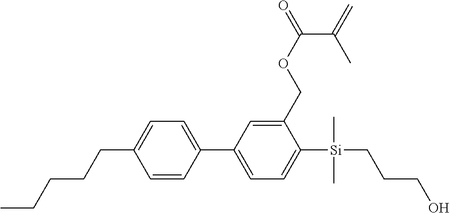 [SMILES: C=C(C)C(=O)OCc1cc(-c2ccc(CCCCC)cc2)ccc1[Si](C)(C)CCCO]

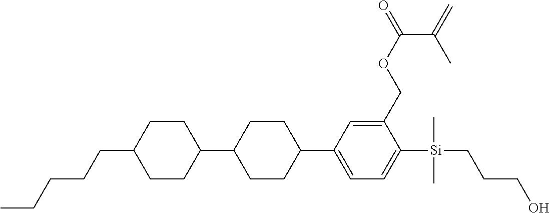 [SMILES: C=C(C)C(=O)OCc1cc(C2CCC(C3CCC(CCCCC)CC3)CC2)ccc1[Si](C)(C)CCCO]

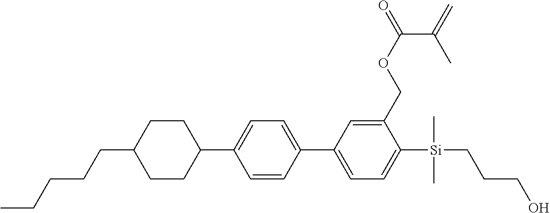 [SMILES: C=C(C)C(=O)OCc1cc(-c2ccc(C3CCC(CCCCC)CC3)cc2)ccc1[Si](C)(C)CCCO]

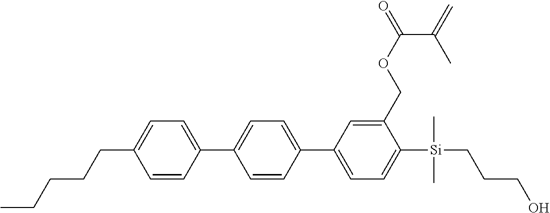 [SMILES: C=C(C)C(=O)OCc1cc(-c2ccc(-c3ccc(CCCCC)cc3)cc2)ccc1[Si](C)(C)CCCO]

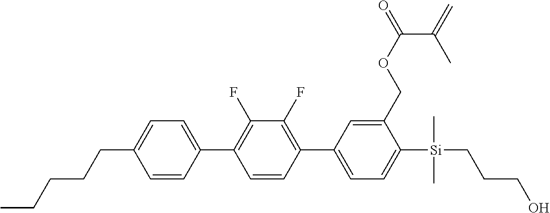 [SMILES: C=C(C)C(=O)OCc1cc(-c2ccc(-c3ccc(CCCCC)cc3)c(F)c2F)ccc1[Si](C)(C)CCCO]

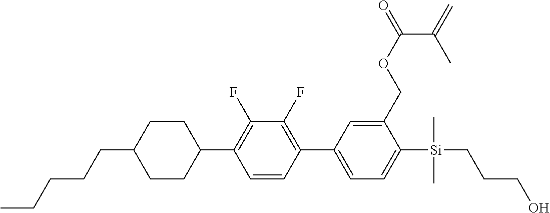 [SMILES: C=C(C)C(=O)OCc1cc(-c2ccc(C3CCC(CCCCC)CC3)c(F)c2F)ccc1[Si](C)(C)CCCO]

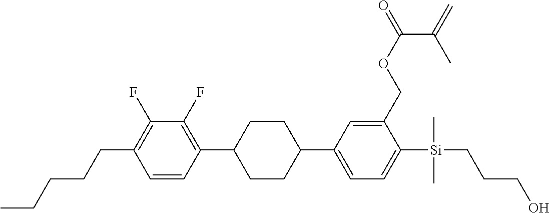 [SMILES: C=C(C)C(=O)OCc1cc(C2CCC(c3ccc(CCCCC)c(F)c3F)CC2)ccc1[Si](C)(C)CCCO]

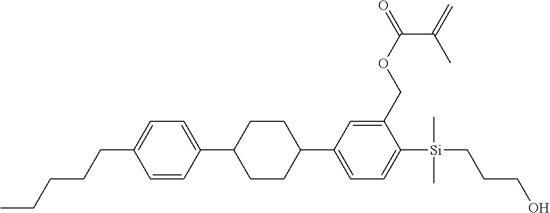 [SMILES: C=C(C)C(=O)OCc1cc(C2CCC(c3ccc(CCCCC)cc3)CC2)ccc1[Si](C)(C)CCCO]

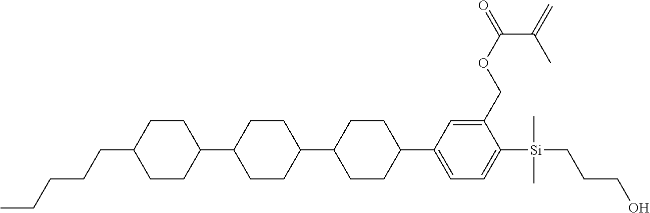 [SMILES: C=C(C)C(=O)OCc1cc(C2CCC(C3CCC(C4CCC(CCCCC)CC4)CC3)CC2)ccc1[Si](C)(C)CCCO]

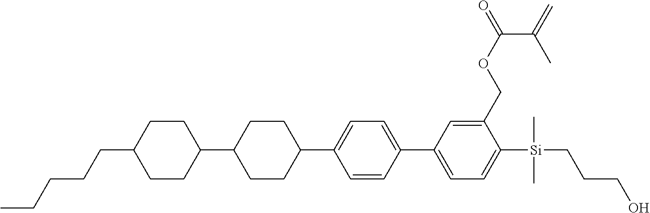 [SMILES: C=C(C)C(=O)OCc1cc(-c2ccc(C3CCC(C4CCC(CCCCC)CC4)CC3)cc2)ccc1[Si](C)(C)CCCO]

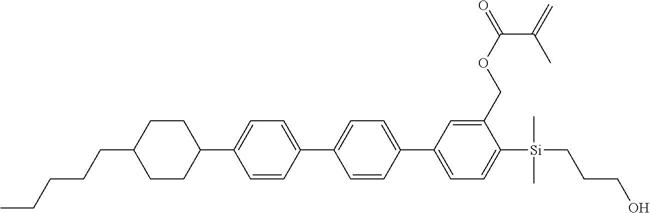 [SMILES: C=C(C)C(=O)OCc1cc(-c2ccc(-c3ccc(C4CCC(CCCCC)CC4)cc3)cc2)ccc1[Si](C)(C)CCCO]

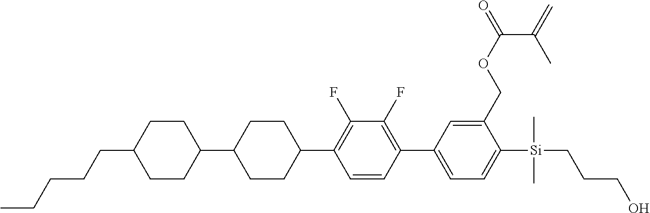 [SMILES: C=C(C)C(=O)OCc1cc(-c2ccc(C3CCC(C4CCC(CCCCC)CC4)CC3)c(F)c2F)ccc1[Si](C)(C)CCCO]

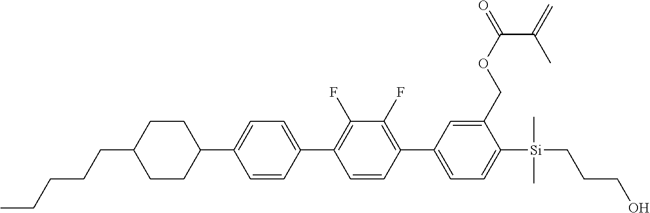 [SMILES: C=C(C)C(=O)OCc1cc(-c2ccc(-c3ccc(C4CCC(CCCCC)CC4)cc3)c(F)c2F)ccc1[Si](C)(C)CCCO]

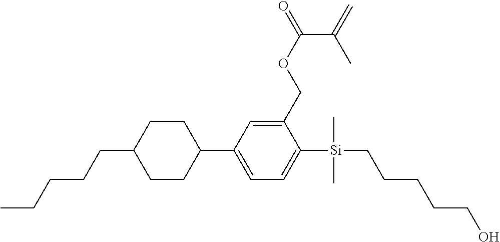 [SMILES: C=C(C)C(=O)OCc1cc(C2CCC(CCCCC)CC2)ccc1[Si](C)(C)CCCCCO]

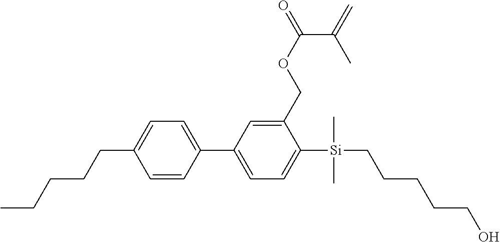 [SMILES: C=C(C)C(=O)OCc1cc(-c2ccc(CCCCC)cc2)ccc1[Si](C)(C)CCCCCO]

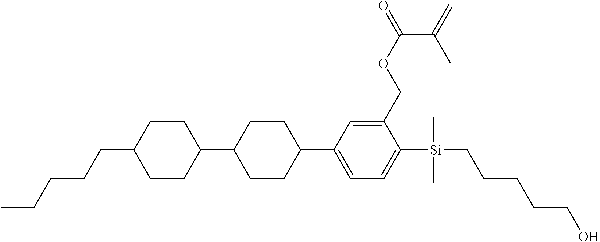 [SMILES: C=C(C)C(=O)OCc1cc(C2CCC(C3CCC(CCCCC)CC3)CC2)ccc1[Si](C)(C)CCCCCO]

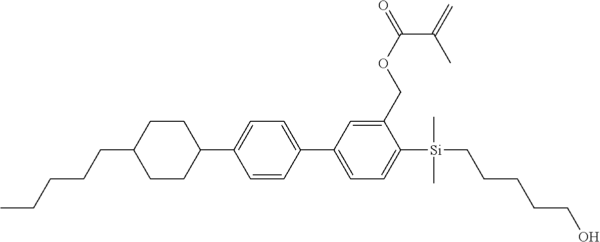 [SMILES: C=C(C)C(=O)OCc1cc(-c2ccc(C3CCC(CCCCC)CC3)cc2)ccc1[Si](C)(C)CCCCCO]

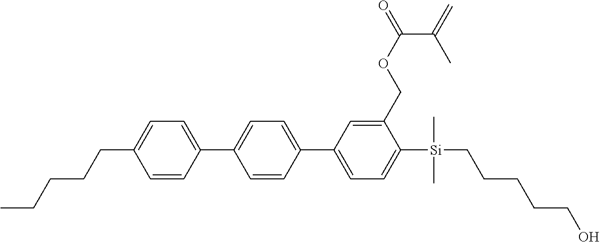 [SMILES: C=C(C)C(=O)OCc1cc(-c2ccc(-c3ccc(CCCCC)cc3)cc2)ccc1[Si](C)(C)CCCCCO]

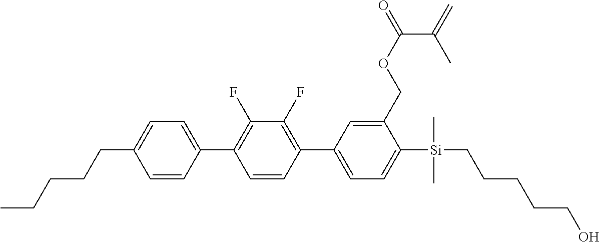 [SMILES: C=C(C)C(=O)OCc1cc(-c2ccc(-c3ccc(CCCCC)cc3)c(F)c2F)ccc1[Si](C)(C)CCCCCO]

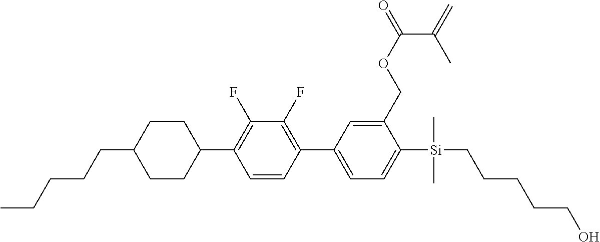 [SMILES: C=C(C)C(=O)OCc1cc(-c2ccc(C3CCC(CCCCC)CC3)c(F)c2F)ccc1[Si](C)(C)CCCCCO]

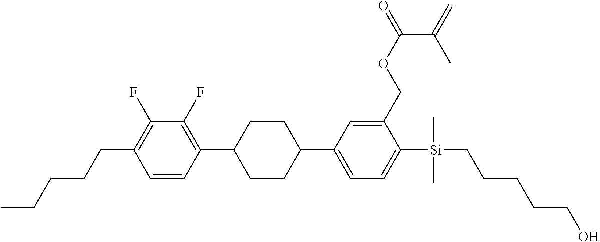 [SMILES: C=C(C)C(=O)OCc1cc(C2CCC(c3ccc(CCCCC)c(F)c3F)CC2)ccc1[Si](C)(C)CCCCCO]

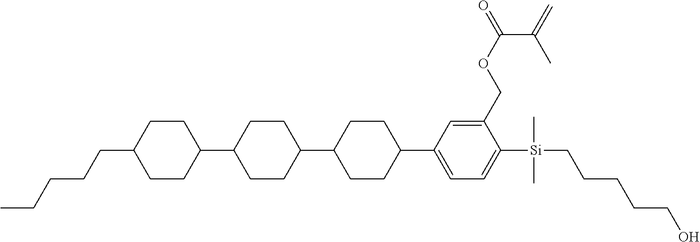 [SMILES: C=C(C)C(=O)OCc1cc(C2CCC(C3CCC(C4CCC(CCCCC)CC4)CC3)CC2)ccc1[Si](C)(C)CCCCCO]

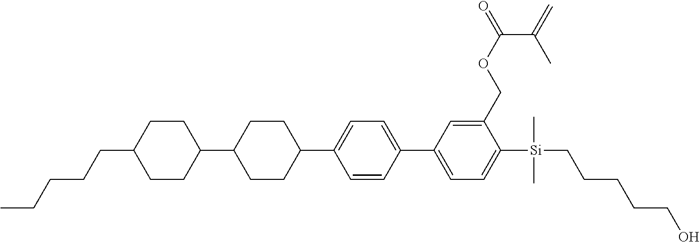 [SMILES: C=C(C)C(=O)OCc1cc(-c2ccc(C3CCC(C4CCC(CCCCC)CC4)CC3)cc2)ccc1[Si](C)(C)CCCCCO]

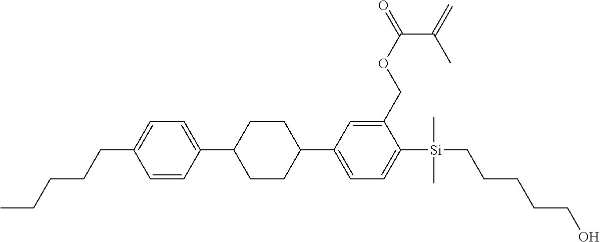 [SMILES: C=C(C)C(=O)OCc1cc(C2CCC(c3ccc(CCCCC)cc3)CC2)ccc1[Si](C)(C)CCCCCO]

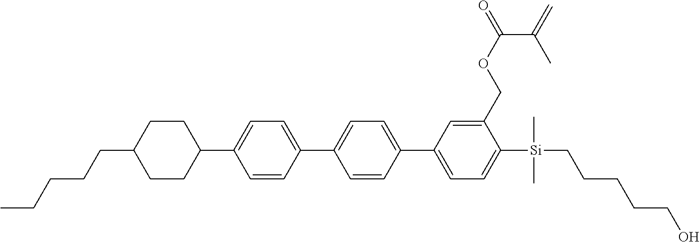 [SMILES: C=C(C)C(=O)OCc1cc(-c2ccc(-c3ccc(C4CCC(CCCCC)CC4)cc3)cc2)ccc1[Si](C)(C)CCCCCO]

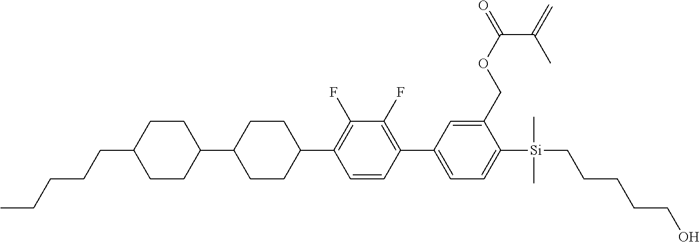 [SMILES: C=C(C)C(=O)OCc1cc(-c2ccc(C3CCC(C4CCC(CCCCC)CC4)CC3)c(F)c2F)ccc1[Si](C)(C)CCCCCO]

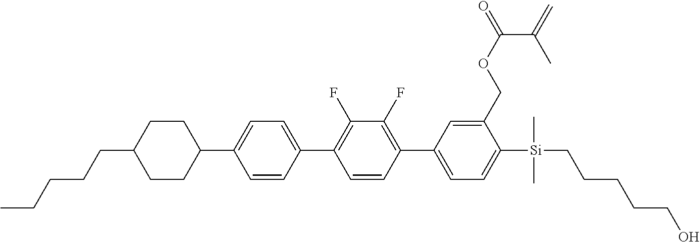 [SMILES: C=C(C)C(=O)OCc1cc(-c2ccc(-c3ccc(C4CCC(CCCCC)CC4)cc3)c(F)c2F)ccc1[Si](C)(C)CCCCCO]

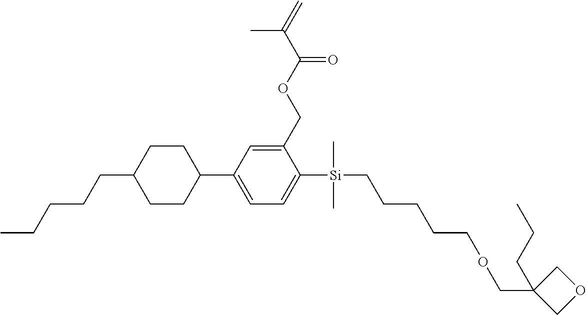 [SMILES: C=C(C)C(=O)OCc1cc(C2CCC(CCCCC)CC2)ccc1[Si](C)(C)CCCCCOCC1(CCC)COC1]

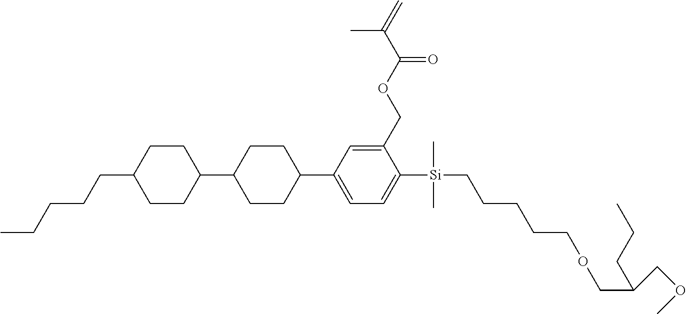 [SMILES: C=C(C)C(=O)OCc1cc(C2CCC(C3CCC(CCCCC)CC3)CC2)ccc1[Si](C)(C)CCCCCOCC(CCC)COC]

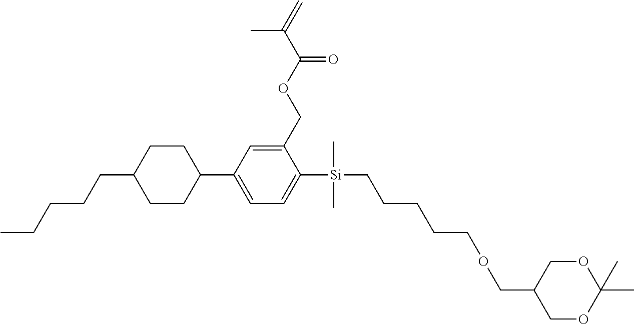 [SMILES: C=C(C)C(=O)OCc1cc(C2CCC(CCCCC)CC2)ccc1[Si](C)(C)CCCCCOCC1COC(C)(C)OC1]

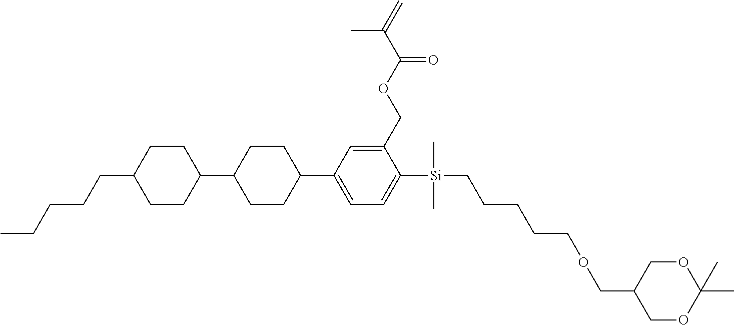 [SMILES: C=C(C)C(=O)OCc1cc(C2CCC(C3CCC(CCCCC)CC3)CC2)ccc1[Si](C)(C)CCCCCOCC1COC(C)(C)OC1]

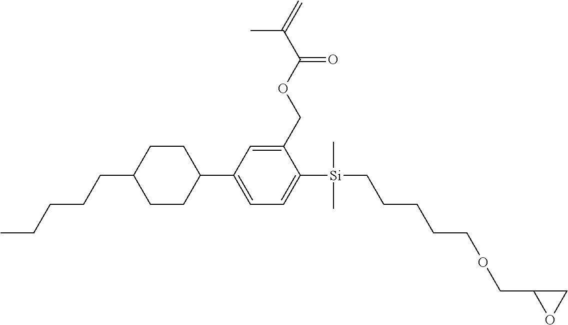 [SMILES: C=C(C)C(=O)OCc1cc(C2CCC(CCCCC)CC2)ccc1[Si](C)(C)CCCCCOCC1CO1]

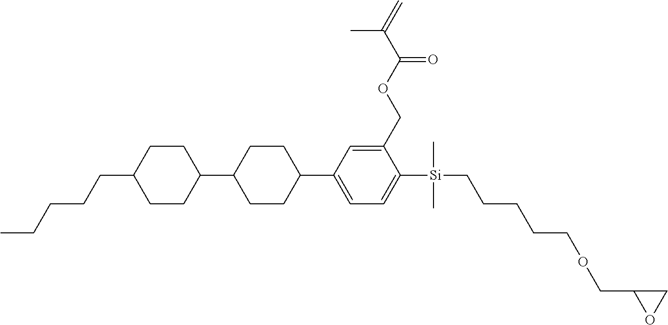 [SMILES: C=C(C)C(=O)OCc1cc(C2CCC(C3CCC(CCCCC)CC3)CC2)ccc1[Si](C)(C)CCCCCOCC1CO1]

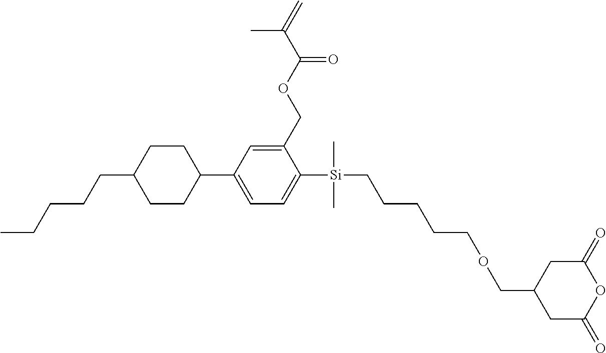 [SMILES: C=C(C)C(=O)OCc1cc(C2CCC(CCCCC)CC2)ccc1[Si](C)(C)CCCCCOCC1CC(=O)OC(=O)C1]

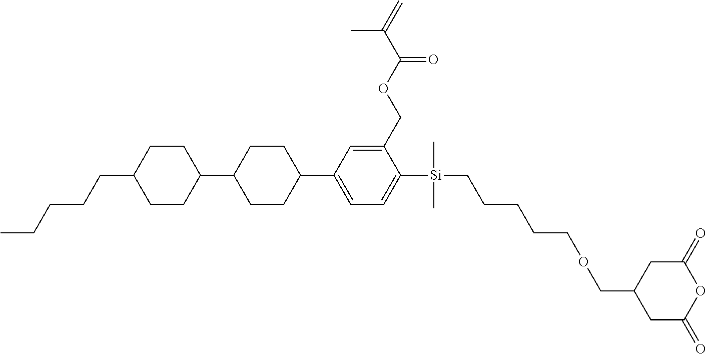 [SMILES: C=C(C)C(=O)OCc1cc(C2CCC(C3CCC(CCCCC)CC3)CC2)ccc1[Si](C)(C)CCCCCOCC1CC(=O)OC(=O)C1]

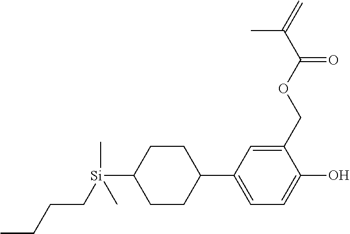 [SMILES: C=C(C)C(=O)OCc1cc(C2CCC([Si](C)(C)CCCC)CC2)ccc1O]

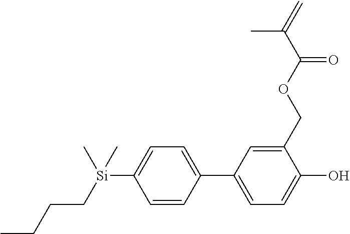 [SMILES: C=C(C)C(=O)OCc1cc(-c2ccc([Si](C)(C)CCCC)cc2)ccc1O]

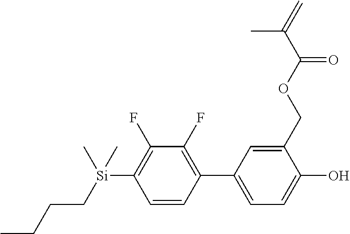 [SMILES: C=C(C)C(=O)OCc1cc(-c2ccc([Si](C)(C)CCCC)c(F)c2F)ccc1O]

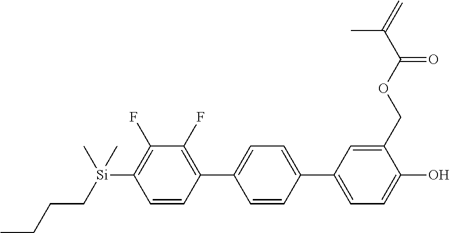 [SMILES: C=C(C)C(=O)OCc1cc(-c2ccc(-c3ccc([Si](C)(C)CCCC)c(F)c3F)cc2)ccc1O]

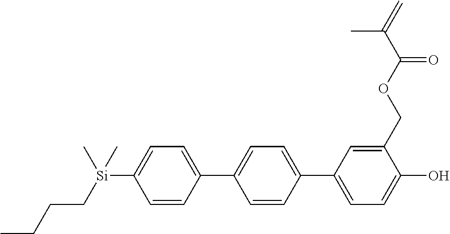 [SMILES: C=C(C)C(=O)OCc1cc(-c2ccc(-c3ccc([Si](C)(C)CCCC)cc3)cc2)ccc1O]

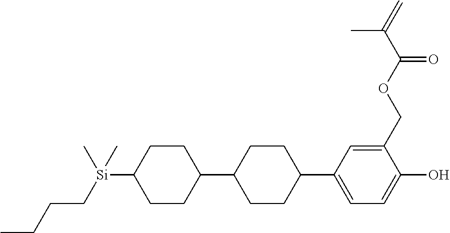 [SMILES: C=C(C)C(=O)OCc1cc(C2CCC(C3CCC([Si](C)(C)CCCC)CC3)CC2)ccc1O]

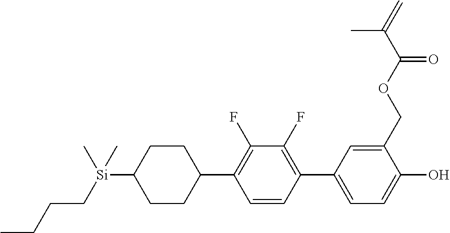 [SMILES: C=C(C)C(=O)OCc1cc(-c2ccc(C3CCC([Si](C)(C)CCCC)CC3)c(F)c2F)ccc1O]

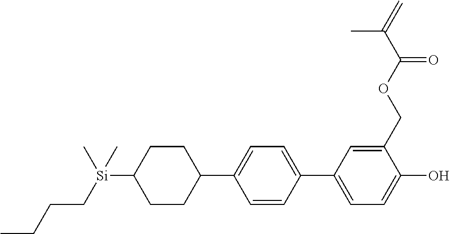 [SMILES: C=C(C)C(=O)OCc1cc(-c2ccc(C3CCC([Si](C)(C)CCCC)CC3)cc2)ccc1O]

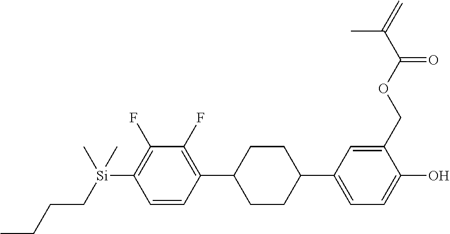 [SMILES: C=C(C)C(=O)OCc1cc(C2CCC(c3ccc([Si](C)(C)CCCC)c(F)c3F)CC2)ccc1O]

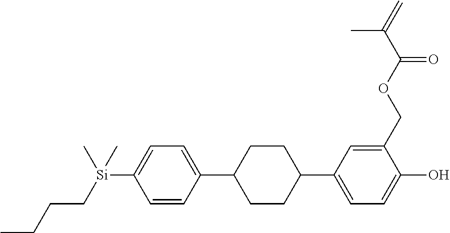 [SMILES: C=C(C)C(=O)OCc1cc(C2CCC(c3ccc([Si](C)(C)CCCC)cc3)CC2)ccc1O]

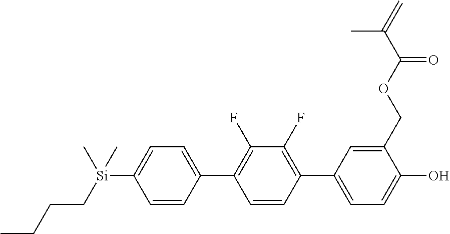 [SMILES: C=C(C)C(=O)OCc1cc(-c2ccc(-c3ccc([Si](C)(C)CCCC)cc3)c(F)c2F)ccc1O]

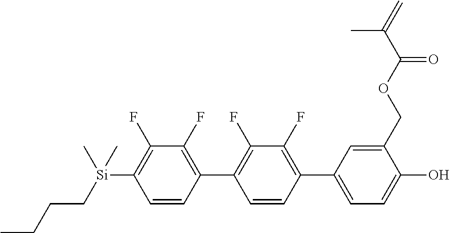 [SMILES: C=C(C)C(=O)OCc1cc(-c2ccc(-c3ccc([Si](C)(C)CCCC)c(F)c3F)c(F)c2F)ccc1O]

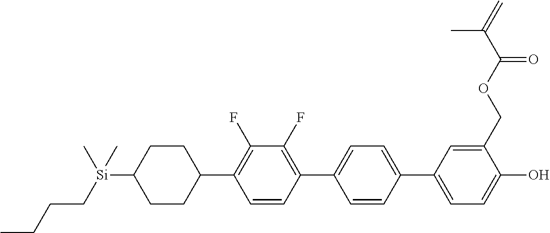 [SMILES: C=C(C)C(=O)OCc1cc(-c2ccc(-c3ccc(C4CCC([Si](C)(C)CCCC)CC4)c(F)c3F)cc2)ccc1O]

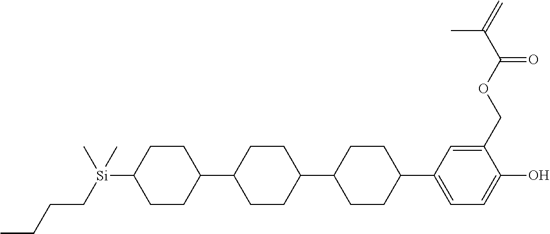 [SMILES: C=C(C)C(=O)OCc1cc(C2CCC(C3CCC(C4CCC([Si](C)(C)CCCC)CC4)CC3)CC2)ccc1O]

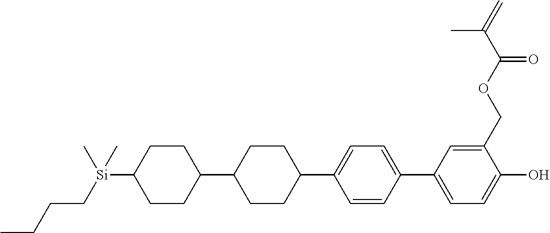 [SMILES: C=C(C)C(=O)OCc1cc(-c2ccc(C3CCC(C4CCC([Si](C)(C)CCCC)CC4)CC3)cc2)ccc1O]

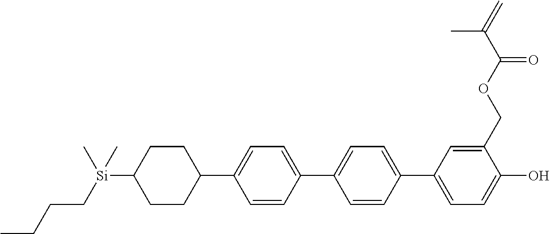 [SMILES: C=C(C)C(=O)OCc1cc(-c2ccc(-c3ccc(C4CCC([Si](C)(C)CCCC)CC4)cc3)cc2)ccc1O]

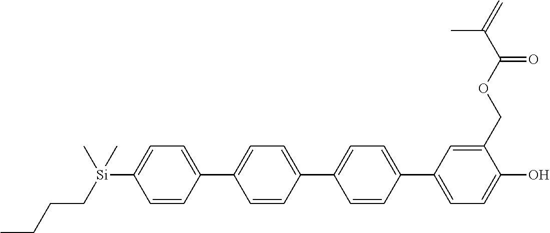 [SMILES: C=C(C)C(=O)OCc1cc(-c2ccc(-c3ccc(-c4ccc([Si](C)(C)CCCC)cc4)cc3)cc2)ccc1O]

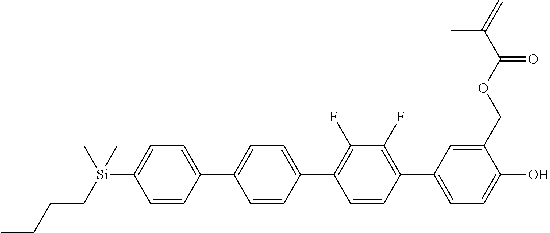 [SMILES: C=C(C)C(=O)OCc1cc(-c2ccc(-c3ccc(-c4ccc([Si](C)(C)CCCC)cc4)cc3)c(F)c2F)ccc1O]

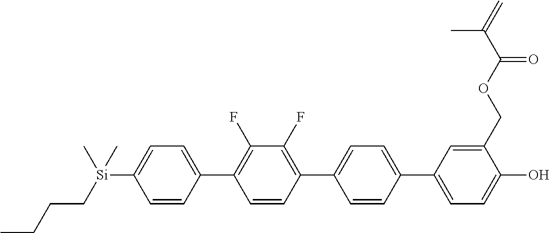 [SMILES: C=C(C)C(=O)OCc1cc(-c2ccc(-c3ccc(-c4ccc([Si](C)(C)CCCC)cc4)c(F)c3F)cc2)ccc1O]

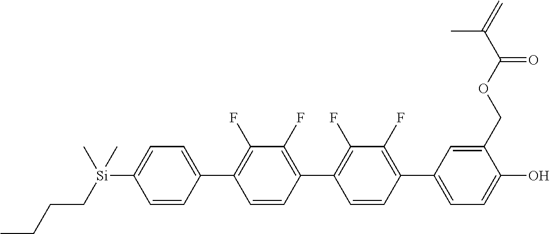 [SMILES: C=C(C)C(=O)OCc1cc(-c2ccc(-c3ccc(-c4ccc([Si](C)(C)CCCC)cc4)c(F)c3F)c(F)c2F)ccc1O]

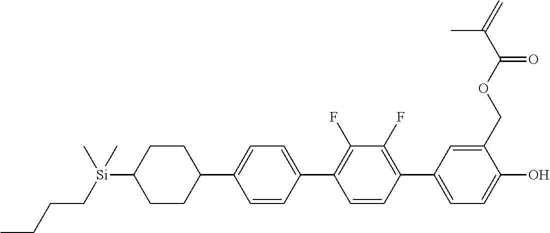 [SMILES: C=C(C)C(=O)OCc1cc(-c2ccc(-c3ccc(C4CCC([Si](C)(C)CCCC)CC4)cc3)c(F)c2F)ccc1O]

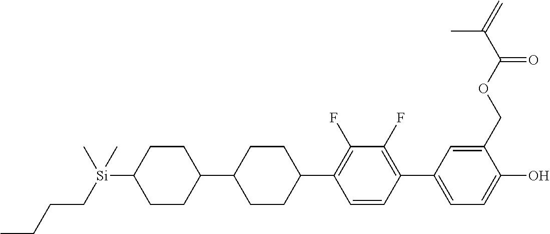 [SMILES: C=C(C)C(=O)OCc1cc(-c2ccc(C3CCC(C4CCC([Si](C)(C)CCCC)CC4)CC3)c(F)c2F)ccc1O]

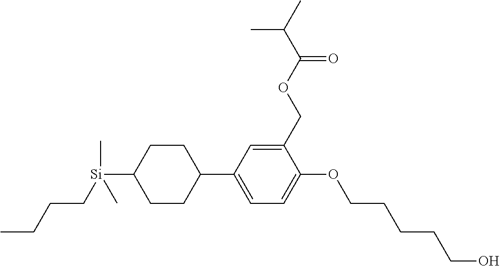 [SMILES: CCCC[Si](C)(C)C1CCC(c2ccc(OCCCCCO)c(COC(=O)C(C)C)c2)CC1]

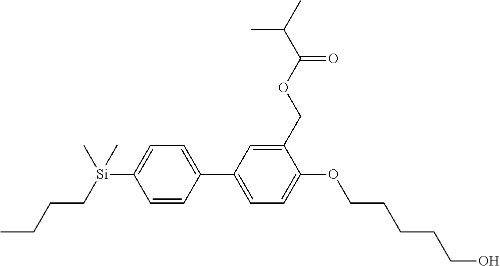 [SMILES: CCCC[Si](C)(C)c1ccc(-c2ccc(OCCCCCO)c(COC(=O)C(C)C)c2)cc1]

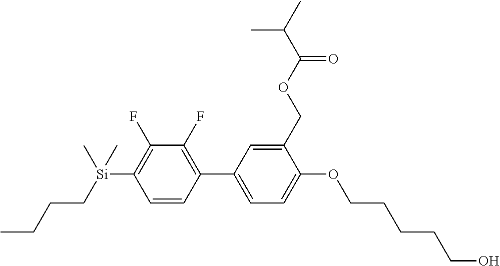 [SMILES: CCCC[Si](C)(C)c1ccc(-c2ccc(OCCCCCO)c(COC(=O)C(C)C)c2)c(F)c1F]

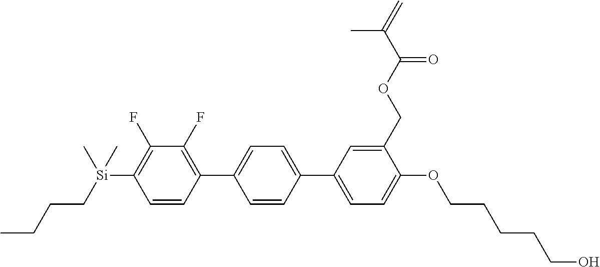 [SMILES: C=C(C)C(=O)OCc1cc(-c2ccc(-c3ccc([Si](C)(C)CCCC)c(F)c3F)cc2)ccc1OCCCCCO]

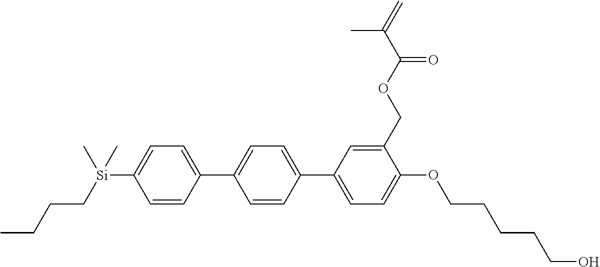 [SMILES: C=C(C)C(=O)OCc1cc(-c2ccc(-c3ccc([Si](C)(C)CCCC)cc3)cc2)ccc1OCCCCCO]

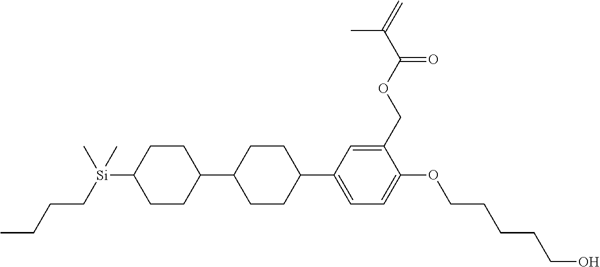 [SMILES: C=C(C)C(=O)OCc1cc(C2CCC(C3CCC([Si](C)(C)CCCC)CC3)CC2)ccc1OCCCCCO]

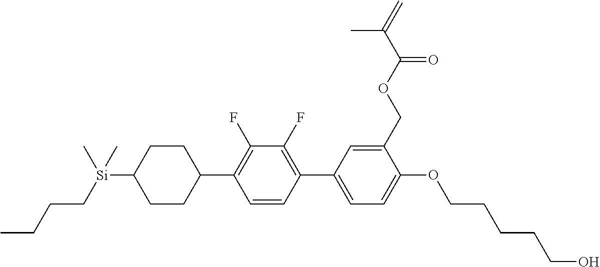 [SMILES: C=C(C)C(=O)OCc1cc(-c2ccc(C3CCC([Si](C)(C)CCCC)CC3)c(F)c2F)ccc1OCCCCCO]

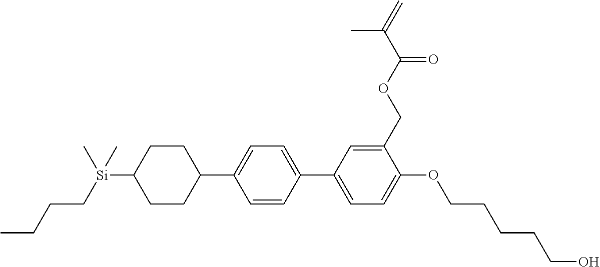 [SMILES: C=C(C)C(=O)OCc1cc(-c2ccc(C3CCC([Si](C)(C)CCCC)CC3)cc2)ccc1OCCCCCO]

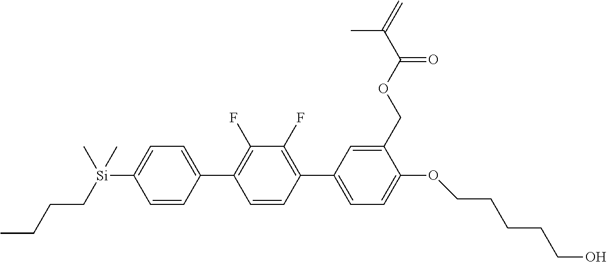 [SMILES: C=C(C)C(=O)OCc1cc(-c2ccc(-c3ccc([Si](C)(C)CCCC)cc3)c(F)c2F)ccc1OCCCCCO]

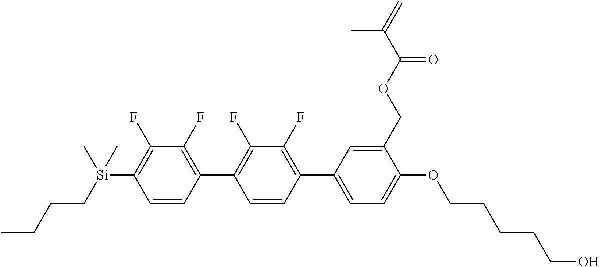 [SMILES: C=C(C)C(=O)OCc1cc(-c2ccc(-c3ccc([Si](C)(C)CCCC)c(F)c3F)c(F)c2F)ccc1OCCCCCO]

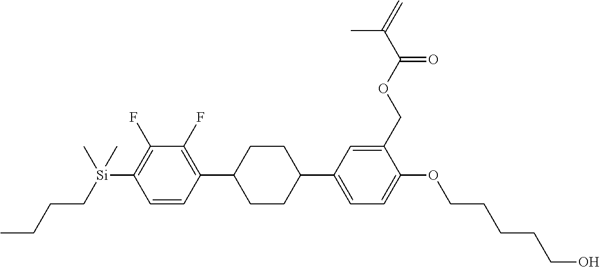 [SMILES: C=C(C)C(=O)OCc1cc(C2CCC(c3ccc([Si](C)(C)CCCC)c(F)c3F)CC2)ccc1OCCCCCO]

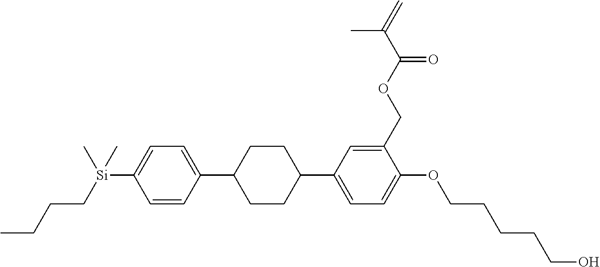 [SMILES: C=C(C)C(=O)OCc1cc(C2CCC(c3ccc([Si](C)(C)CCCC)cc3)CC2)ccc1OCCCCCO]

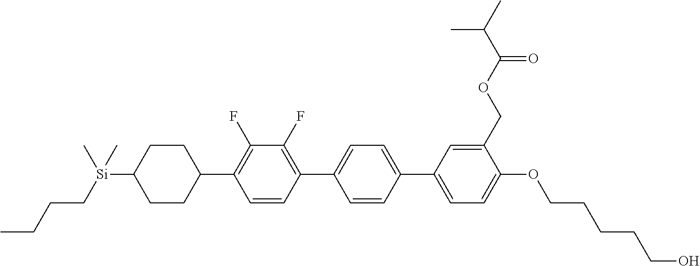 [SMILES: CCCC[Si](C)(C)C1CCC(c2ccc(-c3ccc(-c4ccc(OCCCCCO)c(COC(=O)C(C)C)c4)cc3)c(F)c2F)CC1]

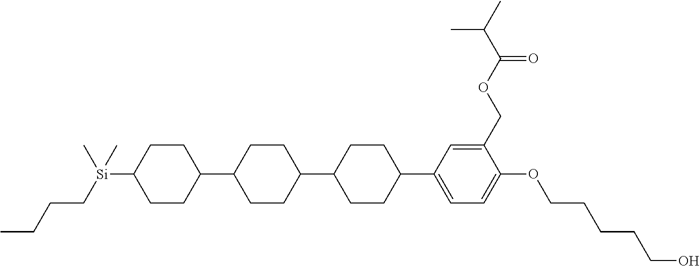 [SMILES: CCCC[Si](C)(C)C1CCC(C2CCC(C3CCC(c4ccc(OCCCCCO)c(COC(=O)C(C)C)c4)CC3)CC2)CC1]

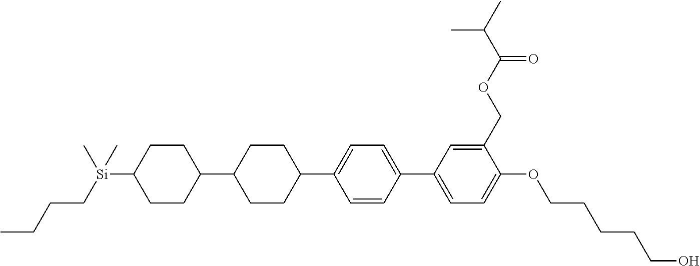 [SMILES: CCCC[Si](C)(C)C1CCC(C2CCC(c3ccc(-c4ccc(OCCCCCO)c(COC(=O)C(C)C)c4)cc3)CC2)CC1]

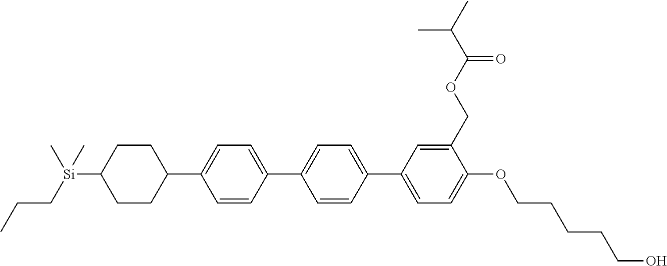 [SMILES: CCC[Si](C)(C)C1CCC(c2ccc(-c3ccc(-c4ccc(OCCCCCO)c(COC(=O)C(C)C)c4)cc3)cc2)CC1]

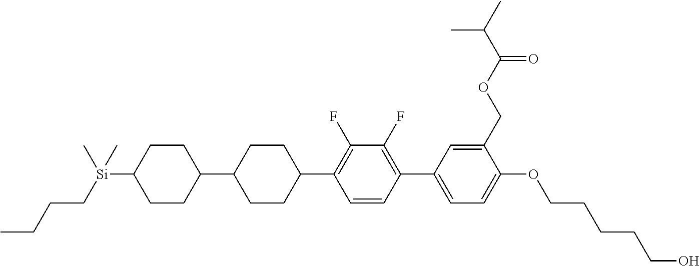 [SMILES: CCCC[Si](C)(C)C1CCC(C2CCC(c3ccc(-c4ccc(OCCCCCO)c(COC(=O)C(C)C)c4)c(F)c3F)CC2)CC1]

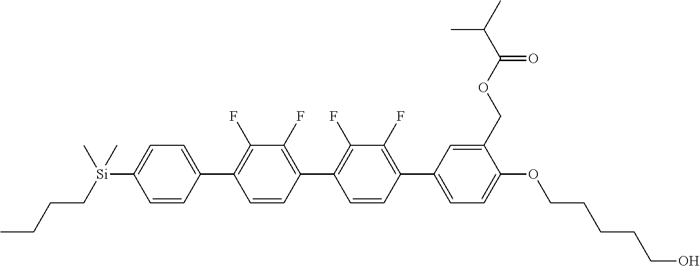 [SMILES: CCCC[Si](C)(C)c1ccc(-c2ccc(-c3ccc(-c4ccc(OCCCCCO)c(COC(=O)C(C)C)c4)c(F)c3F)c(F)c2F)cc1]

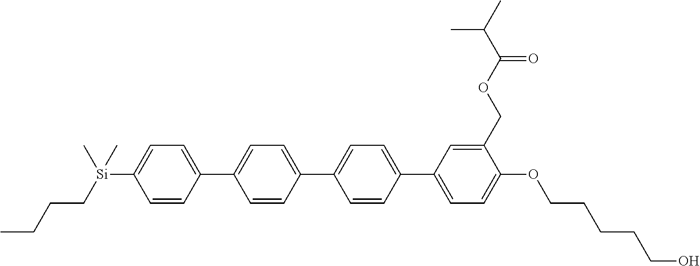 [SMILES: CCCC[Si](C)(C)c1ccc(-c2ccc(-c3ccc(-c4ccc(OCCCCCO)c(COC(=O)C(C)C)c4)cc3)cc2)cc1]

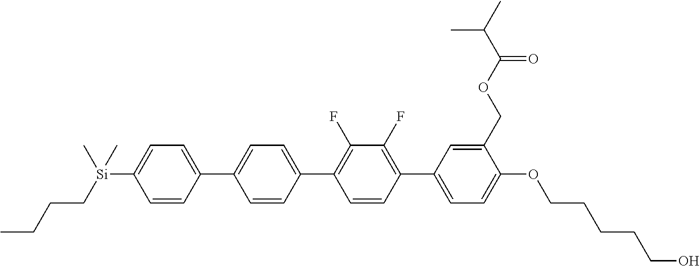 [SMILES: CCCC[Si](C)(C)c1ccc(-c2ccc(-c3ccc(-c4ccc(OCCCCCO)c(COC(=O)C(C)C)c4)c(F)c3F)cc2)cc1]

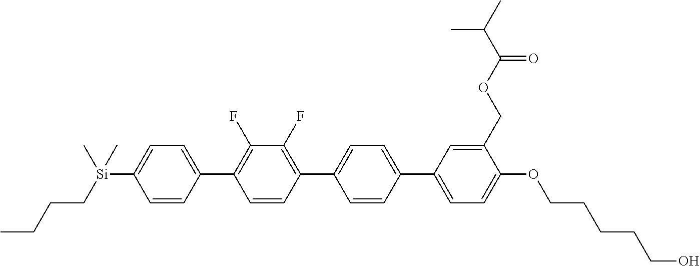 [SMILES: CCCC[Si](C)(C)c1ccc(-c2ccc(-c3ccc(-c4ccc(OCCCCCO)c(COC(=O)C(C)C)c4)cc3)c(F)c2F)cc1]

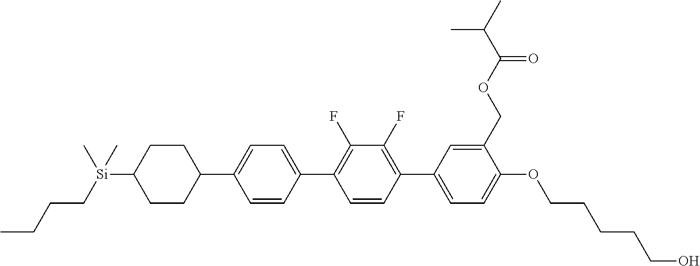 [SMILES: CCCC[Si](C)(C)C1CCC(c2ccc(-c3ccc(-c4ccc(OCCCCCO)c(COC(=O)C(C)C)c4)c(F)c3F)cc2)CC1]

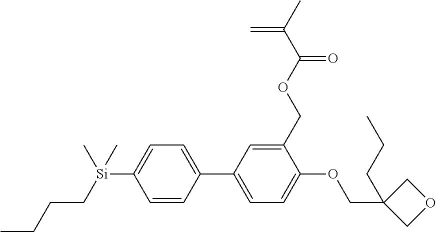 [SMILES: C=C(C)C(=O)OCc1cc(-c2ccc([Si](C)(C)CCCC)cc2)ccc1OCC1(CCC)COC1]

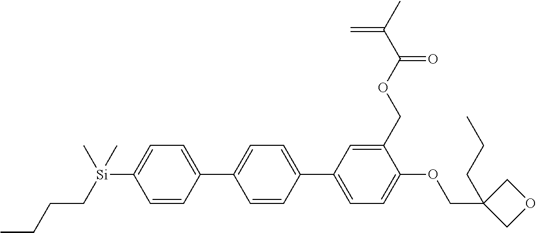 [SMILES: C=C(C)C(=O)OCc1cc(-c2ccc(-c3ccc([Si](C)(C)CCCC)cc3)cc2)ccc1OCC1(CCC)COC1]

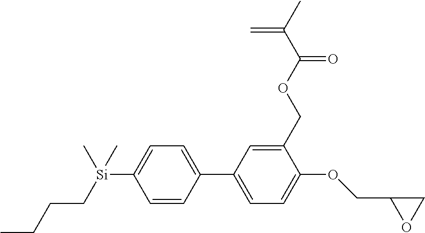 [SMILES: C=C(C)C(=O)OCc1cc(-c2ccc([Si](C)(C)CCCC)cc2)ccc1OCC1CO1]

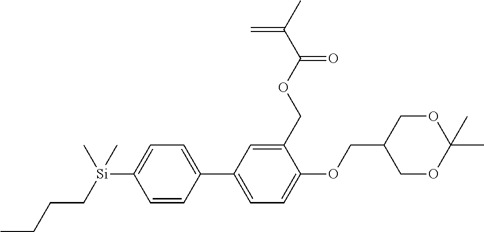 [SMILES: C=C(C)C(=O)OCc1cc(-c2ccc([Si](C)(C)CCCC)cc2)ccc1OCC1COC(C)(C)OC1]

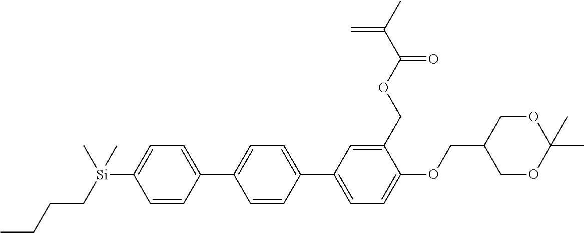 [SMILES: C=C(C)C(=O)OCc1cc(-c2ccc(-c3ccc([Si](C)(C)CCCC)cc3)cc2)ccc1OCC1COC(C)(C)OC1]

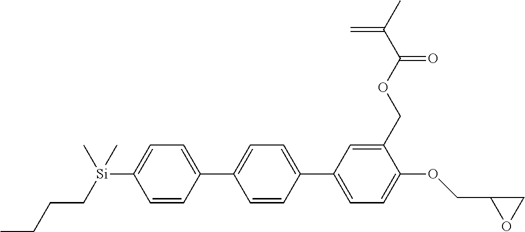 [SMILES: C=C(C)C(=O)OCc1cc(-c2ccc(-c3ccc([Si](C)(C)CCCC)cc3)cc2)ccc1OCC1CO1]

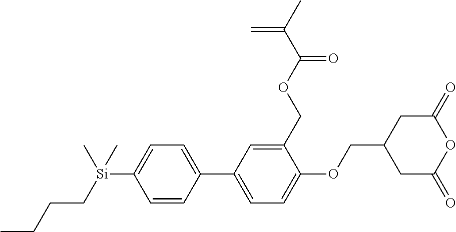 [SMILES: C=C(C)C(=O)OCc1cc(-c2ccc([Si](C)(C)CCCC)cc2)ccc1OCC1CC(=O)OC(=O)C1]

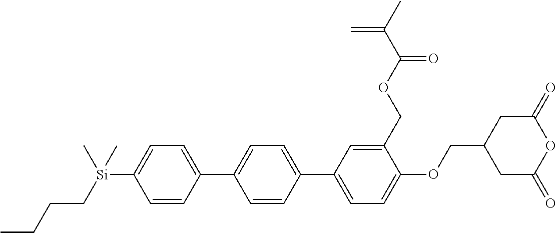 [SMILES: C=C(C)C(=O)OCc1cc(-c2ccc(-c3ccc([Si](C)(C)CCCC)cc3)cc2)ccc1OCC1CC(=O)OC(=O)C1]

TABLE 3

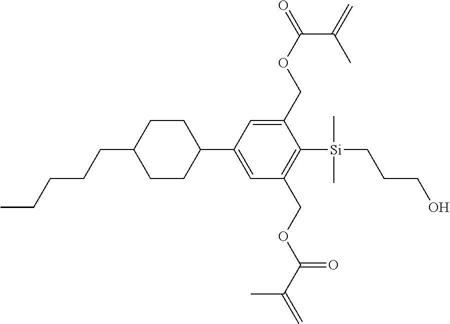 [SMILES: C=C(C)C(=O)OCc1cc(C2CCC(CCCCC)CC2)cc(COC(=O)C(=C)C)c1[Si](C)(C)CCCO]

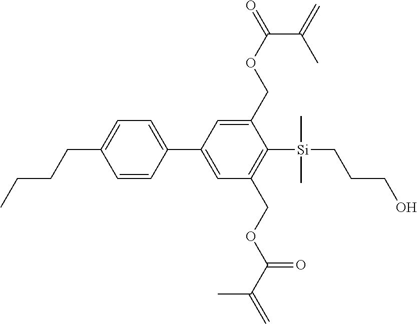 [SMILES: C=C(C)C(=O)OCc1cc(-c2ccc(CCCC)cc2)cc(COC(=O)C(=C)C)c1[Si](C)(C)CCCO]

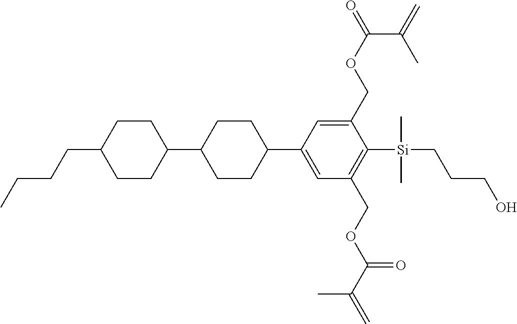 [SMILES: C=C(C)C(=O)OCc1cc(C2CCC(C3CCC(CCCC)CC3)CC2)cc(COC(=O)C(=C)C)c1[Si](C)(C)CCCO]

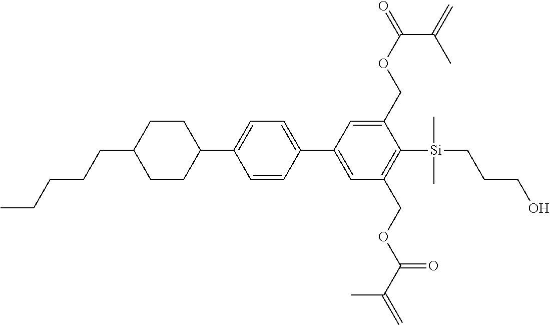 [SMILES: C=C(C)C(=O)OCc1cc(-c2ccc(C3CCC(CCCCC)CC3)cc2)cc(COC(=O)C(=C)C)c1[Si](C)(C)CCCO]

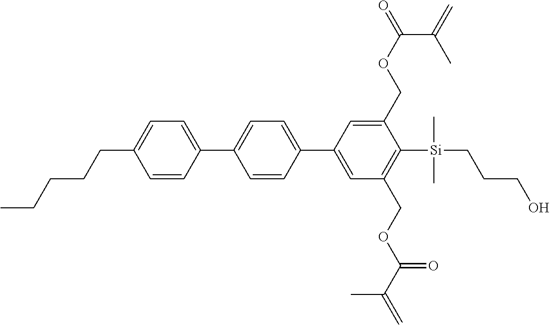 [SMILES: C=C(C)C(=O)OCc1cc(-c2ccc(-c3ccc(CCCCC)cc3)cc2)cc(COC(=O)C(=C)C)c1[Si](C)(C)CCCO]

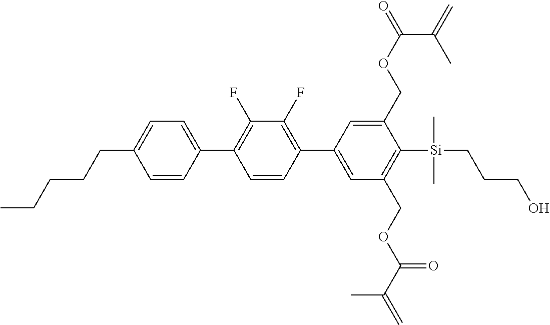 [SMILES: C=C(C)C(=O)OCc1cc(-c2ccc(-c3ccc(CCCCC)cc3)c(F)c2F)cc(COC(=O)C(=C)C)c1[Si](C)(C)CCCO]

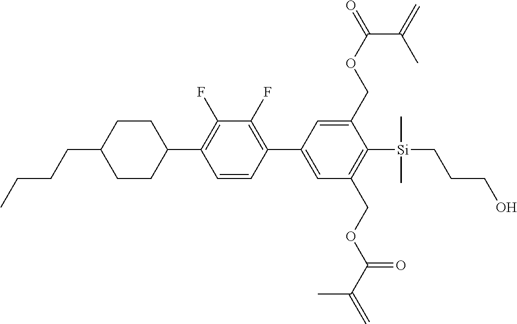 [SMILES: C=C(C)C(=O)OCc1cc(-c2ccc(C3CCC(CCCC)CC3)c(F)c2F)cc(COC(=O)C(=C)C)c1[Si](C)(C)CCCO]

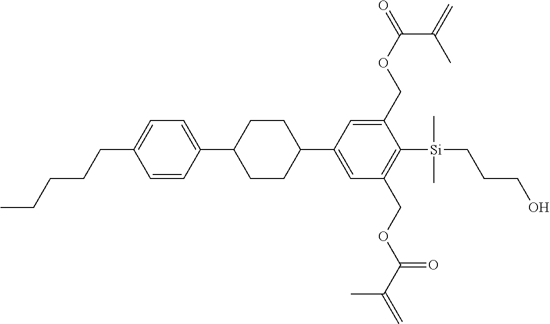 [SMILES: C=C(C)C(=O)OCc1cc(C2CCC(c3ccc(CCCCC)cc3)CC2)cc(COC(=O)C(=C)C)c1[Si](C)(C)CCCO]

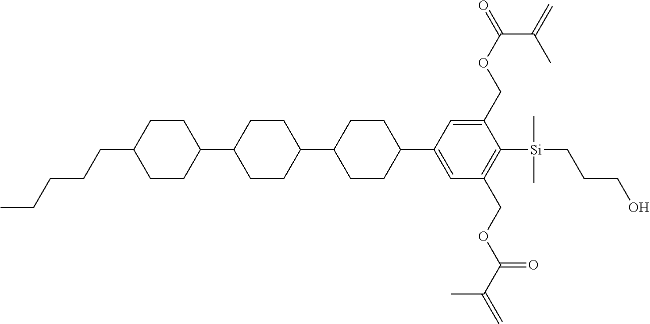 [SMILES: C=C(C)C(=O)OCc1cc(C2CCC(C3CCC(C4CCC(CCCCC)CC4)CC3)CC2)cc(COC(=O)C(=C)C)c1[Si](C)(C)CCCO]

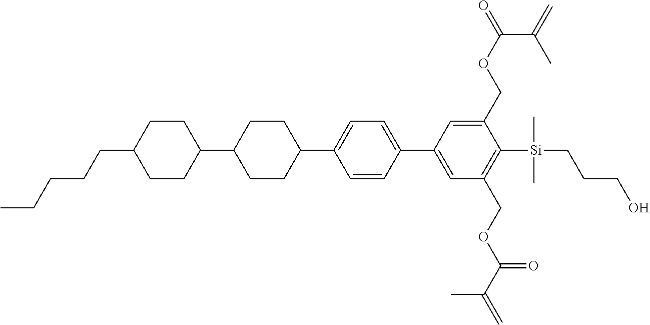 [SMILES: C=C(C)C(=O)OCc1cc(-c2ccc(C3CCC(C4CCC(CCCCC)CC4)CC3)cc2)cc(COC(=O)C(=C)C)c1[Si](C)(C)CCCO]

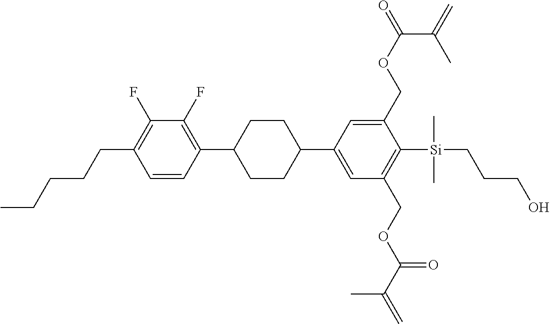 [SMILES: C=C(C)C(=O)OCc1cc(C2CCC(c3ccc(CCCCC)c(F)c3F)CC2)cc(COC(=O)C(=C)C)c1[Si](C)(C)CCCO]

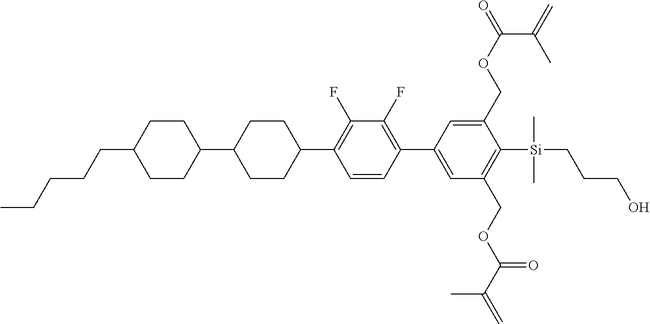 [SMILES: C=C(C)C(=O)OCc1cc(-c2ccc(C3CCC(C4CCC(CCCCC)CC4)CC3)c(F)c2F)cc(COC(=O)C(=C)C)c1[Si](C)(C)CCCO]

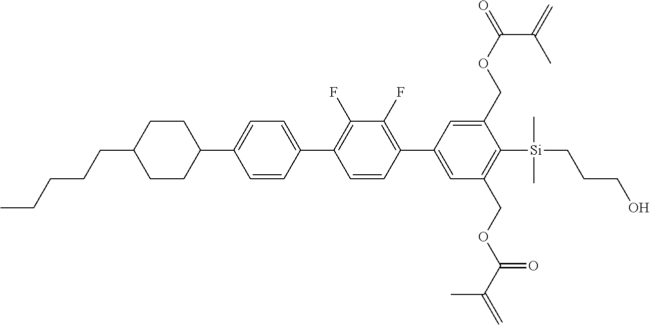 [SMILES: C=C(C)C(=O)OCc1cc(-c2ccc(-c3ccc(C4CCC(CCCCC)CC4)cc3)c(F)c2F)cc(COC(=O)C(=C)C)c1[Si](C)(C)CCCO]

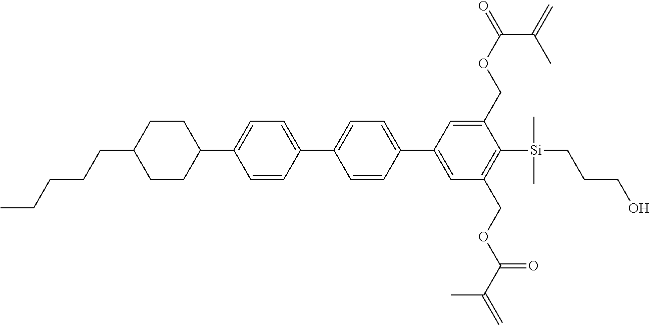 [SMILES: C=C(C)C(=O)OCc1cc(-c2ccc(-c3ccc(C4CCC(CCCCC)CC4)cc3)cc2)cc(COC(=O)C(=C)C)c1[Si](C)(C)CCCO]

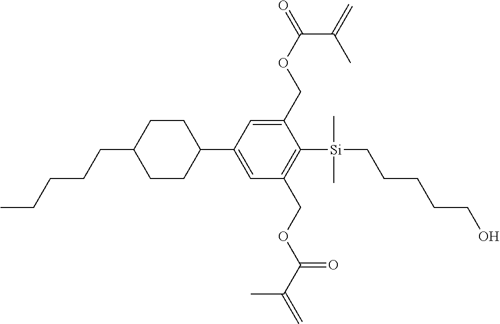 [SMILES: C=C(C)C(=O)OCc1cc(C2CCC(CCCCC)CC2)cc(COC(=O)C(=C)C)c1[Si](C)(C)CCCCCO]

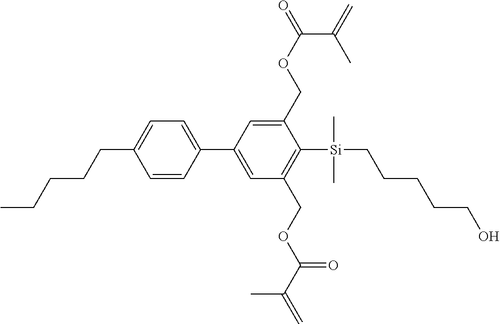 [SMILES: C=C(C)C(=O)OCc1cc(-c2ccc(CCCCC)cc2)cc(COC(=O)C(=C)C)c1[Si](C)(C)CCCCCO]

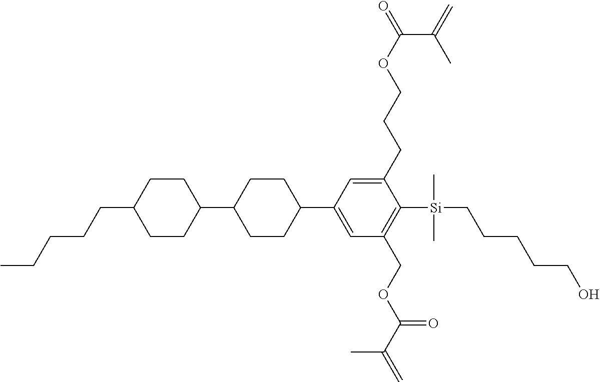 [SMILES: C=C(C)C(=O)OCCCc1cc(C2CCC(C3CCC(CCCCC)CC3)CC2)cc(COC(=O)C(=C)C)c1[Si](C)(C)CCCCCO]

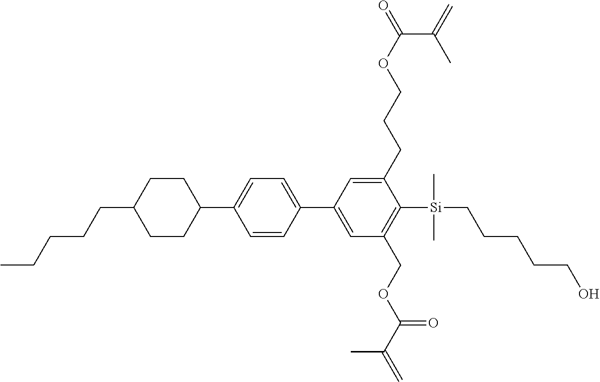 [SMILES: C=C(C)C(=O)OCCCc1cc(-c2ccc(C3CCC(CCCCC)CC3)cc2)cc(COC(=O)C(=C)C)c1[Si](C)(C)CCCCCO]

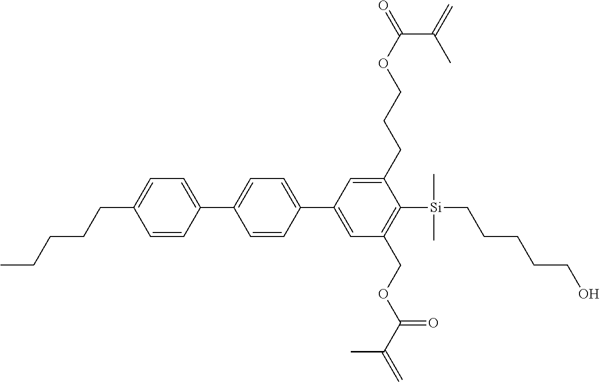 [SMILES: C=C(C)C(=O)OCCCc1cc(-c2ccc(-c3ccc(CCCCC)cc3)cc2)cc(COC(=O)C(=C)C)c1[Si](C)(C)CCCCCO]

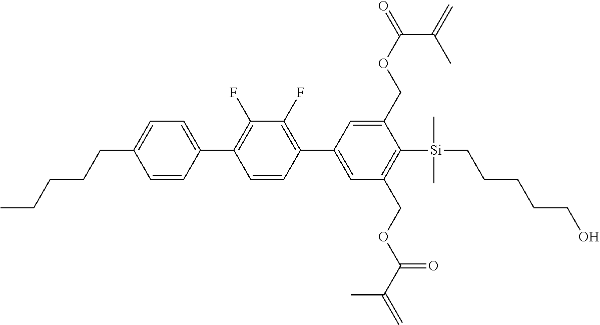 [SMILES: C=C(C)C(=O)OCc1cc(-c2ccc(-c3ccc(CCCCC)cc3)c(F)c2F)cc(COC(=O)C(=C)C)c1[Si](C)(C)CCCCCO]

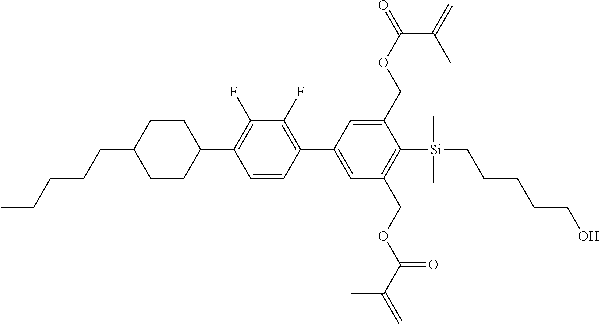 [SMILES: C=C(C)C(=O)OCc1cc(-c2ccc(C3CCC(CCCCC)CC3)c(F)c2F)cc(COC(=O)C(=C)C)c1[Si](C)(C)CCCCCO]

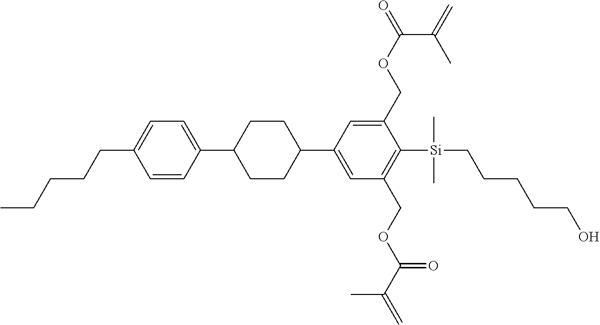 [SMILES: C=C(C)C(=O)OCc1cc(C2CCC(c3ccc(CCCCC)cc3)CC2)cc(COC(=O)C(=C)C)c1[Si](C)(C)CCCCCO]

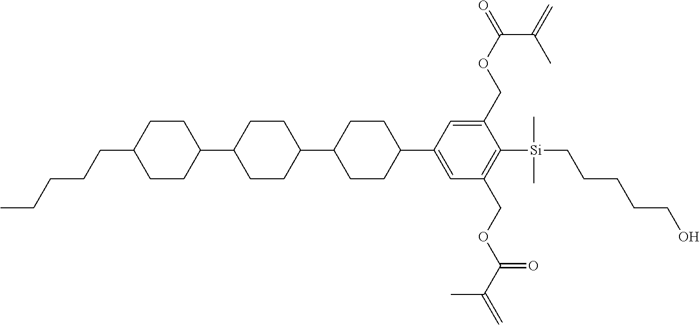 [SMILES: C=C(C)C(=O)OCc1cc(C2CCC(C3CCC(C4CCC(CCCCC)CC4)CC3)CC2)cc(COC(=O)C(=C)C)c1[Si](C)(C)CCCCCO]

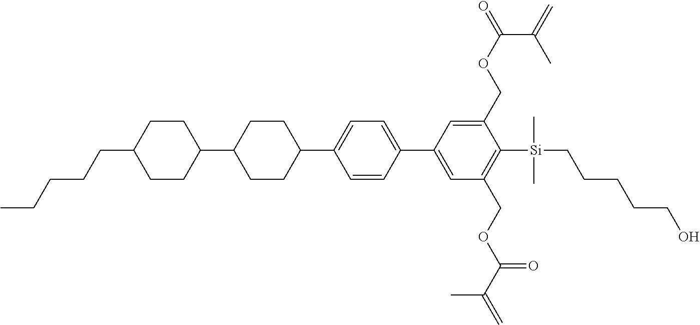 [SMILES: C=C(C)C(=O)OCc1cc(-c2ccc(C3CCC(C4CCC(CCCCC)CC4)CC3)cc2)cc(COC(=O)C(=C)C)c1[Si](C)(C)CCCCCO]

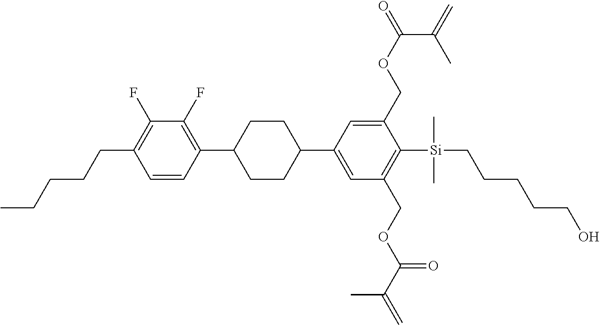 [SMILES: C=C(C)C(=O)OCc1cc(C2CCC(c3ccc(CCCCC)c(F)c3F)CC2)cc(COC(=O)C(=C)C)c1[Si](C)(C)CCCCCO]

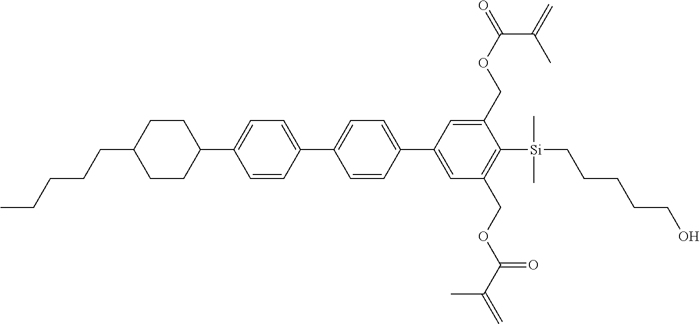 [SMILES: C=C(C)C(=O)OCc1cc(-c2ccc(-c3ccc(C4CCC(CCCCC)CC4)cc3)cc2)cc(COC(=O)C(=C)C)c1[Si](C)(C)CCCCCO]

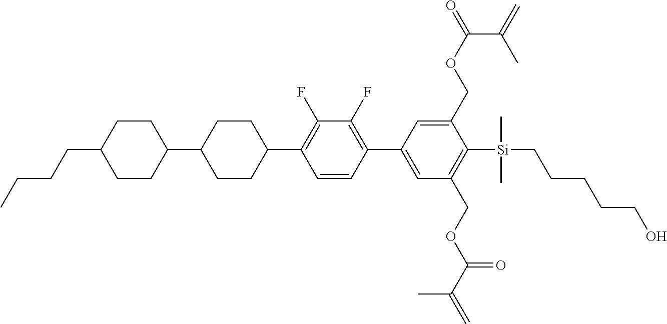 [SMILES: C=C(C)C(=O)OCc1cc(-c2ccc(C3CCC(C4CCC(CCCC)CC4)CC3)c(F)c2F)cc(COC(=O)C(=C)C)c1[Si](C)(C)CCCCCO]

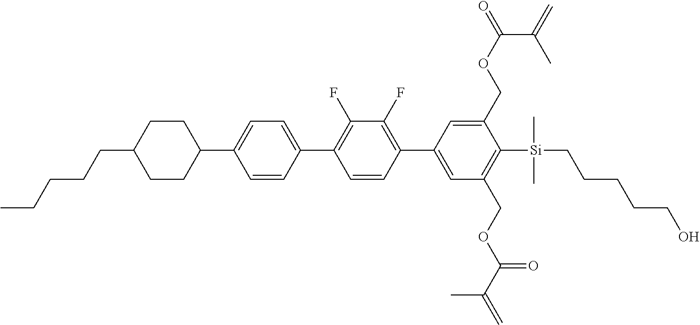 [SMILES: C=C(C)C(=O)OCc1cc(-c2ccc(-c3ccc(C4CCC(CCCCC)CC4)cc3)c(F)c2F)cc(COC(=O)C(=C)C)c1[Si](C)(C)CCCCCO]

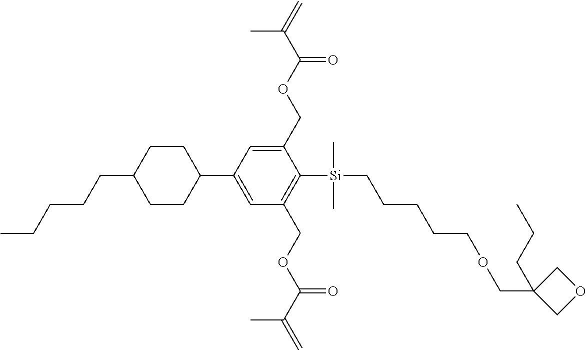 [SMILES: C=C(C)C(=O)OCc1cc(C2CCC(CCCCC)CC2)cc(COC(=O)C(=C)C)c1[Si](C)(C)CCCCCOCC1(CCC)COC1]

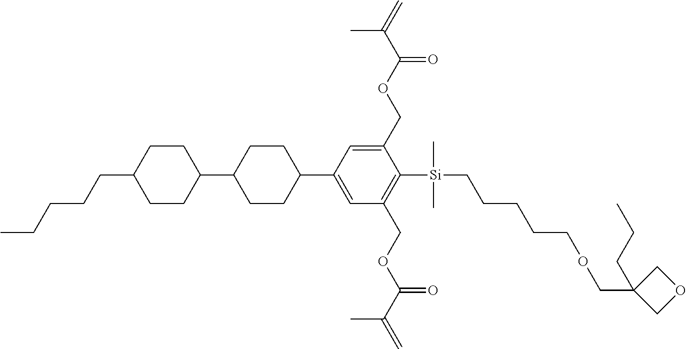 [SMILES: C=C(C)C(=O)OCc1cc(C2CCC(C3CCC(CCCCC)CC3)CC2)cc(COC(=O)C(=C)C)c1[Si](C)(C)CCCCCOCC1(CCC)COC1]

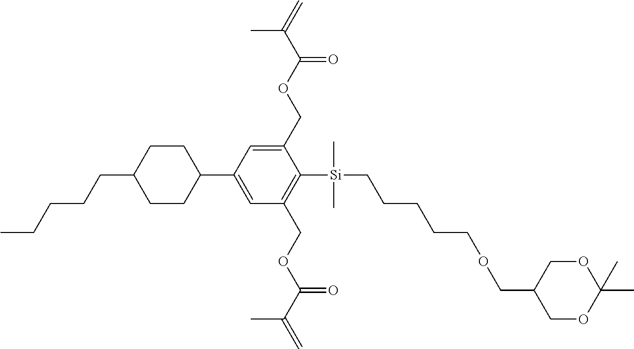 [SMILES: C=C(C)C(=O)OCc1cc(C2CCC(CCCCC)CC2)cc(COC(=O)C(=C)C)c1[Si](C)(C)CCCCCOCC1COC(C)(C)OC1]

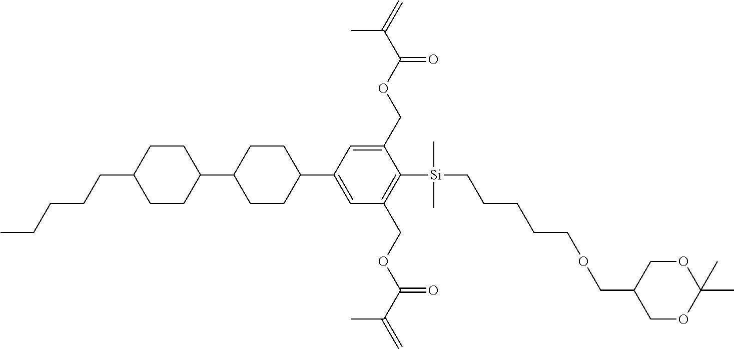 [SMILES: C=C(C)C(=O)OCc1cc(C2CCC(C3CCC(CCCCC)CC3)CC2)cc(COC(=O)C(=C)C)c1[Si](C)(C)CCCCCOCC1COC(C)(C)OC1]

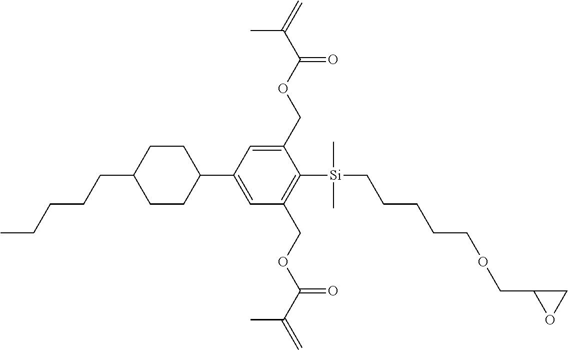 [SMILES: C=C(C)C(=O)OCc1cc(C2CCC(CCCCC)CC2)cc(COC(=O)C(=C)C)c1[Si](C)(C)CCCCCOCC1CO1]

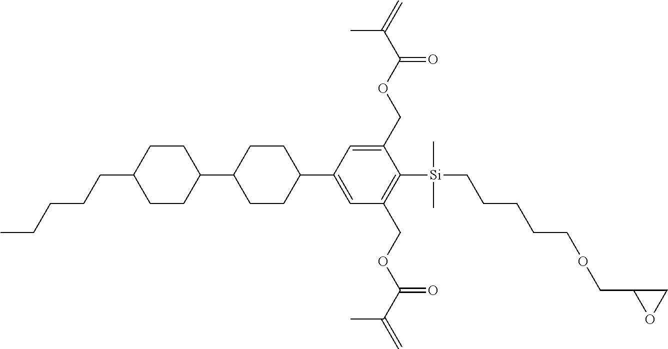 [SMILES: C=C(C)C(=O)OCc1cc(C2CCC(C3CCC(CCCCC)CC3)CC2)cc(COC(=O)C(=C)C)c1[Si](C)(C)CCCCCOCC1CO1]

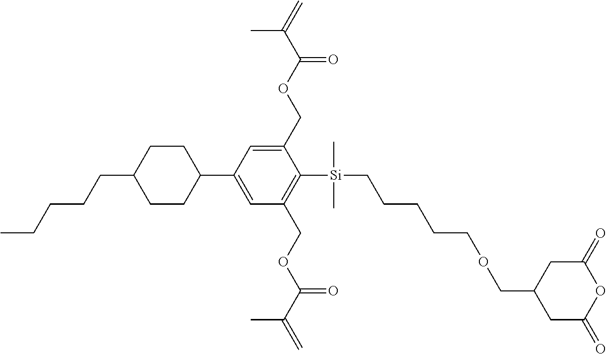 [SMILES: C=C(C)C(=O)OCc1cc(C2CCC(CCCCC)CC2)cc(COC(=O)C(=C)C)c1[Si](C)(C)CCCCCOCC1CC(=O)OC(=O)C1]

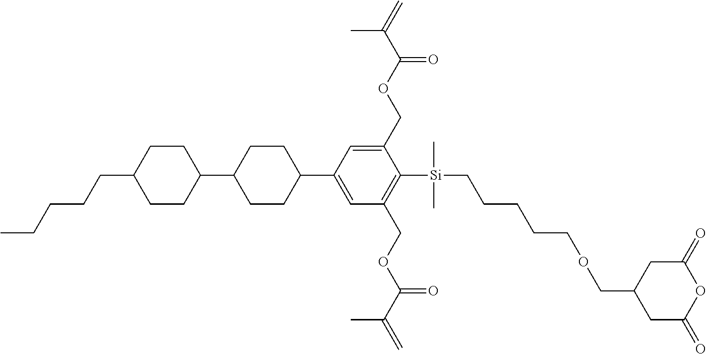 [SMILES: C=C(C)C(=O)OCc1cc(C2CCC(C3CCC(CCCCC)CC3)CC2)cc(COC(=O)C(=C)C)c1[Si](C)(C)CCCCCOCC1CC(=O)OC(=O)C1]

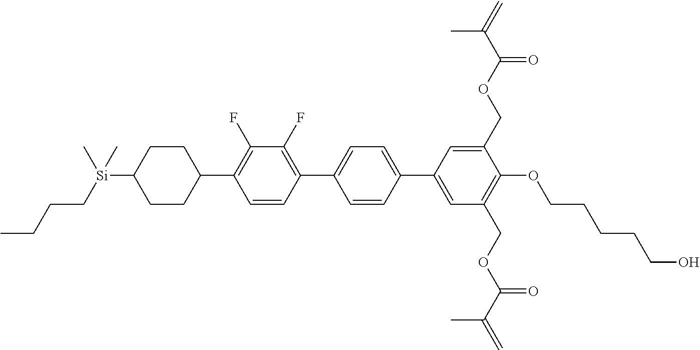 [SMILES: C=C(C)C(=O)OCc1cc(-c2ccc(-c3ccc(C4CCC([Si](C)(C)CCCC)CC4)c(F)c3F)cc2)cc(COC(=O)C(=C)C)c1OCCCCCO]

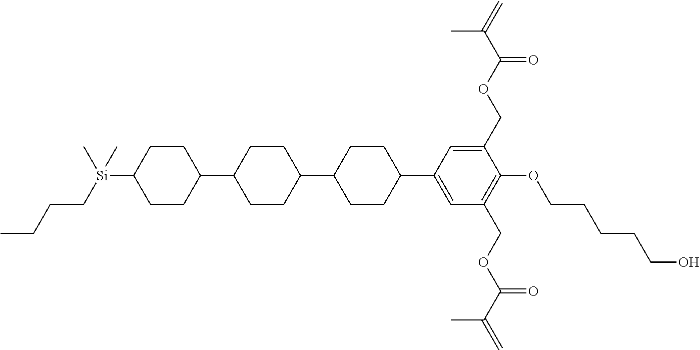 [SMILES: C=C(C)C(=O)OCc1cc(C2CCC(C3CCC(C4CCC([Si](C)(C)CCCC)CC4)CC3)CC2)cc(COC(=O)C(=C)C)c1OCCCCCO]

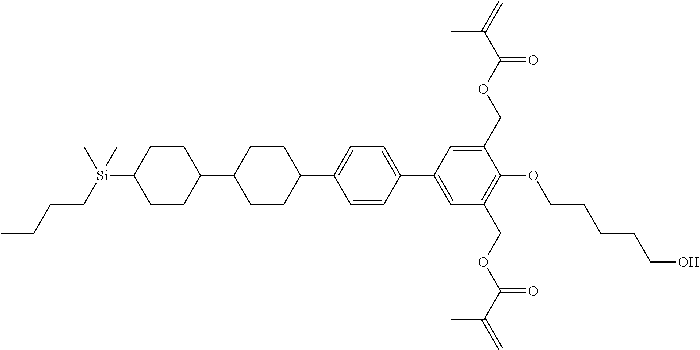 [SMILES: C=C(C)C(=O)OCc1cc(-c2ccc(C3CCC(C4CCC([Si](C)(C)CCCC)CC4)CC3)cc2)cc(COC(=O)C(=C)C)c1OCCCCCO]

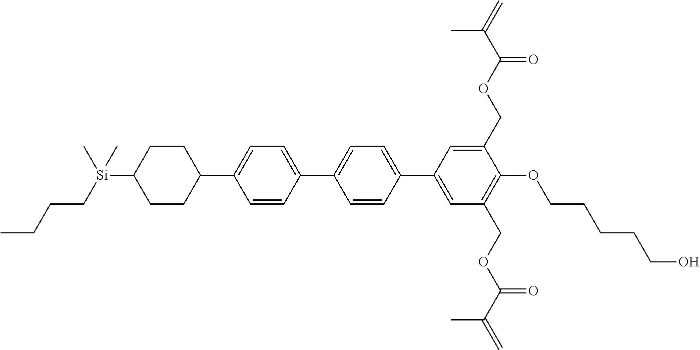 [SMILES: C=C(C)C(=O)OCc1cc(-c2ccc(-c3ccc(C4CCC([Si](C)(C)CCCC)CC4)cc3)cc2)cc(COC(=O)C(=C)C)c1OCCCCCO]

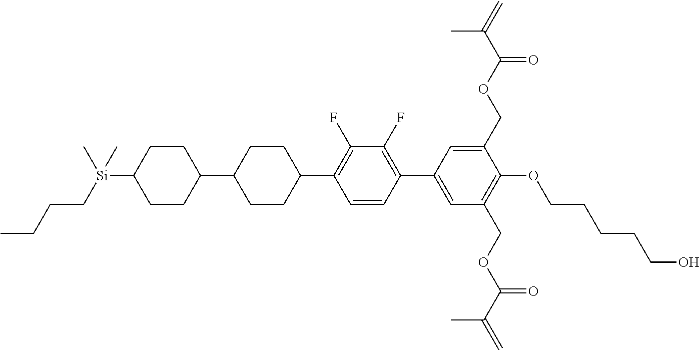 [SMILES: C=C(C)C(=O)OCc1cc(-c2ccc(C3CCC(C4CCC([Si](C)(C)CCCC)CC4)CC3)c(F)c2F)cc(COC(=O)C(=C)C)c1OCCCCCO]

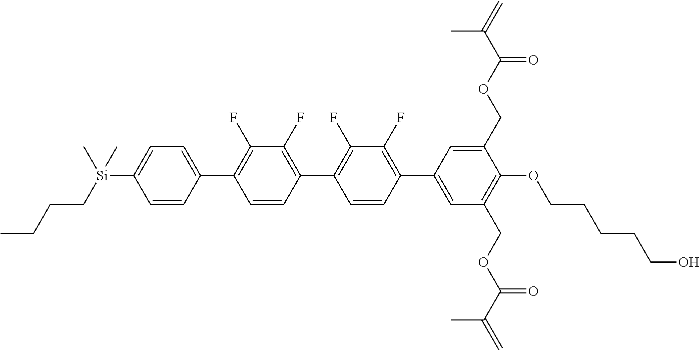 [SMILES: C=C(C)C(=O)OCc1cc(-c2ccc(-c3ccc(-c4ccc([Si](C)(C)CCCC)cc4)c(F)c3F)c(F)c2F)cc(COC(=O)C(=C)C)c1OCCCCCO]

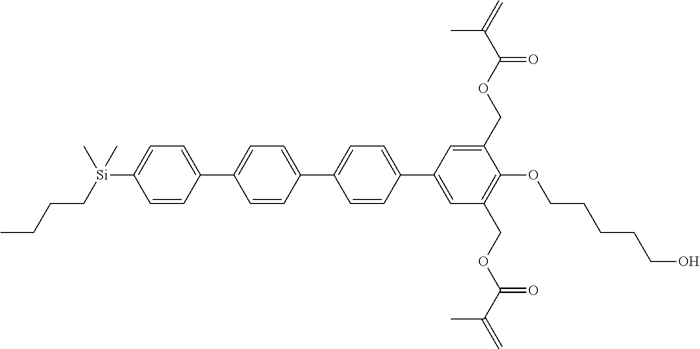 [SMILES: C=C(C)C(=O)OCc1cc(-c2ccc(-c3ccc(-c4ccc([Si](C)(C)CCCC)cc4)cc3)cc2)cc(COC(=O)C(=C)C)c1OCCCCCO]

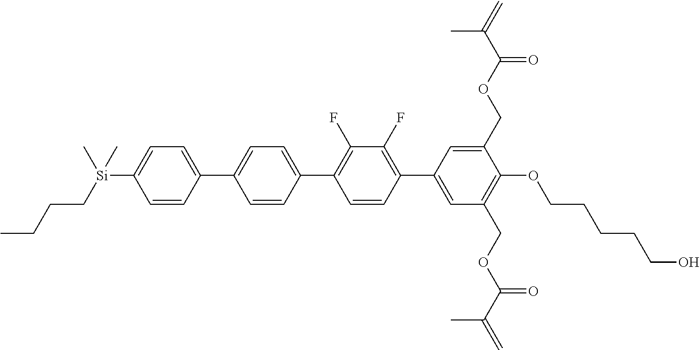 [SMILES: C=C(C)C(=O)OCc1cc(-c2ccc(-c3ccc(-c4ccc([Si](C)(C)CCCC)cc4)cc3)c(F)c2F)cc(COC(=O)C(=C)C)c1OCCCCCO]

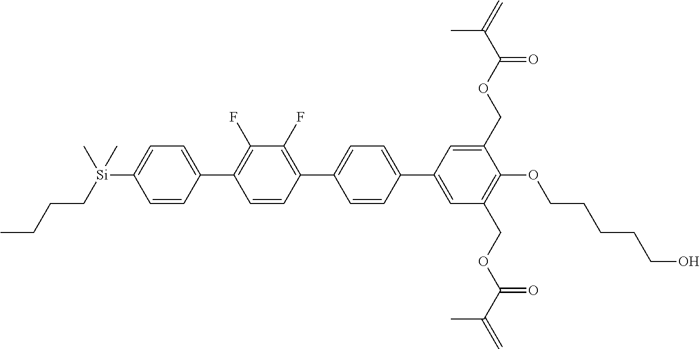 [SMILES: C=C(C)C(=O)OCc1cc(-c2ccc(-c3ccc(-c4ccc([Si](C)(C)CCCC)cc4)c(F)c3F)cc2)cc(COC(=O)C(=C)C)c1OCCCCCO]

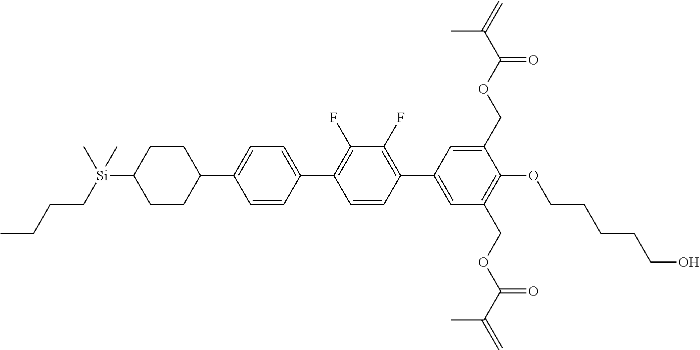 [SMILES: C=C(C)C(=O)OCc1cc(-c2ccc(-c3ccc(C4CCC([Si](C)(C)CCCC)CC4)cc3)c(F)c2F)cc(COC(=O)C(=C)C)c1OCCCCCO]

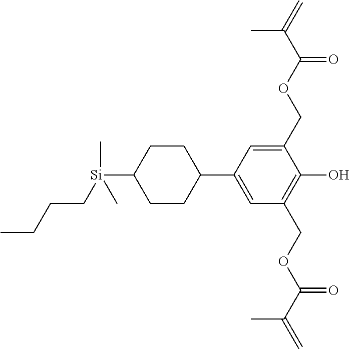 [SMILES: C=C(C)C(=O)OCc1cc(C2CCC([Si](C)(C)CCCC)CC2)cc(COC(=O)C(=C)C)c1O]

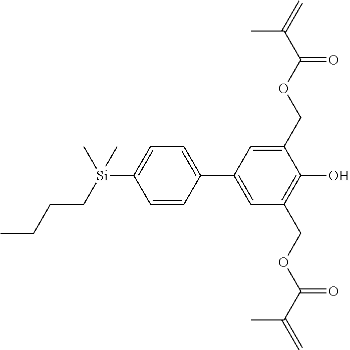 [SMILES: C=C(C)C(=O)OCc1cc(-c2ccc([Si](C)(C)CCCC)cc2)cc(COC(=O)C(=C)C)c1O]

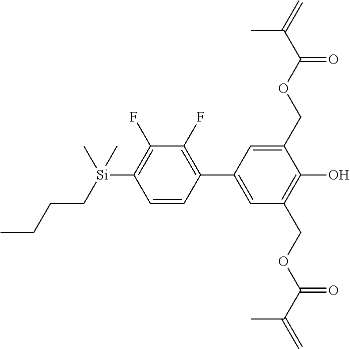 [SMILES: C=C(C)C(=O)OCc1cc(-c2ccc([Si](C)(C)CCCC)c(F)c2F)cc(COC(=O)C(=C)C)c1O]

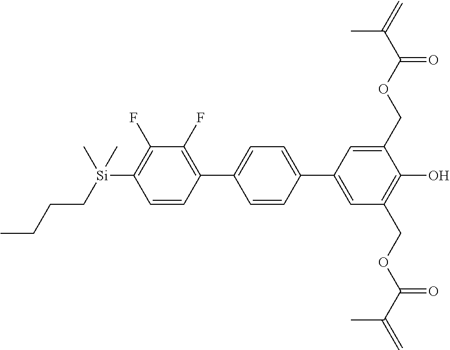 [SMILES: C=C(C)C(=O)OCc1cc(-c2ccc(-c3ccc([Si](C)(C)CCCC)c(F)c3F)cc2)cc(COC(=O)C(=C)C)c1O]

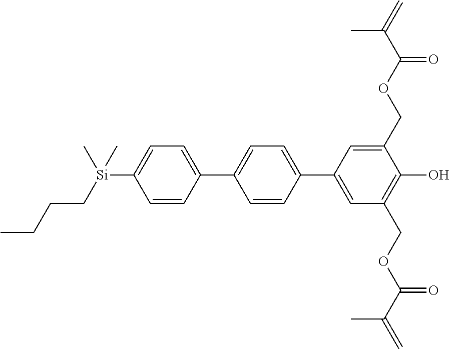 [SMILES: C=C(C)C(=O)OCc1cc(-c2ccc(-c3ccc([Si](C)(C)CCCC)cc3)cc2)cc(COC(=O)C(=C)C)c1O]

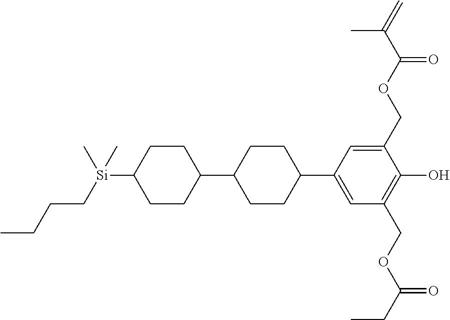 [SMILES: C=C(C)C(=O)OCc1cc(C2CCC(C3CCC([Si](C)(C)CCCC)CC3)CC2)cc(COC(=O)CC)c1O]

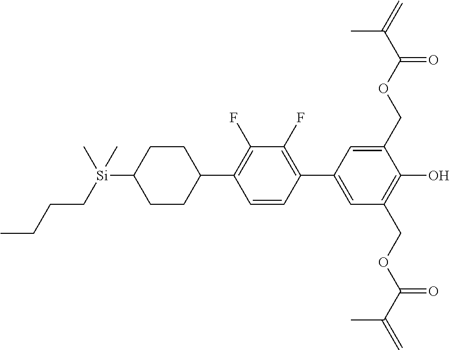 [SMILES: C=C(C)C(=O)OCc1cc(-c2ccc(C3CCC([Si](C)(C)CCCC)CC3)c(F)c2F)cc(COC(=O)C(=C)C)c1O]

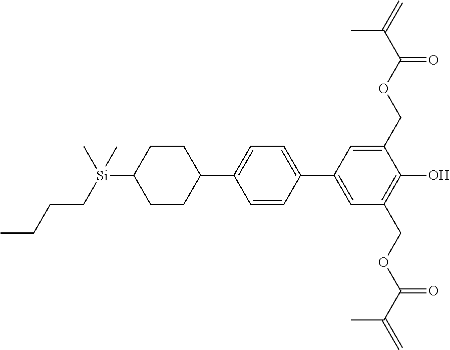 [SMILES: C=C(C)C(=O)OCc1cc(-c2ccc(C3CCC([Si](C)(C)CCCC)CC3)cc2)cc(COC(=O)C(=C)C)c1O]

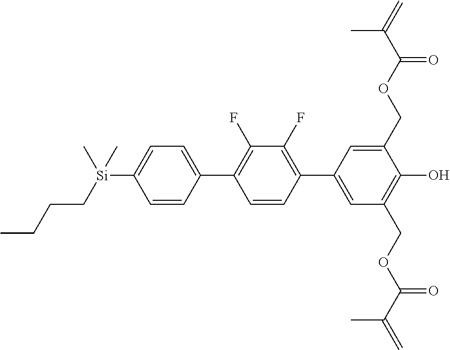 [SMILES: C=C(C)C(=O)OCc1cc(-c2ccc(-c3ccc([Si](C)(C)CCCC)cc3)c(F)c2F)cc(COC(=O)C(=C)C)c1O]

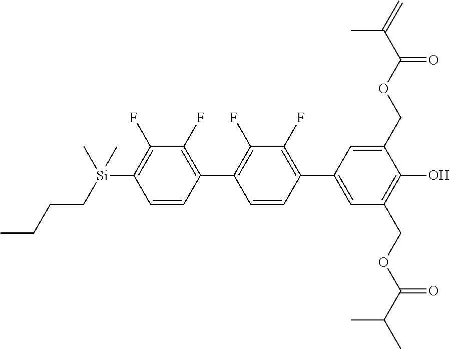 [SMILES: C=C(C)C(=O)OCc1cc(-c2ccc(-c3ccc([Si](C)(C)CCCC)c(F)c3F)c(F)c2F)cc(COC(=O)C(C)C)c1O]

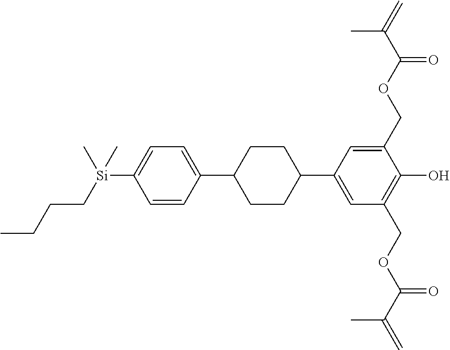 [SMILES: C=C(C)C(=O)OCc1cc(C2CCC(c3ccc([Si](C)(C)CCCC)cc3)CC2)cc(COC(=O)C(=C)C)c1O]

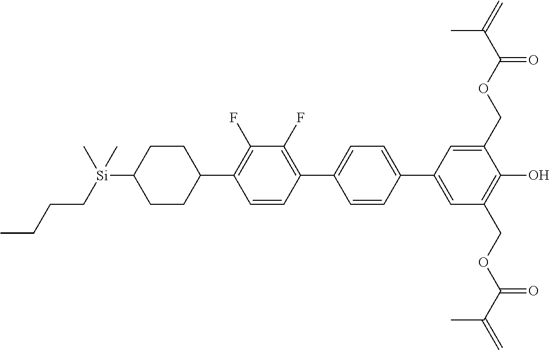 [SMILES: C=C(C)C(=O)OCc1cc(-c2ccc(-c3ccc(C4CCC([Si](C)(C)CCCC)CC4)c(F)c3F)cc2)cc(COC(=O)C(=C)C)c1O]

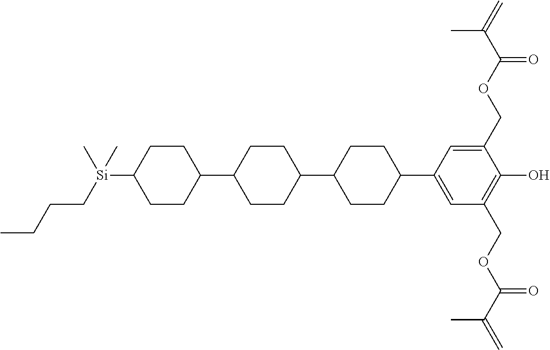 [SMILES: C=C(C)C(=O)OCc1cc(C2CCC(C3CCC(C4CCC([Si](C)(C)CCCC)CC4)CC3)CC2)cc(COC(=O)C(=C)C)c1O]

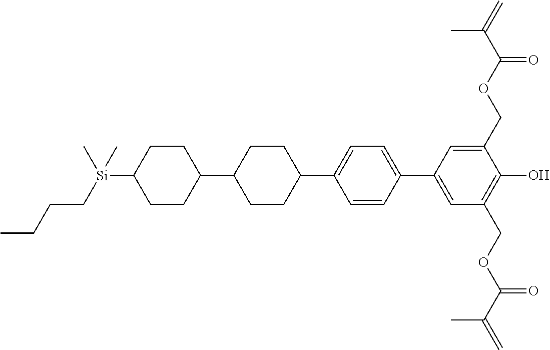 [SMILES: C=C(C)C(=O)OCc1cc(-c2ccc(C3CCC(C4CCC([Si](C)(C)CCCC)CC4)CC3)cc2)cc(COC(=O)C(=C)C)c1O]

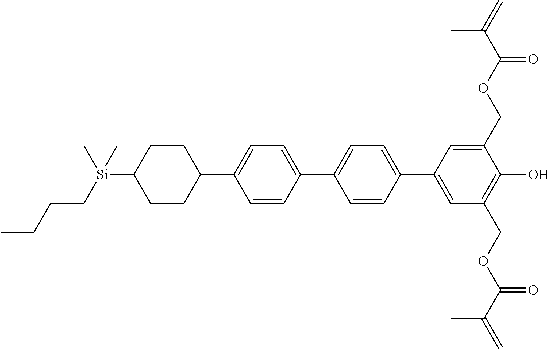 [SMILES: C=C(C)C(=O)OCc1cc(-c2ccc(-c3ccc(C4CCC([Si](C)(C)CCCC)CC4)cc3)cc2)cc(COC(=O)C(=C)C)c1O]

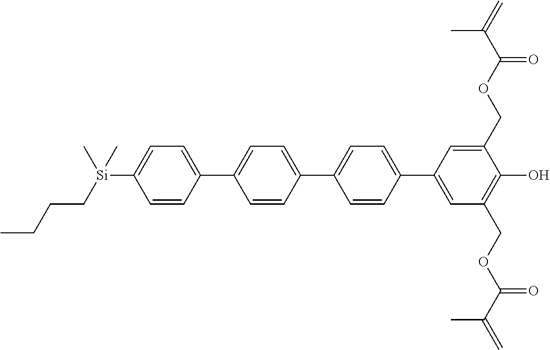 [SMILES: C=C(C)C(=O)OCc1cc(-c2ccc(-c3ccc(-c4ccc([Si](C)(C)CCCC)cc4)cc3)cc2)cc(COC(=O)C(=C)C)c1O]

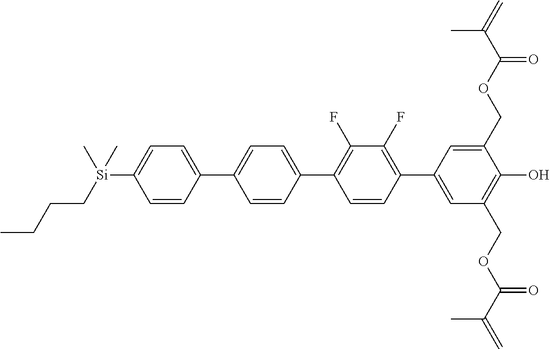 [SMILES: C=C(C)C(=O)OCc1cc(-c2ccc(-c3ccc(-c4ccc([Si](C)(C)CCCC)cc4)cc3)c(F)c2F)cc(COC(=O)C(=C)C)c1O]

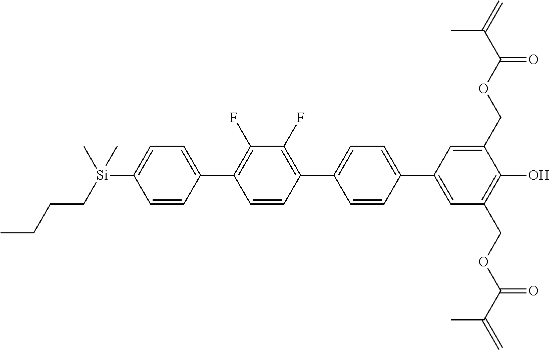 [SMILES: C=C(C)C(=O)OCc1cc(-c2ccc(-c3ccc(-c4ccc([Si](C)(C)CCCC)cc4)c(F)c3F)cc2)cc(COC(=O)C(=C)C)c1O]

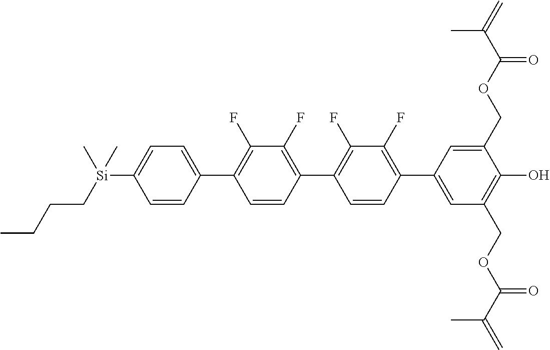 [SMILES: C=C(C)C(=O)OCc1cc(-c2ccc(-c3ccc(-c4ccc([Si](C)(C)CCCC)cc4)c(F)c3F)c(F)c2F)cc(COC(=O)C(=C)C)c1O]

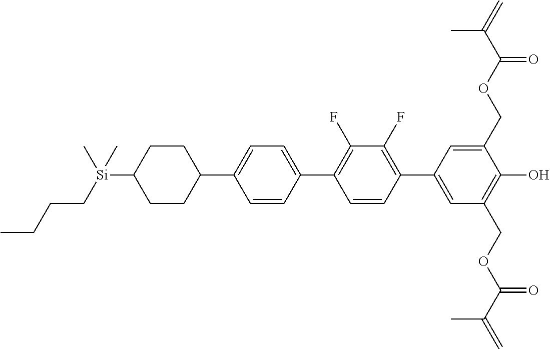 [SMILES: C=C(C)C(=O)OCc1cc(-c2ccc(-c3ccc(C4CCC([Si](C)(C)CCCC)CC4)cc3)c(F)c2F)cc(COC(=O)C(=C)C)c1O]

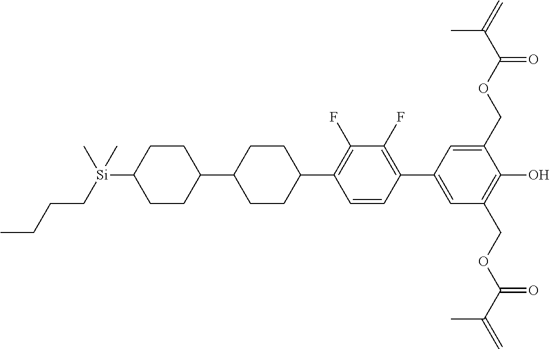 [SMILES: C=C(C)C(=O)OCc1cc(-c2ccc(C3CCC(C4CCC([Si](C)(C)CCCC)CC4)CC3)c(F)c2F)cc(COC(=O)C(=C)C)c1O]

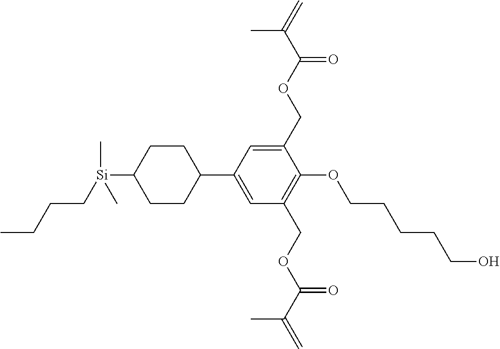 [SMILES: C=C(C)C(=O)OCc1cc(C2CCC([Si](C)(C)CCCC)CC2)cc(COC(=O)C(=C)C)c1OCCCCCO]

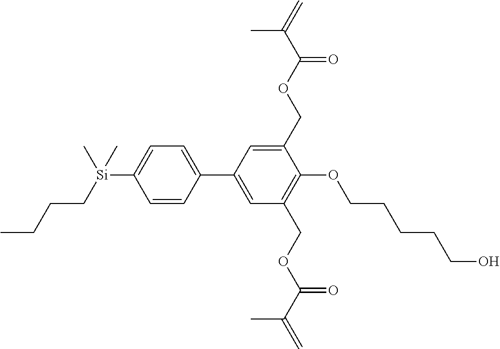 [SMILES: C=C(C)C(=O)OCc1cc(-c2ccc([Si](C)(C)CCCC)cc2)cc(COC(=O)C(=C)C)c1OCCCCCO]

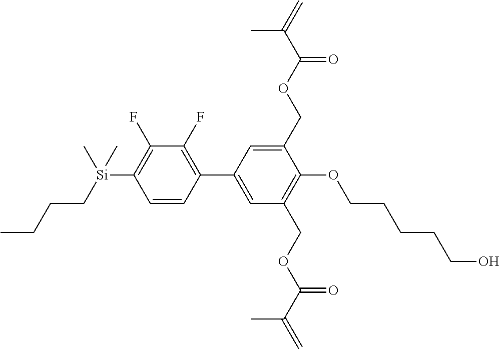 [SMILES: C=C(C)C(=O)OCc1cc(-c2ccc([Si](C)(C)CCCC)c(F)c2F)cc(COC(=O)C(=C)C)c1OCCCCCO]

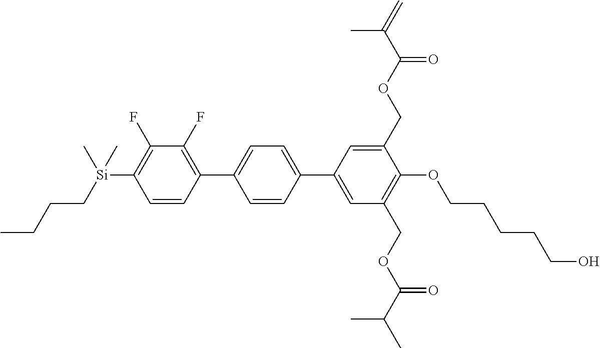 [SMILES: C=C(C)C(=O)OCc1cc(-c2ccc(-c3ccc([Si](C)(C)CCCC)c(F)c3F)cc2)cc(COC(=O)C(C)C)c1OCCCCCO]

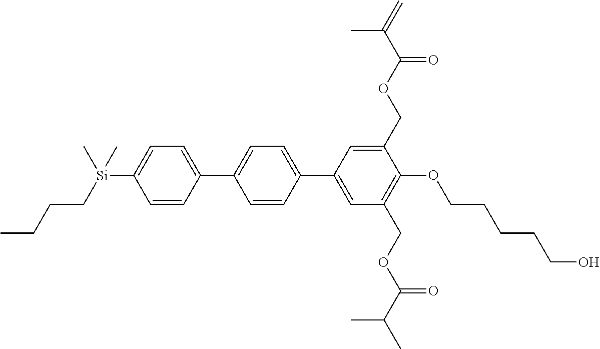 [SMILES: C=C(C)C(=O)OCc1cc(-c2ccc(-c3ccc([Si](C)(C)CCCC)cc3)cc2)cc(COC(=O)C(C)C)c1OCCCCCO]

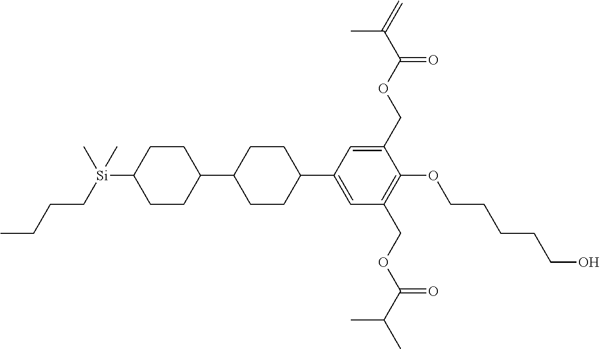 [SMILES: C=C(C)C(=O)OCc1cc(C2CCC(C3CCC([Si](C)(C)CCCC)CC3)CC2)cc(COC(=O)C(C)C)c1OCCCCCO]

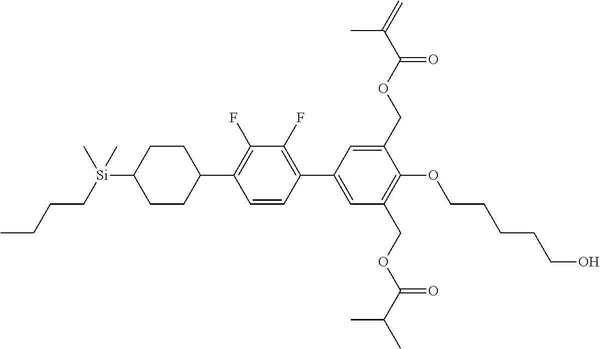 [SMILES: C=C(C)C(=O)OCc1cc(-c2ccc(C3CCC([Si](C)(C)CCCC)CC3)c(F)c2F)cc(COC(=O)C(C)C)c1OCCCCCO]

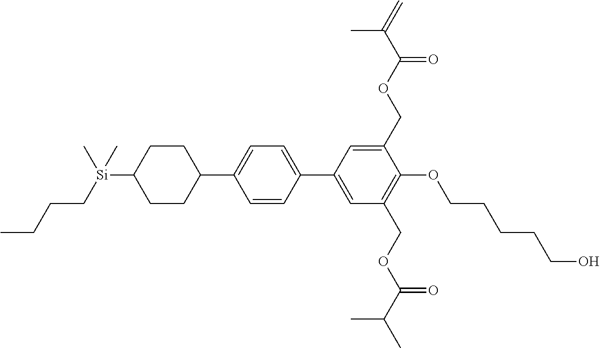 [SMILES: C=C(C)C(=O)OCc1cc(-c2ccc(C3CCC([Si](C)(C)CCCC)CC3)cc2)cc(COC(=O)C(C)C)c1OCCCCCO]

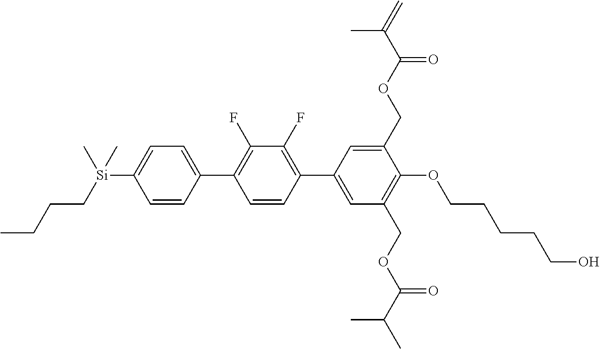 [SMILES: C=C(C)C(=O)OCc1cc(-c2ccc(-c3ccc([Si](C)(C)CCCC)cc3)c(F)c2F)cc(COC(=O)C(C)C)c1OCCCCCO]

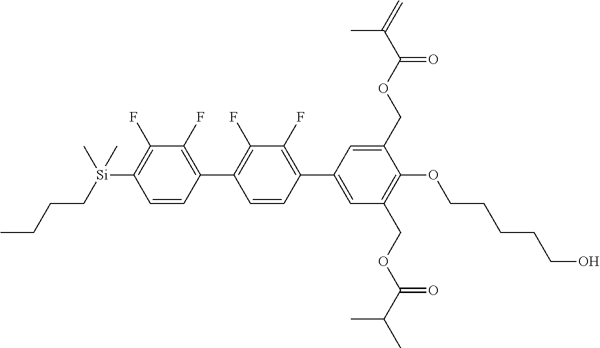 [SMILES: C=C(C)C(=O)OCc1cc(-c2ccc(-c3ccc([Si](C)(C)CCCC)c(F)c3F)c(F)c2F)cc(COC(=O)C(C)C)c1OCCCCCO]

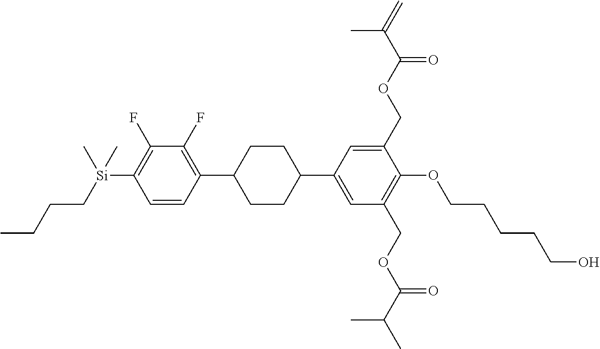 [SMILES: C=C(C)C(=O)OCc1cc(C2CCC(c3ccc([Si](C)(C)CCCC)c(F)c3F)CC2)cc(COC(=O)C(C)C)c1OCCCCCO]

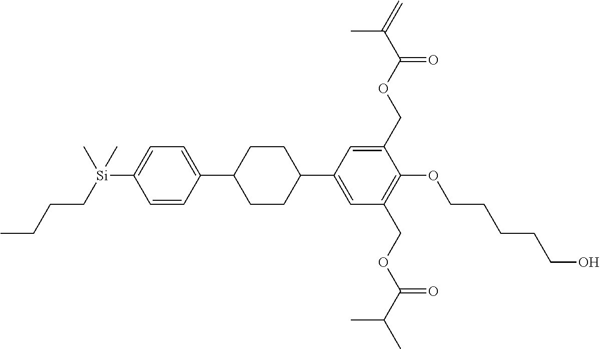 [SMILES: C=C(C)C(=O)OCc1cc(C2CCC(c3ccc([Si](C)(C)CCCC)cc3)CC2)cc(COC(=O)C(C)C)c1OCCCCCO]

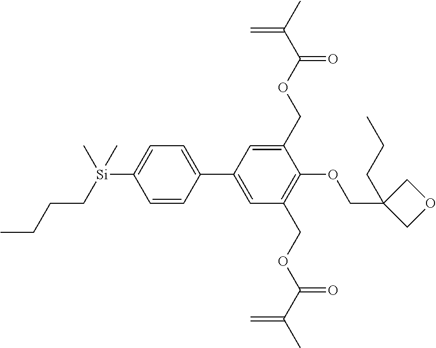 [SMILES: C=C(C)C(=O)OCc1cc(-c2ccc([Si](C)(C)CCCC)cc2)cc(COC(=O)C(=C)C)c1OCC1(CCC)COC1]

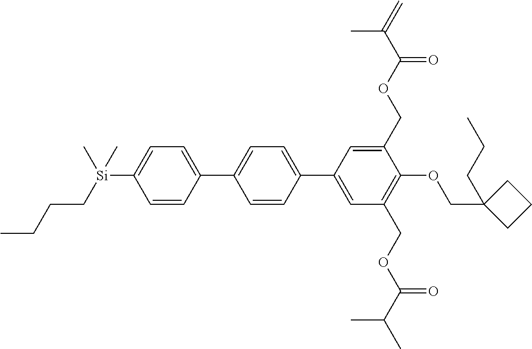 [SMILES: C=C(C)C(=O)OCc1cc(-c2ccc(-c3ccc([Si](C)(C)CCCC)cc3)cc2)cc(COC(=O)C(C)C)c1OCC1(CCC)CCC1]

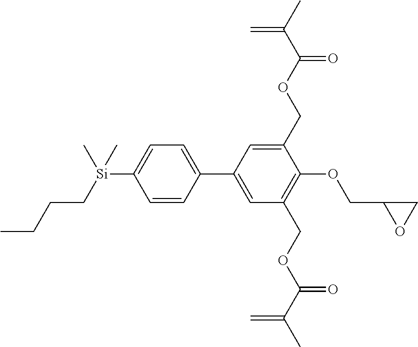 [SMILES: C=C(C)C(=O)OCc1cc(-c2ccc([Si](C)(C)CCCC)cc2)cc(COC(=O)C(=C)C)c1OCC1CO1]

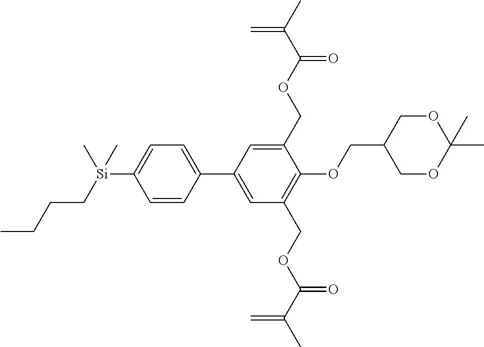 [SMILES: C=C(C)C(=O)OCc1cc(-c2ccc([Si](C)(C)CCCC)cc2)cc(COC(=O)C(=C)C)c1OCC1COC(C)(C)OC1]

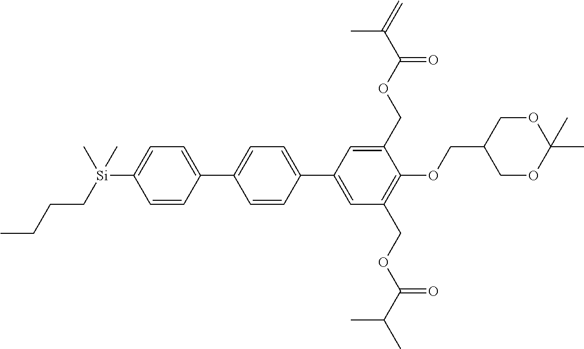 [SMILES: C=C(C)C(=O)OCc1cc(-c2ccc(-c3ccc([Si](C)(C)CCCC)cc3)cc2)cc(COC(=O)C(C)C)c1OCC1COC(C)(C)OC1]

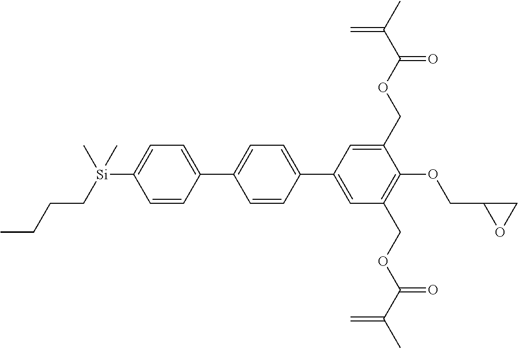 [SMILES: C=C(C)C(=O)OCc1cc(-c2ccc(-c3ccc([Si](C)(C)CCCC)cc3)cc2)cc(COC(=O)C(=C)C)c1OCC1CO1]

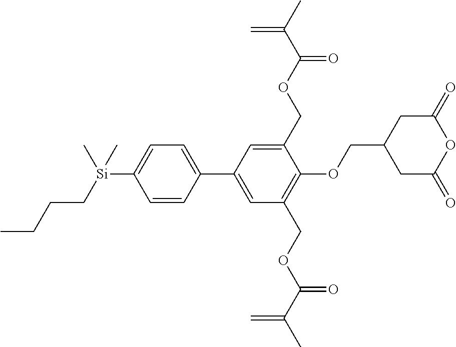 [SMILES: C=C(C)C(=O)OCc1cc(-c2ccc([Si](C)(C)CCCC)cc2)cc(COC(=O)C(=C)C)c1OCC1CC(=O)OC(=O)C1]

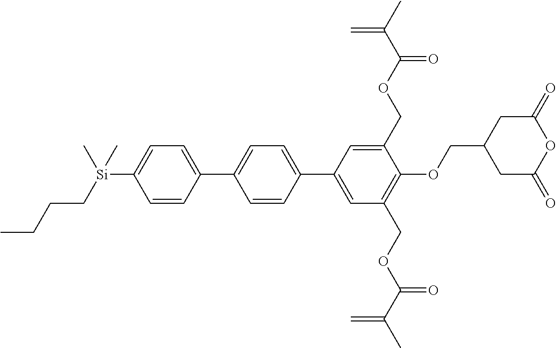 [SMILES: C=C(C)C(=O)OCc1cc(-c2ccc(-c3ccc([Si](C)(C)CCCC)cc3)cc2)cc(COC(=O)C(=C)C)c1OCC1CC(=O)OC(=O)C1]

TABLE 4

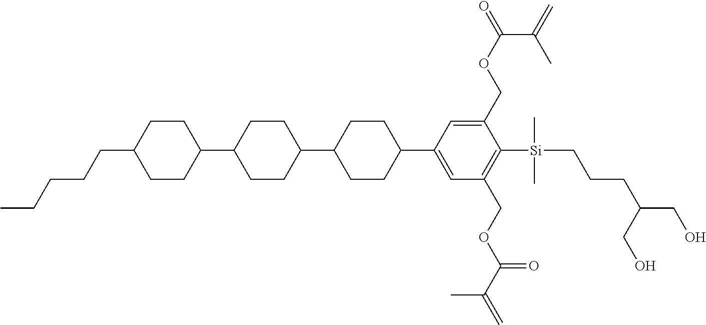 [SMILES: C=C(C)C(=O)OCc1cc(C2CCC(C3CCC(C4CCC(CCCCC)CC4)CC3)CC2)cc(COC(=O)C(=C)C)c1[Si](C)(C)CCCC(CO)CO]

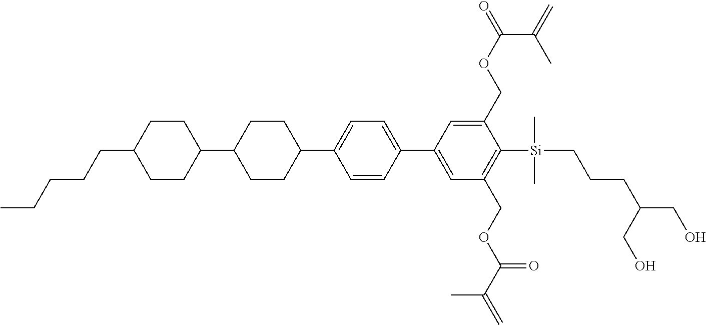 [SMILES: C=C(C)C(=O)OCc1cc(-c2ccc(C3CCC(C4CCC(CCCCC)CC4)CC3)cc2)cc(COC(=O)C(=C)C)c1[Si](C)(C)CCCC(CO)CO]

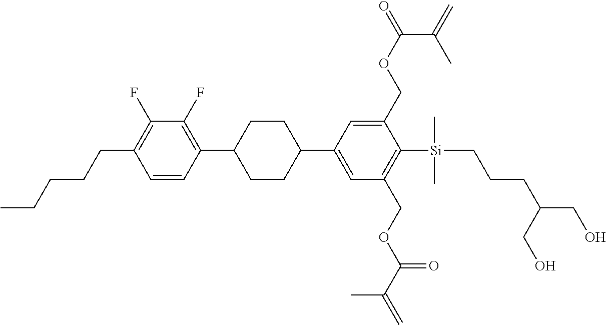 [SMILES: C=C(C)C(=O)OCc1cc(C2CCC(c3ccc(CCCCC)c(F)c3F)CC2)cc(COC(=O)C(=C)C)c1[Si](C)(C)CCCC(CO)CO]

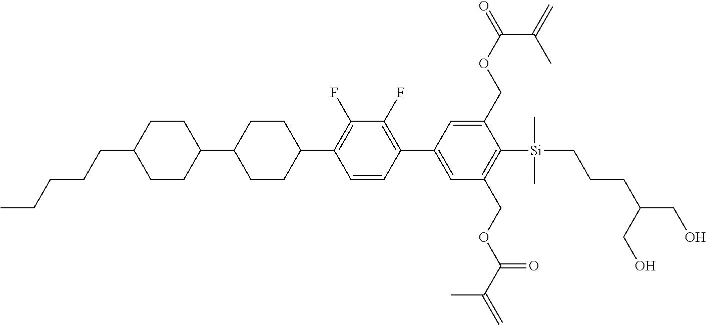 [SMILES: C=C(C)C(=O)OCc1cc(-c2ccc(C3CCC(C4CCC(CCCCC)CC4)CC3)c(F)c2F)cc(COC(=O)C(=C)C)c1[Si](C)(C)CCCC(CO)CO]

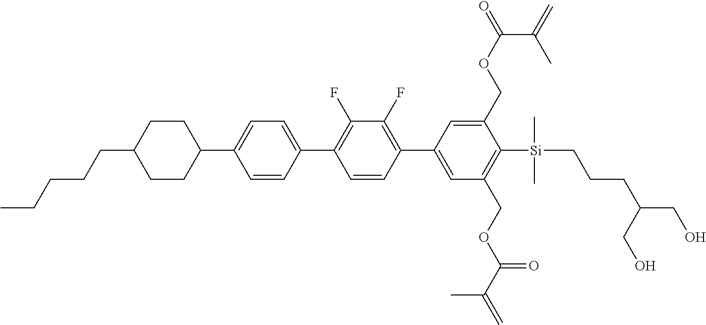 [SMILES: C=C(C)C(=O)OCc1cc(-c2ccc(-c3ccc(C4CCC(CCCCC)CC4)cc3)c(F)c2F)cc(COC(=O)C(=C)C)c1[Si](C)(C)CCCC(CO)CO]

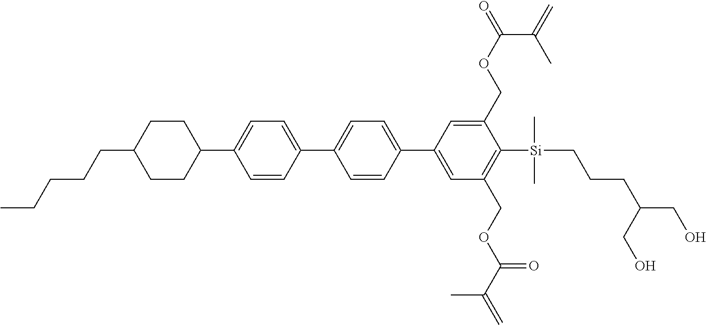 [SMILES: C=C(C)C(=O)OCc1cc(-c2ccc(-c3ccc(C4CCC(CCCCC)CC4)cc3)cc2)cc(COC(=O)C(=C)C)c1[Si](C)(C)CCCC(CO)CO]

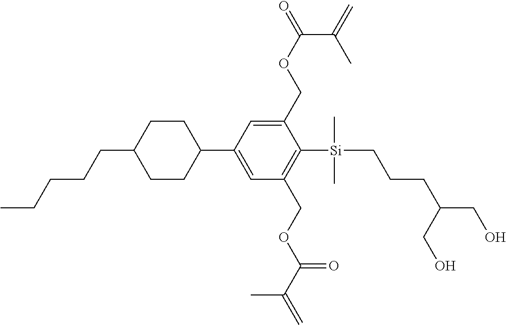 [SMILES: C=C(C)C(=O)OCc1cc(C2CCC(CCCCC)CC2)cc(COC(=O)C(=C)C)c1[Si](C)(C)CCCC(CO)CO]

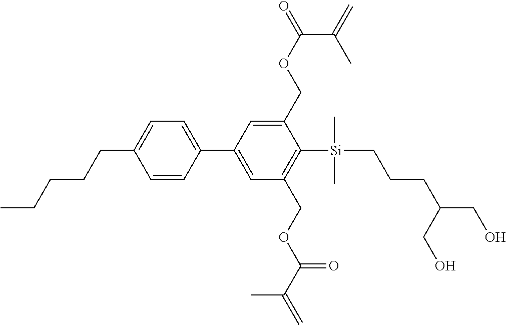 [SMILES: C=C(C)C(=O)OCc1cc(-c2ccc(CCCCC)cc2)cc(COC(=O)C(=C)C)c1[Si](C)(C)CCCC(CO)CO]

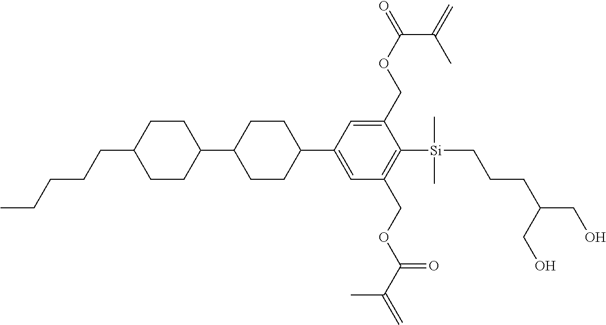 [SMILES: C=C(C)C(=O)OCc1cc(C2CCC(C3CCC(CCCCC)CC3)CC2)cc(COC(=O)C(=C)C)c1[Si](C)(C)CCCC(CO)CO]

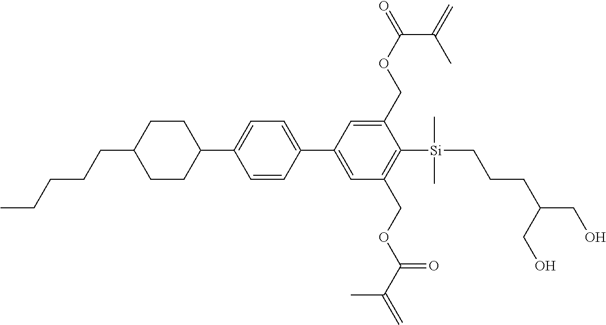 [SMILES: C=C(C)C(=O)OCc1cc(-c2ccc(C3CCC(CCCCC)CC3)cc2)cc(COC(=O)C(=C)C)c1[Si](C)(C)CCCC(CO)CO]

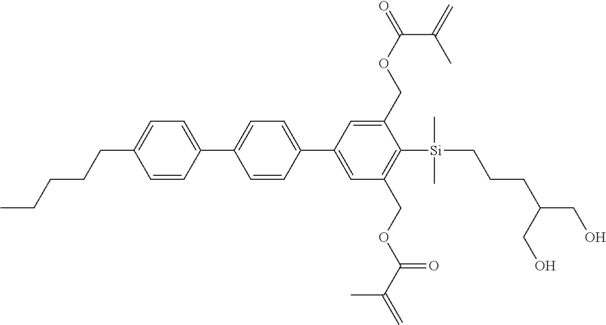 [SMILES: C=C(C)C(=O)OCc1cc(-c2ccc(-c3ccc(CCCCC)cc3)cc2)cc(COC(=O)C(=C)C)c1[Si](C)(C)CCCC(CO)CO]

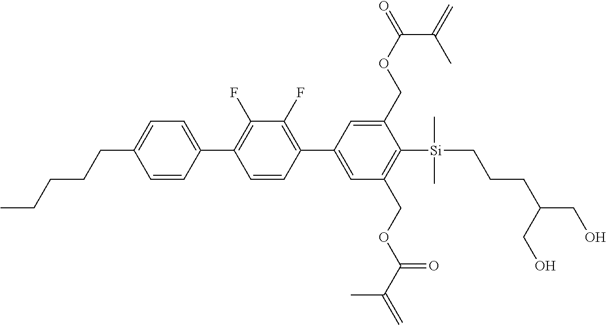 [SMILES: C=C(C)C(=O)OCc1cc(-c2ccc(-c3ccc(CCCCC)cc3)c(F)c2F)cc(COC(=O)C(=C)C)c1[Si](C)(C)CCCC(CO)CO]

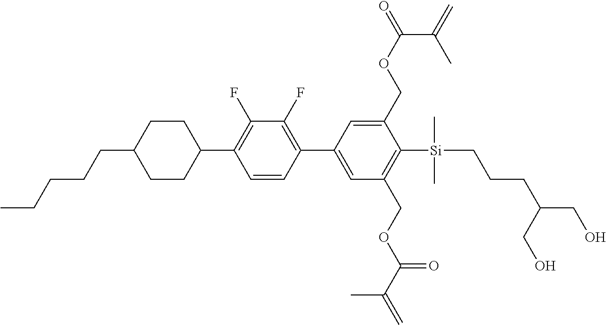 [SMILES: C=C(C)C(=O)OCc1cc(-c2ccc(C3CCC(CCCCC)CC3)c(F)c2F)cc(COC(=O)C(=C)C)c1[Si](C)(C)CCCC(CO)CO]

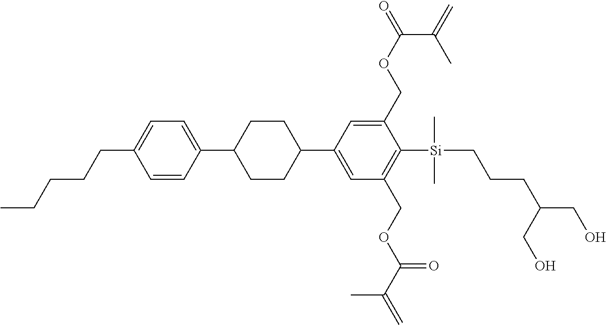 [SMILES: C=C(C)C(=O)OCc1cc(C2CCC(c3ccc(CCCCC)cc3)CC2)cc(COC(=O)C(=C)C)c1[Si](C)(C)CCCC(CO)CO]

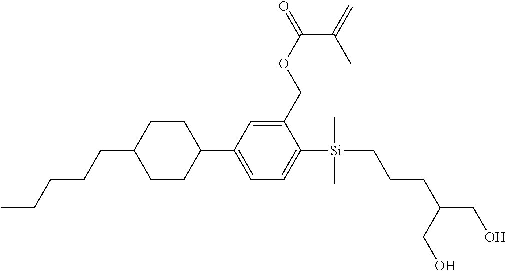 [SMILES: C=C(C)C(=O)OCc1cc(C2CCC(CCCCC)CC2)ccc1[Si](C)(C)CCCC(CO)CO]

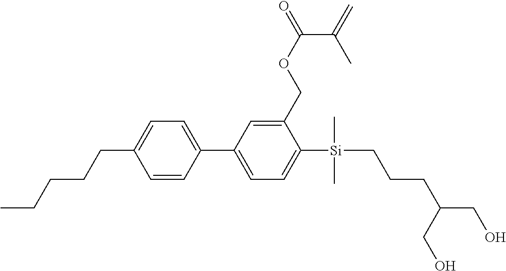 [SMILES: C=C(C)C(=O)OCc1cc(-c2ccc(CCCCC)cc2)ccc1[Si](C)(C)CCCC(CO)CO]

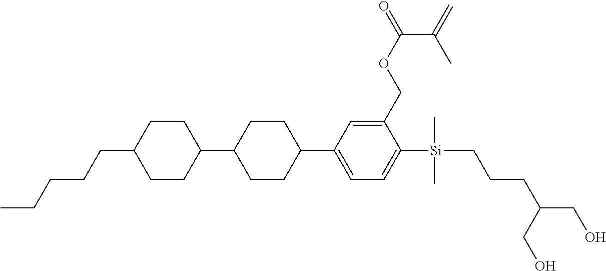 [SMILES: C=C(C)C(=O)OCc1cc(C2CCC(C3CCC(CCCCC)CC3)CC2)ccc1[Si](C)(C)CCCC(CO)CO]

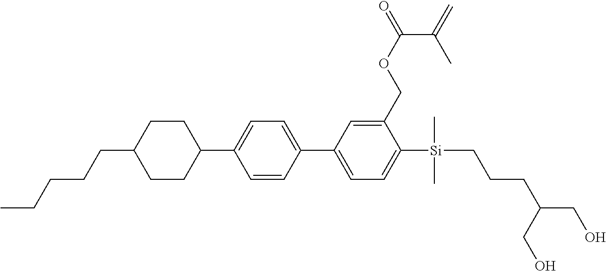 [SMILES: C=C(C)C(=O)OCc1cc(-c2ccc(C3CCC(CCCCC)CC3)cc2)ccc1[Si](C)(C)CCCC(CO)CO]

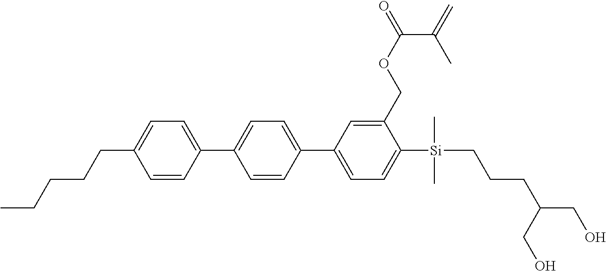 [SMILES: C=C(C)C(=O)OCc1cc(-c2ccc(-c3ccc(CCCCC)cc3)cc2)ccc1[Si](C)(C)CCCC(CO)CO]

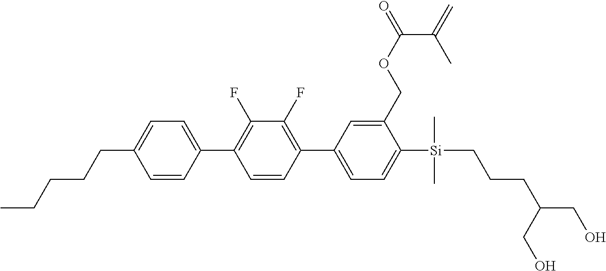 [SMILES: C=C(C)C(=O)OCc1cc(-c2ccc(-c3ccc(CCCCC)cc3)c(F)c2F)ccc1[Si](C)(C)CCCC(CO)CO]

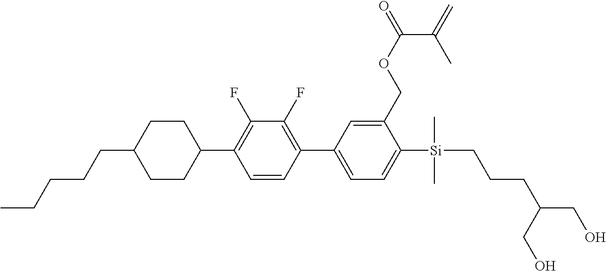 [SMILES: C=C(C)C(=O)OCc1cc(-c2ccc(C3CCC(CCCCC)CC3)c(F)c2F)ccc1[Si](C)(C)CCCC(CO)CO]

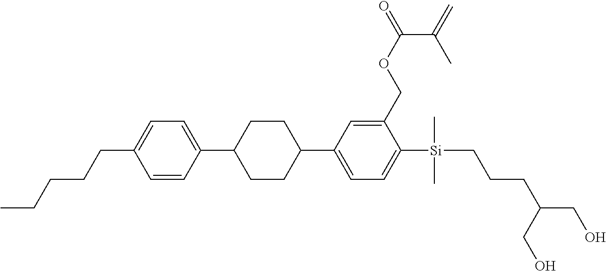 [SMILES: C=C(C)C(=O)OCc1cc(C2CCC(c3ccc(CCCCC)cc3)CC2)ccc1[Si](C)(C)CCCC(CO)CO]

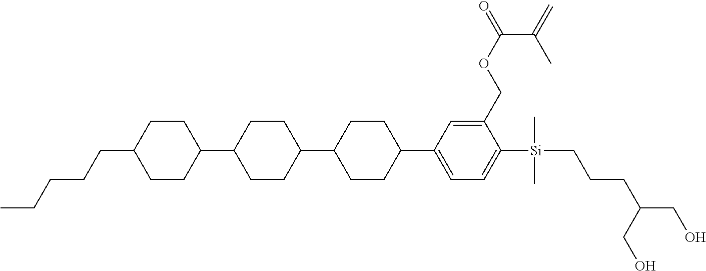 [SMILES: C=C(C)C(=O)OCc1cc(C2CCC(C3CCC(C4CCC(CCCCC)CC4)CC3)CC2)ccc1[Si](C)(C)CCCC(CO)CO]

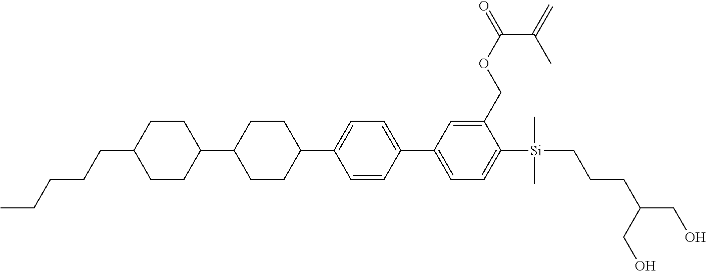 [SMILES: C=C(C)C(=O)OCc1cc(-c2ccc(C3CCC(C4CCC(CCCCC)CC4)CC3)cc2)ccc1[Si](C)(C)CCCC(CO)CO]

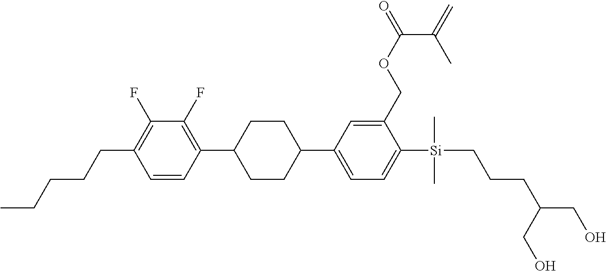 [SMILES: C=C(C)C(=O)OCc1cc(C2CCC(c3ccc(CCCCC)c(F)c3F)CC2)ccc1[Si](C)(C)CCCC(CO)CO]

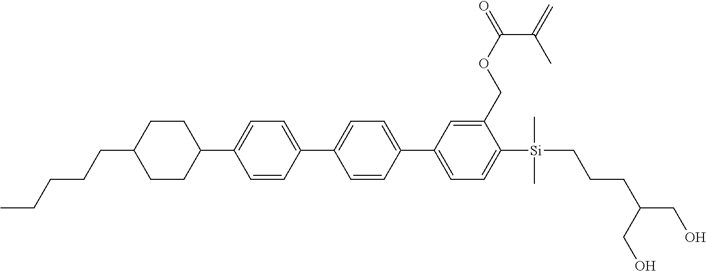 [SMILES: C=C(C)C(=O)OCc1cc(-c2ccc(-c3ccc(C4CCC(CCCCC)CC4)cc3)cc2)ccc1[Si](C)(C)CCCC(CO)CO]

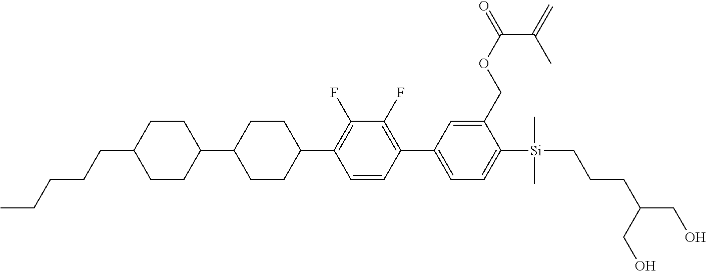 [SMILES: C=C(C)C(=O)OCc1cc(-c2ccc(C3CCC(C4CCC(CCCCC)CC4)CC3)c(F)c2F)ccc1[Si](C)(C)CCCC(CO)CO]

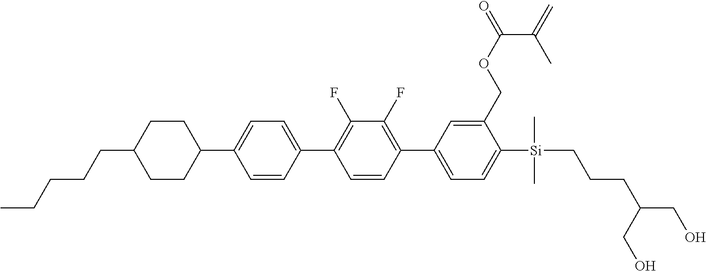 [SMILES: C=C(C)C(=O)OCc1cc(-c2ccc(-c3ccc(C4CCC(CCCCC)CC4)cc3)c(F)c2F)ccc1[Si](C)(C)CCCC(CO)CO]

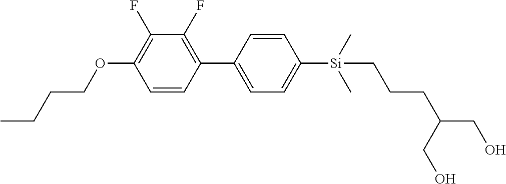 [SMILES: CCCCOc1ccc(-c2ccc([Si](C)(C)CCCC(CO)CO)cc2)c(F)c1F]

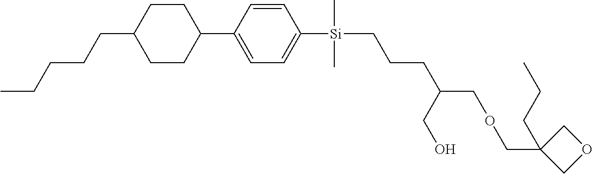 [SMILES: CCCCCC1CCC(c2ccc([Si](C)(C)CCCC(CO)COCC3(CCC)COC3)cc2)CC1]

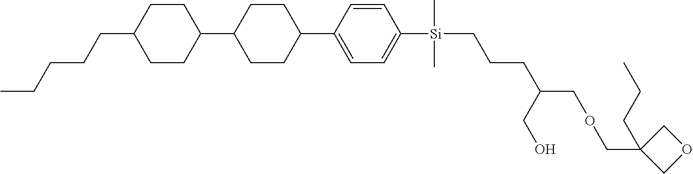 [SMILES: CCCCCC1CCC(C2CCC(c3ccc([Si](C)(C)CCCC(CO)COCC4(CCC)COC4)cc3)CC2)CC1]

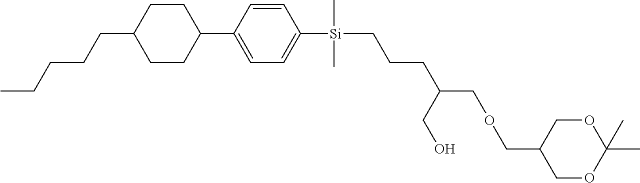 [SMILES: CCCCCC1CCC(c2ccc([Si](C)(C)CCCC(CO)COCC3COC(C)(C)OC3)cc2)CC1]

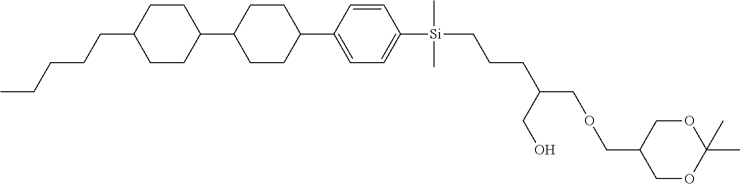 [SMILES: CCCCCC1CCC(C2CCC(c3ccc([Si](C)(C)CCCC(CO)COCC4COC(C)(C)OC4)cc3)CC2)CC1]

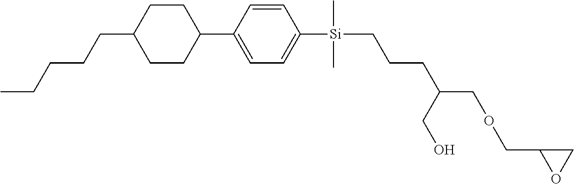 [SMILES: CCCCCC1CCC(c2ccc([Si](C)(C)CCCC(CO)COCC3CO3)cc2)CC1]

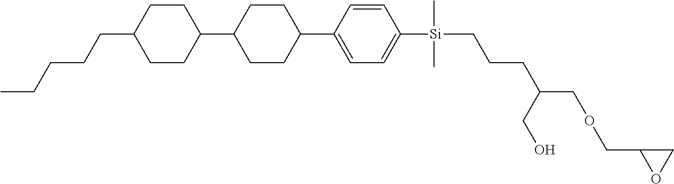 [SMILES: CCCCCC1CCC(C2CCC(c3ccc([Si](C)(C)CCCC(CO)COCC4CO4)cc3)CC2)CC1]

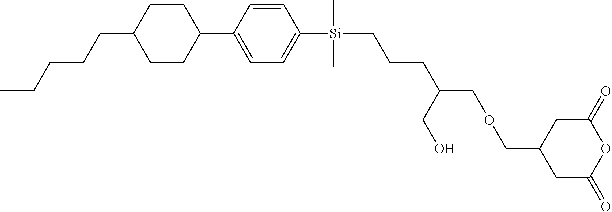 [SMILES: CCCCCC1CCC(c2ccc([Si](C)(C)CCCC(CO)COCC3CC(=O)OC(=O)C3)cc2)CC1]

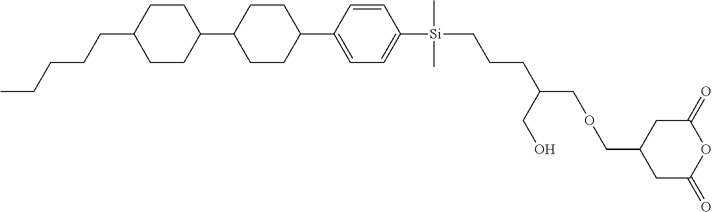 [SMILES: CCCCCC1CCC(C2CCC(c3ccc([Si](C)(C)CCCC(CO)COCC4CC(=O)OC(=O)C4)cc3)CC2)CC1]

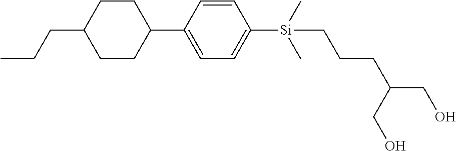 [SMILES: CCCC1CCC(c2ccc([Si](C)(C)CCCC(CO)CO)cc2)CC1]

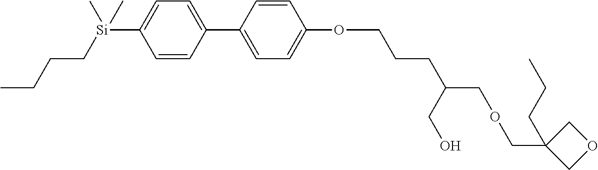 [SMILES: CCCC[Si](C)(C)c1ccc(-c2ccc(OCCCC(CO)COCC3(CCC)COC3)cc2)cc1]

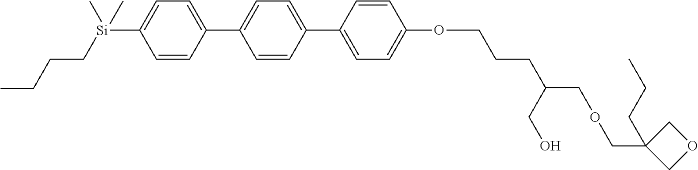 [SMILES: CCCC[Si](C)(C)c1ccc(-c2ccc(-c3ccc(OCCCC(CO)COCC4(CCC)COC4)cc3)cc2)cc1]

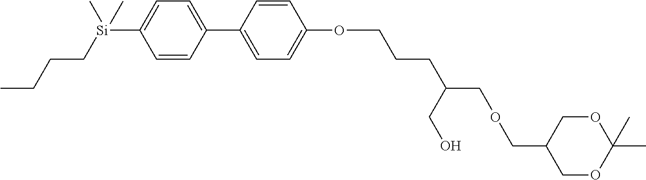 [SMILES: CCCC[Si](C)(C)c1ccc(-c2ccc(OCCCC(CO)COCC3COC(C)(C)OC3)cc2)cc1]

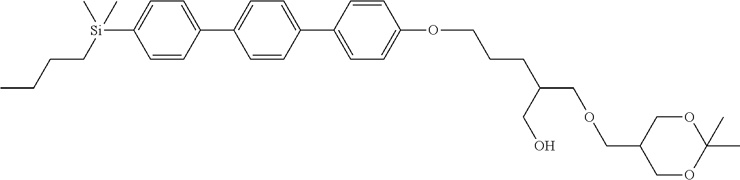 [SMILES: CCCC[Si](C)(C)c1ccc(-c2ccc(-c3ccc(OCCCC(CO)COCC4COC(C)(C)OC4)cc3)cc2)cc1]

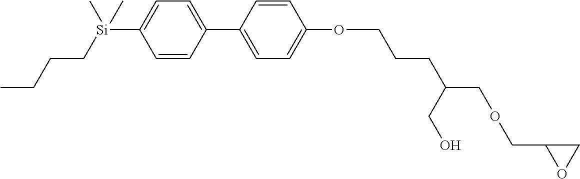 [SMILES: CCCC[Si](C)(C)c1ccc(-c2ccc(OCCCC(CO)COCC3CO3)cc2)cc1]

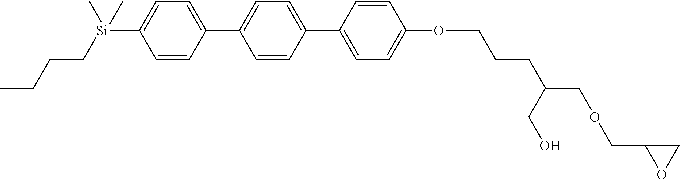 [SMILES: CCCC[Si](C)(C)c1ccc(-c2ccc(-c3ccc(OCCCC(CO)COCC4CO4)cc3)cc2)cc1]

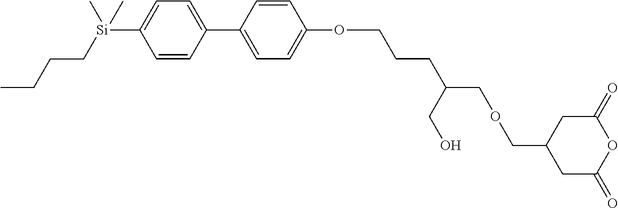 [SMILES: CCCC[Si](C)(C)c1ccc(-c2ccc(OCCCC(CO)COCC3CC(=O)OC(=O)C3)cc2)cc1]

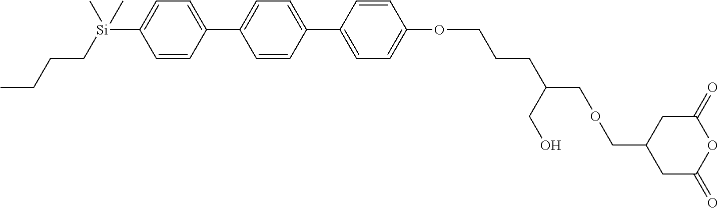 [SMILES: CCCC[Si](C)(C)c1ccc(-c2ccc(-c3ccc(OCCCC(CO)COCC4CC(=O)OC(=O)C4)cc3)cc2)cc1]

TABLE 5

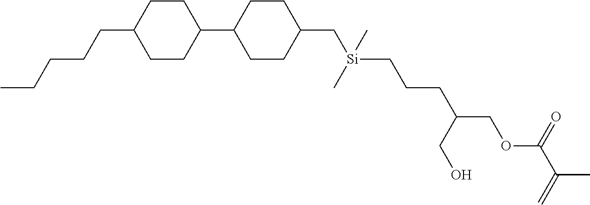 [SMILES: C=C(C)C(=O)OCC(CO)CCC[Si](C)(C)CC1CCC(C2CCC(CCCCC)CC2)CC1]

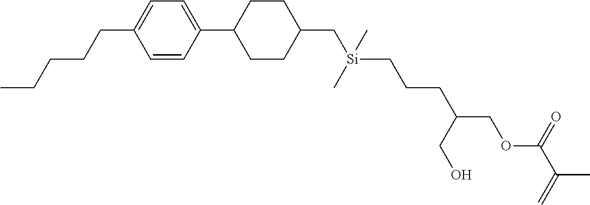 [SMILES: C=C(C)C(=O)OCC(CO)CCC[Si](C)(C)CC1CCC(c2ccc(CCCCC)cc2)CC1]

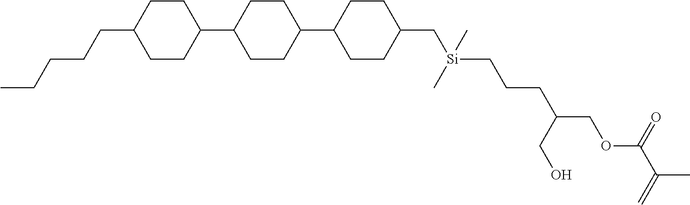 [SMILES: C=C(C)C(=O)OCC(CO)CCC[Si](C)(C)CC1CCC(C2CCC(C3CCC(CCCCC)CC3)CC2)CC1]

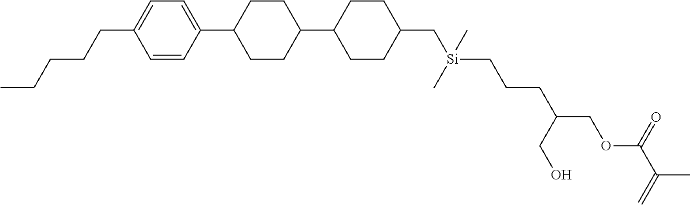 [SMILES: C=C(C)C(=O)OCC(CO)CCC[Si](C)(C)CC1CCC(C2CCC(c3ccc(CCCCC)cc3)CC2)CC1]

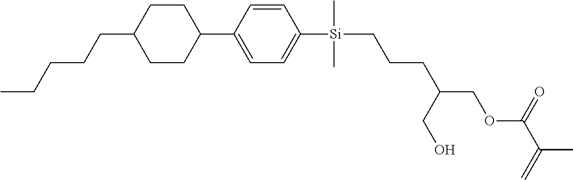 [SMILES: C=C(C)C(=O)OCC(CO)CCC[Si](C)(C)c1ccc(C2CCC(CCCCC)CC2)cc1]

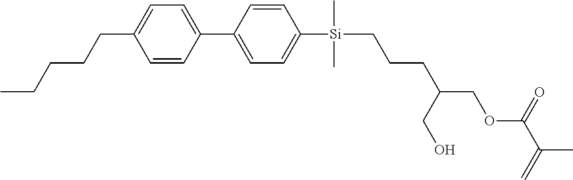 [SMILES: C=C(C)C(=O)OCC(CO)CCC[Si](C)(C)c1ccc(-c2ccc(CCCCC)cc2)cc1]

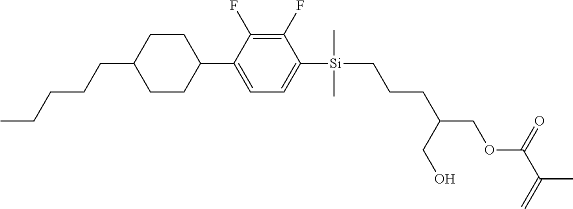 [SMILES: C=C(C)C(=O)OCC(CO)CCC[Si](C)(C)c1ccc(C2CCC(CCCCC)CC2)c(F)c1F]

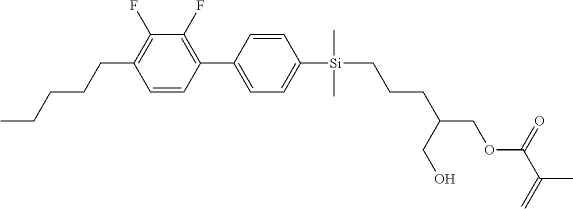 [SMILES: C=C(C)C(=O)OCC(CO)CCC[Si](C)(C)c1ccc(-c2ccc(CCCCC)c(F)c2F)cc1]

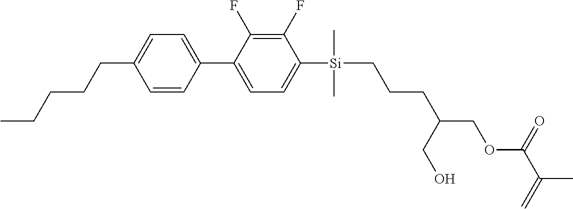 [SMILES: C=C(C)C(=O)OCC(CO)CCC[Si](C)(C)c1ccc(-c2ccc(CCCCC)cc2)c(F)c1F]

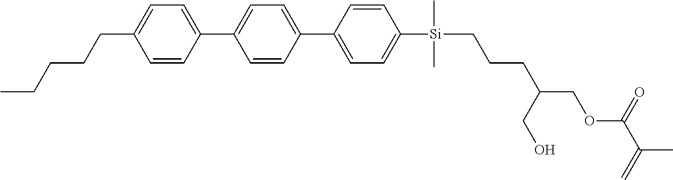 [SMILES: C=C(C)C(=O)OCC(CO)CCC[Si](C)(C)c1ccc(-c2ccc(-c3ccc(CCCCC)cc3)cc2)cc1]

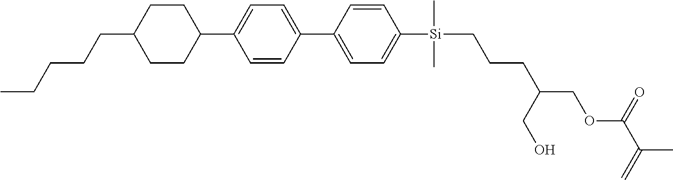 [SMILES: C=C(C)C(=O)OCC(CO)CCC[Si](C)(C)c1ccc(-c2ccc(C3CCC(CCCCC)CC3)cc2)cc1]

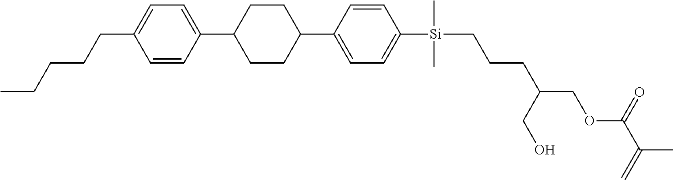 [SMILES: C=C(C)C(=O)OCC(CO)CCC[Si](C)(C)c1ccc(C2CCC(c3ccc(CCCCC)cc3)CC2)cc1]

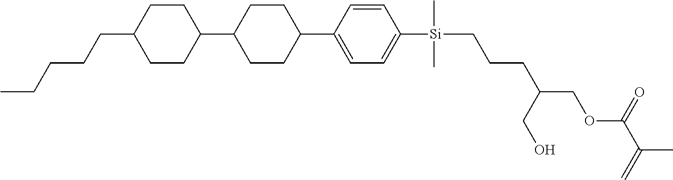 [SMILES: C=C(C)C(=O)OCC(CO)CCC[Si](C)(C)c1ccc(C2CCC(C3CCC(CCCCC)CC3)CC2)cc1]

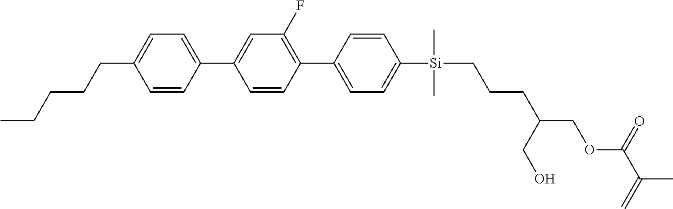 [SMILES: C=C(C)C(=O)OCC(CO)CCC[Si](C)(C)c1ccc(-c2ccc(-c3ccc(CCCCC)cc3)cc2F)cc1]

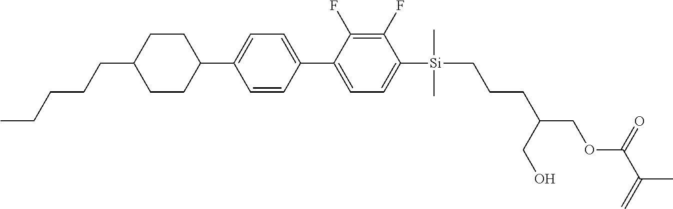 [SMILES: C=C(C)C(=O)OCC(CO)CCC[Si](C)(C)c1ccc(-c2ccc(C3CCC(CCCCC)CC3)cc2)c(F)c1F]

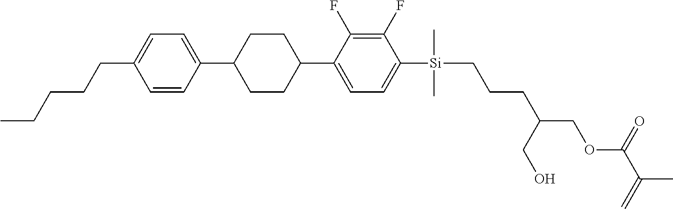 [SMILES: C=C(C)C(=O)OCC(CO)CCC[Si](C)(C)c1ccc(C2CCC(c3ccc(CCCCC)cc3)CC2)c(F)c1F]

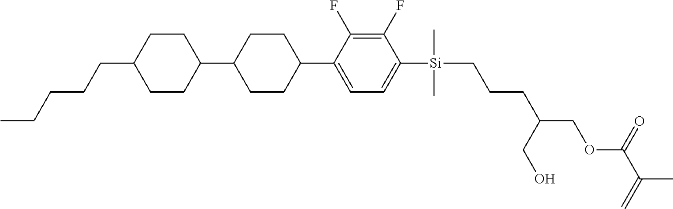 [SMILES: C=C(C)C(=O)OCC(CO)CCC[Si](C)(C)c1ccc(C2CCC(C3CCC(CCCCC)CC3)CC2)c(F)c1F]

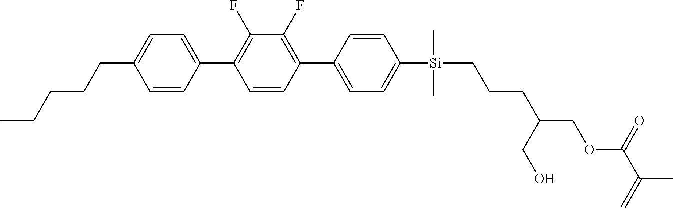 [SMILES: C=C(C)C(=O)OCC(CO)CCC[Si](C)(C)c1ccc(-c2ccc(-c3ccc(CCCCC)cc3)c(F)c2F)cc1]

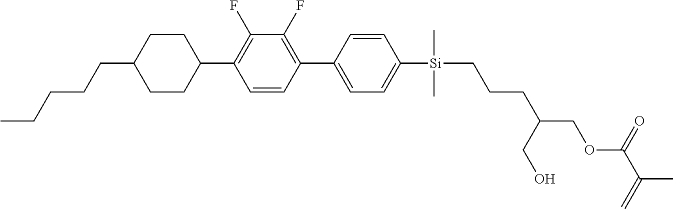 [SMILES: C=C(C)C(=O)OCC(CO)CCC[Si](C)(C)c1ccc(-c2ccc(C3CCC(CCCCC)CC3)c(F)c2F)cc1]

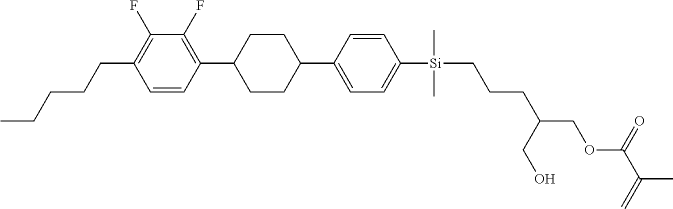 [SMILES: C=C(C)C(=O)OCC(CO)CCC[Si](C)(C)c1ccc(C2CCC(c3ccc(CCCCC)c(F)c3F)CC2)cc1]

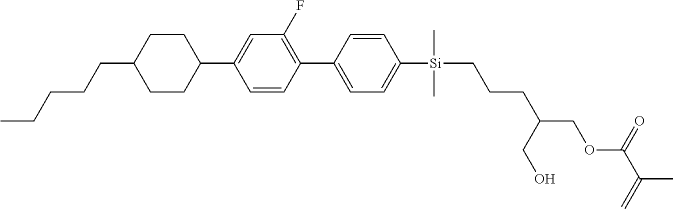 [SMILES: C=C(C)C(=O)OCC(CO)CCC[Si](C)(C)c1ccc(-c2ccc(C3CCC(CCCCC)CC3)cc2F)cc1]

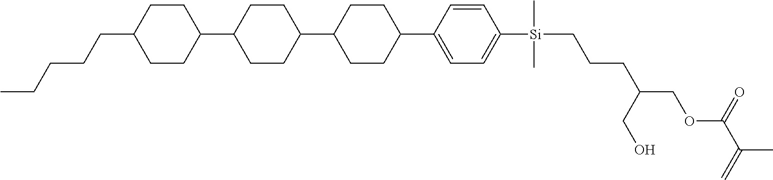 [SMILES: C=C(C)C(=O)OCC(CO)CCC[Si](C)(C)c1ccc(C2CCC(C3CCC(C4CCC(CCCCC)CC4)CC3)CC2)cc1]

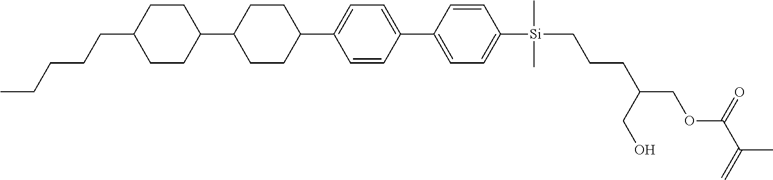 [SMILES: C=C(C)C(=O)OCC(CO)CCC[Si](C)(C)c1ccc(-c2ccc(C3CCC(C4CCC(CCCCC)CC4)CC3)cc2)cc1]

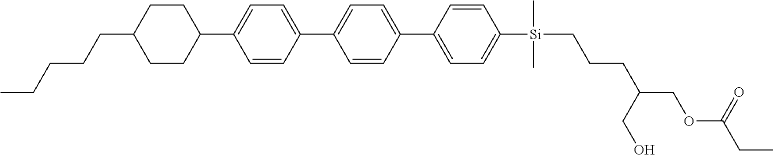 [SMILES: CCCCCC1CCC(c2ccc(-c3ccc(-c4ccc([Si](C)(C)CCCC(CO)COC(=O)CC)cc4)cc3)cc2)CC1]

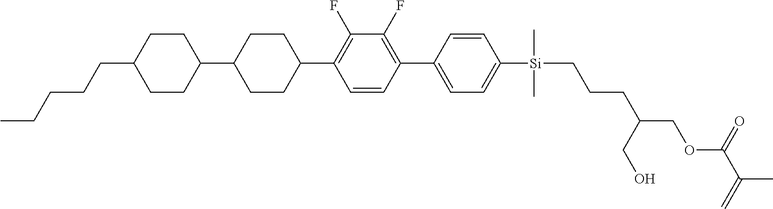 [SMILES: C=C(C)C(=O)OCC(CO)CCC[Si](C)(C)c1ccc(-c2ccc(C3CCC(C4CCC(CCCCC)CC4)CC3)c(F)c2F)cc1]

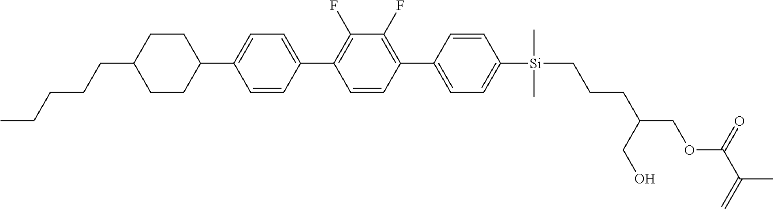 [SMILES: C=C(C)C(=O)OCC(CO)CCC[Si](C)(C)c1ccc(-c2ccc(-c3ccc(C4CCC(CCCCC)CC4)cc3)c(F)c2F)cc1]

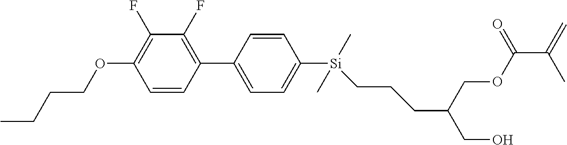 [SMILES: C=C(C)C(=O)OCC(CO)CCC[Si](C)(C)c1ccc(-c2ccc(OCCCC)c(F)c2F)cc1]

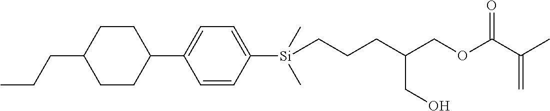 [SMILES: C=C(C)C(=O)OCC(CO)CCC[Si](C)(C)c1ccc(C2CCC(CCC)CC2)cc1]

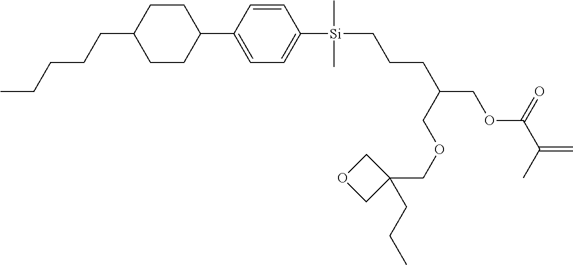 [SMILES: C=C(C)C(=O)OCC(CCC[Si](C)(C)c1ccc(C2CCC(CCCCC)CC2)cc1)COCC1(CCC)COC1]

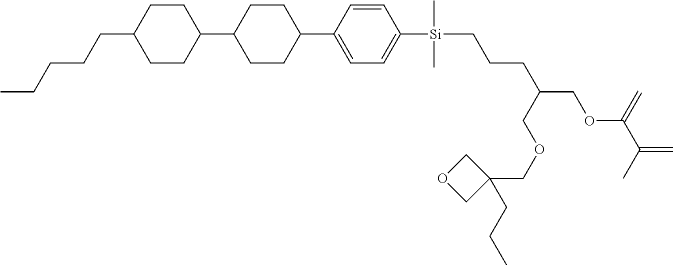 [SMILES: C=C(C)C(=C)OCC(CCC[Si](C)(C)c1ccc(C2CCC(C3CCC(CCCCC)CC3)CC2)cc1)COCC1(CCC)COC1]

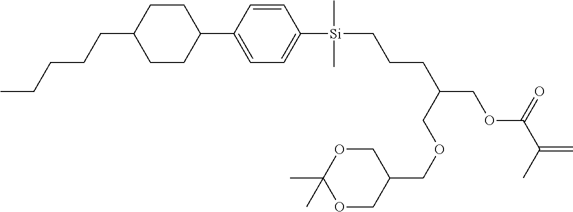 [SMILES: C=C(C)C(=O)OCC(CCC[Si](C)(C)c1ccc(C2CCC(CCCCC)CC2)cc1)COCC1COC(C)(C)OC1]

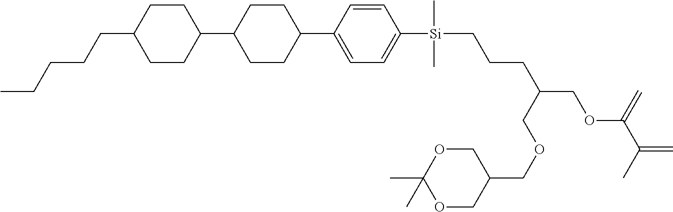 [SMILES: C=C(C)C(=C)OCC(CCC[Si](C)(C)c1ccc(C2CCC(C3CCC(CCCCC)CC3)CC2)cc1)COCC1COC(C)(C)OC1]

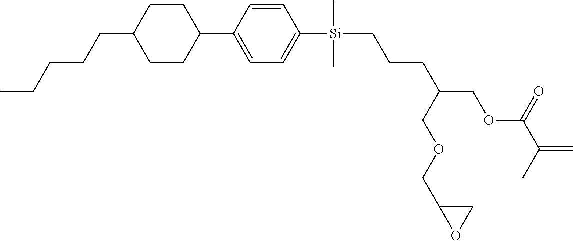 [SMILES: C=C(C)C(=O)OCC(CCC[Si](C)(C)c1ccc(C2CCC(CCCCC)CC2)cc1)COCC1CO1]

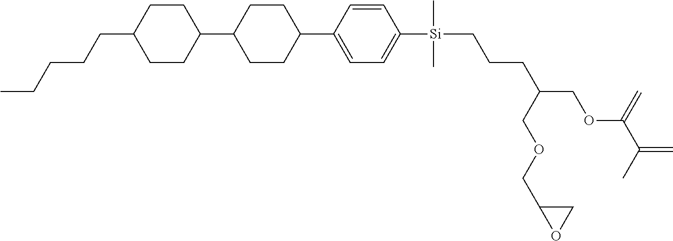 [SMILES: C=C(C)C(=C)OCC(CCC[Si](C)(C)c1ccc(C2CCC(C3CCC(CCCCC)CC3)CC2)cc1)COCC1CO1]

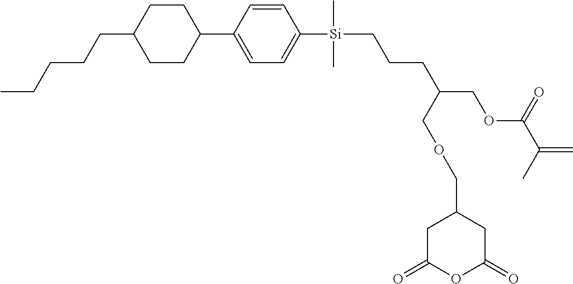 [SMILES: C=C(C)C(=O)OCC(CCC[Si](C)(C)c1ccc(C2CCC(CCCCC)CC2)cc1)COCC1CC(=O)OC(=O)C1]

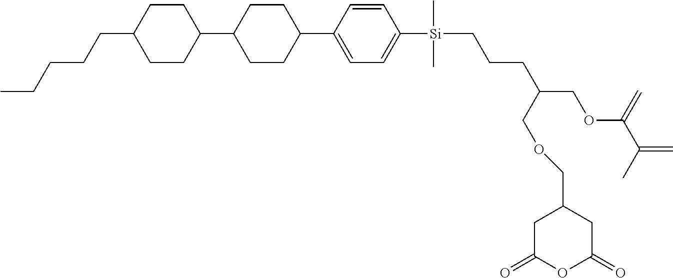 [SMILES: C=C(C)C(=C)OCC(CCC[Si](C)(C)c1ccc(C2CCC(C3CCC(CCCCC)CC3)CC2)cc1)COCC1CC(=O)OC(=O)C1]

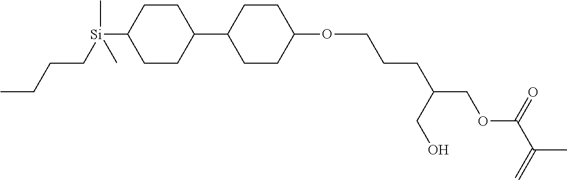 [SMILES: C=C(C)C(=O)OCC(CO)CCCOC1CCC(C2CCC([Si](C)(C)CCCC)CC2)CC1]

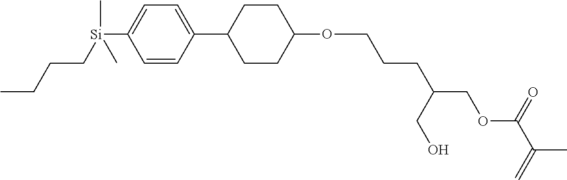 [SMILES: C=C(C)C(=O)OCC(CO)CCCOC1CCC(c2ccc([Si](C)(C)CCCC)cc2)CC1]

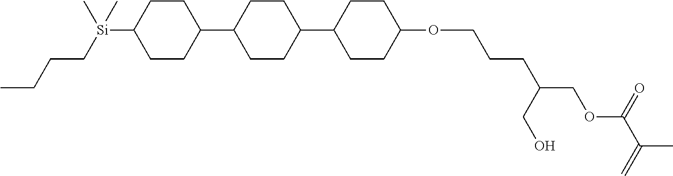 [SMILES: C=C(C)C(=O)OCC(CO)CCCOC1CCC(C2CCC(C3CCC([Si](C)(C)CCCC)CC3)CC2)CC1]

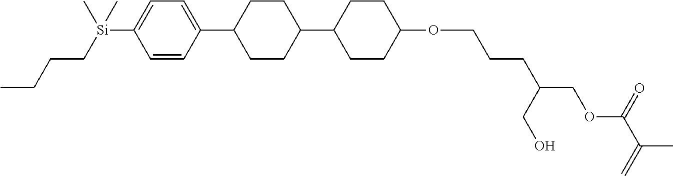 [SMILES: C=C(C)C(=O)OCC(CO)CCCOC1CCC(C2CCC(c3ccc([Si](C)(C)CCCC)cc3)CC2)CC1]

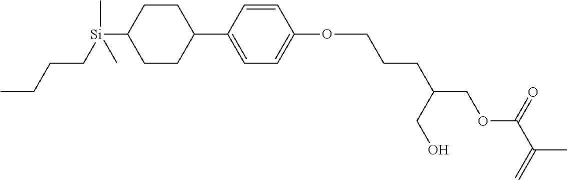 [SMILES: C=C(C)C(=O)OCC(CO)CCCOc1ccc(C2CCC([Si](C)(C)CCCC)CC2)cc1]

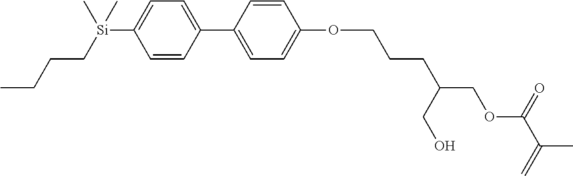 [SMILES: C=C(C)C(=O)OCC(CO)CCCOc1ccc(-c2ccc([Si](C)(C)CCCC)cc2)cc1]

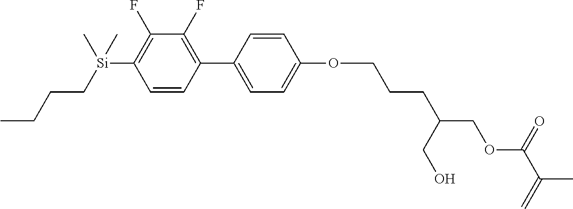 [SMILES: C=C(C)C(=O)OCC(CO)CCCOc1ccc(-c2ccc([Si](C)(C)CCCC)c(F)c2F)cc1]

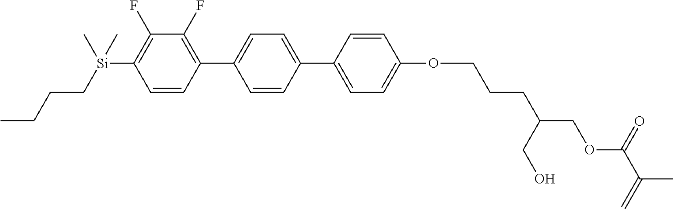 [SMILES: C=C(C)C(=O)OCC(CO)CCCOc1ccc(-c2ccc(-c3ccc([Si](C)(C)CCCC)c(F)c3F)cc2)cc1]

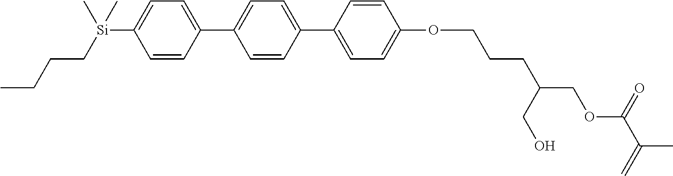 [SMILES: C=C(C)C(=O)OCC(CO)CCCOc1ccc(-c2ccc(-c3ccc([Si](C)(C)CCCC)cc3)cc2)cc1]

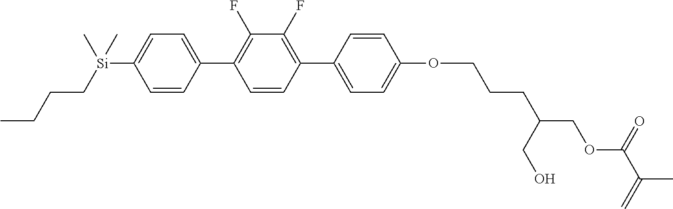

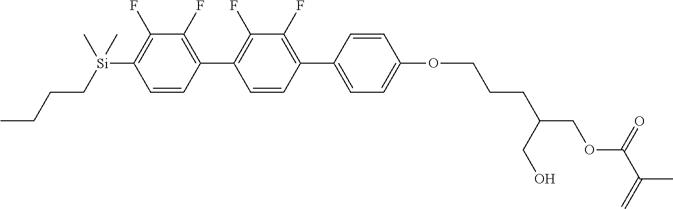

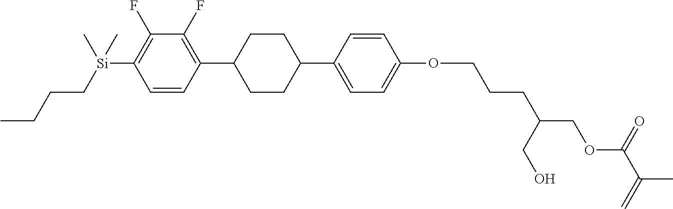

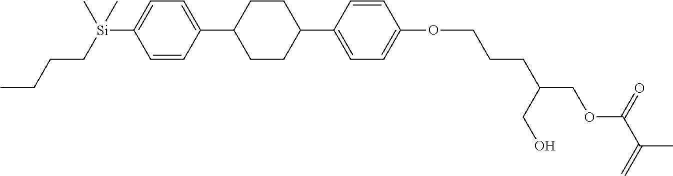

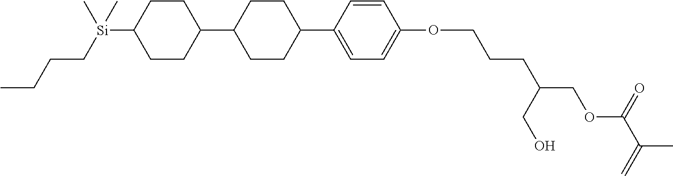

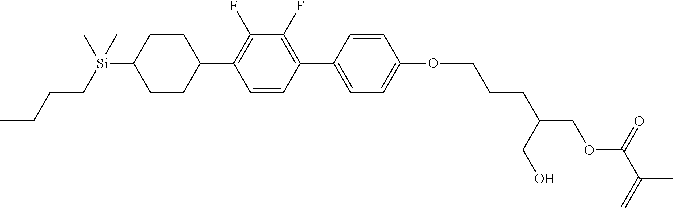

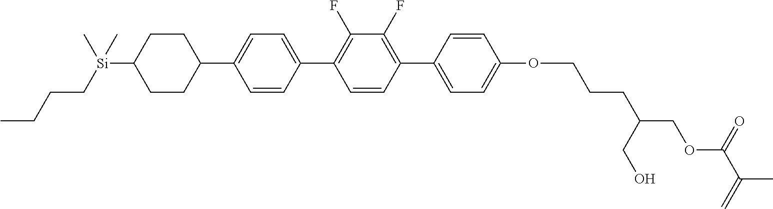 [SMILES: C=C(C)C(=O)OCC(CO)CCCOc1ccc(-c2ccc(-c3ccc(C4CCC([Si](C)(C)CCCC)CC4)cc3)c(F)c2F)cc1]

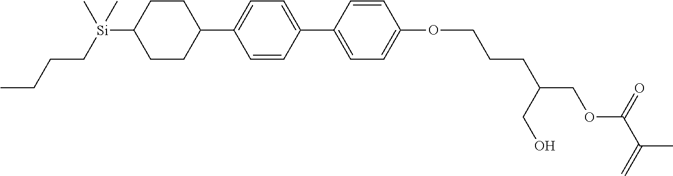

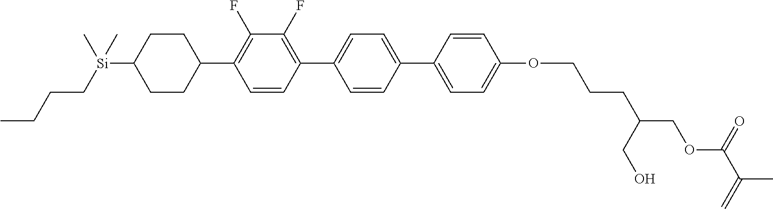 [SMILES: C=C(C)C(=O)OCC(CO)CCCOc1ccc(-c2ccc(-c3ccc(C4CCC([Si](C)(C)CCCC)CC4)c(F)c3F)cc2)cc1]

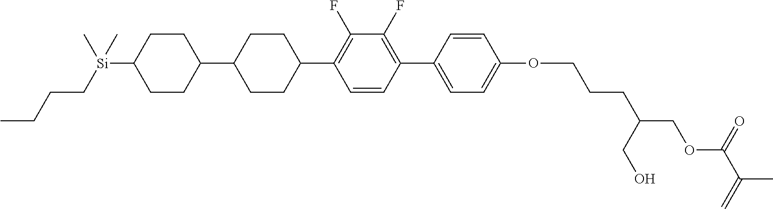 [SMILES: C=C(C)C(=O)OCC(CO)CCCOc1ccc(-c2ccc(C3CCC(C4CCC([Si](C)(C)CCCC)CC4)CC3)c(F)c2F)cc1]

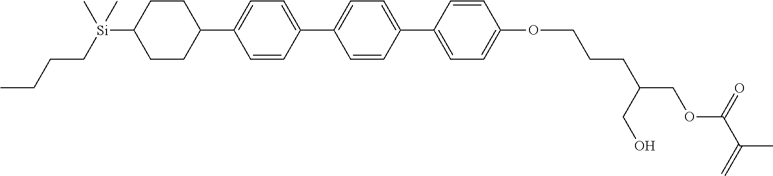 [SMILES: C=C(C)C(=O)OCC(CO)CCCOc1ccc(-c2ccc(-c3ccc(C4CCC([Si](C)(C)CCCC)CC4)cc3)cc2)cc1]

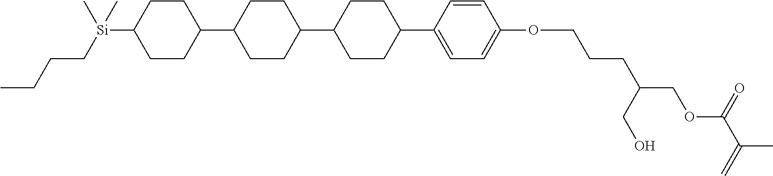 [SMILES: C=C(C)C(=O)OCC(CO)CCCOc1ccc(C2CCC(C3CCC(C4CCC([Si](C)(C)CCCC)CC4)CC3)CC2)cc1]

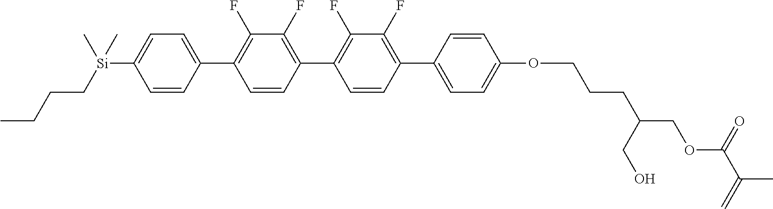 [SMILES: C=C(C)C(=O)OCC(CO)CCCOc1ccc(-c2ccc(-c3ccc(-c4ccc([Si](C)(C)CCCC)cc4)c(F)c3F)c(F)c2F)cc1]

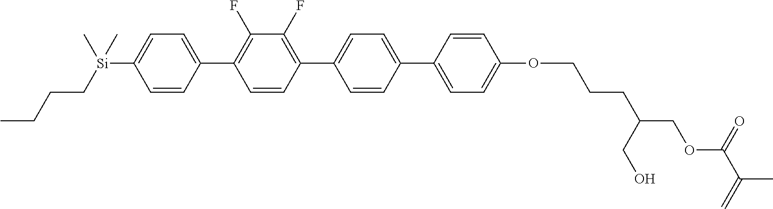 [SMILES: C=C(C)C(=O)OCC(CO)CCCOc1ccc(-c2ccc(-c3ccc(-c4ccc([Si](C)(C)CCCC)cc4)c(F)c3F)cc2)cc1]

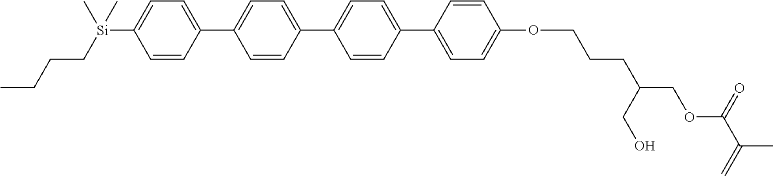 [SMILES: C=C(C)C(=O)OCC(CO)CCCOc1ccc(-c2ccc(-c3ccc(-c4ccc([Si](C)(C)CCCC)cc4)cc3)cc2)cc1]

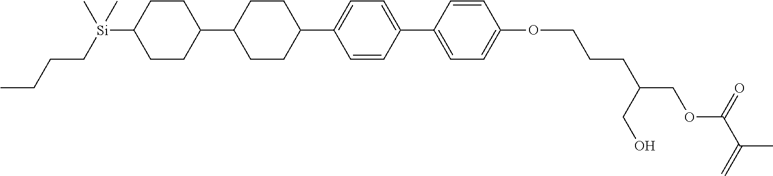 [SMILES: C=C(C)C(=O)OCC(CO)CCCOc1ccc(-c2ccc(C3CCC(C4CCC([Si](C)(C)CCCC)CC4)CC3)cc2)cc1]

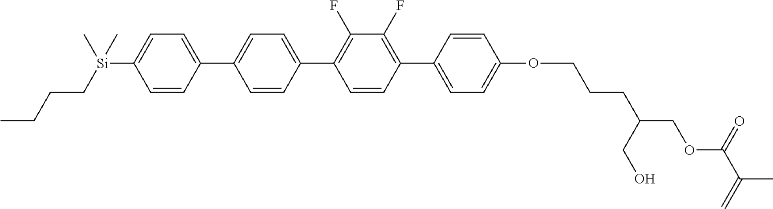 [SMILES: C=C(C)C(=O)OCC(CO)CCCOc1ccc(-c2ccc(-c3ccc(-c4ccc([Si](C)(C)CCCC)cc4)cc3)c(F)c2F)cc1]

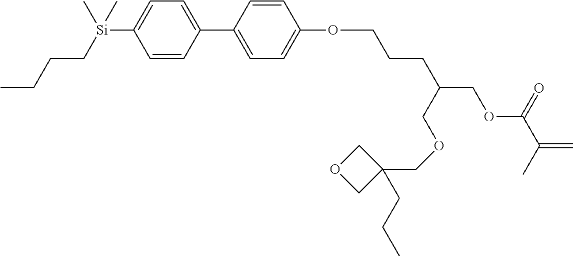 [SMILES: C=C(C)C(=O)OCC(CCCOc1ccc(-c2ccc([Si](C)(C)CCCC)cc2)cc1)COCC1(CCC)COC1]

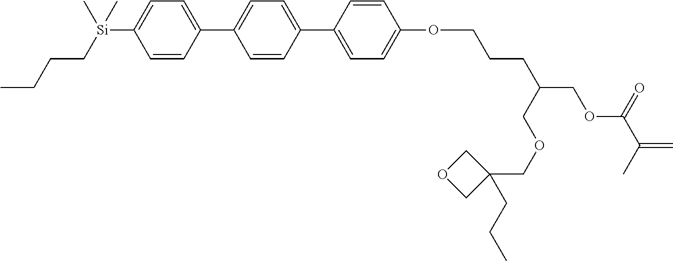 [SMILES: C=C(C)C(=O)OCC(CCCOc1ccc(-c2ccc(-c3ccc([Si](C)(C)CCCC)cc3)cc2)cc1)COCC1(CCC)COC1]

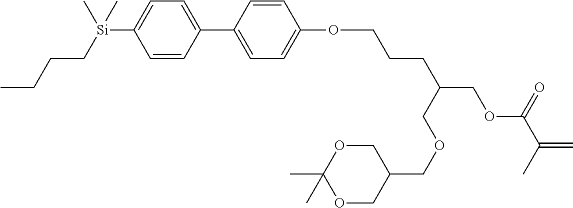 [SMILES: C=C(C)C(=O)OCC(CCCOc1ccc(-c2ccc([Si](C)(C)CCCC)cc2)cc1)COCC1COC(C)(C)OC1]

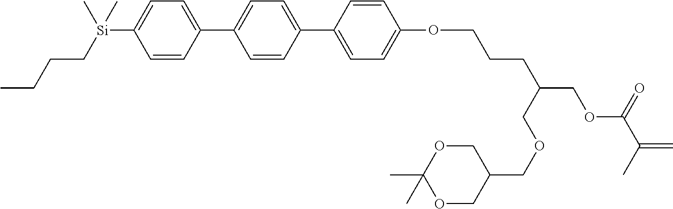 [SMILES: C=C(C)C(=O)OCC(CCCOc1ccc(-c2ccc(-c3ccc([Si](C)(C)CCCC)cc3)cc2)cc1)COCC1COC(C)(C)OC1]

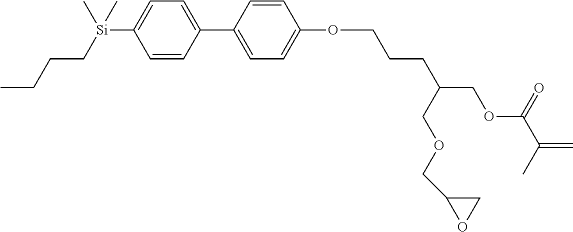 [SMILES: C=C(C)C(=O)OCC(CCCOc1ccc(-c2ccc([Si](C)(C)CCCC)cc2)cc1)COCC1CO1]

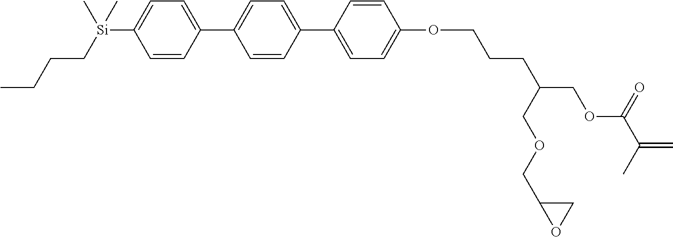 [SMILES: C=C(C)C(=O)OCC(CCCOc1ccc(-c2ccc(-c3ccc([Si](C)(C)CCCC)cc3)cc2)cc1)COCC1CO1]

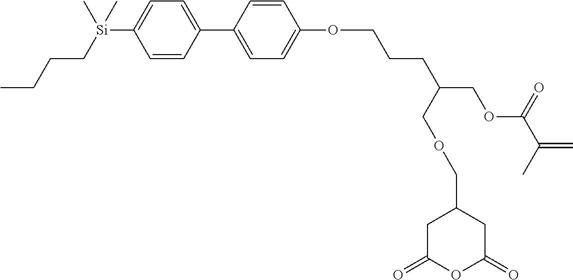 [SMILES: C=C(C)C(=O)OCC(CCCOc1ccc(-c2ccc([Si](C)(C)CCCC)cc2)cc1)COCC1CC(=O)OC(=O)C1]

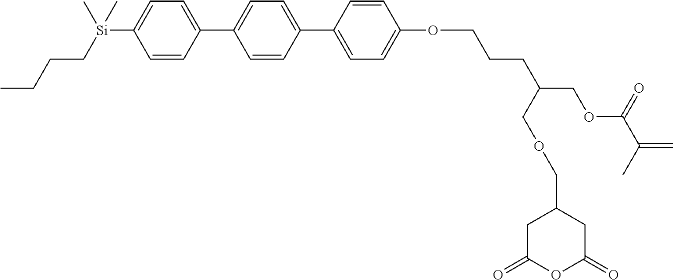 [SMILES: C=C(C)C(=O)OCC(CCCOc1ccc(-c2ccc(-c3ccc([Si](C)(C)CCCC)cc3)cc2)cc1)COCC1CC(=O)OC(=O)C1]

TABLE 6

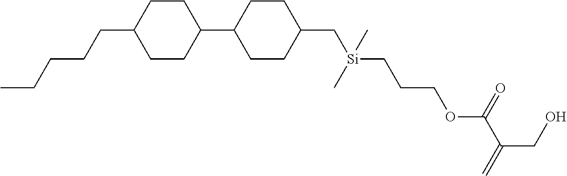 [SMILES: C=C(CO)C(=O)OCCC[Si](C)(C)CC1CCC(C2CCC(CCCCC)CC2)CC1]

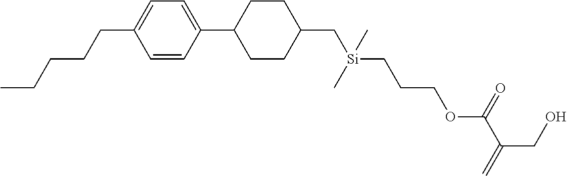 [SMILES: C=C(CO)C(=O)OCCC[Si](C)(C)CC1CCC(c2ccc(CCCCC)cc2)CC1]

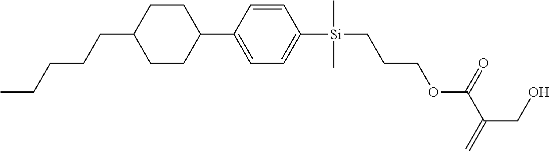 [SMILES: C=C(CO)C(=O)OCCC[Si](C)(C)c1ccc(C2CCC(CCCCC)CC2)cc1]

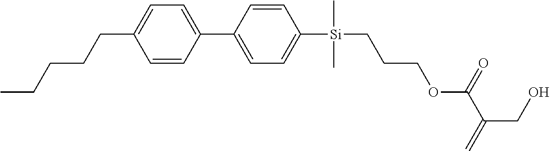 [SMILES: C=C(CO)C(=O)OCCC[Si](C)(C)c1ccc(-c2ccc(CCCCC)cc2)cc1]

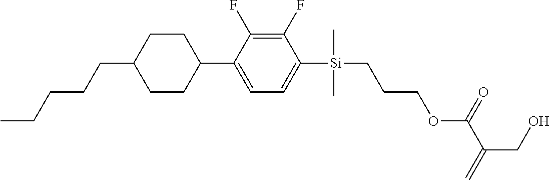 [SMILES: C=C(CO)C(=O)OCCC[Si](C)(C)c1ccc(C2CCC(CCCCC)CC2)c(F)c1F]

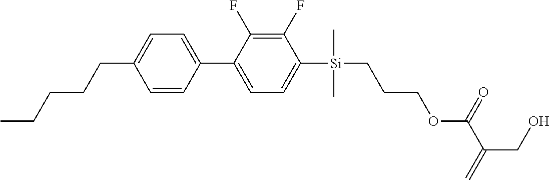 [SMILES: C=C(CO)C(=O)OCCC[Si](C)(C)c1ccc(-c2ccc(CCCCC)cc2)c(F)c1F]

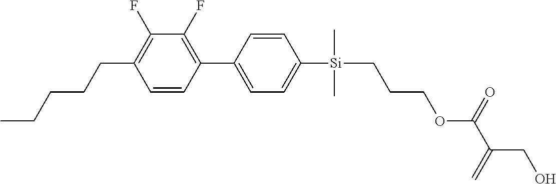 [SMILES: C=C(CO)C(=O)OCCC[Si](C)(C)c1ccc(-c2ccc(CCCCC)c(F)c2F)cc1]

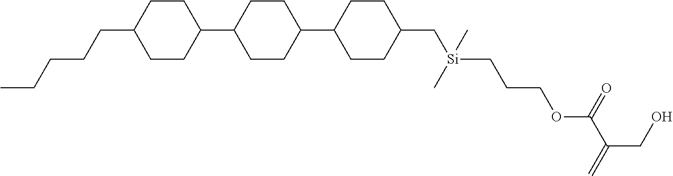 [SMILES: C=C(CO)C(=O)OCCC[Si](C)(C)CC1CCC(C2CCC(C3CCC(CCCCC)CC3)CC2)CC1]

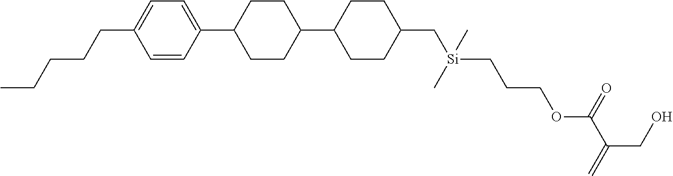 [SMILES: C=C(CO)C(=O)OCCC[Si](C)(C)CC1CCC(C2CCC(c3ccc(CCCCC)cc3)CC2)CC1]

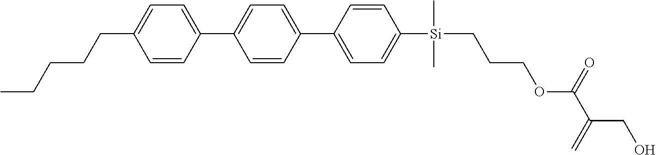 [SMILES: C=C(CO)C(=O)OCCC[Si](C)(C)c1ccc(-c2ccc(-c3ccc(CCCCC)cc3)cc2)cc1]

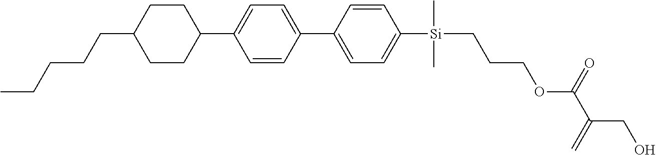 [SMILES: C=C(CO)C(=O)OCCC[Si](C)(C)c1ccc(-c2ccc(C3CCC(CCCCC)CC3)cc2)cc1]

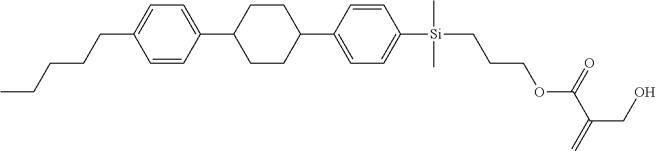 [SMILES: C=C(CO)C(=O)OCCC[Si](C)(C)c1ccc(C2CCC(c3ccc(CCCCC)cc3)CC2)cc1]

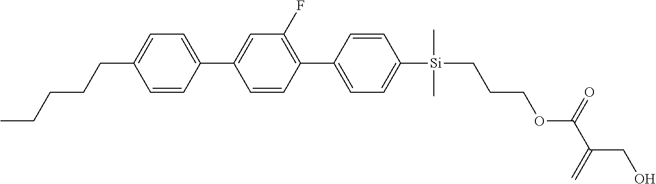 [SMILES: C=C(CO)C(=O)OCCC[Si](C)(C)c1ccc(-c2ccc(-c3ccc(CCCCC)cc3)cc2F)cc1]

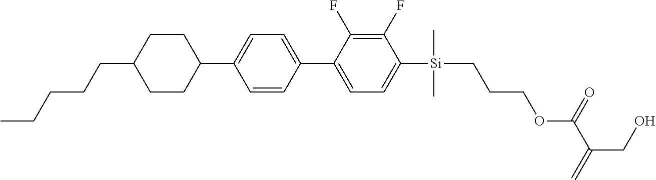 [SMILES: C=C(CO)C(=O)OCCC[Si](C)(C)c1ccc(-c2ccc(C3CCC(CCCCC)CC3)cc2)c(F)c1F]

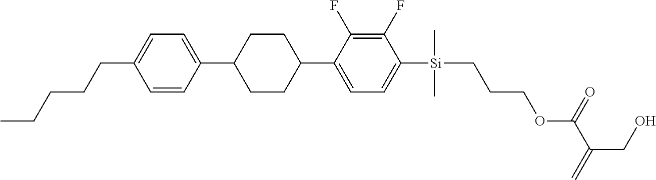 [SMILES: C=C(CO)C(=O)OCCC[Si](C)(C)c1ccc(C2CCC(c3ccc(CCCCC)cc3)CC2)c(F)c1F]

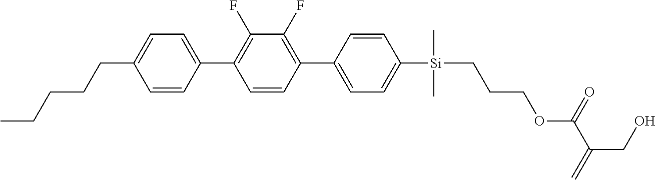 [SMILES: C=C(CO)C(=O)OCCC[Si](C)(C)c1ccc(-c2ccc(-c3ccc(CCCCC)cc3)c(F)c2F)cc1]

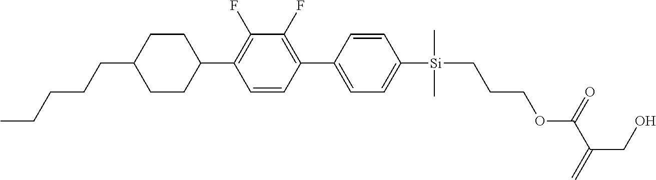 [SMILES: C=C(CO)C(=O)OCCC[Si](C)(C)c1ccc(-c2ccc(C3CCC(CCCCC)CC3)c(F)c2F)cc1]

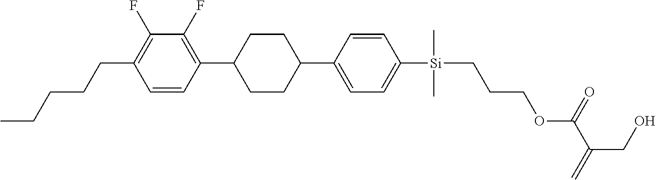 [SMILES: C=C(CO)C(=O)OCCC[Si](C)(C)c1ccc(C2CCC(c3ccc(CCCCC)c(F)c3F)CC2)cc1]

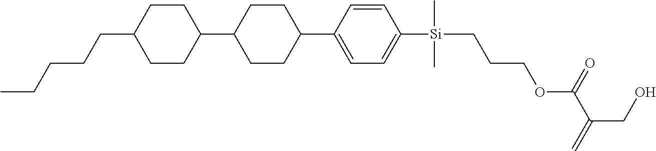 [SMILES: C=C(CO)C(=O)OCCC[Si](C)(C)c1ccc(C2CCC(C3CCC(CCCCC)CC3)CC2)cc1]

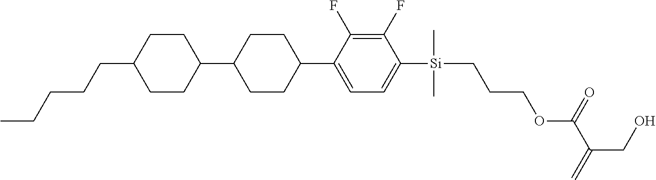 [SMILES: C=C(CO)C(=O)OCCC[Si](C)(C)c1ccc(C2CCC(C3CCC(CCCCC)CC3)CC2)c(F)c1F]

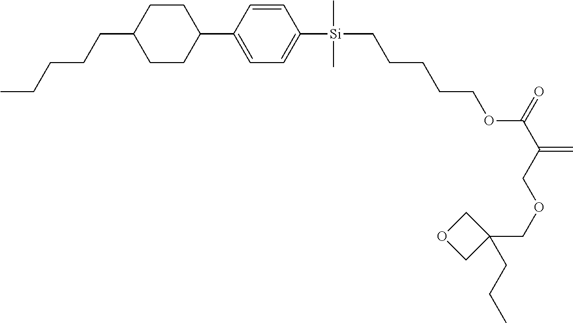 [SMILES: C=C(COCC1(CCC)COC1)C(=O)OCCCCC[Si](C)(C)c1ccc(C2CCC(CCCCC)CC2)cc1]

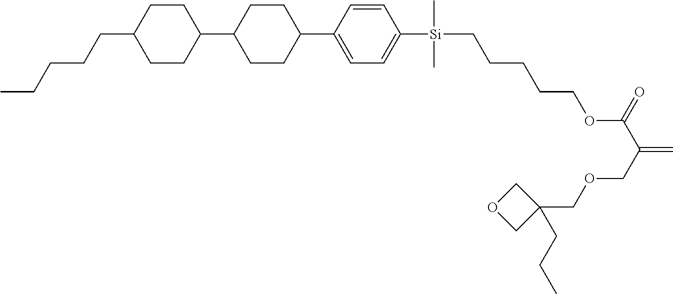 [SMILES: C=C(COCC1(CCC)COC1)C(=O)OCCCCC[Si](C)(C)c1ccc(C2CCC(C3CCC(CCCCC)CC3)CC2)cc1]

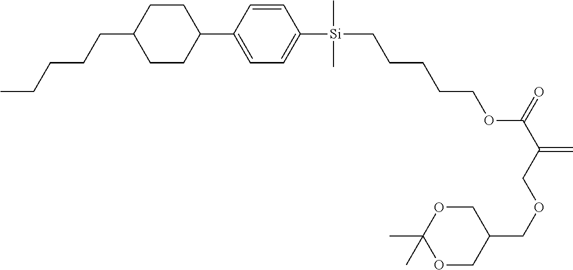 [SMILES: C=C(COCC1COC(C)(C)OC1)C(=O)OCCCCC[Si](C)(C)c1ccc(C2CCC(CCCCC)CC2)cc1]

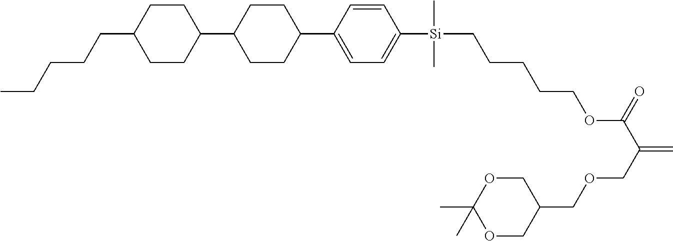 [SMILES: C=C(COCC1COC(C)(C)OC1)C(=O)OCCCCC[Si](C)(C)c1ccc(C2CCC(C3CCC(CCCCC)CC3)CC2)cc1]

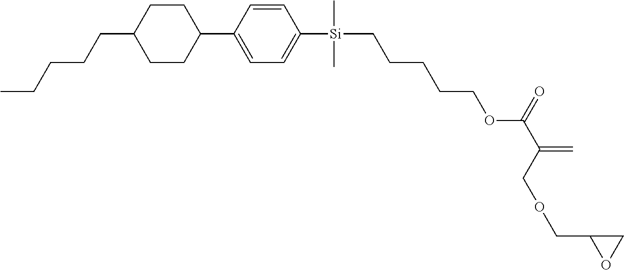 [SMILES: C=C(COCC1CO1)C(=O)OCCCCC[Si](C)(C)c1ccc(C2CCC(CCCCC)CC2)cc1]

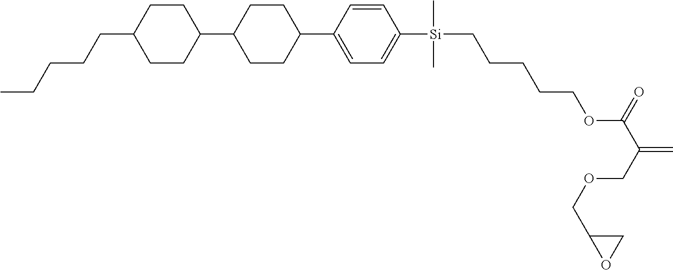 [SMILES: C=C(COCC1CO1)C(=O)OCCCCC[Si](C)(C)c1ccc(C2CCC(C3CCC(CCCCC)CC3)CC2)cc1]

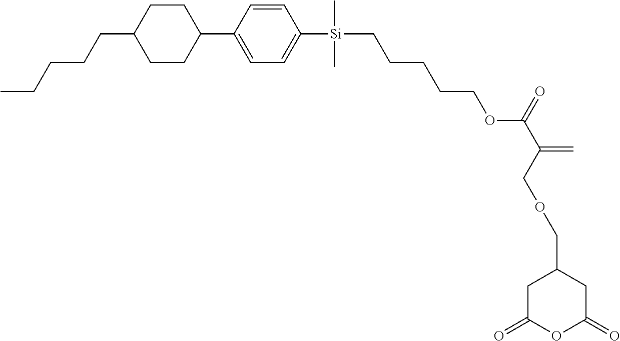 [SMILES: C=C(COCC1CC(=O)OC(=O)C1)C(=O)OCCCCC[Si](C)(C)c1ccc(C2CCC(CCCCC)CC2)cc1]

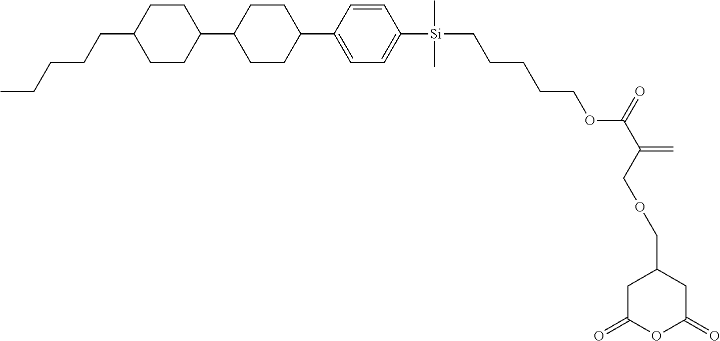 [SMILES: C=C(COCC1CC(=O)OC(=O)C1)C(=O)OCCCCC[Si](C)(C)c1ccc(C2CCC(C3CCC(CCCCC)CC3)CC2)cc1]

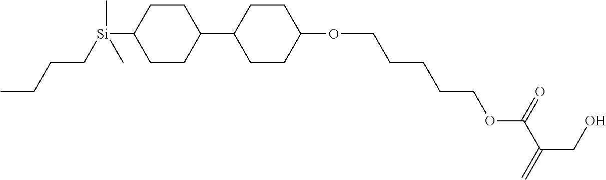 [SMILES: C=C(CO)C(=O)OCCCCCOC1CCC(C2CCC([Si](C)(C)CCCC)CC2)CC1]

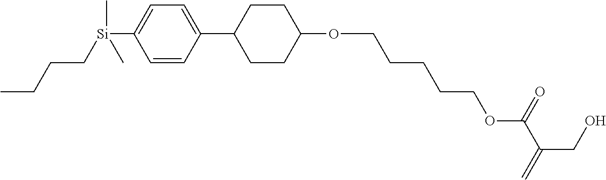 [SMILES: C=C(CO)C(=O)OCCCCCOC1CCC(c2ccc([Si](C)(C)CCCC)cc2)CC1]

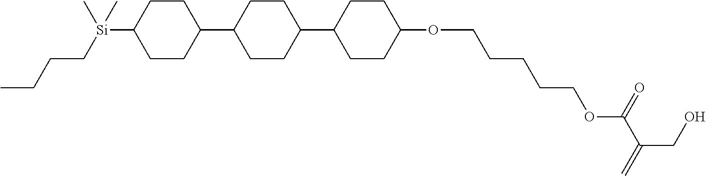 [SMILES: C=C(CO)C(=O)OCCCCCOC1CCC(C2CCC(C3CCC([Si](C)(C)CCCC)CC3)CC2)CC1]

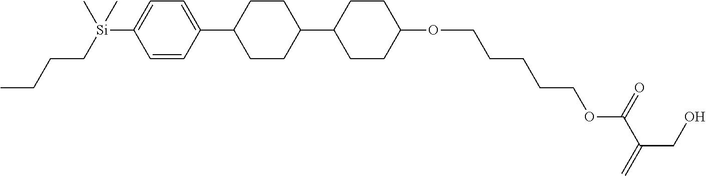 [SMILES: C=C(CO)C(=O)OCCCCCOC1CCC(C2CCC(c3ccc([Si](C)(C)CCCC)cc3)CC2)CC1]

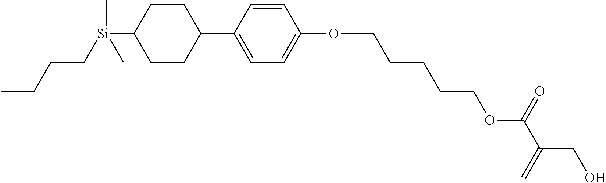 [SMILES: C=C(CO)C(=O)OCCCCCOc1ccc(C2CCC([Si](C)(C)CCCC)CC2)cc1]

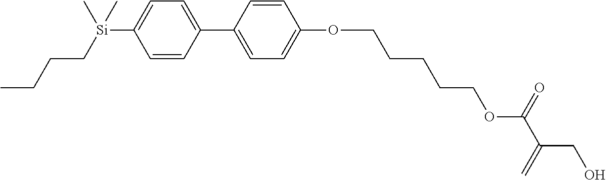 [SMILES: C=C(CO)C(=O)OCCCCCOc1ccc(-c2ccc([Si](C)(C)CCCC)cc2)cc1]

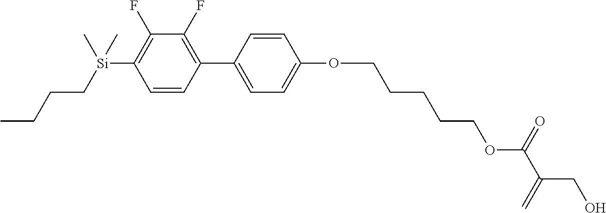 [SMILES: C=C(CO)C(=O)OCCCCCOc1ccc(-c2ccc([Si](C)(C)CCCC)c(F)c2F)cc1]

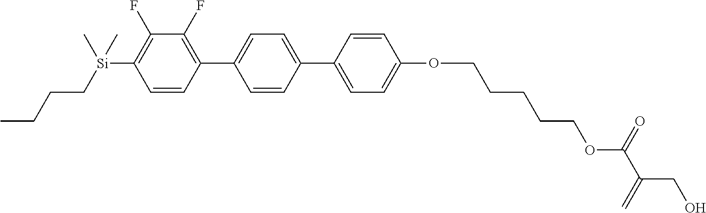 [SMILES: C=C(CO)C(=O)OCCCCCOc1ccc(-c2ccc(-c3ccc([Si](C)(C)CCCC)c(F)c3F)cc2)cc1]

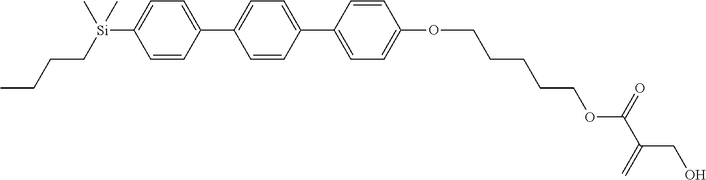 [SMILES: C=C(CO)C(=O)OCCCCCOc1ccc(-c2ccc(-c3ccc([Si](C)(C)CCCC)cc3)cc2)cc1]

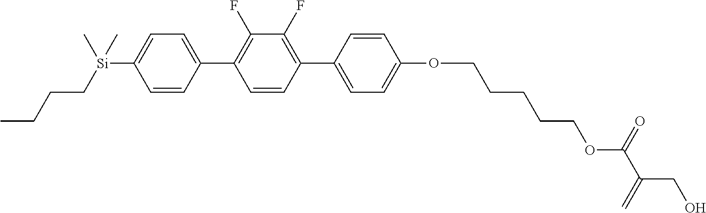 [SMILES: C=C(CO)C(=O)OCCCCCOc1ccc(-c2ccc(-c3ccc([Si](C)(C)CCCC)cc3)c(F)c2F)cc1]

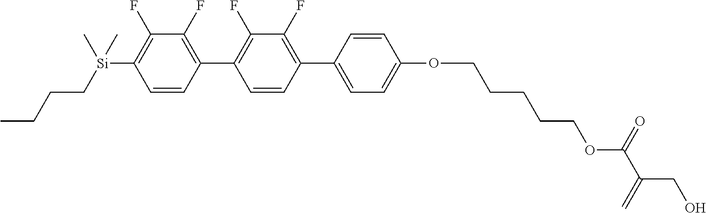 [SMILES: C=C(CO)C(=O)OCCCCCOc1ccc(-c2ccc(-c3ccc([Si](C)(C)CCCC)c(F)c3F)c(F)c2F)cc1]

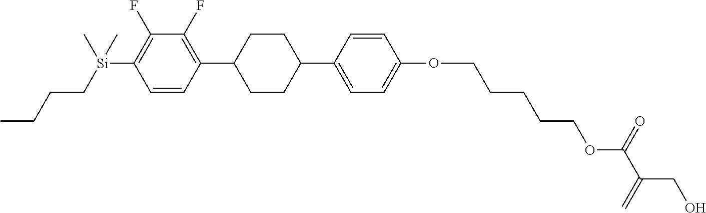 [SMILES: C=C(CO)C(=O)OCCCCCOc1ccc(C2CCC(c3ccc([Si](C)(C)CCCC)c(F)c3F)CC2)cc1]

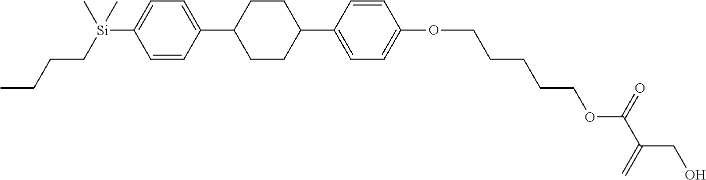 [SMILES: C=C(CO)C(=O)OCCCCCOc1ccc(C2CCC(c3ccc([Si](C)(C)CCCC)cc3)CC2)cc1]

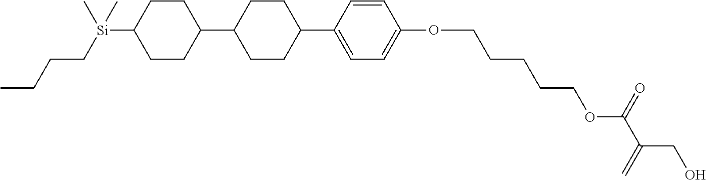 [SMILES: C=C(CO)C(=O)OCCCCCOc1ccc(C2CCC(C3CCC([Si](C)(C)CCCC)CC3)CC2)cc1]

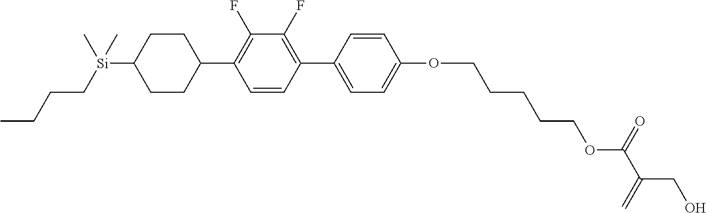 [SMILES: C=C(CO)C(=O)OCCCCCOc1ccc(-c2ccc(C3CCC([Si](C)(C)CCCC)CC3)c(F)c2F)cc1]

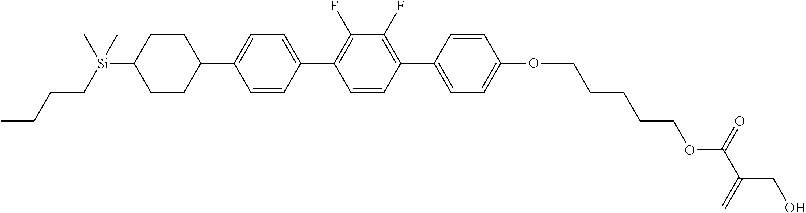 [SMILES: C=C(CO)C(=O)OCCCCCOc1ccc(-c2ccc(-c3ccc(C4CCC([Si](C)(C)CCCC)CC4)cc3)c(F)c2F)cc1]

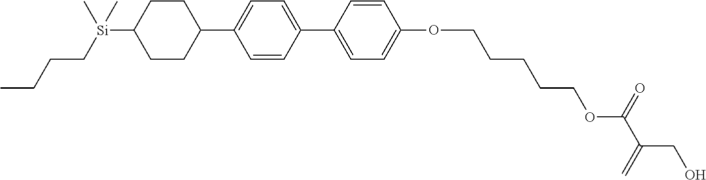 [SMILES: C=C(CO)C(=O)OCCCCCOc1ccc(-c2ccc(C3CCC([Si](C)(C)CCCC)CC3)cc2)cc1]

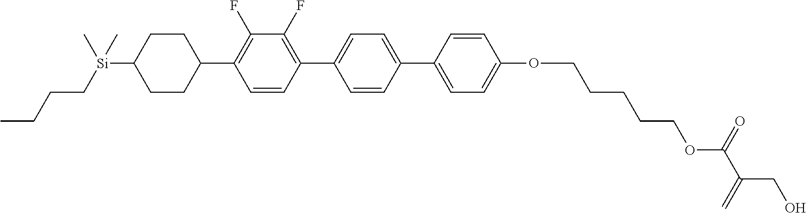 [SMILES: C=C(CO)C(=O)OCCCCCOc1ccc(-c2ccc(-c3ccc(C4CCC([Si](C)(C)CCCC)CC4)c(F)c3F)cc2)cc1]

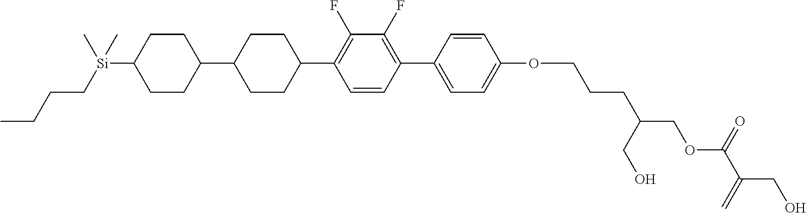 [SMILES: C=C(CO)C(=O)OCC(CO)CCCOc1ccc(-c2ccc(C3CCC(C4CCC([Si](C)(C)CCCC)CC4)CC3)c(F)c2F)cc1]

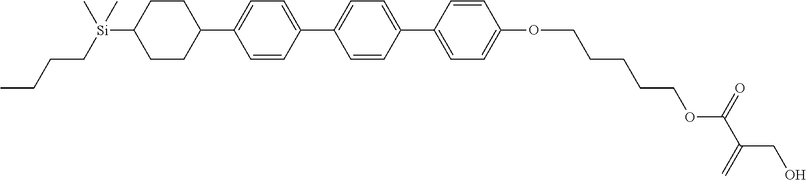 [SMILES: C=C(CO)C(=O)OCCCCCOc1ccc(-c2ccc(-c3ccc(C4CCC([Si](C)(C)CCCC)CC4)cc3)cc2)cc1]

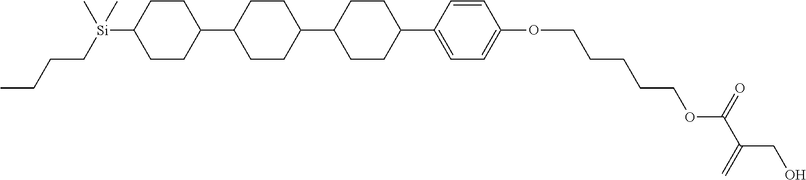 [SMILES: C=C(CO)C(=O)OCCCCCOc1ccc(C2CCC(C3CCC(C4CCC([Si](C)(C)CCCC)CC4)CC3)CC2)cc1]

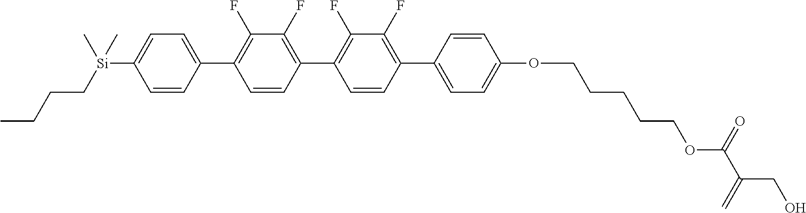 [SMILES: C=C(CO)C(=O)OCCCCCOc1ccc(-c2ccc(-c3ccc(-c4ccc([Si](C)(C)CCCC)cc4)c(F)c3F)c(F)c2F)cc1]

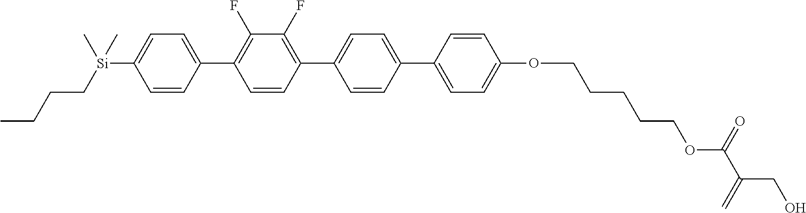 [SMILES: C=C(CO)C(=O)OCCCCCOc1ccc(-c2ccc(-c3ccc(-c4ccc([Si](C)(C)CCCC)cc4)c(F)c3F)cc2)cc1]

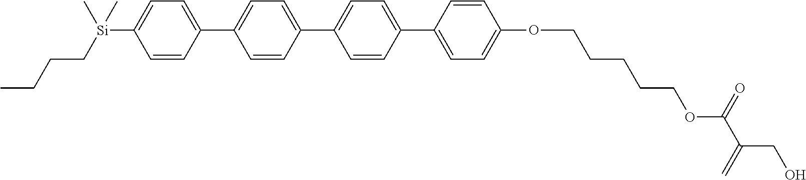 [SMILES: C=C(CO)C(=O)OCCCCCOc1ccc(-c2ccc(-c3ccc(-c4ccc([Si](C)(C)CCCC)cc4)cc3)cc2)cc1]

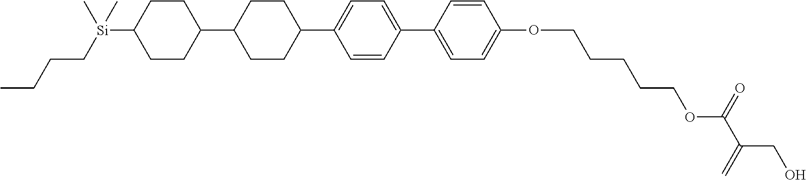 [SMILES: C=C(CO)C(=O)OCCCCCOc1ccc(-c2ccc(C3CCC(C4CCC([Si](C)(C)CCCC)CC4)CC3)cc2)cc1]

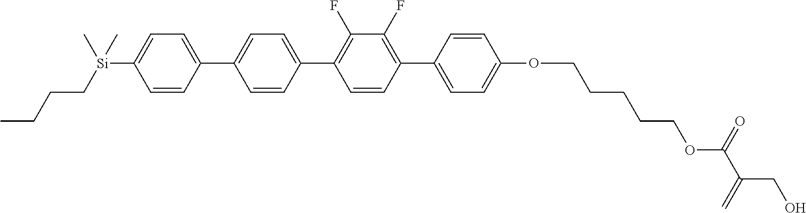 [SMILES: C=C(CO)C(=O)OCCCCCOc1ccc(-c2ccc(-c3ccc(-c4ccc([Si](C)(C)CCCC)cc4)cc3)c(F)c2F)cc1]

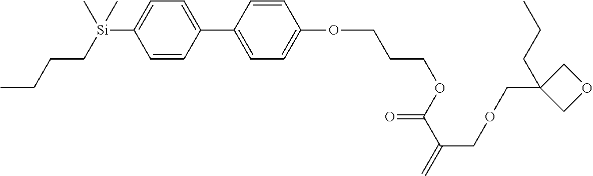 [SMILES: C=C(COCC1(CCC)COC1)C(=O)OCCCOc1ccc(-c2ccc([Si](C)(C)CCCC)cc2)cc1]

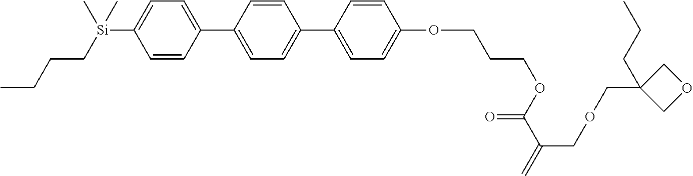 [SMILES: C=C(COCC1(CCC)COC1)C(=O)OCCCOc1ccc(-c2ccc(-c3ccc([Si](C)(C)CCCC)cc3)cc2)cc1]

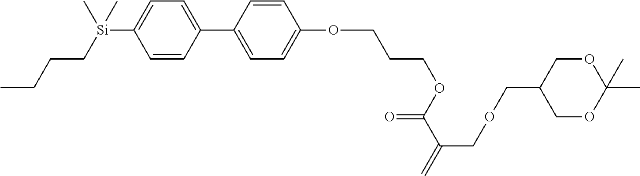 [SMILES: C=C(COCC1COC(C)(C)OC1)C(=O)OCCCOc1ccc(-c2ccc([Si](C)(C)CCCC)cc2)cc1]

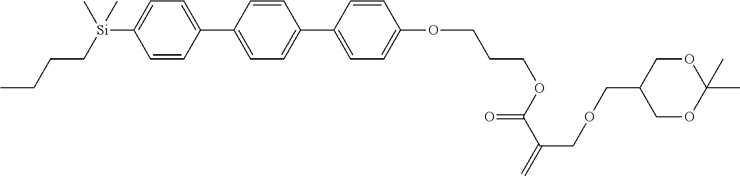 [SMILES: C=C(COCC1COC(C)(C)OC1)C(=O)OCCCOc1ccc(-c2ccc(-c3ccc([Si](C)(C)CCCC)cc3)cc2)cc1]

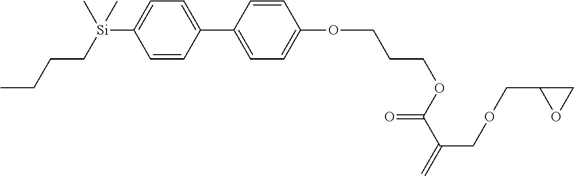 [SMILES: C=C(COCC1CO1)C(=O)OCCCOc1ccc(-c2ccc([Si](C)(C)CCCC)cc2)cc1]

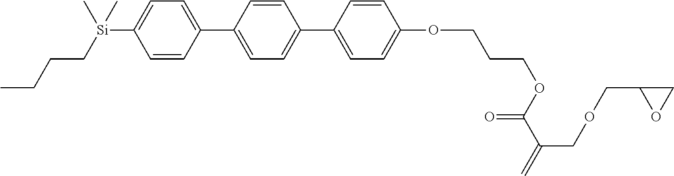 [SMILES: C=C(COCC1CO1)C(=O)OCCCOc1ccc(-c2ccc(-c3ccc([Si](C)(C)CCCC)cc3)cc2)cc1]

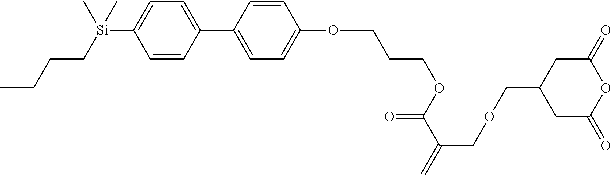 [SMILES: C=C(COCC1CC(=O)OC(=O)C1)C(=O)OCCCOc1ccc(-c2ccc([Si](C)(C)CCCC)cc2)cc1]

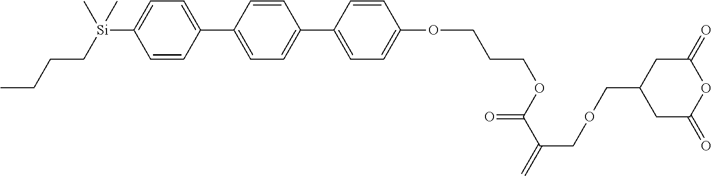 [SMILES: C=C(COCC1CC(=O)OC(=O)C1)C(=O)OCCCOc1ccc(-c2ccc(-c3ccc([Si](C)(C)CCCC)cc3)cc2)cc1]

In other embodiments of the present disclosure, a liquid-crystal composition is provided. The liquid-crystal composition includes a first component and a second component. The first component includes at least one silicon-containing compound as mentioned above, and the second component includes at least one compound represented by Formula (II):

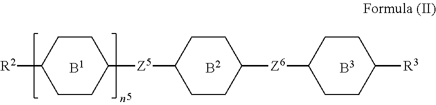

wherein

each of R² and R³ independently represents hydrogen, halogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by a halogen atom, and/or at least one —CH₂— of the C₁-C₁₅ alkyl group or the C₂-C₁₅ alkenyl group is substituted by —O—, and wherein the —O— do not directly bond to another —O—;

each of B¹, B², and B³ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is unsubstituted or at least one hydrogen atom of the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is substituted by a halogen atom or a CN group, and/or at least one —CH₂— of the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is substituted by —O—, —N— or —S—, and wherein the —O—, —N—, and —S— do not directly bond to one another;

each of Z⁵ and Z⁶ independently represents a single bond, a C₁-C₄ alkylene group, a C₂-C₄ alkenylene group, or a C₂-C₄ alkynylene group, wherein the C₁-C₄ alkylene group, the C₂-C₄ alkenylene group, or the C₂-C₄ alkynylene group is unsubstituted or at least one hydrogen atom of the C₁-C₄ alkylene group, the C₂-C₄ alkenylene group, or the C₂-C₄ alkynylene group is substituted by a halogen atom or a CN group, and/or at least one —CH₂— of the C₁-C₄ alkylene group, the C₂-C₄ alkenylene group, or the C₂-C₄ alkynylene group is substituted by —O— or —S—, and wherein the —O— does not directly bond to —O— or —S—, and —S— does not directly bond to —S—; and

n⁵ represents 0, 1, or 2, and when n⁵ represents 2, two B¹ groups are identical to each other or different from each other.

In accordance with some embodiments, the above-mentioned second component includes at least one compound represented by Formula (II-1) or Formula (II-2):

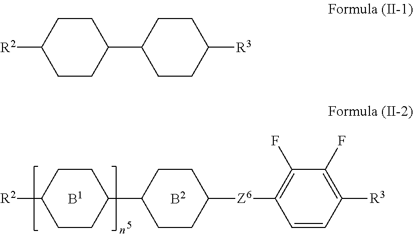

wherein

the definitions of R², R³, B¹, B², Z⁶, and n⁵ are respectively the same as the definitions of R², R³, B¹, B², Z⁶, and n⁵ defined in the previous paragraphs.

Because the cyclic group of the compound of the Formula (II-1) has no fluorine atom, the viscosity of the liquid-crystal composition can be lowered, and the response speed of the liquid-crystal molecules can be improved when a voltage is applied. The compound of the Formula (II-2) includes at least one phenylene group, and two hydrogen atoms on the same side of this phenylene group are substituted by fluorine atoms. The compound of the Formula (II-2) can be used to adjust the dielectric anisotropy (Δε) of the liquid-crystal composition.

In accordance with some embodiments, the above-mentioned second component further includes a third component, and the third component includes at least one compound represented by Formula (III), Formula (IV), or Formula (V):

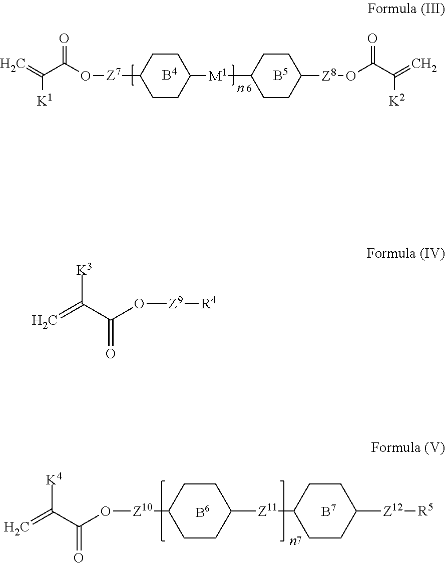

wherein

each of K¹, K², K³, and K⁴ independently represents hydrogen or a methyl group;

each of Z⁷ and Z⁸ independently represents a single bond, a C₁-C₁₅ linear alkylene group, a C₃-C₁₅ branched alkylene group, a C₂-C₁₅ linear alkenylene group, or a C₃-C₁₅ branched alkenylene group, wherein the C₁-C₁₅ linear alkylene group, the C₃-C₁₅ branched alkylene group, the C₂-C₁₅ linear alkenylene group, or the C₃-C₁₅ branched alkenylene group is unsubstituted or at least one hydrogen atom of the C₁-C₁₅ linear alkylene group, the C₃-C₁₅ branched alkylene group, the C₂-C₁₅ linear alkenylene group, or the C₃-C₁₅ branched alkenylene group is substituted by a halogen atom, and/or at least one —CH₂— of the C₁-C₁₅ linear alkylene group, the C₃-C₁₅ branched alkylene group, the C₂-C₁₅ linear alkenylene group, or the C₃-C₁₅ branched alkenylene group is substituted by —O—, —CO—, —COO—, or —OCO—, and wherein the —O—, —CO—, —COO—, and —OCO— do not directly bond to one another;

each of Z⁹, Z¹⁰, Z¹¹, and Z¹² independently represents a single bond, —C≡C—, a C₁-C₁₅ linear alkylene group, a C₃-C₁₅ branched alkylene group, a C₂-C₁₅ linear alkenylene group, or a C₃-C₁₅ branched alkenylene group, wherein the C₁-C₁₅ linear alkylene group, the C₃-C₁₅ branched alkylene group, the C₂-C₁₅ linear alkenylene group, or the C₃-C₁₅ branched alkenylene group is unsubstituted or at least one hydrogen atom of the C₁-C₁₅ linear alkylene group, the C₃-C₁₅ branched alkylene group, the C₂-C₁₅ linear alkenylene group, or the C₃-C₁₅ branched alkenylene group is substituted by a halogen atom, and/or at least one —CH₂— of the C₁-C₁₅ linear alkylene group, the C₃-C₁₅ branched alkylene group, the C₂-C₁₅ linear alkenylene group, or the C₃-C₁₅ branched alkenylene group is substituted by —SiR^{e}₂—, —S—, —O—, —CO—, —COO—, —OCO—, —CO—NR^{e}—, or —NR^{e}—CO—, and the —SiR^{e}₂—, —S—, —O—, —CO—, —COO—, —OCO—, —CO—NR^{e}—, and —NR^{e}—CO— do not directly bond to one another, wherein R^{e} represents hydrogen, a C₁-C₄ linear alkyl group, or a C₃-C₄ branched alkyl group, and two R^{e} groups bonded to the same Si atom are identical to each other or different from each other;

each of B⁴, B⁵, B⁶ and B⁷ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the tetrahydronaphthalene-2,6-diyl group, or the indane-2,5-diyl group is unsubstituted or is substituted by at least one substituent, wherein the at least one substituent is selected from fluorine, chlorine, a CN group, a C₁-C₁₂ linear alkyl group, a C₃-C₁₂ branched alkyl group, a C₂-C₁₂ linear alkenyl group, a C₄-C₁₂ branched alkenyl group, a C₂-C₁₂ linear alkynyl group, or a C₄-C₁₂ branched alkynyl group, wherein the C₁-C₁₂ linear alkyl group, the C₃-C₁₂ branched alkyl group, the C₂-C₁₂ linear alkenyl group, the C₄-C₁₂ branched alkenyl group, a C₂-C₁₂ linear alkynyl group, or the C₄-C₁₂ branched alkynyl group is unsubstituted or at least one hydrogen atom of the C₁-C₁₂ linear alkyl group, the C₃-C₁₂ branched alkyl group, the C₂-C₁₂ linear alkenyl group, the C₄-C₁₂ branched alkenyl group, a C₂-C₁₂ linear alkynyl group, or the C₄-C₁₂ branched alkynyl group is substituted by a halogen atom, and/or at least one —CH₂— of the C₁-C₁₂ linear alkyl group, the C₃-C₁₂ branched alkyl group, the C₂-C₁₂ linear alkenyl group, the C₄-C₁₂ branched alkenyl group, a C₂-C₁₂ linear alkynyl group, or the C₄-C₁₂ branched alkynyl group is substituted by —O—, —CO—, —COO—, or —OCO—, and the —O—, —CO—, —COO—, and —OCO— do not directly bond to one another;

M¹ represents a single bond, —CH₂O—, —OCH₂—, —CH₂CH₂—, —CH═CH—. —C≡C—, —CH₂—, —C(CH₃)₂—, —C(CF₃)₂—, —SiH₂—, —Si(CH₃)₂—, or —Si(CF₃)₂—;

each of R⁴ and R⁵ independently represents a C₁-C₇₀ linear alkyl group or a C₃-C₇₀ branched alkyl group, wherein the C₁-C₇₀ linear alkyl group or the C₃-C₇₀ branched alkyl group is unsubstituted or at least one hydrogen atom of the C₁-C₇₀ linear alkyl group or the C₃-C₇₀ branched alkyl group is substituted by a halogen atom, and/or at least one —CH₂— of the C₁-C₇₀ linear alkyl group or the C₃-C₇₀ branched alkyl group is substituted by —Si—, —O—, —CO—, —COO—, or —OCO—, and the —Si—, —O—, —CO—, —COO—, and —OCO— do not directly bond to one another; and

each of n⁶ and n⁷ independently represents an integer of 0 to 3, and when n⁶ is greater than 2, two groups comprising B⁴ and M¹ are identical to each other or different from each other, and when n⁷ is greater than 2, two groups comprising B⁶ and Z¹¹ are identical to each other or different from each other.

The compound of the third component includes at least one polymerizable group, and the polymerizable group may include an acrylic group, a methacrylic group, or a derivative thereof. More specifically, each of the compounds of the Formula (IV) and the Formula (V) has a polymerizable group at one end of the molecule. Each of the compounds of the Formula (III) has a polymerizable group at both ends of the molecule. The polymerizable group of the third component may undergo the polymerization reaction with another polymerizable group of the above-mentioned silicon-containing compound by irradiation or heating. In this way, it is helpful to form the above-mentioned network, and the degree of vertical alignment of the liquid-crystal molecules can be improved further.

For those skilled in the art, it should be understood that the liquid-crystal composition may further include other liquid-crystal compounds other than the above-mentioned molecules of the Formula (I), Formula (II), or Formula (III), or it may further include other additives with an appropriate amount. In some embodiments, these other additives may include, for example, chiral dopants, UV stabilizers, antioxidants, free radical scavengers, nanoparticles, and so on.

If the content of the first component is too low, the degree of vertical alignment and the voltage holding ratio of the liquid-crystal composition may not be effectively improved. On the other hand, if the content of the first component is too high, it may not dissolve well in the liquid-crystal composition, and it may precipitate. Such a liquid-crystal composition cannot be used. Furthermore, when the first component exceeds the specific content, even if the first component is further increased, the degree of vertical alignment of the liquid-crystal composition cannot be improved further. Furthermore, the first component has the group (for example, an anchoring group) having a relatively high polarity. Therefore, if the content of the first component is too high, the voltage holding ratio of the liquid-crystal composition may be lowered. As described above, in order to balance the degree of the vertical alignment and the voltage holding ratio of the liquid-crystal composition, the content of the first component may be controlled within an appropriate range.

The content of the first component may be 0.01-40 wt %, more preferably 0.01-25 wt %, based on 100 wt % of the total weight of the liquid-crystal composition. The content of the second component may be 30-99.99 wt %, more preferably 50-99.99 wt %, based on 100 wt % of the total weight of the liquid-crystal composition. The content of the third component may be 0-50 wt %, more preferably 0-25 wt %, based on 100 wt % of the total weight of the liquid-crystal composition. In some embodiments, the content of the first component is 0.01-40 wt %, and the content of the second component is 60-99.99 wt %. In other embodiments, the content of the first component is 1-20 wt %, and the content of the second component is 80-99 wt %. In still other embodiments, the content of the first component is 2-10 wt %, and the content of the second component is 90-98 wt %. In some embodiments, the liquid-crystal composition further includes the third component. In such embodiments, the content of the first component is 0.01-40 wt %, the content of the second component is 30-99.99 wt %, and the content of the third component is 0.01-50 wt %. In other embodiments, the content of the first component is 5-30 wt %, the content of the second component is 50-90 wt %, and the content of the third component is 1-40 wt %. In still other embodiments, the content of the first component is 10-15 wt %, the content of the second component is 60-70 wt %, and the content of the third component is 10-30 wt %.

In the present disclosure, a liquid-crystal display device using the liquid-crystal composition is also provided. The sole FIGURE is a cross-sectional view showing a liquid-crystal display device 100 in accordance with some embodiments of the present disclosure.

Referring to the sole FIGURE, the liquid-crystal display device 100 includes a first substrate 110 and a second substrate 120 disposed opposite to the first substrate 110. The liquid-crystal display device 100 also includes a liquid-crystal layer 130 disposed between the first substrate 110 and the second substrate 120. The liquid-crystal layer 130 includes the above-mentioned silicon-containing compound. The first substrate 110 and the second substrate 120 are respectively a conventional thin film transistor substrate and a conventional color filter substrate. In order to simplify the description, the materials, structures, and manufacturing methods of the first substrate 110 and the second substrate 120 will not be described in detail herein.

The liquid-crystal layer 130 of the liquid-crystal display device 100 of the present disclosure uses the above-mentioned liquid-crystal composition, and the liquid-crystal composition includes the silicon-containing compound of the Formula (I). As described above, the silicon-containing compound of the Formula (I) has excellent vertical alignment ability while having a high voltage holding ratio. By adding the silicon-containing compound of the Formula (I) to the liquid-crystal composition, the liquid-crystal molecules can be vertically aligned well without using a conventional alignment film. On the other hand, the liquid-crystal display device 100 using the silicon-containing compound of the present disclosure has the advantages of high voltage holding ratio, energy saving, and improved response speed. The liquid-crystal composition of the present disclosure can be applied to all kinds of liquid-crystal display devices.

In order to further simplify and clarify the foregoing contents and other objects, characteristics, and merits of the present disclosure, a few examples are given to explain the silicon-containing compounds and the liquid-crystal compositions of the present disclosure. The chemical structures and contents corresponding to the compounds of the Formula (II) and the Formula (III) used in the liquid-crystal compositions of the Examples are shown in Table 7 below. The silicon-containing compounds of the Examples and the molecules of the Reference Examples are shown in Table 8 below.

TABLE 7

| | | | Content |
|---|---|---|---|
| | | Chemical structure | (wt %) |
| Formula (II) | Formula (II-1) | 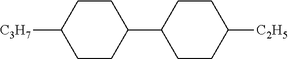 | 10 |
| | | 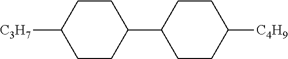 | 5 |
| | | 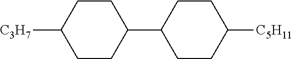 | 12 |
| | | 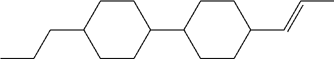 [SMILES: C/C=C/C1CCC(C2CCC(CCC)CC2)CC1] | 14 |
| | Formula (II-2) | 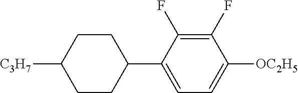 | 10 |
| | | 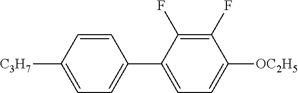 | 19 |
| | | 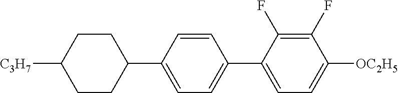 | 15 |
| | | 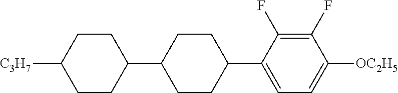 | 15 |

| | | |
|---|---|---|
| Formula (III) | 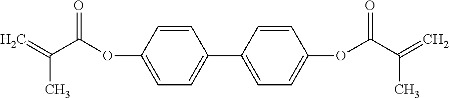 [SMILES: C=C(C)C(=O)Oc1ccc(-c2ccc(OC(=O)C(=C)C)cc2)cc1] | 0.3 |

TABLE 8

| No. | Classification | Chemical structure |
|---|---|---|
| Ref-1 | — | 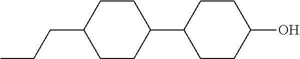 [SMILES: CCCC1CCC(C2CCC(O)CC2)CC1] |
| Ref-2 | — | 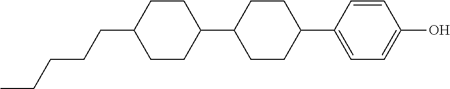 [SMILES: CCCCCC1CCC(C2CCC(c3ccc(O)cc3)CC2)CC1] |
| Ref-3 | — | 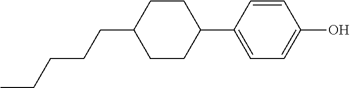 [SMILES: CCCCCC1CCC(c2ccc(O)cc2)CC1] |
| Ref-4 | — | 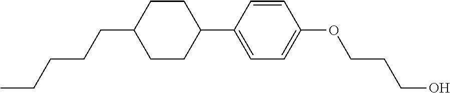 [SMILES: CCCCCC1CCC(c2ccc(OCCCO)cc2)CC1] |
| Exp-1 | Formula (I-A-1) | 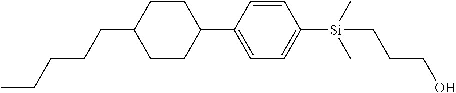 [SMILES: CCCCCC1CCC(c2ccc([Si](C)(C)CCCO)cc2)CC1] |
| Exp-2 | Formula (I-A-1) | 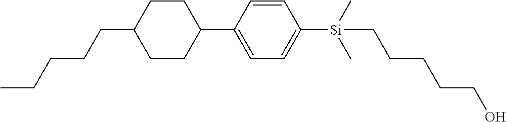 [SMILES: CCCCCC1CCC(c2ccc([Si](C)(C)CCCCCO)cc2)CC1] |
| Exp-3 | Formula (I-A-1) | 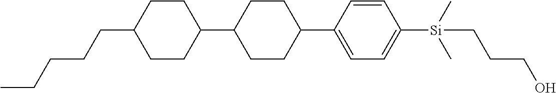 [SMILES: CCCCCC1CCC(C2CCC(c3ccc([Si](C)(C)CCCO)cc3)CC2)CC1] |
| Exp-4 | Formula (I-A-1) | 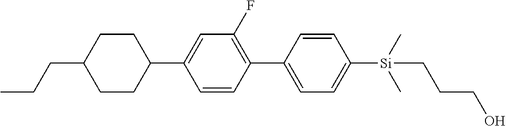 [SMILES: CCCC1CCC(c2ccc(-c3ccc([Si](C)(C)CCCO)cc3)c(F)c2)CC1] |
| Exp-5 | Formula (I-A-1) | 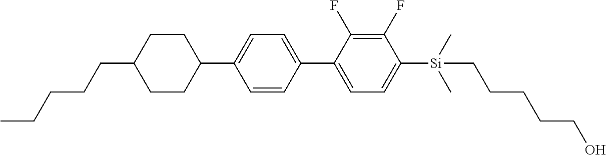 [SMILES: CCCCCC1CCC(c2ccc(-c3ccc([Si](C)(C)CCCCCO)c(F)c3F)cc2)CC1] |
| Exp-6 | Formula (I-A-1) | 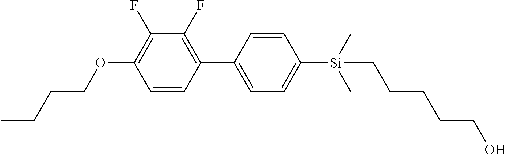 [SMILES: CCCCOc1ccc(-c2ccc([Si](C)(C)CCCCCO)cc2)c(F)c1F] |
| Exp-7 | Formula (I-B-1) | 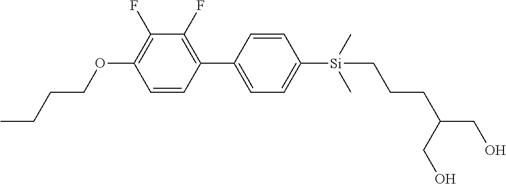 [SMILES: CCCCOc1ccc(-c2ccc([Si](C)(C)CCCC(CO)CO)cc2)c(F)c1F] |
| Exp-8 | Formula (I-C-1) | 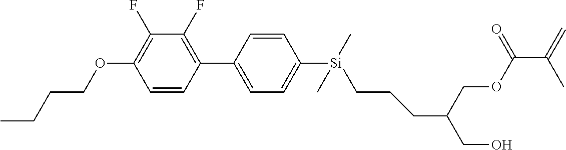 [SMILES: C=C(C)C(=O)OCC(CO)CCC[Si](C)(C)c1ccc(-c2ccc(OCCCC)c(F)c2F)cc1] |
| Exp-9 | Formula (I-C-1) | 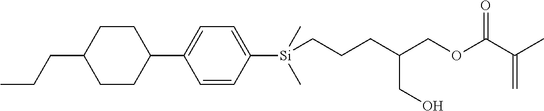 [SMILES: C=C(C)C(=O)OCC(CO)CCC[Si](C)(C)c1ccc(C2CCC(CCC)CC2)cc1] |
| Exp-10 | Formula (I-A-2) | 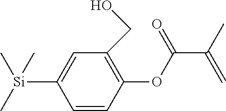 [SMILES: C=C(C)C(=O)Oc1ccc([Si](C)(C)C)cc1CO] |
| Exp-11 | Formula (I-A-2) | 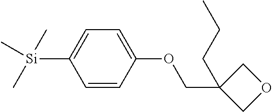 [SMILES: CCCC1(COc2ccc([Si](C)(C)C)cc2)COC1] |
| Exp-12 | Formula (I-A-1) | 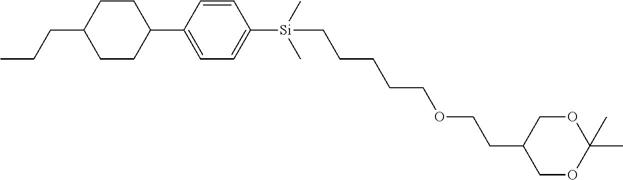 [SMILES: CCCC1CCC(c2ccc([Si](C)(C)CCCCCOCCC3COC(C)(C)OC3)cc2)CC1] |

The synthesis methods of the silicon-containing compounds and the molecules used in Reference Example of Table 8 are described as follows.

### Preparation Example 1

Preparing silicon-containing compound Exp-1

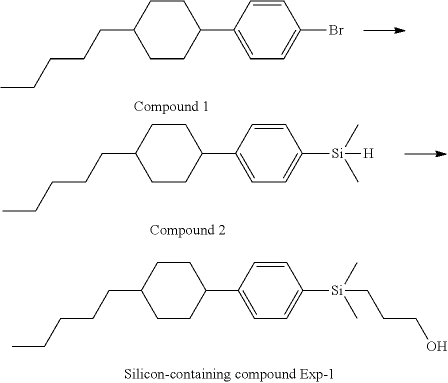 [SMILES: CCCCCC1CCC(c2ccc(Br)cc2)CC1 ; CCCCCC1CCC(c2ccc([SiH](C)C)cc2)CC1 ; CCCCCC1CCC(c2ccc([Si](C)(C)CCCO)cc2)CC1]

Compound 1 (6.0 g, 19.4 mmol) and anhydrous tetrahydrofuran (50 mL) were placed in a 250 mL reaction flask and stirred to dissolve. Then, n-butyllithium (2.5 M, 8.5 mL, 21.3 mmol) was slowly added to the reaction flask at −78° C., and the reaction was carried out for 1 hour. Next, dimethylchlorosilane (2.48 g, 26.2 mmol) was added to the reaction flask at −78° C., and the reaction was carried out at room temperature (20-30° C.) for 2 hours. After the reaction was completed, dilute hydrochloric acid (1 N, 30 mL) was added. Then, an extraction was performed by using ethyl acetate and water, and the organic phase was collected. The solvent of the collected organic phase was removed by using a rotary concentrator. Then, column chromatography was performed to obtain Compound 2.

Compound 2 (2.5 g, 8.7 mmol), toluene (30 mL) and platinum-containing catalyst (Pt/C, 5% on carbon, 0.25 g) were placed in a 100 mL double-necked flask. Nitrogen gas was introduced into the double-necked flask. Then, allyl alcohol (0.76 g, 13.02 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain silicon-containing compound Exp-1 (white solid).

The silicon-containing compound Exp-1 was analyzed by nuclear magnetic resonance spectroscopy, and the obtained spectral information was as follows: ¹H NMR (CDCl₃, 400 MHz): 0.26 (s, 6H), 0.71-0.75 (m, 2H), 0.90 (t, J=7.2 Hz, 3H), 1.05-1.60 (m, 16H), 1.84-1.90 (m, 4H), 2.43-2.47 (m, 1H), 3.58 (t, J=6.8 Hz, 2H), 7.20 (d, J=8.0 Hz, 2H), 7.43 (d, J=8.0 Hz, 2H).

### Preparation Example 2

Preparing silicon-containing compound Exp-2

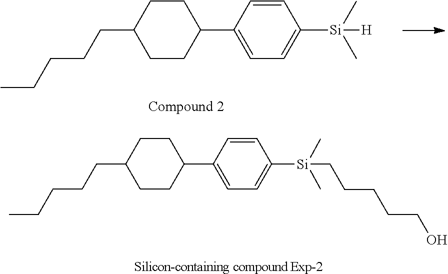 [SMILES: CCCCCC1CCC(c2ccc([SiH](C)C)cc2)CC1 ; CCCCCC1CCC(c2ccc([Si](C)(C)CCCCCO)cc2)CC1]

Compound 2 (2.5 g, 8.7 mmol), toluene (30 mL) and platinum-containing catalyst (Pt/C, 5% on carbon, 0.25 g) were placed in a 100 mL double-necked flask. Nitrogen gas was introduced into the double-necked flask. Then, 4-penten-1-ol (1.12 g, 13.0 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain silicon-containing compound Exp-2 (colorless liquid).

The silicon-containing compound Exp-2 was analyzed by nuclear magnetic resonance spectroscopy, and the obtained spectral information was as follows: ¹H NMR (CDCl₃, 400 MHz): 0.26 (s, 6H), 0.71-0.75 (m, 2H), 0.90 (t, J=7.2 Hz, 3H), 1.05-1.60 (m, 20H), 1.84-1.91 (m, 4H), 2.41-2.49 (m, 1H), 3.60 (t, J=6.8 Hz, 2H), 7.20 (d, J=8.0 Hz, 2H), 7.42 (d, J=8.0 Hz, 2H).

### Preparation Example 3

Preparing silicon-containing compound Exp-3

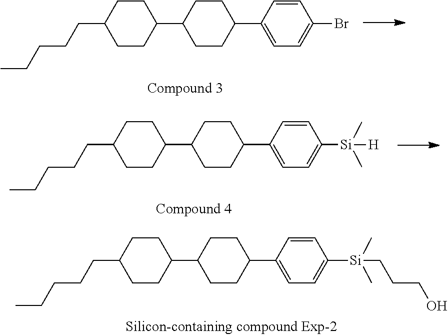 [SMILES: CCCCCC1CCC(C2CCC(c3ccc(Br)cc3)CC2)CC1 ; CCCCCC1CCC(C2CCC(c3ccc([SiH](C)C)cc3)CC2)CC1 ; CCCCCC1CCC(C2CCC(c3ccc([Si](C)(C)CCCO)cc3)CC2)CC1]

Compound 3 (6.0 g, 15.4 mmol) and anhydrous tetrahydrofuran (120 mL) were placed in a 250 mL reaction flask and stirred to dissolve. Then, n-butyllithium (2.5 M, 6.8 mL, 16.9 mmol) was slowly added to the reaction flask at −78° C., and the reaction was carried out for 1 hour. Next, dimethylchlorosilane (1.89 g, 19.95 mmol) was added to the reaction flask at −78° C., and the reaction was carried out at room temperature (20-30° C.) for 2 hours. After the reaction was completed, dilute hydrochloric acid (1 N, 20 mL) was added. Then, an extraction was performed by using ethyl acetate and water, and the organic phase was collected. The solvent of the collected organic phase was removed by using a rotary concentrator. Then, column chromatography was performed to obtain Compound 4.

Compound 4 (2.5 g, 6.7 mmol), toluene (30 mL) and platinum-containing catalyst (Pt/C, 5% on carbon, 0.20 g) were placed in a 100 mL double-necked flask. Nitrogen gas was introduced into the double-necked flask. Then, allyl alcohol (0.59 g, 10.1 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain silicon-containing compound Exp-3 (white solid).

The silicon-containing compound Exp-3 was analyzed by nuclear magnetic resonance spectroscopy, and the obtained spectral information was as follows: ¹H NMR (CDCl₃, 400 MHz): 0.26 (s, 6H), 0.70-0.75 (m, 2H), 0.85-1.93 (m, 33H), 2.36-2.48 (m, 1H), 3.57 (t, J=6.8 Hz, 2H), 7.19 (d, J=7.6 Hz, 2H), 7.42 (d, J=7.6 Hz, 2H).

### Preparation Example 4

Preparing silicon-containing compound Exp-4

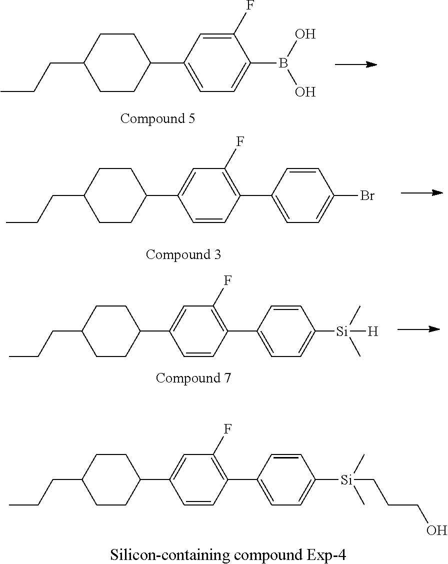 [SMILES: CCCC1CCC(c2ccc(B(O)O)c(F)c2)CC1 ; CCCC1CCC(c2ccc(-c3ccc(Br)cc3)c(F)c2)CC1 ; CCCC1CCC(c2ccc(-c3ccc([SiH](C)C)cc3)c(F)c2)CC1 ; CCCC1CCC(c2ccc(-c3ccc([Si](C)(C)CCCO)cc3)c(F)c2)CC1]

Compound 5 (6.0 g, 22.7 mmol), 1,4-dibromobenzene (8.0 g, 34.1 mmol), tetrahydrofuran (100 mL), water (20 mL) and potassium carbonate (14.1 g, 102.3 mmol) were placed in a 250 mL reaction flask and stirred to dissolve. Nitrogen gas was introduced into the reaction flask to deoxygenate for 30 minutes. Then, tetrakis(triphenylphosphine)palladium (0) (0.79 g, 0.681 mmol) was added, and the mixture was heated to reflux for 5 hours to carry out the reaction. After the reaction was completed, an extraction was performed by using ethyl acetate and water, and the organic phase was collected. The solvent of the collected organic phase was removed by using a rotary concentrator. Then, column chromatography was performed to obtain Compound 6.

Compound 6 (5.0 g, 13.3 mmol) and anhydrous tetrahydrofuran (120 mL) were placed in a 250 mL reaction flask and stirred to dissolve. Then, n-butyllithium (2.5 M, 6.4 mL, 16 mmol) was slowly added to the reaction flask at −78° C., and the reaction was carried out for 1 hour. Next, dimethylchlorosilane (1.77 g, 18.67 mmol) was added to the reaction flask at −78° C., and the reaction was carried out at room temperature (20-30° C.) for 2 hours. After the reaction was completed, dilute hydrochloric acid (1 N, 20 mL) was added. Then, an extraction was performed by using ethyl acetate and water, and the organic phase was collected. The solvent of the collected organic phase was removed by using a rotary concentrator. Then, column chromatography was performed to obtain Compound 7.

Compound 7 (2.0 g, 5.6 mmol), toluene (25 mL) and platinum-containing catalyst (Pt/C, 5% on carbon, 0.16 g) were placed in a 100 mL double-necked flask. Nitrogen gas was introduced into the double-necked flask. Then, allyl alcohol (0.65 g, 11.3 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain silicon-containing compound Exp-4 (white solid).

The silicon-containing compound Exp-4 was analyzed by nuclear magnetic resonance spectroscopy, and the obtained spectral information was as follows: ¹H NMR (CDCl₃, 400 MHz): 0.31 (s, 6H), 0.76-0.80 (m, 2H), 0.91 (t, J=7.2 Hz, 3H), 1.08-1.63 (m, 12H), 1.82-1.95 (m, 4H), 2.43-2.57 (m, 1H), 3.60 (t, J=6.8 Hz, 2H), 6.98-7.06 (m, 2H), 7.34 (t, J=8.0 Hz, 1H), 7.51-7.58 (m, 4H).

### Preparation Example 5

Preparing silicon-containing compound Exp-5

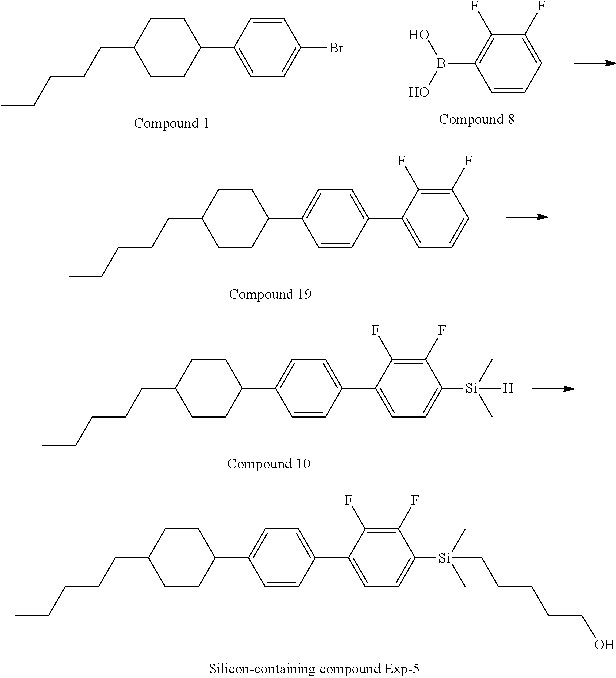 [SMILES: CCCCCC1CCC(c2ccc(Br)cc2)CC1 ; OB(O)c1cccc(F)c1F ; CCCCCC1CCC(c2ccc(-c3cccc(F)c3F)cc2)CC1 ; CCCCCC1CCC(c2ccc(-c3ccc([SiH](C)C)c(F)c3F)cc2)CC1 ; CCCCCC1CCC(c2ccc(-c3ccc([Si](C)(C)CCCCCO)c(F)c3F)cc2)CC1]

Compound 1 (9.8 g, 31.6 mmol), Compound 8 (5.0 g, 31.6 mmol), tetrahydrofuran (125 mL), water (25 mL) and potassium carbonate (19.7 g, 142.4 mmol) were placed in a 500 mL reaction flask and stirred to dissolve. Nitrogen gas was introduced into the reaction flask to deoxygenate for 30 minutes. Then, tetrakis(triphenylphosphine)palladium (1.1 g, 0.949 mmol) was added, and the mixture was heated to reflux for 5 hours to carry out the reaction. After the reaction was completed, an extraction was performed by using ethyl acetate and water, and the organic phase was collected. The solvent of the collected organic phase was removed by using a rotary concentrator. Then, column chromatography was performed to obtain Compound 9. Next, 3.0 g of Compound 9 (8.77 mmol) was dissolved in 20 mL of anhydrous tetrahydrofuran to obtain a solution of Compound 9.

Potassium tert-butoxide (1.3 g, 11.4 mmol) and anhydrous tetrahydrofuran (60 mL) were placed in a 250 mL reaction flask and stirred and mixed. After the dissolution was completed, the reaction flask was cooled to −78° C., and n-butyllithium (2.5 M, 4.9 mL, 12.28 mmol) was slowly added to carry out the reaction for 0.5 hour. Then, the above solution of the compound 9 was added at −78° C., and the reaction was carried out for 1 hour. Next, dimethylchlorosilane (2.5 g, 26.32 mmol) was placed in a reaction flask at −78° C., and the mixture in the reaction flask reacted at 20° C. to 30° C. for 2 hours. After the reaction was completed, the reaction mixture was extracted by using ethyl acetate and water, and the organic phase was collected. The solvent of the collected organic phase was removed by using a rotary concentrator to obtain a crude product. Then, the crude product was purified by column chromatography to obtain Compound 10.

Compound 10 (1.5 g, 3.74 mmol), toluene (30 mL) and platinum-containing catalyst (Pt/C, 5% on carbon, 0.11 g) were placed in a 100 mL double-necked flask. Nitrogen gas was introduced into the double-necked flask. Then, 4-penten-1-ol (0.64 g, 7.49 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain silicon-containing compound Exp-5 (white viscous liquid).

The silicon-containing compound Exp-5 was analyzed by nuclear magnetic resonance spectroscopy, and the obtained spectral information was as follows: ¹H NMR (CDCl₃, 400 MHz): 0.34 (s, 6H), 0.84-0.92 (m, 5H), 1.09-1.59 (m, 20H), 1.85-1.97 (m, 4H), 2.45-2.58 (m, 1H), 3.62 (t, J=6.8 Hz, 2H), 7.13-7.17 (m, 2H), 7.29 (d, J=8.0 Hz, 2H), 7.47 (d, J=8.0 Hz, 2H).

### Preparation Example 6

Preparing silicon-containing compound Exp-6

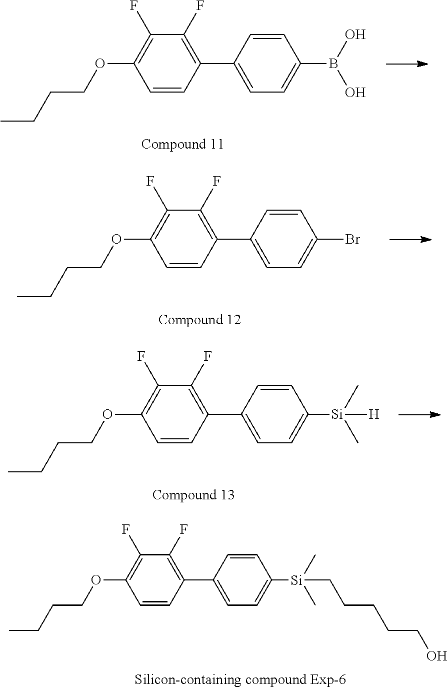 [SMILES: CCCCOc1ccc(-c2ccc(B(O)O)cc2)c(F)c1F ; CCCCOc1ccc(-c2ccc(Br)cc2)c(F)c1F ; CCCCOc1ccc(-c2ccc([SiH](C)C)cc2)c(F)c1F ; CCCCOc1ccc(-c2ccc([Si](C)(C)CCCCCO)cc2)c(F)c1F]

Compound 11 (3.9 g, 17.0 mmol), 1,4-dibromobenzene (4.0 g, 17.0 mmol), tetrahydrofuran (100 mL), water (20 mL) and potassium carbonate (10.6 g, 76.81 mmol) were placed in a 250 mL reaction flask and stirred to dissolve. Nitrogen gas was introduced into the reaction flask to deoxygenate for 30 minutes. Then, tetrakis(triphenylphosphine)palladium (0.98 g, 0.848 mmol) was added, and the mixture was heated to reflux for 5 hours to carry out the reaction. After the reaction was completed, an extraction was performed by using ethyl acetate and water, and the organic phase was collected. The solvent of the collected organic phase was removed by using a rotary concentrator. Then, column chromatography was performed to obtain Compound 12.

Compound 12 (6.0 g, 17.6 mmol) and anhydrous tetrahydrofuran (130 mL) were placed in a 500 mL double-necked flask. Then, n-butyllithium (2.5 M, 8.5 mL, 21.2 mmol) was slowly added to the reaction flask at −78° C., and the reaction was carried out for 1 hour. Next, dimethylchlorosilane (2.5 g, 26.39 mmol) was added to the reaction flask at −78° C., and the reaction was carried out at room temperature (20-30° C.) for 2 hours. After the reaction was completed, dilute hydrochloric acid (1 N, 30 mL) was added. Then, an extraction was performed by using ethyl acetate and water, and the organic phase was collected. The solvent of the collected organic phase was removed by using a rotary concentrator. Then, column chromatography was performed to obtain Compound 13.

Compound 13 (1.5 g, 3.77 mmol), toluene (10 mL) and platinum-containing catalyst (Pt/C, 5% on carbon, 0.15 g) were placed in a 100 mL double-necked flask. Nitrogen gas was introduced into the double-necked flask. Then, 4-penten-1-ol (0.48 g, 5.62 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain silicon-containing compound Exp-6 (white solid).

The silicon-containing compound Exp-6 was analyzed by nuclear magnetic resonance spectroscopy, and the obtained spectral information was as follows: ¹H NMR (CDCl₃, 400 MHz): 0.28 (s, 6H), 0.76-0.80 (m, 2H), 0.99 (t, J=7.6 Hz, 3H), 1.36-1.55 (m, 9H), 1.81-1.84 (m, 2H), 3.61 (t, J=6.4 Hz, 2H), 4.08 (t, J=6.4 Hz, 2H), 6.79-6.81 (m, 1H), 7.07-7.10 (m, 1H), 7.48 (d, J=8.0 Hz, 2H), 7.57 (d, J=8.0 Hz, 2H).

### Preparation Example 7

Preparing silicon-containing compound Exp-7 and silicon-containing compound Exp-8

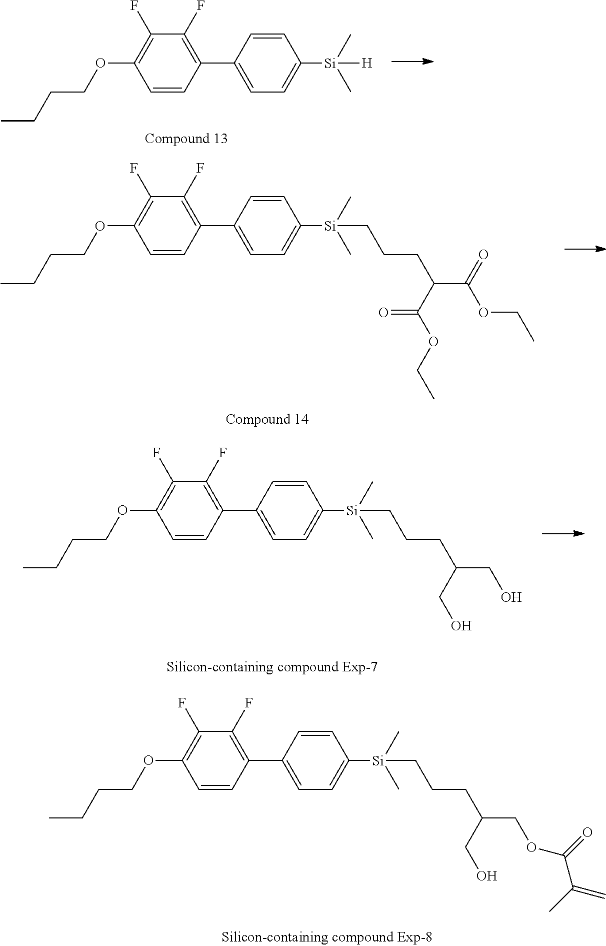

Compound 13 (30 g, 9.38 mmol), toluene (10 mL) and platinum-containing catalyst (Pt/C, 5% on carbon, 0.37 g) were placed in a 100 mL double-necked flask. Nitrogen gas was introduced into the double-necked flask. Then, diethyl allylmalonate (2.81 g, 14.06 mmol) was added and heated to 80° C. for 5 hours to carry out the reaction. After the reaction was completed, the platinum-containing catalyst was removed by filtration. Then, an extraction was performed by using toluene and water, and the organic phase was collected. The solvent of the collected organic phase was removed by using a rotary concentrator. Then, column chromatography was performed to obtain Compound 14.

Lithium aluminum hydride (LAH, 0.4 g, 11.5 mmol) and anhydrous tetrahydrofuran (80 mL) were placed in a 250 mL reaction flask and stirred to dissolve. Then, Compound 14 (3.0 g, 5.7 mmol) was slowly added to the reaction flask at 0° C., and the reaction was carried out for 1 hour. Next, the reaction was carried out at room temperature (20-30° C.) for 4 hours. After the reaction was completed, water was added. Then, an extraction was performed by using ethyl acetate and water, and the organic phase was collected. The solvent of the collected organic phase was removed by using a rotary concentrator. Then, column chromatography was performed to obtain silicon-containing compound Exp-7.

The silicon-containing compound Exp-7 was analyzed by nuclear magnetic resonance spectroscopy, and the obtained spectral information was as follows: ¹H NMR (CDCl₃, 400 MHz): 0.29 (s, 6H), 0.75-0.79 (m, 2H), 0.99 (t, J=7.2 Hz, 3H), 1.25-1.84 (m, 9H), 2.20 (br, 2H), 3.60-3.64 (m, 2H), 3.76-3.79 (m, 2H), 4.08 (t, J=6.4 Hz, 2H), 6.79-6.81 (m, 1H), 7.07-7.10 (m, 1H), 7.48 (d, J=8.0 Hz, 2H), 7.56 (d, J=8.0 Hz, 2H).

The silicon-containing compound Exp-7 (0.5 g, 1.15 mmol), triethylamine (0.12 g, 1.15 mmol) and anhydrous tetrahydrofuran (20 mL) were placed in a 100 mL reaction flask and stirred to dissolve. Then, methylpropionyl chloride (0.12 g, 1.15 mmol) was slowly added to the reaction flask at 0° C., and the reaction was carried out for 2 hours. After the reaction was completed, water was added. Then, an extraction was performed by using ethyl acetate and water, and the organic phase was collected. The solvent of the collected organic phase was removed by using a rotary concentrator. Then, column chromatography was performed to obtain silicon-containing compound Exp-8.

The silicon-containing compound Exp-8 was analyzed by nuclear magnetic resonance spectroscopy, and the obtained spectral information was as follows: ¹H NMR (CDCl₃, 400 MHz): 0.28 (s, 6H), 0.73-0.80 (m, 2H), 0.99 (t, J=7.2 Hz, 3H), 1.12-1.93 (m, 12H), 2.20-2.30 (m, 1H), 3.47-3.60 (m, 2H), 4.06-4.27 (m, 4H), 5.56 (s, 1H), 6.09 (s, 1H), 6.77-6.82 (m, 1H), 7.07-7.11 (m, 1H), 7.48 (d, J=8.0 Hz, 2H), 7.56 (d, J=8.0 Hz, 2H).

### Preparation Example 8

Preparing silicon-containing compound Exp-9

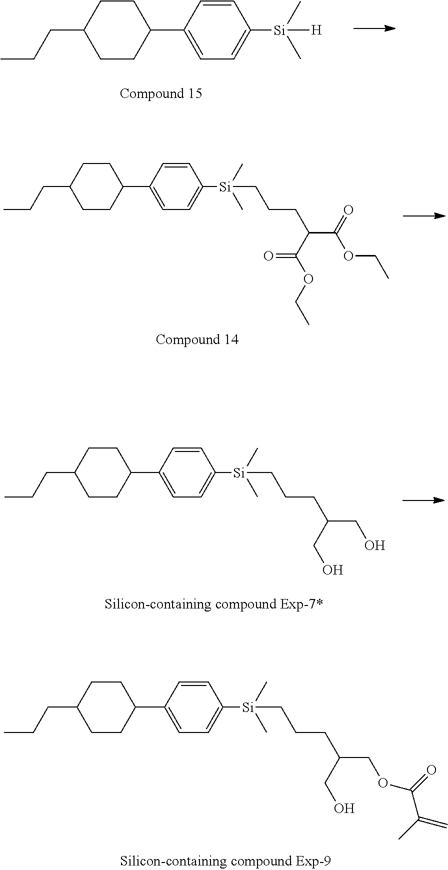

Compound 15 was synthesized in accordance with the procedure of Preparation Example 1. Then, the silicon-containing compound Exp-9 was synthesized in accordance with the procedure of Preparation Example 7 by using Compound 15 as the starting material.

The silicon-containing compound Exp-9 was analyzed by nuclear magnetic resonance spectroscopy, and the obtained spectral information was as follows: ¹H NMR (CDCl₃, 400 MHz): 0.24 (s, 6H), 0.72-0.75 (m, 2H), 0.90 (t, J=7.2 Hz, 3H), 1.06-1.90 (m, 19H), 1.94 (s, 3H), 2.4-2.5 (m, 1H), 3.45-3.60 (m, 2H), 4.11-4.27 (m, 2H), 5.56 (s, 1H), 6.09 (s, 1H), 7.19 (d, J=8.0 Hz, 2H), 7.41 (d, J=8.0 Hz, 2H).

### Preparation Example 9

Preparing silicon-containing compound Exp-10

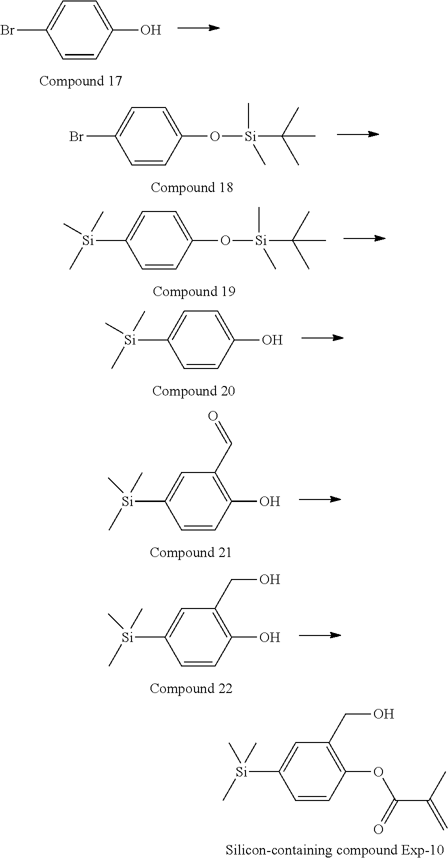

Compound 17 (15.0 g, 86.7 mmol), tert-butyldimethylsilyl chloride (15.0 g, 99.7 mmol) and dichloromethane (200 mL) were placed in a 500 mL reaction flask. Nitrogen gas was introduced into the double-necked flask. Then, imidazole (14.2 g, 208.1 mmol) was added, and the reaction was carried out at room temperature (20-30° C.) for 12 hours. After the reaction was completed, an extraction was performed by using dichloromethane and water, and the organic phase was collected. The solvent of the collected organic phase was removed by using a rotary concentrator. Then, column chromatography was performed to obtain Compound 18.

Compound 18 (15.0 g, 52.3 mmol) and anhydrous tetrahydrofuran (120 mL) were placed in a 500 mL reaction flask and stirred to dissolve. Then, n-butyllithium (2.5 M, 25.1 mL, 62.7 mmol) was slowly added to the reaction flask at −78° C., and the reaction was carried out for 1 hour. Next, trimethylsilyl chloride (9.1 g, 83.6 mmol) was added to the reaction flask at −78° C., and the reaction was carried out at room temperature (20-30° C.) for 2 hours. After the reaction was completed, dilute hydrochloric acid (1 N, 70 mL) was added. Then, an extraction was performed by using ethyl acetate and water, and the organic phase was collected. The solvent of the collected organic phase was removed by using a rotary concentrator. Then, column chromatography was performed to obtain Compound 19.

Compound 19 (23.0 g, 82.1 mmol) and methanol (60 mL) were placed in a 250 mL two-necked flask. Nitrogen gas was introduced into the double-necked flask. Then, potassium hydroxide solution (10 g of potassium hydroxide mixed with 20 mL of water) was added and heated to 70° C. for 4 hours to carry out the reaction. After the reaction was completed, an extraction was performed by using water and ethyl acetate, and the organic phase was collected. The solvent of the collected organic phase was removed by using a rotary concentrator. Then, column chromatography was performed to obtain Compound 20.

Compound 20 (10 g, 60.2 mmol), tetrahydrofuran (120 mL), triethylamine (21.3 g, 210.8 mmol) and magnesium chloride (8.6 g, 90.5 mmol) were placed in a 500 mL reaction flask and stirred. Paraformaldehyde (11.8 g, 392 mmol) was added and heated to reflux for 5 hours to carry out the reaction. After the reaction was completed, dilute hydrochloric acid (1 N, 300 mL) was added. Then, an extraction was performed by using ethyl acetate and water, and the organic phase was collected. The solvent of the collected organic phase was removed by using a rotary concentrator. Then, column chromatography was performed to obtain Compound 21.

Compound 21 (2.0 g, 8.1 mmol), tetrahydrofuran (10 mL) and methanol (20 mL) were placed in a 100 mL reaction flask and stirred to dissolve. Under ice bath, sodium borohydride (0.93 g, 24.4 mmol) was slowly added to the reaction flask, and the reaction was carried out at room temperature for 4 hours. After the reaction was completed, an extraction was performed by using ethyl acetate and water, and the organic phase was collected. The solvent of the collected organic phase was removed by using a rotary concentrator. Then, column chromatography was performed to obtain Compound 22.

Compound 22 (0.9 g, 4.6 mmol), triethylamine (0.46 g, 4.6 mmol) and anhydrous tetrahydrofuran (20 mL) were placed in a 100 mL reaction flask and stirred to dissolve. Then, methylpropionyl chloride (0.58 g, 5.5 mmol) was slowly added to the reaction flask at 0° C., and the reaction was carried out for 2 hours. After the reaction was completed, water was added. Then, an extraction was performed by using ethyl acetate and water, and the organic phase was collected. The solvent of the collected organic phase was removed by using a rotary concentrator. Then, column chromatography was performed to obtain silicon-containing compound Exp-10.

The silicon-containing compound Exp-10 was analyzed by nuclear magnetic resonance spectroscopy, and the obtained spectral information was as follows: ¹H NMR (CDCl₃, 400 MHz): δ 0.24 (s, 9H), 1.94 (s, 3H), 5.21 (s, 2H), 5.63 (s, 1H), 6.21 (s, 1H), 6.92 (d, J=7.6 Hz, 1H), 7.41-7.44 (m, 2H)), 8.22 (br, 1H).

### Preparation Example 10

Preparing silicon-containing compound Exp-11

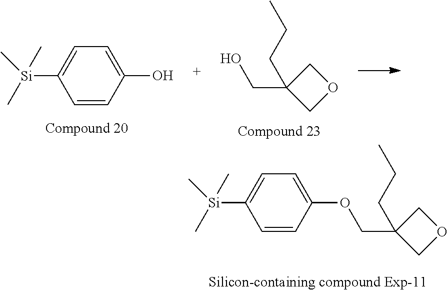

Compound 20 (2.0 g, 12.1 mmol), Compound 23 (2.4 g, 18.1 mmol), triphenylphosphine (6.3 g, 24.1 mmol) and tetrahydrofuran (40 mL) were placed in a 250 mL reaction flask and stirred to dissolve. Then, diisopropyl azodicarboxylate (DIAD, 4.9 mL, 24.1 mmol) was added to the reaction flask, and the reaction was carried out for 4 hours. After the reaction was completed, water was added. Then, an extraction was performed by using ethyl acetate and water, and the organic phase was collected. The solvent of the collected organic phase was removed by using a rotary concentrator. Then, column chromatography was performed to obtain silicon-containing compound Exp-11.

The silicon-containing compound Exp-11 was analyzed by nuclear magnetic resonance spectroscopy, and the obtained spectral information was as follows: ¹H NMR (CDCl₃, 400 MHz): δ 0.25 (s, 9H), 0.90-0.97 (m, 3H), 1.31-1.37 (m, 2H), 1.80-1.84 (m, 2H), 4.09 (s, 2H), 4.5 (d, J=6.0 Hz, 2H), 4.7 (d, J=6.0 Hz, 2H), 6.94 (d, J=6.8 Hz, 2H), 7.46 (d, J=6.8 Hz, 2H).

### Preparation Example 11

Preparing silicon-containing compound Exp-12 and reference compound Ref-4

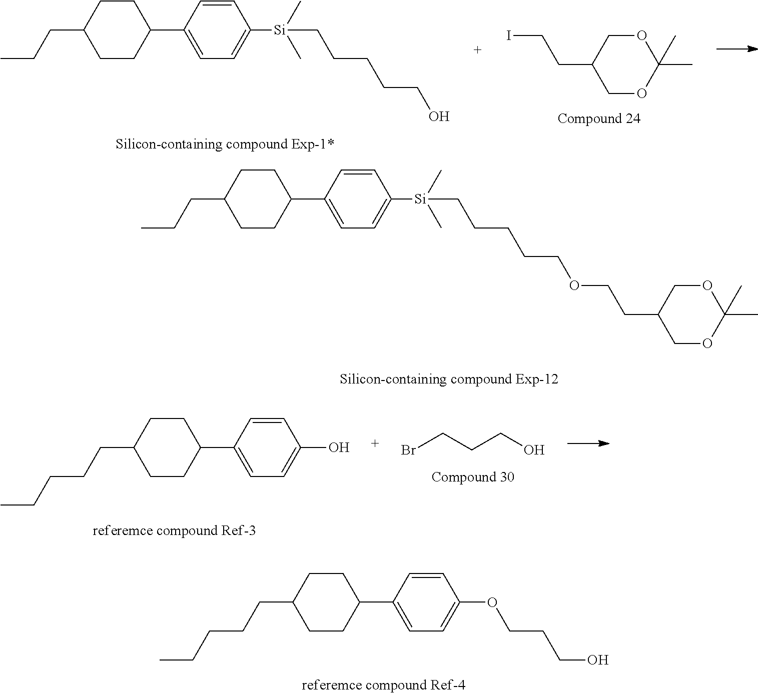

Silicon-containing compound Exp-1* was synthesized in accordance with the procedure of Preparation Example 1. Then, sodium hydride (NaH, 0.1 g), dimethylformamide (DMF, 15 mL), and silicon-containing compound Exp-1* (1.0 g) were added and stirred for 30 minutes. Next, Compound 24 (0.9 g) was added and heated to 90° C. After 18 hours, the degree of reaction was checked by thin layer chromatography (TLC, elution solution: 5% hexane/ethyl acetate (Hex/EA)). After the reaction was completed, water (30 mL) was added to terminate the reaction. Then, an extraction was performed by using ethyl acetate, and the organic phase was collected and dehydrated by anhydrous magnesium sulfate. Next, the organic phase was concentrated on a rotary concentrator, and purified by silica gel column chromatography (elution solution: 5% Hex/EA) to obtain silicon-containing compound Exp-12. Reference compound Ref-4 can be synthesized in accordance with the procedure for preparing silicon-containing compound Exp-12 by using reference compound Ref-3 and Compound 30 as starting materials.

The silicon-containing compound Exp-12 was analyzed by nuclear magnetic resonance spectroscopy, and the obtained spectral information was as follows: ¹H NMR (CDCl₃, 400 MHz): δ 0.24 (s, 6H), 0.74 (t, J=7.2 Hz, 2H), 0.90 (t, J=7.2 Hz, 2H), 1.05-1.57 (m, 21H), 1.39 (s, 3H), 1.40 (s, 3H), 1.83-1.90 (m, 4H), 2.41-2.49 (m, 1H), 3.36-3.39 (m, 4H), 3.57 (d, J=12 Hz, 2H), 3.68 (d, J=12 Hz, 2H), 7.23 (d, J=8.8 Hz, 2H), 7.22 (d, J=8.8 Hz, 2H).

### Preparation Example 12

Preparing reference compound Ref-1

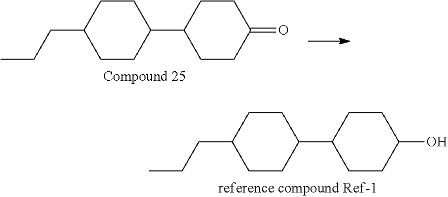 [SMILES: CCCC1CCC(C2CCC(=O)CC2)CC1 ; CCCC1CCC(C2CCC(O)CC2)CC1]

Lithium aluminum hydride (0.4 g, 11.5 mmol) and anhydrous tetrahydrofuran (80 mL) were placed in a 250 mL reaction flask and stirred to dissolve. Then, Compound 25 (1.27 g, 5.7 mmol) was slowly added to the reaction flask at 0° C., and the reaction was carried out for 1 hour. Next, the reaction was carried out at room temperature (20-30° C.) for 4 hours. After the reaction was completed, water was added to the reaction flask. Then, an extraction was performed by using ethyl acetate and water, and the organic phase was collected. The solvent of the collected organic phase was removed by using a rotary concentrator. Then, column chromatography was performed to obtain reference compound Ref-1.

### Preparation Example 13

Preparing reference compound Ref-2 and reference compound Ref-3

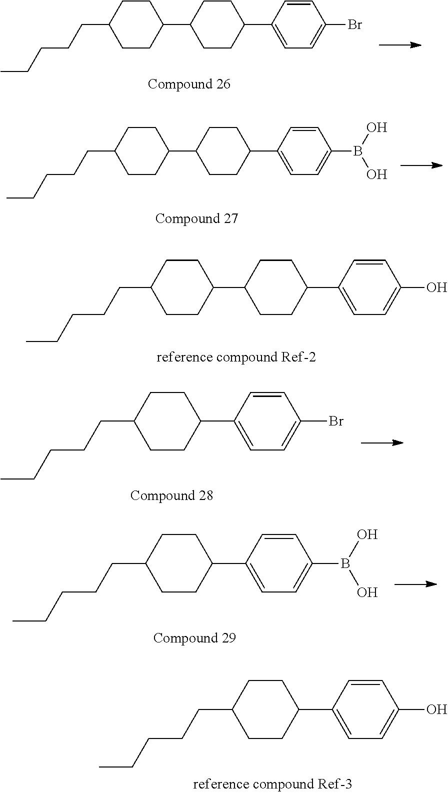 [SMILES: CCCCCC1CCC(C2CCC(c3ccc(Br)cc3)CC2)CC1 ; CCCCCC1CCC(C2CCC(c3ccc(B(O)O)cc3)CC2)CC1 ; CCCCCC1CCC(C2CCC(c3ccc(O)cc3)CC2)CC1 ; CCCCCC1CCC(c2ccc(Br)cc2)CC1 ; CCCCCC1CCC(c2ccc(B(O)O)cc2)CC1 ; CCCCCC1CCC(c2ccc(O)cc2)CC1]

Compound 26 (10 g, 25.6 mmol) and anhydrous tetrahydrofuran (150 mL) were placed in a 500 mL reaction flask and stirred and mixed. After the dissolution was completed, the reaction flask was cooled to −78° C., and n-butyllithium (2.5 M, 12.3 mL, 30.7 mmol) was slowly added to carry out the reaction for 0.5 hour. Then, triisopropyl borate (7.2 g, 38.4 mmol) was added at −78° C., and the mixture in the reaction flask reacted at 0° C. for 1 hour. After the reaction was completed, dilute hydrochloric acid (1 N, 40 mL) was added to the reaction flask and stirred at 20° C. to 30° C. for 0.5 hour. The reaction mixture was extracted by using ethyl acetate and water, and the organic phase was collected. The solvent of the collected organic phase was removed by using a rotary concentrator to obtain a crude product. Then, the crude product was purified by column chromatography to obtain Compound 27 (white solid).

Compound 27 (10 g, 30.5 mmol) and tetrahydrofuran (120 mL) were placed in a 500 mL reaction flask and stirred to dissolve. Under ice bath, hydrogen peroxide (30-35%, 120 mL) was slowly added to the reaction flask, and the reaction was carried out at room temperature for 2 hours. After the reaction was completed, an extraction was performed by using ethyl acetate and water, and the organic phase was collected. The solvent of the collected organic phase was removed by using a rotary concentrator. Then, column chromatography was performed to obtain reference compound Ref-2.

Compound 28 can be synthesized in accordance with the procedure for preparing reference compound Ref-2. Reference compound Ref-3 can be synthesized by using Compound 28 as a starting material, and the synthesis step is as shown in the above flow chart.

In the following Examples and Reference Examples, all of the liquid-crystal compositions were prepared by forming the mother liquid formed by the molecules of the formula (II) in accordance with Table 7, and then, 0.3 wt % of molecule of the formula (III) shown in Table 7 was added. Next, the molecules shown in Table 8 were additionally added to the above liquid-crystal composition as needed. For example, in Table 9, the liquid-crystal composition of Example 1 is 100 wt % of the mother liquor formed by the molecules of formula (II) shown in Table 7, and 0.3 wt % of the molecule of formula (III) and 1 wt % of the silicon-containing compound Exp-1 is further added. Furthermore, the liquid-crystal composition of the Blank Experimental Example was obtained by adding 0.3 wt % of the molecule of the formula (III) to 100 wt % of the mother liquid formed by the molecules of the formula (II) shown in Table 7. In other words, the liquid-crystal composition of the Blank Experimental Example did not add any of the molecules listed in Table 8.

Production of the Liquid-Crystal Display Device

In 100 wt % of the mother liquid formed by the molecules of the formula (II), 0.3 wt % of the molecule of the formula (III) shown in Table 7 and the reference compound or the silicon-containing compound shown in Table 8 were added, and the mixture was uniformly mixed and heated to the clearing point. Then, it was cooled to room temperature to form a liquid-crystal composition of a Blank Experimental Example, a Reference Example or an Example. The liquid-crystal composition of the Blank Experimental Example, the Reference Example or the Example is injected between two indium tin oxide (ITO) substrates having an interval of 3.5 μm and having no alignment layer to form the liquid-crystal display element of the Blank Experimental Example, the Reference Example or the Example, respectively. A DC voltage of 12 V and irradiation of ultraviolet light (peak wavelength: 313 nm) were applied to the liquid-crystal display element to form the liquid-crystal display device of the Blank Experimental Example, the Reference Example or the Example.

Properties of the Liquid-Crystal Composition

[Vertical Alignment]

The liquid-crystal display device is disposed in a polarizing microscope in which a polarizing element and an analyzer are arranged orthogonally. The element was irradiated with light from below, and the presence or absence of light leakage was observed to judge the vertical alignment.

O: Light does not transmitted through any part of the element (the whole piece is uniform and has no light transmission). This result indicates that the device has good vertical alignment.

Δ: Light transmits a part of the element. This result indicates that the device has vertical alignment, but the degree of vertical alignment is lower.

X: Light passes through all parts of the element (the whole piece is uniformly transmitted by light). This result indicates that the device has no vertical alignment.

[Voltage Holding Ratio]

A DC voltage (charge voltage of 1 V or 5 V, operating frequency of 60 Hz, pulse width of 60 μsec) is applied to the liquid-crystal display of the Blank Experimental Example, the Reference Example or the Example at an ambient temperature of 60° C. The voltage value V2 after the application was released to 16.67 msec was measured by the liquid-crystal physical parameter measuring instrument (product number: ALCT-IV1, manufactured by INSTEC Co., Ltd.). The formula for calculating the voltage holding ratio (VHR) of the liquid-crystal display device is as follows:

VHR=(V2/applied voltage value)×100%.

| | Molecules of | Amount added | Vertical |
|---|---|---|---|
| | Table 8 | (wt %) | alignment |
| Blank | None | — | X |
| Experimental | | | |
| Example | | | |
| Reference | Ref-1 | 1.5 | Δ |
| Example 1 | | | |
| Reference | Ref-2 | 1.0 | Δ |
| Example 2 | | | |
| Reference | Ref-3 | 1.0 | X |
| Example 3 | | | |
| Reference | Ref-4 | 1.0 | Δ |
| Example 4 | | | |
| Example 1 | Exp-1 | 1.5 | ◯ |
| Example 2 | Exp-2 | 1.0 | Δ |
| Example 3 | Exp-2 | 2.0 | ◯ |
| Example 4 | Exp-3 | 1.5 | ◯ |
| Example 5 | Exp-4 | 1.5 | Δ |
| Example 6 | Exp-5 | 1.5 | ◯ |
| Example 7 | Exp-7 | 0.2 | Δ |
| Example 8 | Exp-8 | 3.0 | Δ |
| Example 9 | Exp-9 | 3.0 | ◯ |
| Example 10 | Exp-2 | 10.0 | ◯ |
| Example 11 | Exp-2 | 20.0 | ◯ |
| Example 12 | Exp-10 | 3.0 | Δ |
| Example 13 | Exp-11 | 3.0 | Δ |
| Example 14 | Exp-12 | 3.0 | Δ |

TABLE 10

| | | Amount | | |
|---|---|---|---|---|
| | Molecules | added | VHR | VHR |
| No. | of Table 8 | (wt %) | (1 V) | (5 V) |
| Blank | None | — | 94.47 | 98.10 |
| Experimental | | | | |
| Example | | | | |
| Reference | Ref-1 | 1.5 | 91.54 | 96.22 |
| Example 1 | | | | |
| Reference | Ref-2 | 1.0 | 81.34 | 92.91 |
| Example 2 | | | | |
| Reference | Ref-4 | 1.0 | 83.17 | 90.27 |
| Example 4 | | | | |
| Example 1 | Exp-1 | 1.5 | 95.54 | 97.74 |
| Example 2 | Exp-2 | 1.0 | 93.29 | 96.30 |
| Example 3 | Exp-2 | 2.0 | 89.84 | 96.30 |
| Example 4 | Exp-3 | 1.5 | 95.66 | 97.90 |
| Example 5 | Exp-4 | 1.5 | 90.44 | 94.47 |
| Example 6 | Exp-5 | 1.5 | 93.12 | 96.77 |

Referring to the Blank Experimental Example of Table 9, because the molecule of the Formula (II-1), the molecule of the Formula (II-2), and the molecule of the Formula (III) do not have the anchoring group as described above, the liquid-crystal molecule cannot be vertical aligned.

Referring to Examples 1-14 of Table 9, Examples 1-14 all include an silicon-containing compound of the Formula (I), and the silicon-containing compounds of the Formula (I) include at least one anchoring group. The results show that the liquid-crystal molecules of Examples 1-14 are all vertically aligned, and in particular, the liquid-crystal molecules of Examples 1, 3, 4, 6, 9, 10, and 11 were vertically aligned well. Accordingly, it should be understood that the silicon-containing compound of the Formula (I) can significantly improve the degree of vertical alignment of the liquid-crystal molecules.

Furthermore, referring to Examples 2, 3, 10, and 11 of Table 9, these examples all used the silicon-containing compound Exp-2 which the difference comes from the amounts added. The results show that the liquid-crystal molecules were vertically aligned well as long as the amount added was over a specific value (for example, 2.0 wt % of Example 3). Accordingly, it should be understood that the silicon-containing compound of the Formula (I) requires only a very low amount to be added to improve the degree of vertical alignment of the liquid-crystal molecules.

Referring to Reference Example 4 and Example 1 of Table 9, Reference Example Ref-4 and the silicon-containing compound Exp-1 were used in Reference Example 4 and Example 1, respectively. The structure of the reference compound Ref-4 is similar to that of the silicon-containing compound Exp-1, except that the reference compound Ref-4 does not include a silicon atom. The results show that the voltage holding ratio (applied voltage of 1 V or 5 V) of Example 1 is superior to the voltage holding ratio of Reference Example 4. Similarly, referring to Reference Example 4 and Embodiment 2 of Table 9, and referring to Reference Example 2 and Embodiment 4 of Table 9, the voltage holding ratio of the Example is superior to the voltage holding ratio of the Reference Example. Accordingly, it should be understood that the silicon-containing compound of the Formula (I) can significantly improve the voltage holding ratio of the liquid-crystal composition.

In addition, referring to Examples 1-6 of Table 9, Examples 1-6 all include a silicon-containing compound of the Formula (I), and the silicon-containing compounds of the Formula (I) include at least one silicon atom. The results show that the liquid-crystal compositions of Examples 1-6 all had good voltage holding ratio.

In summary, the silicon-containing compound of the present disclosure can have excellent vertical alignment ability while having a high voltage holding ratio. By adding the above-mentioned silicon-containing compound as an additive to the liquid-crystal composition, it is possible to realize a state in which most of the liquid-crystal molecules are vertically aligned well without using a conventional alignment film. Furthermore, the liquid-crystal display device using the silicon-containing compound of the present disclosure can reduce the occurrence of defects while having a high voltage holding ratio. In addition, the content of the silicon-containing compound can be adjusted to balance the degree of the vertical alignment and the voltage holding ratio of the liquid-crystal composition.

Although the disclosure has been described by way of example and in terms of the preferred embodiments, it should be understood that various modifications and similar arrangements (as would be apparent to those skilled in the art) can be made herein without departing from the spirit and scope of the disclosure as defined by the appended claims.

What is claimed is:

1. A silicon-containing compound represented by Formula (I): 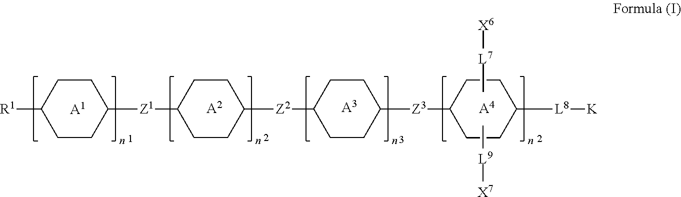
wherein
K represents 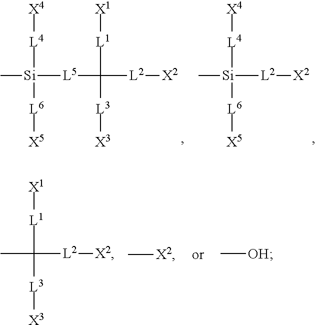
R¹ represents fluorine, chlorine, hydrogen, a C₁-C₂₀ linear alkyl group, a C₃-C₂₀ branched alkyl group, a C₁-C₂₀ linear alkoxy group, or a C₃-C₂₀ branched alkoxy group, wherein the C₁-C₂₀ linear alkyl group, the C₃-C₂₀ branched alkyl group, the C₁-C₂₀ linear alkoxy group, or the C₃-C₂₀ branched alkoxy group is unsubstituted or at least one —CH₂— of the C₁-C₂₀ linear alkyl group, the C₃-C₂₀ branched alkyl group, the C₁-C₂₀ linear alkoxy group, or the C₃-C₂₀ branched alkoxy group is substituted by —SiR^{a}₂—, —C≡C—, —CH═CH—, —CF₂O—, —O—, —COO—, —OCO—, or —OOC—, and/or at least one hydrogen atom of the C₁-C₂₀ linear alkyl group, the C₃-C₂₀ branched alkyl group, the C₁-C₂₀ linear alkoxy group, or the C₃-C₂₀ branched alkoxy group is substituted by a halogen atom, and wherein R^{a} represents a C₁-C₁₀ linear alkyl group or a C₃-C₁₀ branched alkyl group, and two R^{a} groups bonded to the same Si atom are identical to each other or different from each other;
each of A¹, A², A³ and A⁴ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the tetrahydronaphthalene-2,6-diyl group, or the indane-2,5-diyl group is unsubstituted or at least one hydrogen atom of the 1,4-phenylene group, the 1,4-cyclohexylene group, the tetrahydronaphthalene-2,6-diyl group, or the indane-2,5-diyl group is substituted by a halogen atom or a CN group, and/or at least one —CH₂— of the 1,4-phenylene group, the 1,4-cyclohexylene group, the tetrahydronaphthalene-2,6-diyl group, or the indane-2,5-diyl group is substituted by —O—, —N— or —S—, and wherein the —O—, —N—, and —S— do not directly bond to one another;
each of Z¹, Z², and Z³ independently represents a single bond, —CH₂—CH₂—, —C≡C—, —CH═CH—, —CF₂O—, —OCF₂—, —CH₂O—, —OCH₂—, —COO—, —OCO—, —OOC—, —CF₂—CF₂—, or —CF═CF—;
each of L¹, L², L³, L⁴, L⁵, L⁶, L⁷, L⁸ and L⁹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by —C≡C—, —CH═CH—, —CF₂O—, —O—, —COO—, —OCO—, or —OOC—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom, and wherein L⁴, L⁵, L⁶, L⁷ and L⁹ are unsubstituted or at least one carbon atom of L⁴, L⁵, L⁶, L⁷ and L⁹ is substituted by a silicon atom;
each of X¹, X², X³, X⁴, X⁵, X⁶, and X⁷ independently represents hydrogen, —OH, 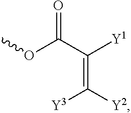
or any one of the following: 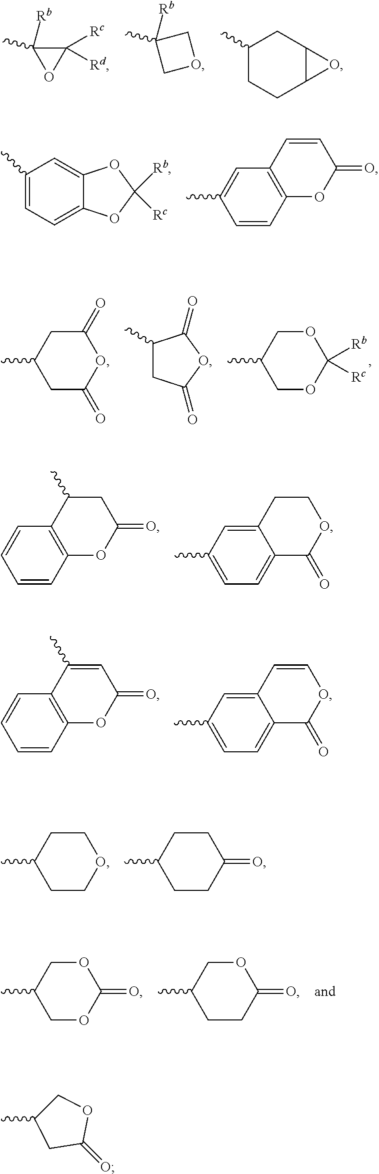
wherein Y¹ represents —OH, hydrogen, a C₁-C₁₅ alkyl group, or a C₂-C₁₅ alkenyl group, and the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH or any one of the following: 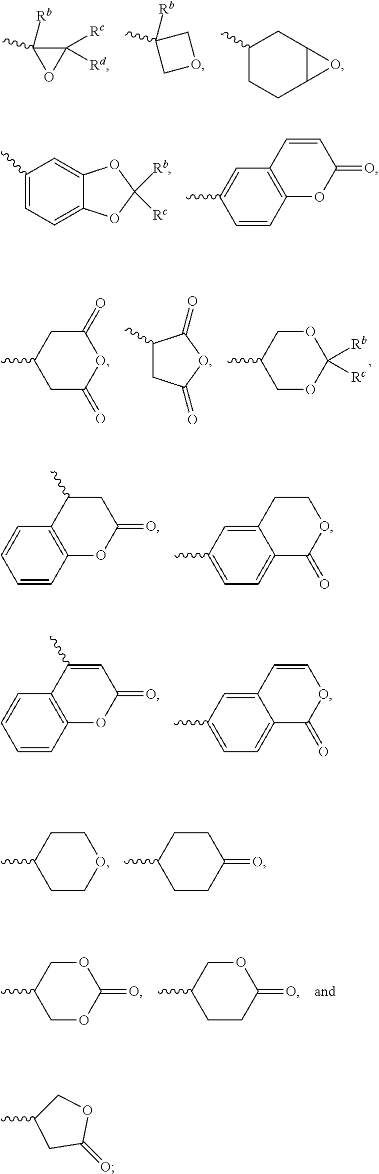
each of Y² and Y³ independently represents hydrogen, halogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by a halogen atom;
each of R^{b}, R^{c}, and R^{d} independently represents fluorine, chlorine, hydrogen, a C₁-C₁₀ linear alkyl group, a C₃-C₁₀ branched alkyl group, a C₁-C₁₀ linear alkoxy group, or a C₃-C₁₀ branched alkoxy group, wherein the C₁-C₁₀ linear alkyl group, the C₃-C₁₀ branched alkyl group, the C₁-C₁₀ linear alkoxy group, or the C₃-C₁₀ branched alkoxy group is unsubstituted or at least one —CH₂— of the C₁-C₁₀ linear alkyl group, the C₃-C₁₀ branched alkyl group, the C₁-C₁₀ linear alkoxy group, or the C₃-C₁₀ branched alkoxy group is substituted by —CH═CH—, —CF₂O—, —O—, —COO—, —OCO—, or —OOC—, and/or at least one hydrogen atom of the C₁-C₁₀ linear alkyl group, the C₃-C₁₀ branched alkyl group, the C₁-C₁₀ linear alkoxy group, or the C₃-C₁₀ branched alkoxy group is substituted by a halogen atom;
wherein at least one of X¹, X², X³, X⁴, X⁵, X⁶, and X⁷ represents —OH or any one of the following: 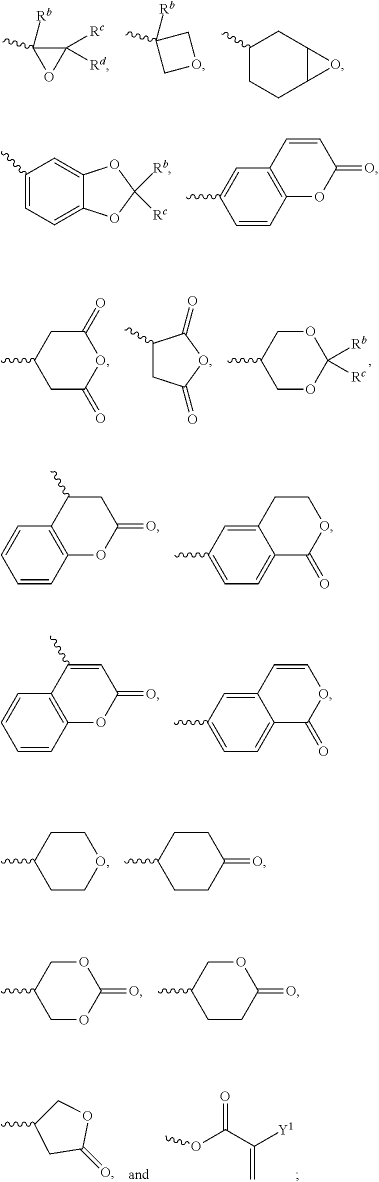
wherein Y1 represents —OH, a C₁-C₁₅ alkyl group, or a C₂-C₁₅ alkenyl group, and wherein at least one hydrogen atom of the C₁-C₁₅ alkyl group or the C₂-C₁₅ alkenyl group is substituted by —OH or any one of the following: 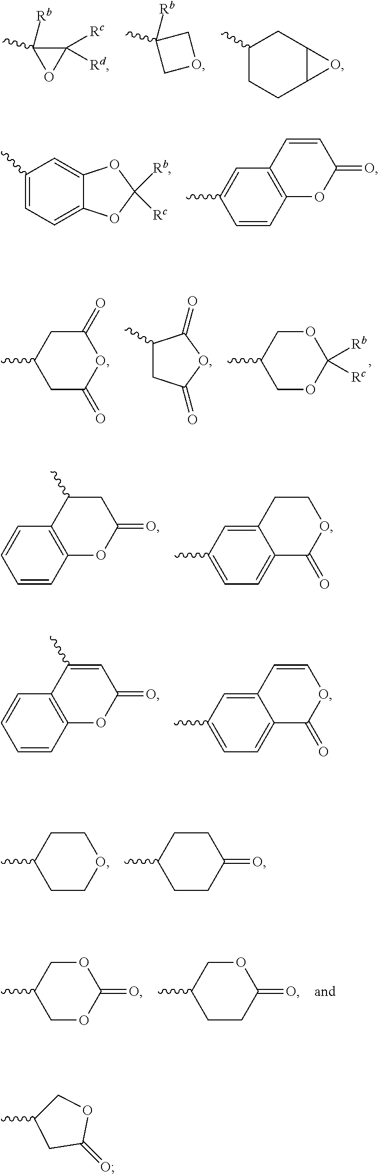
wherein at most two of X, X², X³, X⁴, X⁵, X⁶, and X⁷ represents —OH;
wherein when R¹ does not comprise silicon, K represents 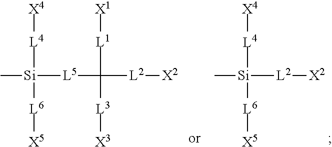
each of n¹, n², n³, and n⁴ independently represents 0 or 1, and wherein at least one of n¹, n², n³, and n⁴ does not represent 0; and
wherein in the Formula (I), a silicon atom does not directly bond to another silicon atom, and a silicon atom does not directly bond to an oxygen atom.

2. The silicon-containing compound as claimed in claim 1, wherein at least one of X¹, X², X³, X⁴, X⁵, X⁶, and X⁷ represents

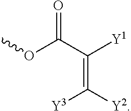

3. The silicon-containing compound as claimed in claim 1, wherein R¹ represents a C₁-C₁₈ alkyl group or a C₁-C₁₈ alkoxy group, and one —CH₂— of the C₁-C₁₈ alkyl group or the C₁-C₁₈ alkoxy group is substituted by —SiR^{a}₂—, wherein R^{a} represents a C₁-C₁₀ linear alkyl group or a C₃-C₁₀ branched alkyl group, and wherein K represents,

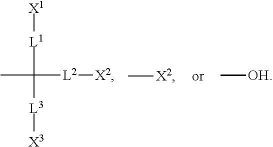

4. The silicon-containing compound as claimed in claim 1, wherein when K represents 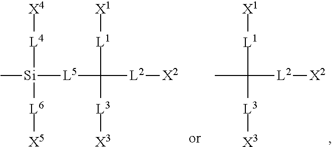
a chain length of L¹ is shorter than a chain length of L³, and a chain length of L² is shorter than the chain length of L³.

5. The silicon-containing compound as claimed in claim 4, wherein each of L¹ and L² independently represents a single bond, a C₁-C₈ alkylene group, a C₂-C₈ alkenylene group, or a C₂-C₈ alkynylene group.

6. The silicon-containing compound as claimed in claim 1, wherein the silicon-containing compound is represented by Formula (I′): 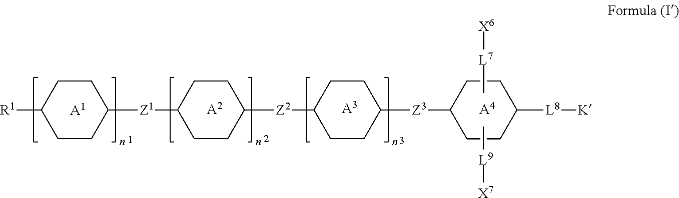
wherein
when R¹ does not comprise silicon, K′ represents 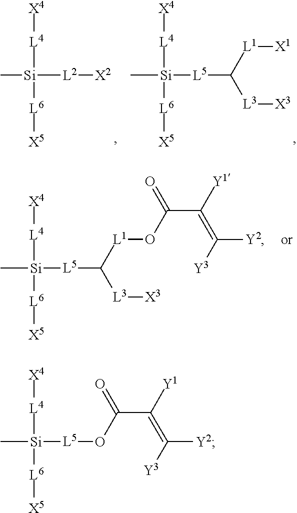
when R¹ comprises silicon, K′ represents 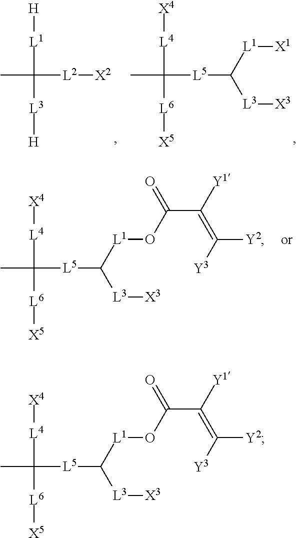
the definitions of R¹, A¹, A², A³, A⁴, Z¹, Z², Z³, L¹, L², L³, L⁴, L⁵, L⁶, L⁷, L⁸, L⁹, X⁴, X⁵, X⁶, X⁷, Y¹, Y², Y³, n¹, n², and n³ are respectively the same as the definitions of R¹, A¹, A², A³, A⁴, Z¹, Z², Z³, L¹, L², L³, L⁴, L⁵, L⁶, L⁷, L⁸, L⁹, X⁴, X⁵, X⁶, X⁷, Y¹, Y², Y³, n¹, n², and n³ defined in claim 1;
each of X¹, X², and X³ independently represents —OH or any one of the following: 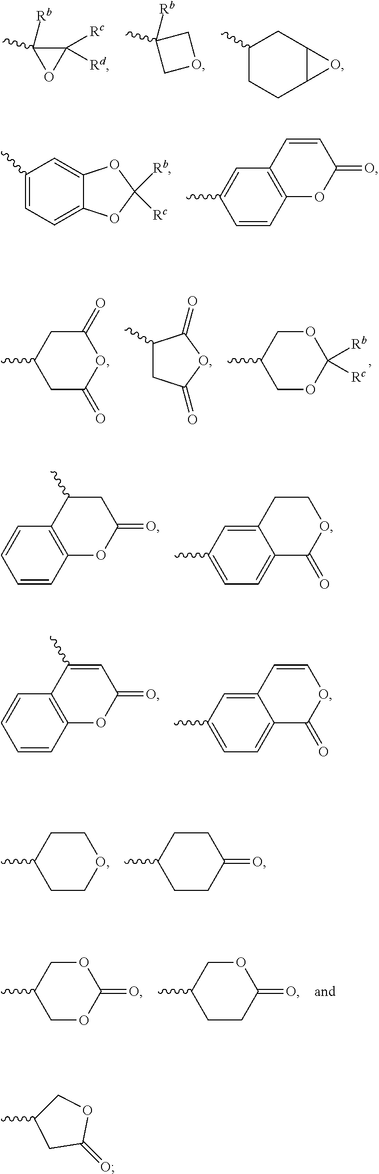
and
Y¹ represents hydrogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH.

7. The silicon-containing compound as claimed in claim 6, wherein the silicon-containing compound is represented by Formula (I-A-1), Formula (I-B-1), Formula (I-C-1), Formula (I-D-1), or Formula (I-D-2): 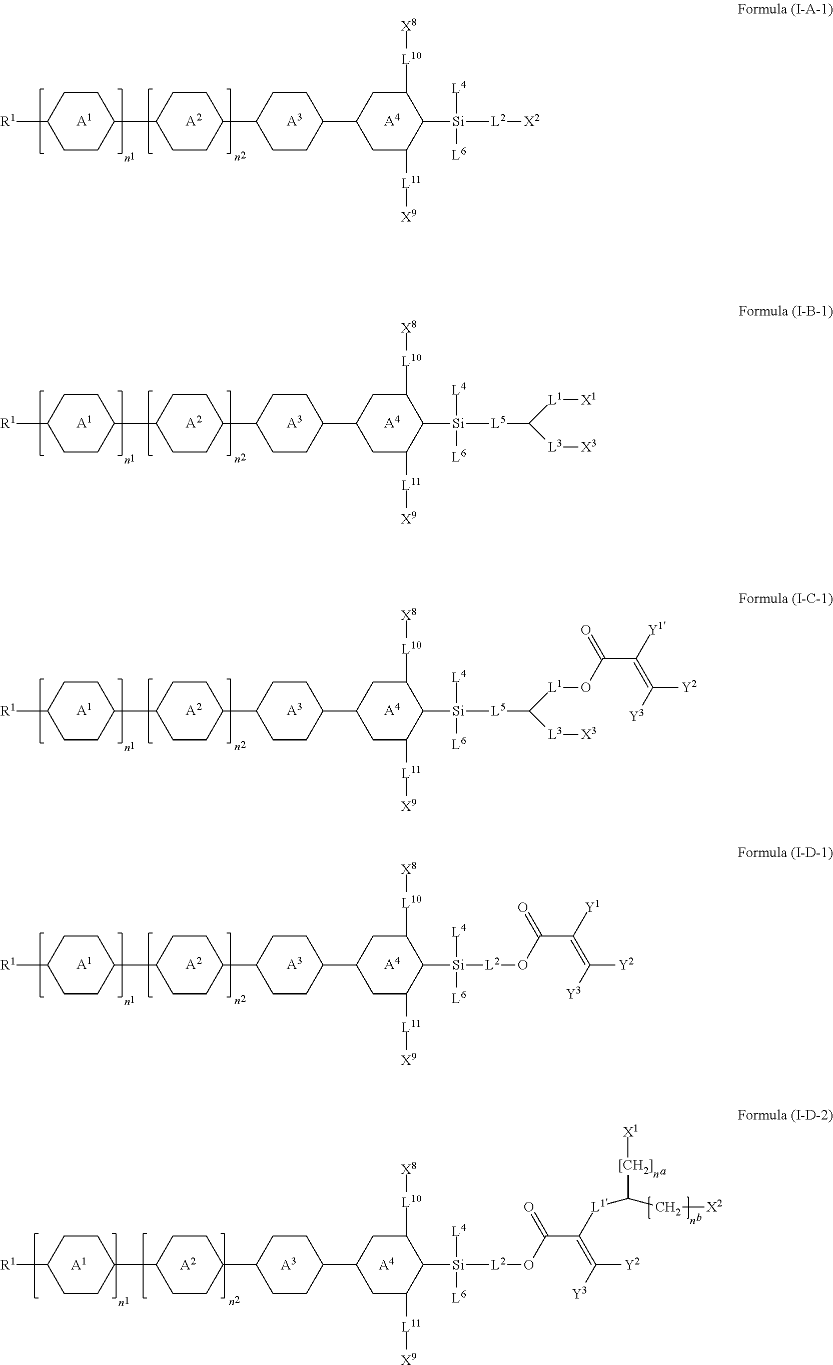
wherein
the definitions of R¹, L¹, L², L³, L⁴, L⁵, L⁶, Y¹, Y², Y³, n¹, and n² are respectively the same as the definitions of R¹, L¹, L², L³, L⁴, L⁵, L⁶, Y¹, Y², Y³, n¹, and n² defined in claim 1;
each of A¹, A², A³ and A⁴ independently represents a 1,4-phenylene group, a tetrahydronaphthalene-2,6-diyl group, or a 1,4-cyclohexylene group, wherein the 1,4-phenylene group, the tetrahydronaphthalene-2,6-diyl group, or the 1,4-cyclohexylene group is unsubstituted or at least one hydrogen atom of the 1,4-phenylene group, the tetrahydronaphthalene-2,6-diyl group, or the 1,4-cyclohexylene group is substituted by a halogen atom, and/or at least one —CH₂— of the 1,4-phenylene group, the tetrahydronaphthalene-2,6-diyl group, or the 1,4-cyclohexylene group is substituted by —O—, and wherein the —O— do not directly bond to another —O—;
the definitions of X¹, X², and X³ are respectively the same as the definitions of X¹, X², and X³ defined in claim 6;
each of X⁸ and X⁹ independently represents hydrogen, 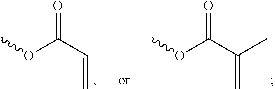
L^{1′} represents a single bond, a C₁-C₅ linear alkylene group, a C₃-C₅ branched alkylene group, a C₁-C₅ linear alkyleneoxy group, or a C₃-C₅ branched alkyleneoxy group, wherein the C₁-C₅ linear alkylene group, the C₃-C₅ branched alkylene group, the C₁-C₅ linear alkyleneoxy group, or the C₃-C₅ branched alkyleneoxy group is unsubstituted or at least one —CH₂— of the C₁-C₅ linear alkylene group, the C₃-C₅ branched alkylene group, the C₁-C₅ linear alkyleneoxy group, or the C₃-C₅ branched alkyleneoxy group is substituted by —O— or —COO—, and/or at least one hydrogen atom of the C₁-C₅ linear alkylene group, the C₃-C₅ branched alkylene group, the C₁-C₅ linear alkyleneoxy group, or the C₃-C₅ branched alkyleneoxy group is substituted by a halogen atom;
each of L¹⁰ and L¹¹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by —O— or —COO—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom;
each of n^{a} and n^{b} independently represents an integer of 0 to 10, and the sum of n^{a} and n^{b} is not greater than 10; and
Y^{1′} represents hydrogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH.

8. The silicon-containing compound as claimed in claim 6, wherein the silicon-containing compound is represented by Formula (I-A-2), Formula (I-B-2), Formula (I-C-2), Formula (I-D-3), or Formula (I-D-4): 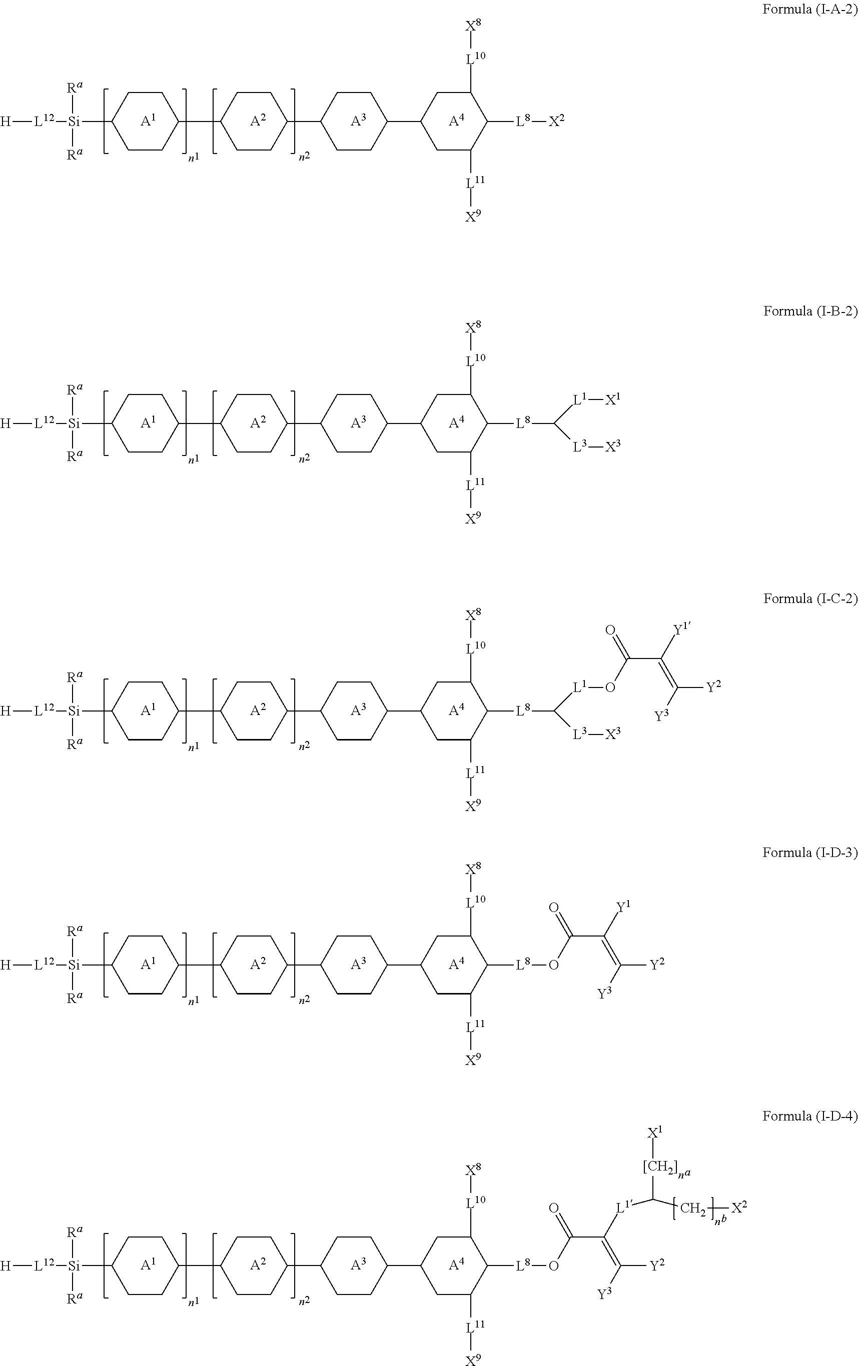
wherein
the definitions of R^{a}, L⁸, Y¹, Y², Y³, n¹, and n² are respectively the same as the definitions of R^{a}, L⁸, Y¹, Y², Y³, n¹, and n² defined in claim 1;
each of A¹, A², A³ and A⁴ independently represents a 1,4-phenylene group, a tetrahydronaphthalene-2,6-diyl group, or a 1,4-cyclohexylene group, wherein the 1,4-phenylene group, the tetrahydronaphthalene-2,6-diyl group, or the 1,4-cyclohexylene group is unsubstituted or at least one hydrogen atom of the 1,4-phenylene group, the tetrahydronaphthalene-2,6-diyl group, or the 1,4-cyclohexylene group is substituted by a halogen atom, and/or at least one —CH₂— of the 1,4-phenylene group, the tetrahydronaphthalene-2,6-diyl group, or the 1,4-cyclohexylene group is substituted by —O—, and wherein the —O— do not directly bond to another —O—;
the definitions of X¹, X², and X³ are respectively the same as the definitions of X¹, X², and X³ defined in claim 6;
each of X⁸ and X⁹ independently represents hydrogen, 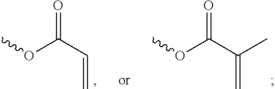
L^{1′} represents a single bond, a C₁-C₅ linear alkylene group, a C₃-C₅ branched alkylene group, a C₁-C₅ linear alkyleneoxy group, or a C₃-C₅ branched alkyleneoxy group, wherein the C₁-C₅ linear alkylene group, the C₃-C₅ branched alkylene group, the C₁-C₅ linear alkyleneoxy group, or the C₃-C₅ branched alkyleneoxy group is unsubstituted or at least one —CH₂— of the C₁-C₅ linear alkylene group, the C₃-C₅ branched alkylene group, the C₁-C₅ linear alkyleneoxy group, or the C₃-C₅ branched alkyleneoxy group is substituted by —O— or —COO—, and/or at least one hydrogen atom of the C₁-C₅ linear alkylene group, the C₃-C₅ branched alkylene group, the C₁-C₅ linear alkyleneoxy group, or the C₃-C₅ branched alkyleneoxy group is substituted by a halogen atom;
each of L¹⁰ and L¹¹ independently represents a single bond, a C₁-C₁₅ linear alkylene group, a C₃-C₁₅ branched alkylene group, a C₁-C₁₅ linear alkyleneoxy group, or a C₃-C₁₅ branched alkyleneoxy group, wherein the C₁-C₁₅ linear alkylene group, the C₃-C₁₅ branched alkylene group, the C₁-C₁₅ linear alkyleneoxy group, or the C₃-C₁₅ branched alkyleneoxy group is unsubstituted or at least one —CH₂— of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by —O— or —COO—, and/or at least one hydrogen atom of the C₁-C₁₅ linear alkylene group, the C₃-C₁₅ branched alkylene group, the C₁-C₁₅ linear alkyleneoxy group, or the C₃-C₁₅ branched alkyleneoxy group is substituted by a halogen atom;
L¹² represents a single bond, a C₁-C₁₈ linear alkylene group, a C₃-C₁₈ branched alkylene group, a C₁-C₁₈ linear alkyleneoxy group, or a C₃-C₁₈ branched alkyleneoxy group, wherein the C₁-C₁₈ linear alkylene group, the C₃-C₁₈ branched alkylene group, the C₁-C₁₈ linear alkyleneoxy group, or the C₃-C₁₈ branched alkyleneoxy group is unsubstituted or at least one —CH₂— of the C₁-C₁₈ linear alkylene group, the C₃-C₁₈ branched alkylene group, the C₁-C₁₈ linear alkyleneoxy group, or the C₃-C₁₈ branched alkyleneoxy group is substituted by —CH═CH—, —CF₂O—, —O—, —COO—, —OCO—, or —OOC—, and/or at least one hydrogen atom of the C₁-C₁₈ linear alkylene group, the C₃-C₁₈ branched alkylene group, the C₁-C₁₈ linear alkyleneoxy group, or the C₃-C₁₈ branched alkyleneoxy group is substituted by a halogen atom;
each of n^{a} and n^{b} independently represents an integer of 0 to 10, and the sum of n^{a} and n^{b} is not greater than 10; and
Y^{1′} represents hydrogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by —OH.

9. A liquid-crystal composition, comprising a first component and a second component, wherein the first component comprises at least one silicon-containing compound as claimed in claim 1, and the second component comprises at least one compound represented by Formula (II): 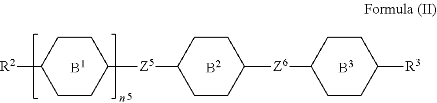
wherein
each of R² and R³ independently represents hydrogen, halogen, a C₁-C₁₅ alkyl group, or a C₂-C₁₅ alkenyl group, wherein the C₁-C₁₅ alkyl group or the C₂-C₁₅ alkenyl group is unsubstituted or at least one hydrogen atom of the C₁-C₁₅ alkyl group or the C₂-C₁₅ alkenyl group is substituted by a halogen atom, and/or at least one —CH₂— of the C₁-C₁₅ alkyl group or the C₂-C₁₅ alkenyl group is substituted by —O—, and wherein the —O— do not directly bond to another —O—;
each of B¹, B², and B³ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is unsubstituted or at least one hydrogen atom of the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is substituted by a halogen atom or a CN group, and/or at least one —CH₂— of the 1,4-phenylene group, the 1,4-cyclohexylene group, the 1,3-dioxane-2,5-diyl group, the benzofuran-2,5-diyl group, the tetrahydronaphthalene-2,6-diyl group, or the tetrahydropyran-2,5-diyl group is substituted by —O—, —N— or —S—, and wherein the —O—, —N—, and —S— do not directly bond to one another;
each of Z⁵ and Z⁶ independently represents a single bond, a C₁-C₄ alkylene group, a C₂-C₄ alkenylene group, or a C₂-C₄ alkynylene group, wherein the C₁-C₄ alkylene group, the C₂-C₄ alkenylene group, or the C₂-C₄ alkynylene group is unsubstituted or at least one hydrogen atom of the C₁-C₄ alkylene group, the C₂-C₄ alkenylene group, or the C₂-C₄ alkynylene group is substituted by a halogen atom or a CN group, and/or at least one —CH₂— of the C₁-C₄ alkylene group, the C₂-C₄ alkenylene group, or the C₂-C₄ alkynylene group is substituted by —O— or —S—, and wherein the —O— does not directly bond to —O— or —S—, and —S— does not directly bond to —S—; and
n⁵ represents 0, 1, or 2, and when n⁵ represents 2, two B¹ groups are identical to each other or different from each other.

10. The liquid-crystal composition as claimed in claim 9, wherein the second component comprises at least one compound represented by Formula (II-1) or Formula (II-2): 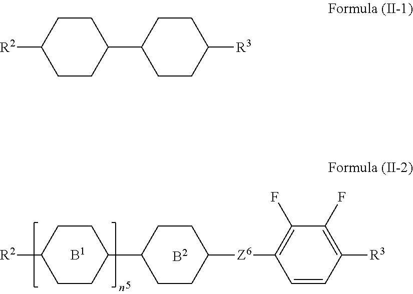
wherein
the definitions of R², R³, B¹, B², Z⁶, and n⁵ are respectively the same as the definitions of R², R³, B¹, B², Z⁶, and n⁵ defined in claim 9.

11. The liquid-crystal composition as claimed in claim 9, wherein the first component is 0.01-40 wt %, based on 100 wt % of a total weight of the liquid-crystal composition.

12. The liquid-crystal composition as claimed in claim 9, wherein the second component is 30-99.99 wt %, based on 100 wt % of a total weight of the liquid-crystal composition.

13. The liquid-crystal composition as claimed in claim 9, further comprising a third component, wherein the third component comprises at least one compound represented by Formula (III), Formula (IV), or Formula (V): 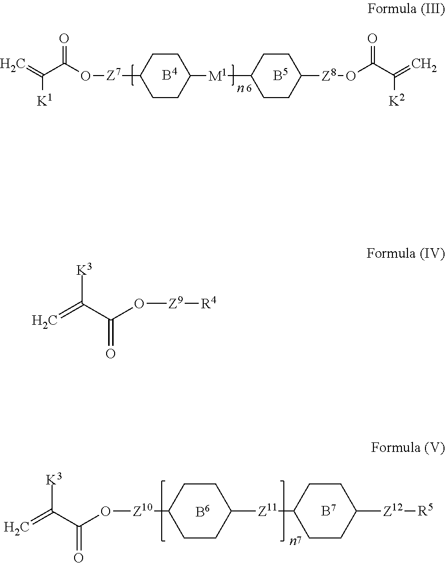
wherein
each of K¹, K², K³, and K⁴ independently represents hydrogen or a methyl group;
each of Z⁷ and Z⁸ independently represents a single bond, a C₁-C₁₅ linear alkylene group, a C₃-C₁₅ branched alkylene group, a C₂-C₁₅ linear alkenylene group, or a C₃-C₁₅ branched alkenylene group, wherein the C₁-C₁₅ linear alkylene group, the C₃-C₁₅ branched alkylene group, the C₂-C₁₅ linear alkenylene group, or the C₃-C₁₅ branched alkenylene group is unsubstituted or at least one hydrogen atom of the C₁-C₁₅ linear alkylene group, the C₃-C₁₅ branched alkylene group, the C₂-C₁₅ linear alkenylene group, or the C₃-C₁₅ branched alkenylene group is substituted by a halogen atom, and/or at least one —CH₂— of the C₁-C₁₅ linear alkylene group, the C₃-C₁₅ branched alkylene group, the C₂-C₁₅ linear alkenylene group, or the C₃-C₁₅ branched alkenylene group is substituted by —O—, —CO—, —COO—, or —OCO—, and wherein the —O—, —CO—, —COO—, and —OCO— do not directly bond to one another;
each of Z⁹, Z¹⁰, Z¹¹, and Z¹² independently represents a single bond, —C≡C—, a C₁-C₁₅ linear alkylene group, a C₃-C₁₅ branched alkylene group, a C₂-C₁₅ linear alkenylene group, or a C₃-C₁₅ branched alkenylene group, wherein the C₁-C₁₅ linear alkylene group, the C₃-C₁₅ branched alkylene group, the C₂-C₁₅ linear alkenylene group, or the C₃-C₁₅ branched alkenylene group is unsubstituted or at least one hydrogen atom of the C₁-C₁₅ linear alkylene group, the C₃-C₁₅ branched alkylene group, the C₂-C₁₅ linear alkenylene group, or the C₃-C₁₅ branched alkenylene group is substituted by a halogen atom, and/or at least one —CH₂— of the C₁-C₁₅ linear alkylene group, the C₃-C₁₅ branched alkylene group, the C₂-C₁₅ linear alkenylene group, or the C₃-C₁₅ branched alkenylene group is substituted by —SiR^{e}₂—, —S—, —O—, —CO—, —COO—, —OCO—, —CO—NR^{e}—, or —NR^{e}—CO—, and the —SiR^{e}₂—, —S—, —O—, —CO—, —COO—, —OCO—, —CO—NR^{e}—, and —NR^{e}—CO— do not directly bond to one another, wherein R^{e} represents hydrogen, a C₁-C₄ linear alkyl group, or a C₃-C₄ branched alkyl group, and two R^{e} groups bonded to the same Si atom are identical to each other or different from each other;
each of B⁴, B⁵, B⁶ and B⁷ independently represents a 1,4-phenylene group, a 1,4-cyclohexylene group, a benzofuran-2,5-diyl group, a 1,3-dioxane-2,5-diyl group, a tetrahydropyran-2,5-diyl group, a divalent dioxabicyclo[2.2.2]octylene group, a divalent trioxabicyclo[2.2.2]octylene group, a tetrahydronaphthalene-2,6-diyl group, or a indane-2,5-diyl group, wherein the 1,4-phenylene group, the 1,4-cyclohexylene group, the tetrahydronaphthalene-2,6-diyl group, or the indane-2,5-diyl group is unsubstituted or is substituted by at least one substituent, wherein the at least one substituent is selected from fluorine, chlorine, a CN group, a C₁-C₁₂ linear alkyl group, a C₃-C₁₂ branched alkyl group, a C₂-C₁₂ linear alkenyl group, a C₄-C₁₂ branched alkenyl group, a C₂-C₁₂ linear alkynyl group or a C₄-C₁₂ branched alkynyl group, wherein the C₁-C₁₂ linear alkyl group, the C₃-C₁₂ branched alkyl group, the C₂-C₁₂ linear alkenyl group, the C₄-C₁₂ branched alkenyl group, the C₂-C₁₂ linear alkynyl group or the C₄-C₁₂ branched alkynyl group is unsubstituted or at least one hydrogen atom of the C₁-C₁₂ linear alkyl group, the C₃-C₁₂ branched alkyl group, the C₂-C₁₂ linear alkenyl group, the C₄-C₁₂ branched alkenyl group, the C₂-C₁₂ linear alkynyl group or the C₄-C₁₂ branched alkynyl group is substituted by a halogen atom, and/or at least one —CH₂— of the C₁-C₁₂ linear alkyl group, the C₃-C₁₂ branched alkyl group, the C₂-C₁₂ linear alkenyl group, the C₄-C₁₂ branched alkenyl group, the C₂-C₁₂ linear alkynyl group or the C₄-C₁₂ branched alkynyl group is substituted by —O—, —CO—, —COO—, or —OCO—, and the —O—, —CO—, —COO—, and —OCO— do not directly bond to one another;
M¹ represents a single bond, —CH₂O—, —OCH₂—, —CH₂CH₂—, —CH═CH—, —C≡C—, —CH₂—, —C(CH₃)₂—, —C(CF₃)₂—, —SiH₂—, —Si(CH₃)₂—, or —Si(CF₃)₂—;
each of R⁴ and R⁵ independently represents a C₁-C₇₀ linear alkyl group or a C₃-C₇₀ branched alkyl group, wherein the C₁-C₇₀ linear alkyl group or the C₃-C₇₀ branched alkyl group is unsubstituted or at least one hydrogen atom of the C₁-C₇₀ linear alkyl group or the C₃-C₇₀ branched alkyl group is substituted by a halogen atom, and/or at least one —CH₂— of the C₁-C₇₀ linear alkyl group or the C₃-C₇₀ branched alkyl group is substituted by —Si—, —O—, —CO—, —COO—, or —OCO—, and the —Si—, —O—, —CO—, —COO—, and —OCO— do not directly bond to one another; and
each of n⁶ and n⁷ independently represents an integer of 0 to 3, and when n⁶ is greater than 2, two groups comprising B⁴ and M¹ are identical to each other or different from each other, and when n⁷ is greater than 2, two groups comprising B⁶ and Z¹¹ are identical to each other or different from each other.

14. The liquid-crystal composition as claimed in claim 13, wherein the third component is 0.01-50 wt %, based on 100 wt % of a total weight of the liquid-crystal composition.

15. A liquid-crystal display device comprising:
a first substrate;
a second substrate disposed opposite to the first substrate;
a liquid-crystal layer disposed between the first substrate and the second substrate, wherein the liquid-crystal layer comprises the silicon-containing compound as claimed in claim 1.
